(19) United States
(12) Patent Application Publication
(10) Pub. No.: US 2024/0204494 A1
(43) Pub. Date: Jun. 20, 2024

(54) LOCATING METHOD

(71) Applicant: ADVANCED INNERGY LTD, Gloucester, Gloucestershire (GB)

(72) Inventor: Gregory Stanley VAN HINSBERGH, Gloucester (GB)

(21) Appl. No.: 18/554,037

(22) PCT Filed: Mar. 30, 2022
(86) PCT No.: PCT/GB2022/050786

§ 371 Date: Oct. 5, 2023

(30) Foreign Application Priority Data
Apr. 7, 2021 (GB) 2104953.1

(51) Int. Cl. H02G 1/08; H02G 1/10

(52) U.S. Cl. CPC H02G 1/081; H02G 1/10

(57) ABSTRACT

A method for locating a rigid support body at a predetermined location with respect to an aperture in a wall of a facility is disclosed. The method comprises the steps of: providing a rigid support body at a first position outside a facility, the rigid support body comprising at least one retaining element disposed in a storage position, and comprising a through-bore that extends through the support body from a first end of the support body to a further end; via a first pulling force applied to a first terminal end region of a flexible elongate member that includes a covered region located in the through-bore, urging the rigid support body at least partially through an aperture in a wall of a facility, the rigid support body thereby being located at a further position whereby a portion of the rigid support body and at least one retaining element supported on the rigid support body is within the facility and the retaining element is spaced apart from an inner surface of the wall of the facility; subsequent to location of said retaining element within the facility and in a spaced apart relationship with said inner wall surface, positioning the retaining element out of a storage position by selectively swivelling the retaining element from the storage position; and subsequently urging the rigid support body into a retained position whereby at least a portion of an abutment surface of the retaining element is disposed in an abutting relationship with the inner surface of the wall proximate to the aperture to thereby locate the rigid support body at a predetermined location with respect to the aperture in which the retaining element is disposed in a deployed position.

The present invention relates to a method for locating a rigid support body at a predetermined location with respect to an aperture in a wall of a facility. In particular, but not exclusively the invention relates to installing a rigid support body of a cable protection system (CPS) at a predetermined position with respect to an aperture in a wall of a facility whereby a retaining element that can swivel to continually adjust its orientation is used to retain the rigid support body at the predetermined position.

From time to time, it is known that flexible elongate members such as electricity cables, flexible pipes, umbilical's or the like need to be passed through a rigid fixed wall in a facility for various reasons. These reasons may include transferring electrical power or utilities to and/or from the facility. The rigid wall is often therefore provided with an aperture through which the flexible elongate member is passed. The flexible elongate member then needs to be held in place with respect to the aperture in the wall of that facility. If the aperture of the facility is located below a local water level there may be an additional need to seal a gap between an outside of the flexible elongate member and the wall of the facility. Depending upon the particular use in question the wall and flexible elongate member need to be held in a predetermined spatial relationship for a prolonged period of time. The predetermined spatial relationship may account for a degree of motion of the elongate member with respect to the wall due to stretching or slipping of the elongate member, and motion of the flexible elongate member due to environmental effects, such as currents/wave cycles outside the facility in a subsea environment for example.

A wide variety of situations wherein passage of a flexible elongate member through one or more wall-like parts of a facility are known. One example of such a situation relates to the provision of a power cable through a monopile section of an offshore wind turbine generator (WTG). Other examples of facilities where passage of a flexible elongate member through a wall-like part of the facility may be desired include concrete WTG foundations, gravity based WTG foundations, floating solar array foundations, tidal wave generation structures, structures associated with telecommunications systems, structures associated with hydraulic systems, structures associated with fluid transfer systems via pipes and the like, structures associated with underwater mining operations, structures associated with underwater oil and gas extraction, structures associated with fracking activities, structures associated with offshore power generation, structures associated with onshore power generation, structures associated with power distribution networks (for example substations and transformers) structures associated with portable power technologies, structures associated with venting gases (for example venting hydrogen gas produced by hydrolysis at offshore wind turbines or solar installations), and the like. The walls of such facilities may be formed from different materials and have a variety of dimensions such as thickness. For example, a wall may be a flat metallic or round metallic element or may be a flat or round concrete element.

In the case of WTGs it is known that these may be located in a variety of different places. For example onshore WTGs are known and include WTGs situated on dry land and also WTGs situated in inland bodies of water such as lakes. Offshore WTGs are also known and are typically arranged such that a monopile section of the WTG facility is submerged in seawater. WTGs could of course alternatively be arranged in freshwater or brackish water environments. For both onshore WTGs and offshore WTGs, it may be desired that a flexible elongate member, such as an electricity cable, is passed into the WTG from the surrounding environment outside a wall of a facility via an aperture in the wall of the WTG. Often, for offshore WTGs and partially submerged onshore WTGs, the aperture is located in a monopile section of the WTG and is therefore below an expected water level of the environment. The monopile portion of the WTG includes a section that is piled into the ground and an upper portion that protrudes upwards to which other parts of the WTG are effectively mounted. In such situations, the dynamic nature of a nearby water environment (due to tides, wave cycles, currents and the like) causes the cable to move. Such motion of the cable, when situated in an aperture of a monopile wall, can cause significant damage to the cable due to excessive bending, and by abutment and chafing of the cable on the inner surface/edge of the aperture through which the cable extends. It is therefore desirable to arrange a cable protection system (CPS) radially around a portion of the cable that includes the part of the cable which extends through the aperture, when the cable is installed in the WTG, or other facility.

A Cable Protection System (CPS) can be received by a suitable CPS aperture in the monopile of the WTG. The CPS is an assembly of multiple elements that help retain the cable in a relative position with respect to the wall of the monopile, and helps control bending of the cable within the inside of the monopile and outside of the monopile wall. The CPS also provides protection for the outer surface of the cable and helps reduce any damage to the cable due to abutment with the inner surface of the aperture in the monopile wall. That is to say the implementation of a cable protection system helps protect the cable from abrasion at the aperture and/or over bending during installation and operation at the aperture by providing a minimum bend radius for a specified moment load. The CPS aperture is ideally as small as possible as it has a direct effect on the fatigue life of the supporting asset (monopile wall).

The CPS typically includes a support body which surrounds the cable portion that resides in and through the aperture of the monopile wall at any given moment in time in use. When the CPS is installed in the WTG monopile, via an aperture in the monopile wall, a retaining method is utilised to retain the support body of the CPS at a predetermined position with respect to the aperture such that the CPS acts to protect the cable. The retaining method typically helps prevent removal of the support body, and thus the CPS, from the aperture in the monopile wall. Often, CPS retaining methods described in the prior art include numerous spring-activated high strength latches each with a single terminal abutment surface. When being inserted into an aperture the latches retract inside the CPS and then, due to the spring loading, extend out from the CPS to retain the CPS in the aperture via engagement with the single abutment surface of each latch and an inner surface of the monopile wall near the edge of the aperture. This approach however results in significant point loading on each of the latches. Due to the significant weight of a cable and CPS being supported on the latches, there is a significant risk of failure of the latches and a significant risk of damage to the inner surface of the monopile wall due to a concentrated pressure exerted on the monopile wall by the relatively small abutment surface of each latch.

Presently offshore and onshore WTG cable and cable protection system failures are prolific. These are very costly in terms of lost revenue and cable and cable protection replacement. New WTGs can generate electricity up to £50,000 per day and therefore the failure of a retaining latch can have large financial implications. Furthermore, should a latch fail or cause damage the WTG monopile, the CPS utilising this typical retaining method is not easy to remove from the WTG monopile for maintenance or decommission. This may incur further costs and may result in further lost revenue.

Furthermore, installing a CPS that utilises the latch based retaining method of the prior art through an aperture in a monopile wall can be challenging as the biasing force acting on each latch via respective springs must be overcome. If a rigid support body is simply urged through the aperture in the monopile wall, the forces imparted on the regions of the monopile wall proximate the aperture by the latches due to the biasing springs may damage the monopile wall and widen the aperture, malform the aperture or weaken the wall surrounding the aperture. This may have disastrous consequences should the monopile wall proximate the aperture fail such that the CPS is no longer retained in position by the latches. If the prior latches are held down, or locked down, while a support body of the CPS is urged into the aperture, this may require the use of further equipment such as deep water ROV's and the like and adds further complications to the installation process. Furthermore, damage to the monopile wall proximate the aperture may still occur when the latches are released inside the monopile and spring into a retaining orientation due to the biasing force provided by the springs. Given the substantial load on a latch and the associated spring during use, it will be appreciated that the biasing force applied to the latch is significant. Furthermore, it is known that installation of a CPS, utilising the latches of the prior art, through an aperture in a monopile wall often results in misalignment of the latches. This misalignment can result in considerable forces being imparted on a particular latch that is supporting the load of the CPS system and therefore contributes to damage to and/or failure of the prior art latches and to the inner surface of the monopile wall due to excessive point loading.

The failure of a retaining latch in prior art systems, possibly partially due to CPS misalignment, can result in an associated load being transferred to the next latch available latch. Current configurations can include up to twelve latches. However, during installation it is not known whether a first or a further latch is the latch that is reacting to the entire load. If there are no remaining latches to retain the CPS the CPS is able to free fall out of the WTG under gravity (which can be disastrous for the WTG system and catastrophic for the cable). Other prior art technology such as ball-grab retaining systems are known which include up to forty-eight or more spring loaded retaining balls. Such ball-grab technologies however similarly suffer from the problems indicated above in relation to the prior art latches.

It is an aim of the present invention to at least partly mitigate one or more of the above-mentioned problems.

It is an aim of certain embodiments of the present invention to provide a method for locating a rigid support body at a predetermined location with respect to an aperture in a wall of a facility.

It is an aim of certain embodiments of the present invention to provide a method for locating a rigid support body at a predetermined location with respect to an aperture in a wall of a facility in which a retaining element is selectively swivelled from a storage position to a deployed position to retain the rigid support body at the predetermined position.

It is an aim of certain embodiments of the present invention to provide a method for locating a rigid support body at a predetermined location with respect to an aperture in a wall of a facility in which, a retaining element is initially locked in a storage position so that the rigid support body can pass through the aperture unencumbered.

It is an aim of certain embodiments of the present invention to provide a method for locating a rigid support body at a predetermined location with respect to an aperture in a wall of a facility without a need for a diver or ROV to change an orientation of a retaining element.

It is an aim of certain embodiments of the present invention to provide a method for locating a rigid support body at a predetermined location with respect to an aperture in a wall of a facility in which selectively swivelling a retaining element from a storage position to a deployed position results in an equilibrium position in which an imperfect alignment of the rigid support body in the aperture does not result in a significant degree of point loading on the inner surface of the facility wall proximate the aperture.

It is an aim of certain embodiments of the present invention to provide a method for locating a rigid support body at a predetermined location with respect to an aperture in a wall of a facility in which the wall of the facility is not subject to forces provided by biasing elements during, or immediately following, passing the rigid support body from a first position in which all of the rigid support body is located outside of the facility to a further position in which a portion of the rigid support body and a retaining element is located inside of the facility.

According to a first aspect of the present invention there is provided a method for locating a rigid support body at a predetermined location with respect to an aperture in a wall of a facility, comprising the steps of: providing a rigid support body at a first position outside a facility, the rigid support body comprising at least one retaining element disposed in a storage position, and comprising a through-bore that extends through the support body from a first end of the support body to a further end; via a first pulling force applied to a first terminal end region of a flexible elongate member that includes a covered region located in the through-bore, urging the rigid support body at least partially through an aperture in a wall of a facility, the rigid support body thereby being located at a further position whereby a portion of the rigid support body and at least one retaining element supported on the rigid support body is within the facility and the retaining element is spaced apart from an inner surface of the wall of the facility; subsequent to location of said retaining element within the facility and in a spaced apart relationship with said inner wall surface, positioning the retaining element out of a storage position by selectively swivelling the retaining element from the storage position; and subsequently urging the rigid support body into a retained position whereby at least a portion of an abutment surface of the retaining element is disposed in an abutting relationship with the inner surface of the wall proximate to the aperture to thereby locate the rigid support body at a predetermined location with respect to the aperture in which the retaining element is disposed in a deployed position.

Aptly the method further comprises securing a terminal end of a first winching line to the first terminal end region of the flexible elongate member, the winching line optionally being secured to the flexible elongate member via a Chinese finger cable grip element.

Aptly the method further comprises providing the first pulling force via a tension in the first winching line provided by a winching element coupled to a remaining terminal end of the first winching line.

Aptly the method further comprises applying the first pulling force applied to the first terminal end in a first pulling direction and, via the first pulling force, providing an urging force to the rigid support body in a first penetration direction aligned with an axis of the rigid support body.

Aptly the method further comprises applying the first pulling force applied to the first terminal end in the first pulling direction that is a substantially vertically upward direction.

Aptly the method further comprises securing a remaining terminal end region of the flexible elongate member to a tensioning element, the tensioning element optionally being secured to the flexible elongate member via a further Chinese finger cable grip element, the tensioning element optionally comprising a further winching line, a cable engine or a clamping quadrant.

Aptly the method further comprises, via a further pulling force on the tensioning element, urging the rigid support body in a further penetration direction directed away from within the facility, the penetration direction optionally extending in an axis that is around 45 degrees to the primary axis associated with the wall of the facility.

Aptly the method further comprises urging the rigid support body into the retained position via relaxing the first pulling force and allowing movement of a previously inside portion of the rigid support body out of the facility via gravity.

Aptly the method further comprises positioning the retaining element by selectively swivelling the retaining element from the storage position to the deployed position, optionally via an intermediate position.

Aptly the method further comprises selectively swivelling at least one of a pair of retaining arms, each disposed on respective opposed sides of the rigid support body, about a respective swivel point, from a storage position towards a deployed position, optionally via an intermediate position.

Aptly the method further comprises simultaneously swivelling both retaining arms of the pair.

Aptly the step of selectively swivelling further comprises removing a securing constraint on each retaining arm and subsequently urging each retaining arm to the deployed position via gravity or via a biasing force exerted via a biasing member.

Aptly the method further comprises reversibly urging the retaining element into a deployed position.

Aptly the method further comprises, via a sealing element, sealing the aperture around the rigid support body to thereby prevent fluid communication between the facility and the environment in at least one direction.

Aptly the method further comprises, with the rigid body in the retained position in which an axial position of the rigid support body with respect to a location of the aperture remains substantially unchanged, constantly adjusting a swivel angle and/or an angle of attack, of an abutment surface of a retaining element, adopted by each retaining element responsive to environmental forces whereby the retaining element maintains an equilibrium position responsive to all forces exerted on the rigid support body despite at least one of a yaw and pitch and roll angle associated with an orientation of the rigid support body varying.

Aptly the method further comprises releasing each retaining element from a storage position by breaking a frangible connection of an associated retaining latch arm via an ROV or by urging an abutment element of the latch arm into abutment with an outside surface of the wall as the rigid support body is urged at least partly through the aperture.

Aptly at least a portion of the inner surface of the wall of the facility comprises a protective layer to reduce damage and/or wear, the protective layer optionally being corrosion resistant.

Aptly the facility comprises a monopile that optionally comprises a portion of a turbine tower of a Wind Turbine Generator (WTG).

Aptly the flexible elongate member comprises a flexible pipe or umbilical or a submarine cable and optionally the elongate member comprises a dynamic portion of a submarine electricity cable.

Aptly the rigid support body is arranged, in the retained position in which the retaining element is located in a deployed position, at an oblique angle in respect of a vertical axis associated with the facility, the angle optionally being about around 45 degrees.

Certain embodiments of the present invention provide a method for locating a rigid support body at a predetermined location with respect to an aperture in a wall of a facility in which the wall is not subjected to possibly harmful forces due to point loading of a retaining element.

Certain embodiments of the present invention provide a method for locating a rigid support body at a predetermined location with respect to an aperture in a wall of a facility in which the wall is not subjected to possibly harmful forces due to abutment of biased retaining elements as the retaining elements are passed through the aperture.

Certain embodiments of the present invention provide a method for locating a rigid support body at a predetermined location with respect to an aperture in a wall of a facility in which misalignment of the rigid support body does not result in aberrant loading on the monopile wall via a retaining element.

Certain embodiments of the present invention provide a method for locating a rigid support body at a predetermined location with respect to an aperture in a wall of a facility in which when a retaining element is in a deployed position, the retaining element is in an equilibrium position and is a pair of simply supported beams thereby significantly reducing a load pressure on the inner and/or aperture surfaces of the monopile wall.

Certain embodiments of the present invention utilise one or more retaining elements such as retaining arms that are arranged to be able to swivel with respect to a supporting rigid body. The connectors that permit swivelling are able to carry high load forces making them resistant to failure and the ability to swivel means that each retaining arm can automatically and constantly adjust its relative angle of rotation to accommodate local environmental forces.

Certain Embodiments of the present invention will now be described hereinafter, by way of example only, with reference to the accompanying drawings in which:

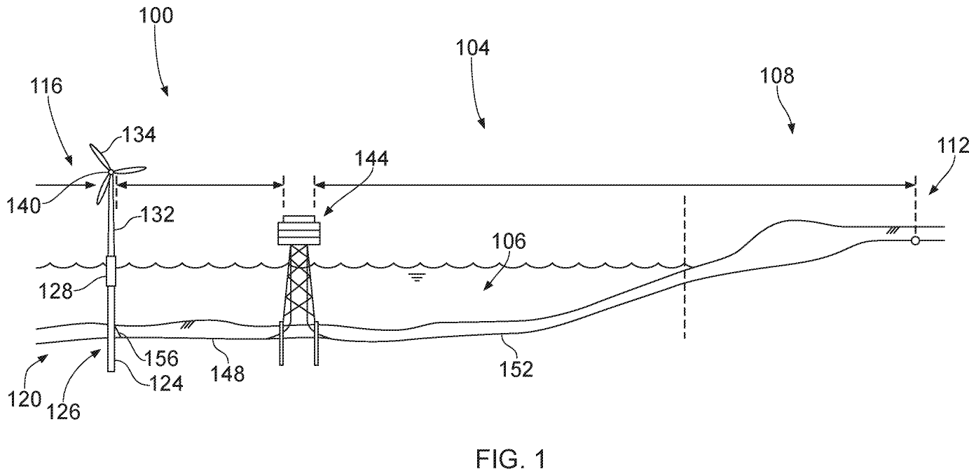

FIG. 1 illustrates a possible environment including an offshore structure;

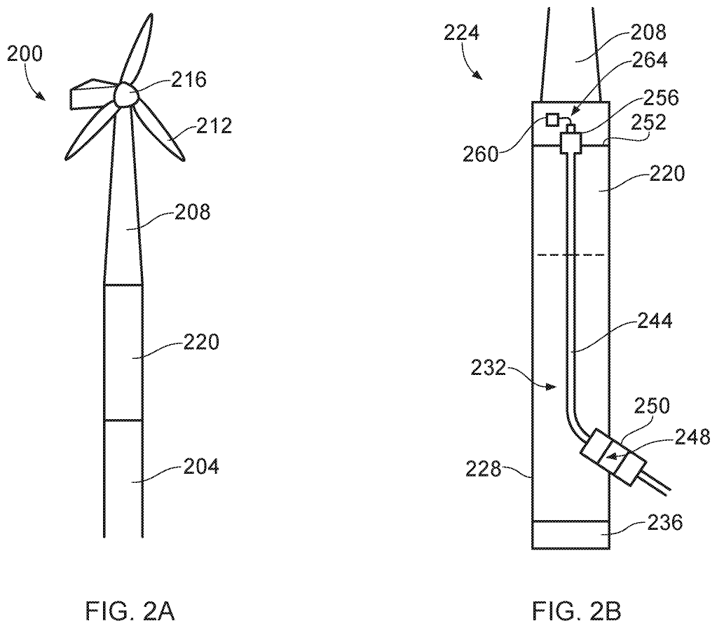

FIG. 2A illustrates an upper portion of a wind turbine generator in more detail;

FIG. 2B illustrates a lower portion of a wind turbine generator in more detail;

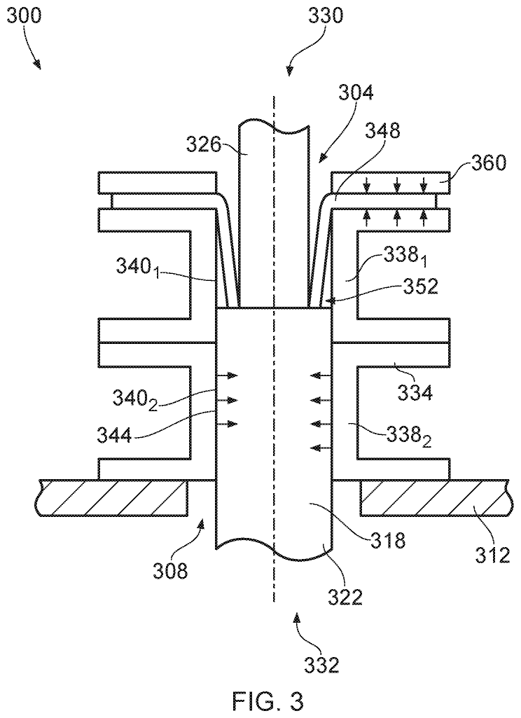

FIG. 3 illustrates a hang-off clamp in more detail;

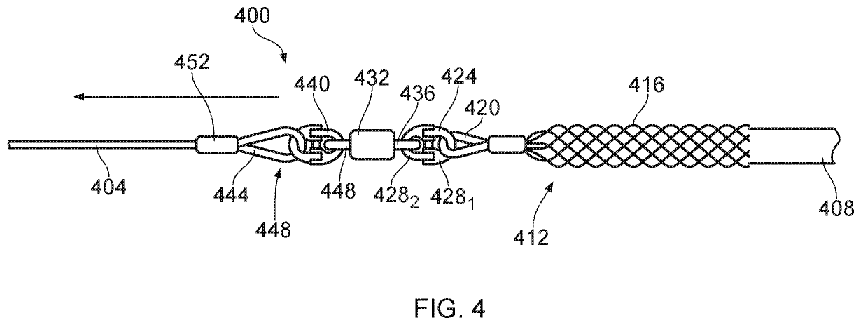

FIG. 4 illustrates a connection between a subsea electrical cable and a winching line;

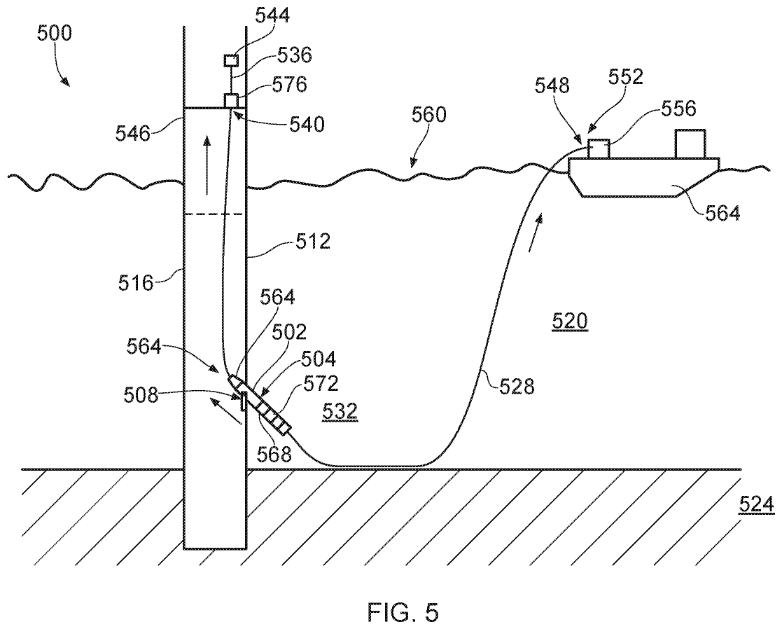

FIG. 5 illustrates the installation of a cable protection system at a predetermined position with respect to an aperture in a monopile wall;

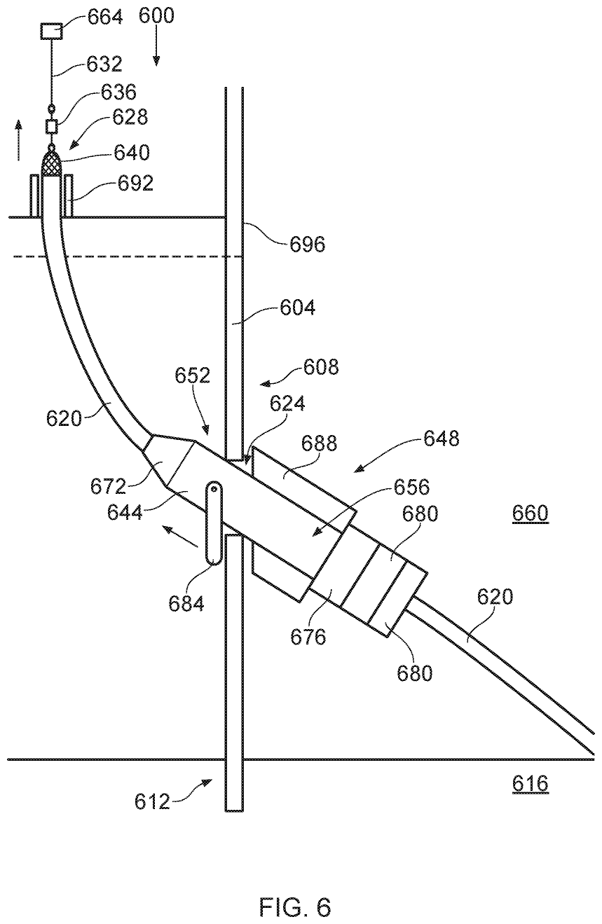

FIG. 6 illustrates the installation of a cable protection system at a predetermined location with respect to an aperture in a monopile wall in more detail;

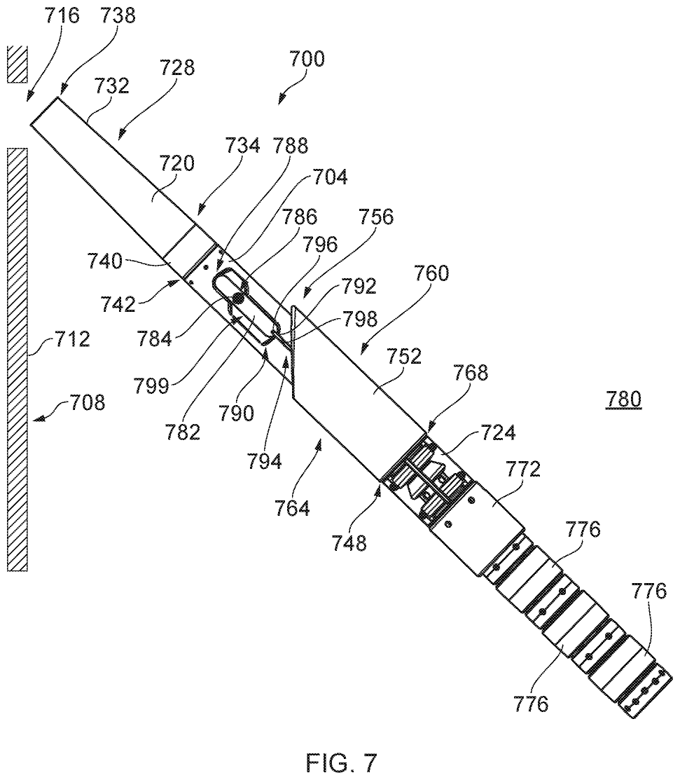

FIG. 7 illustrates a cable protection system including a rigid support body at a first position prior to installation at a predetermined position with respect to an aperture in a wall of a monopile in which the rigid support body is located outside of a monopile;

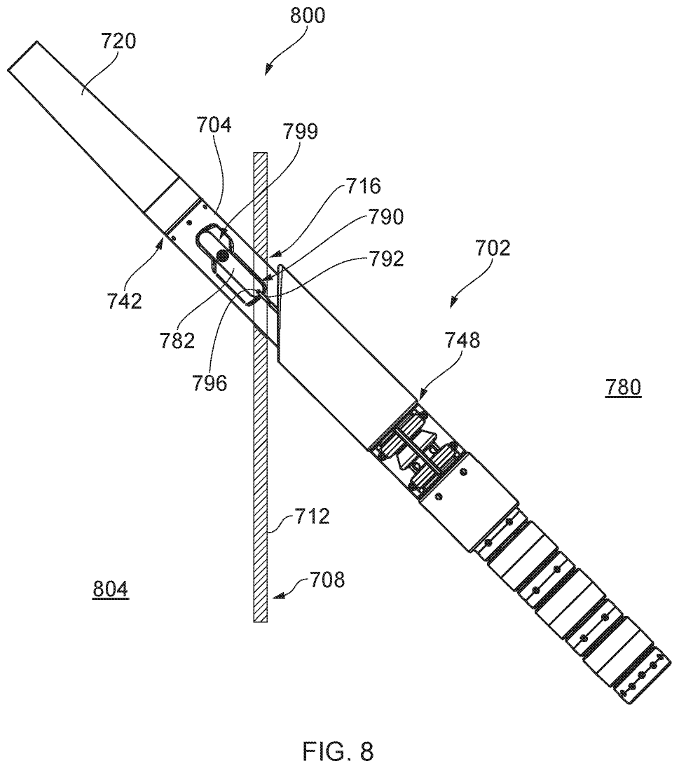

FIG. 8 illustrates the cable protection system of FIG. 7 in another position during installation as a rigid support body is passed through an aperture in a wall of a monopile;

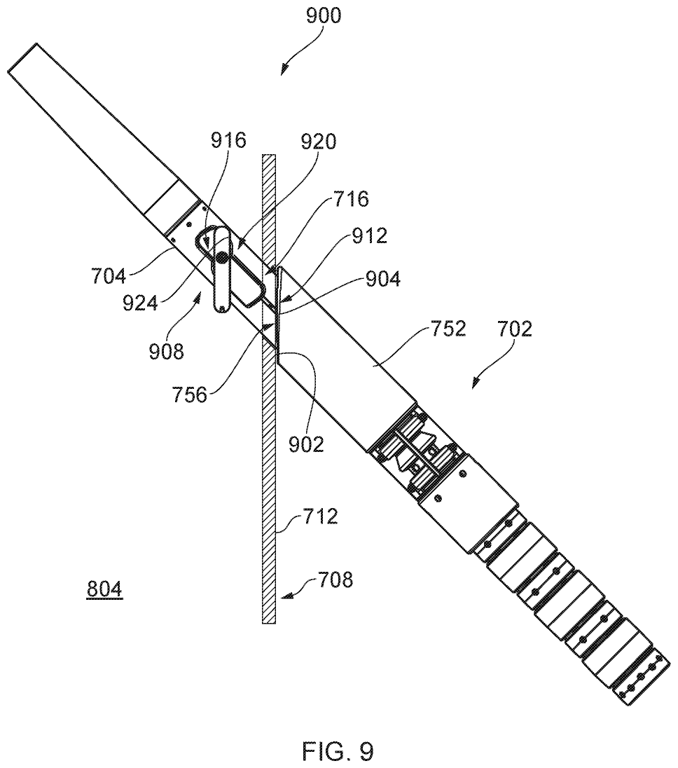

FIG. 9 illustrates the cable protection system of FIG. 7 or FIG. 8 in a further position during installation as part of a rigid support body is passed through an aperture in a wall of an offshore structure;

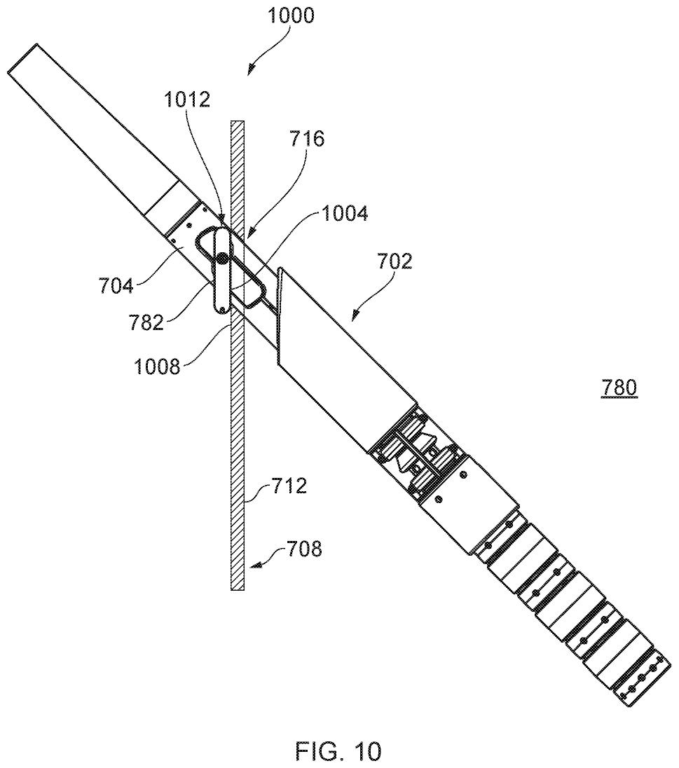

FIG. 10 illustrates the cable protection system of FIGS. 7, 8 and 9 in a retained position following installation;

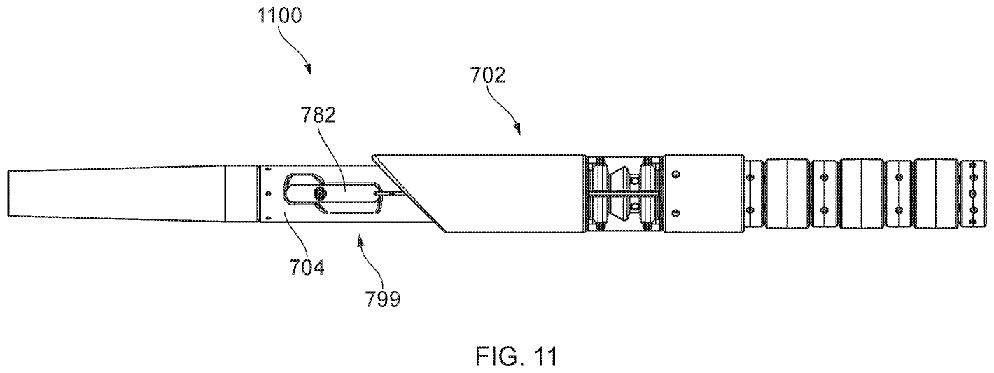

FIG. 11 illustrates another perspective view of the cable protection system of FIGS. 7 to 10 with retaining arms being arranged in the storage position;

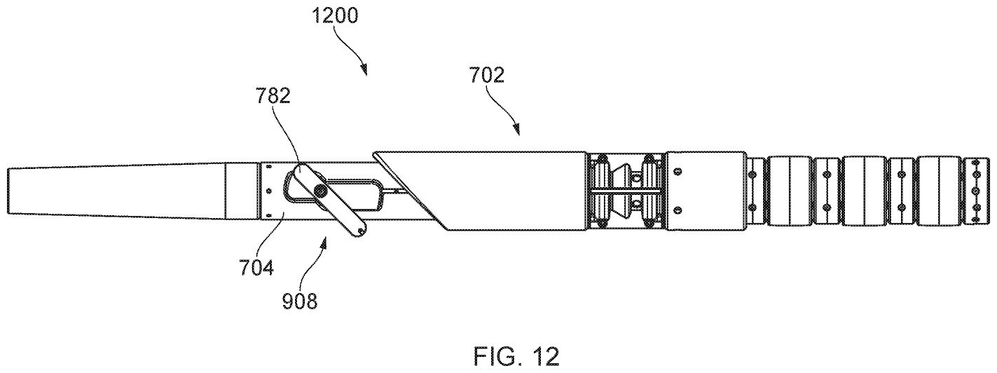

FIG. 12 illustrates another perspective view of the cable protection system of FIGS. 7 to 11 with the retaining arms no longer being arranged in the storage position and being arranged in an intermediate position;

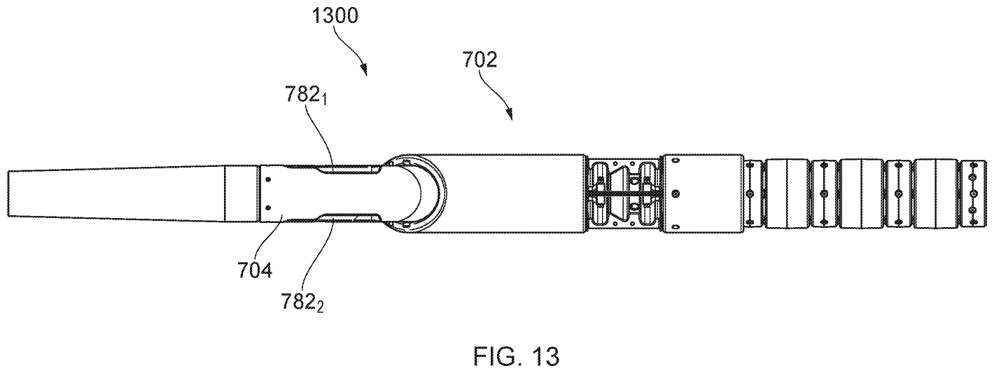

FIG. 13 illustrates a further perspective view of the cable protection system of FIG. 11;

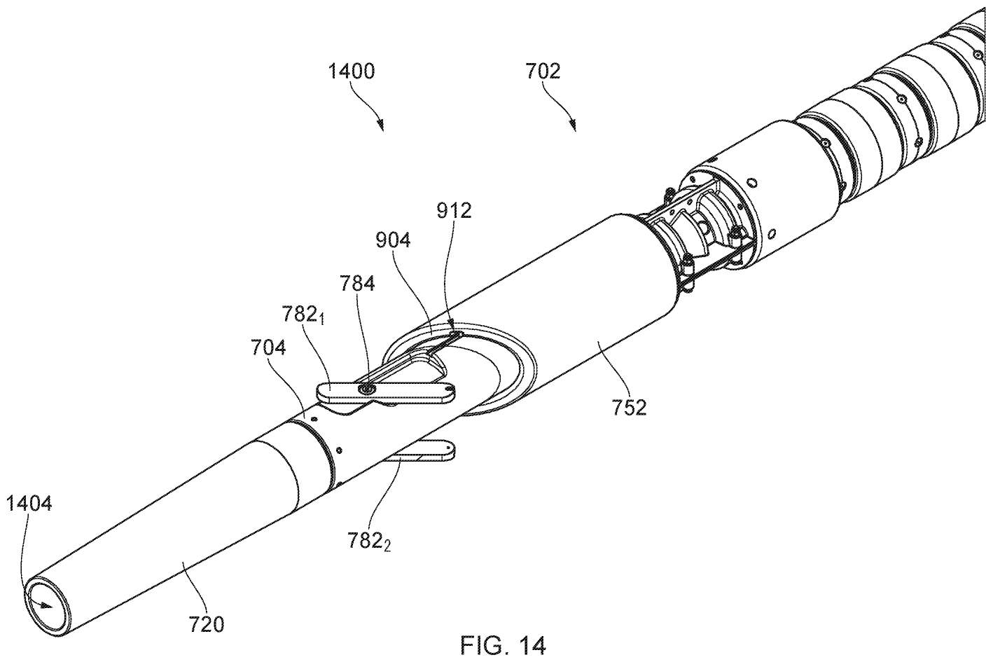

FIG. 14 illustrates a still further perspective view of a cable protection system showing retaining arms and a dished out side region;

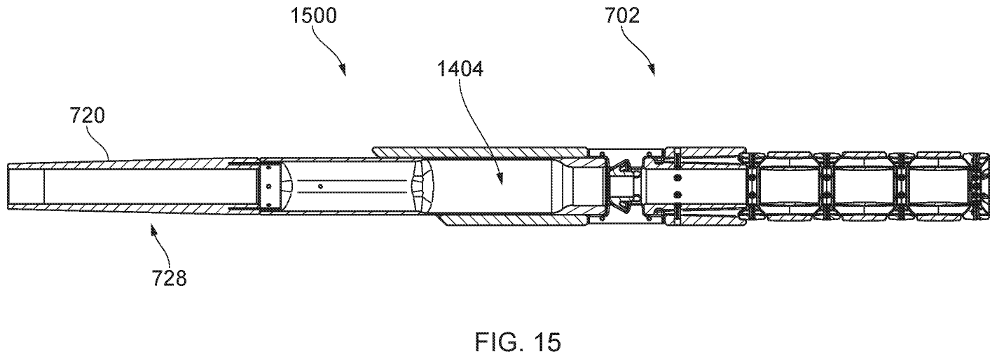

FIG. 15 illustrates a cross-sectional view of the cable protection system of FIGS. 7 to 14;

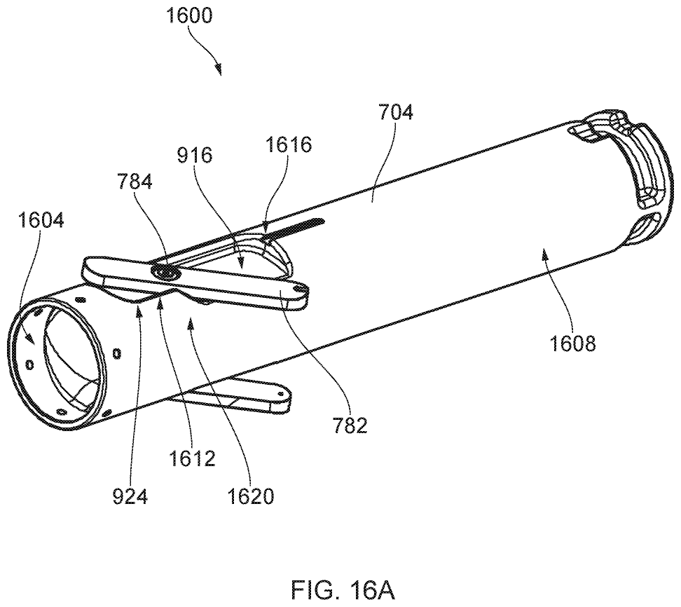

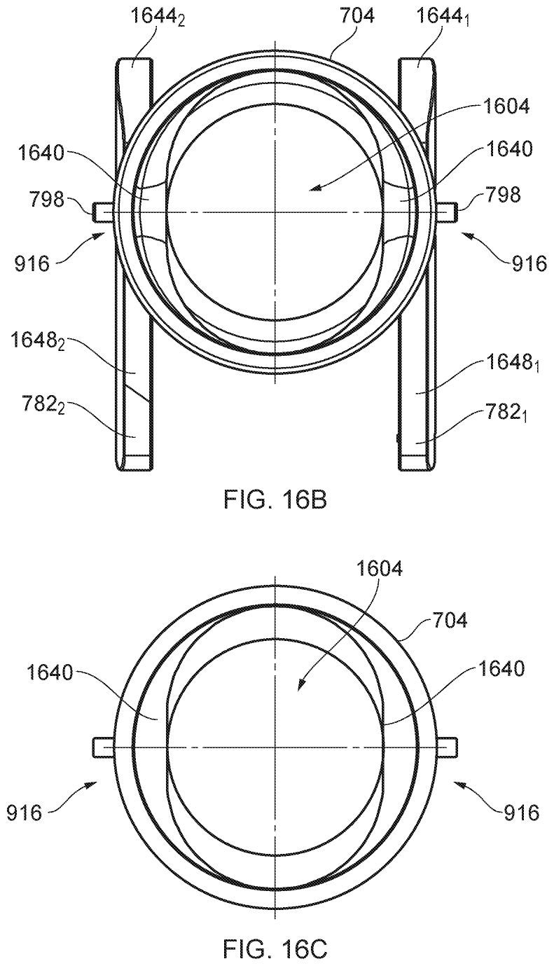

FIG. 16A illustrates a rigid support body of a cable protection system in more detail;

FIG. 16B illustrates an end on view of the rigid support body of FIG. 16A when the retaining arms are not disposed in a storage position;

FIG. 16C illustrates an end on view of the rigid support body of FIG. 16A when the retaining arms are disposed in a storage position;

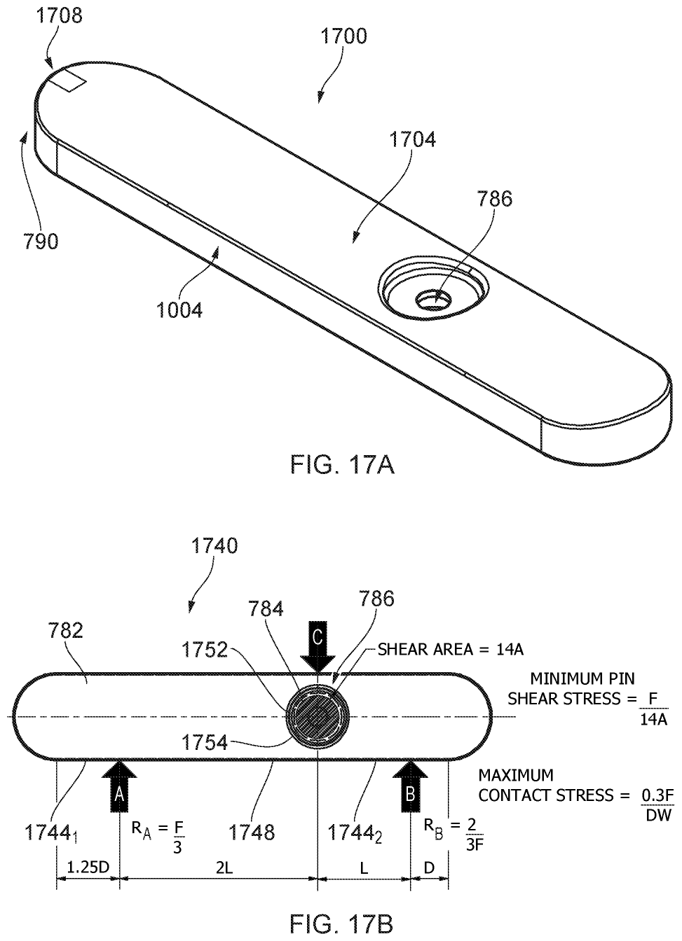

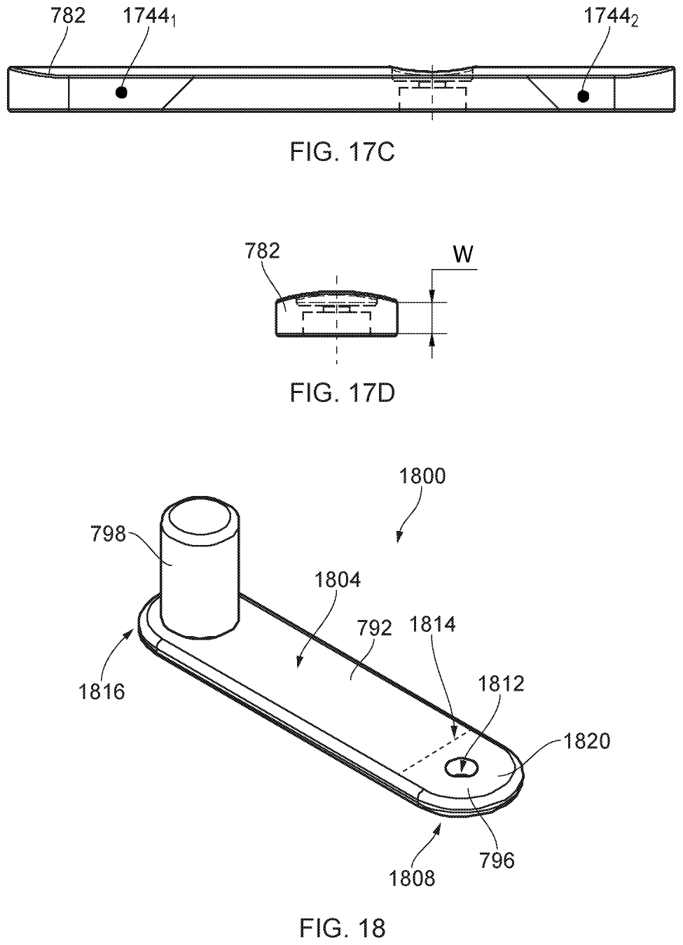

FIG. 17A illustrates the retaining arm of the cable protection system of FIGS. 7 to 16 in more detail;

FIG. 17B illustrates a further perspective view of the retaining arm of FIG. 17A;

FIG. 17C illustrates a still further perspective view of the retaining arm of FIG. 17A;

FIG. 17D illustrates another perspective view of the retaining arm of FIG. 17A;

FIG. 18 illustrates a latch arm of the cable protection system of FIGS. 7 to 17 in more detail;

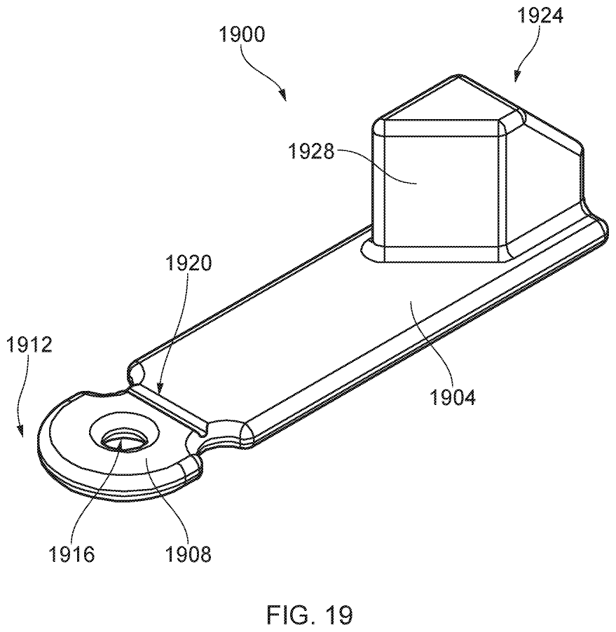

FIG. 19 illustrates an alternative latch arm for use in the cable protection system of FIGS. 7 to 17;

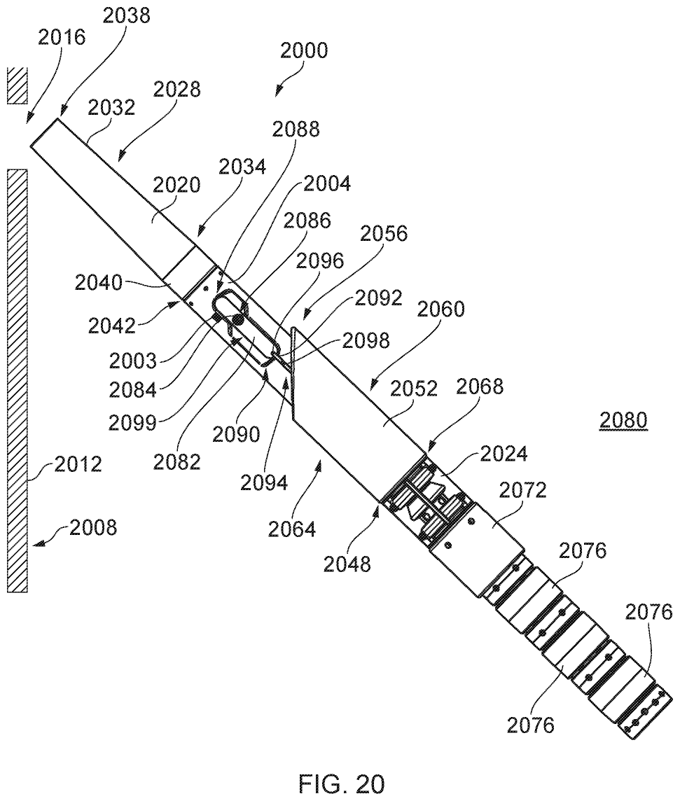

FIG. 20 illustrates an alternative cable protection system including a rigid support body at a first position, and also including a biasing spring, prior to installation at a predetermined position with respect to an aperture in a wall of a monopile in which a rigid support body is located outside of a monopile;

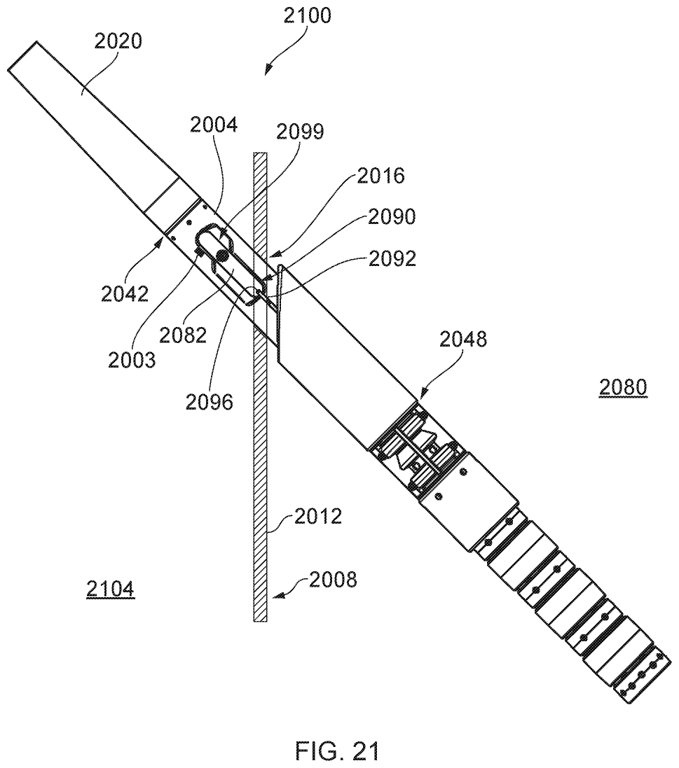

FIG. 21 illustrates the cable protection system of FIG. 20 in another position during installation as a rigid support body is passed through an aperture in a wall of a monopile;

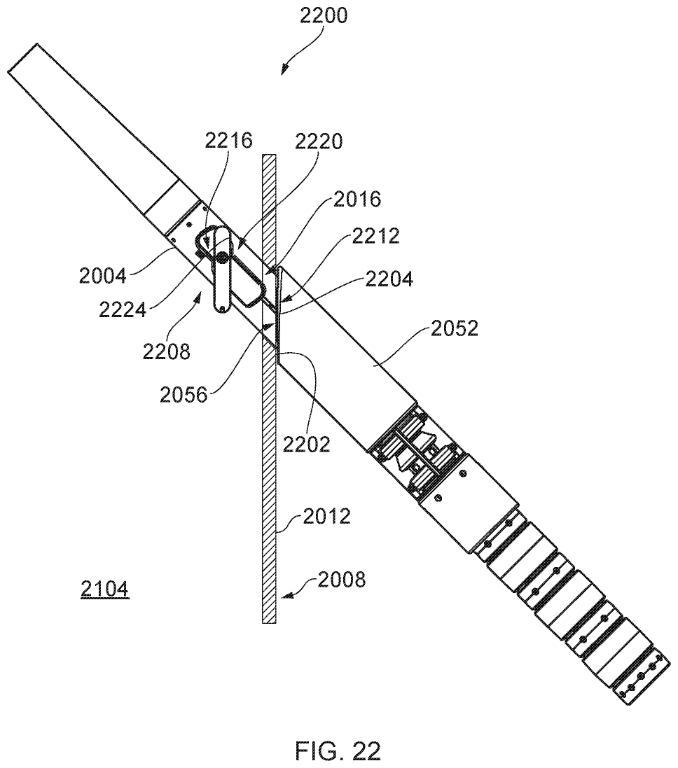

FIG. 22 illustrates the cable protection system of FIG. 21 or FIG. 22 in a further position during installation as a rigid support body is passed through an aperture in a wall of an offshore structure;

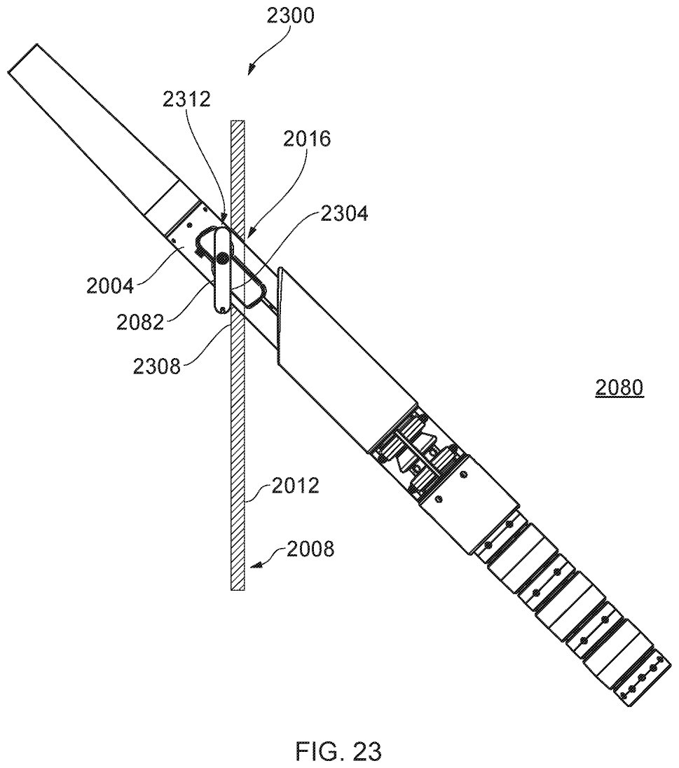

FIG. 23 illustrates the cable protection system of FIGS. 20, 21 and 22 in a retained position following installation;

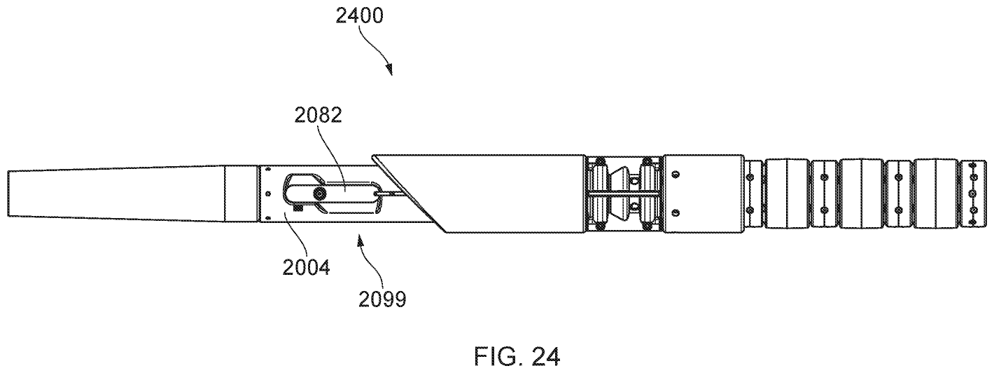

FIG. 24 illustrates another perspective view of the cable protection system of FIGS. 20 to 23 with retaining arms being arranged in the storage position;

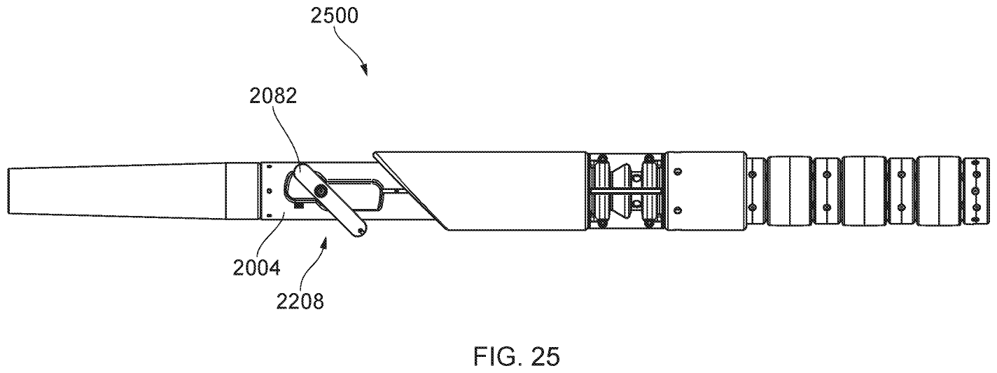

FIG. 25 illustrates another perspective view of the cable protection system of FIGS. 20 to with the retaining arms being arranged in an intermediate position;

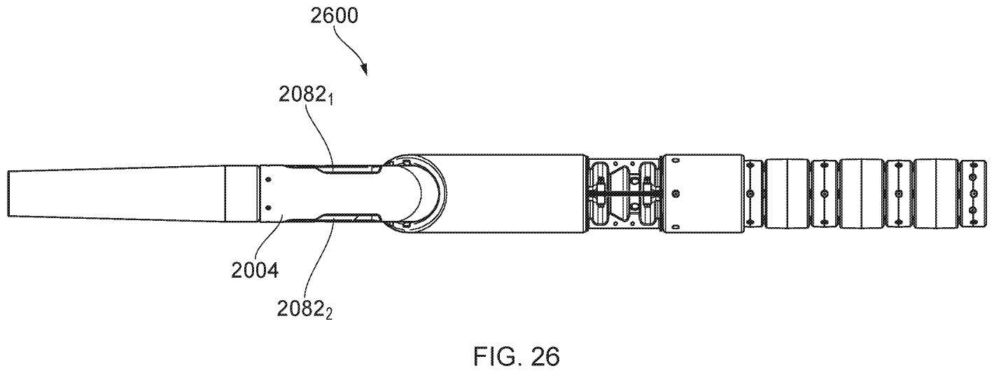

FIG. 26 illustrates a further perspective view of the cable protection system of FIG. 24;

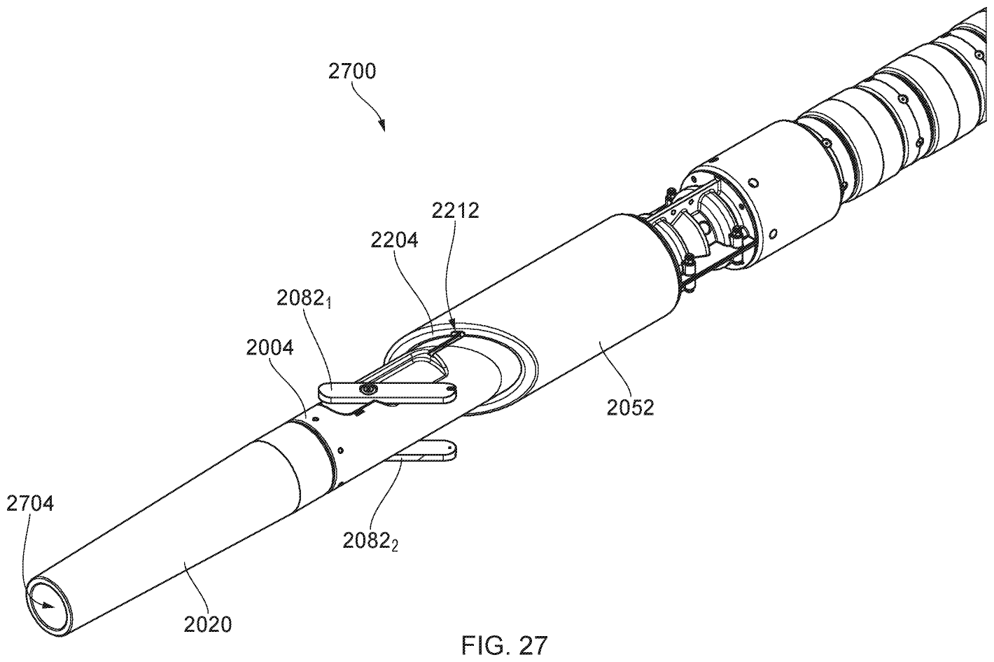

FIG. 27 illustrates a still further perspective view of a cable protection system with a biasing spring, showing retaining arms and a dished out side region;

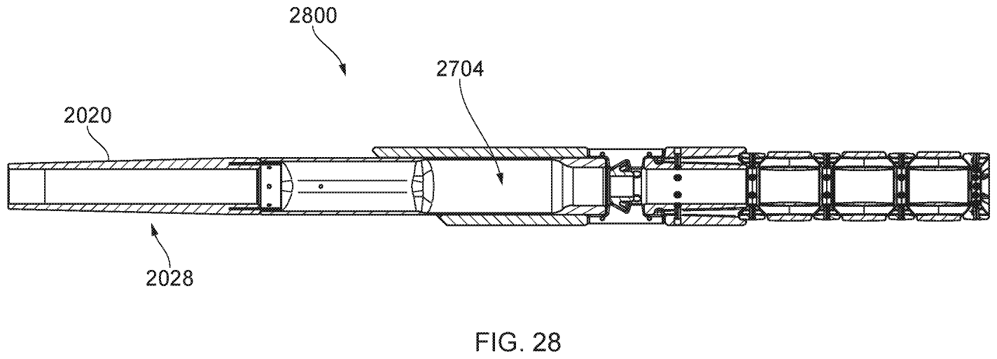

FIG. 28 illustrates a cross-sectional view of the cable protection system of FIGS. 20 to 27;

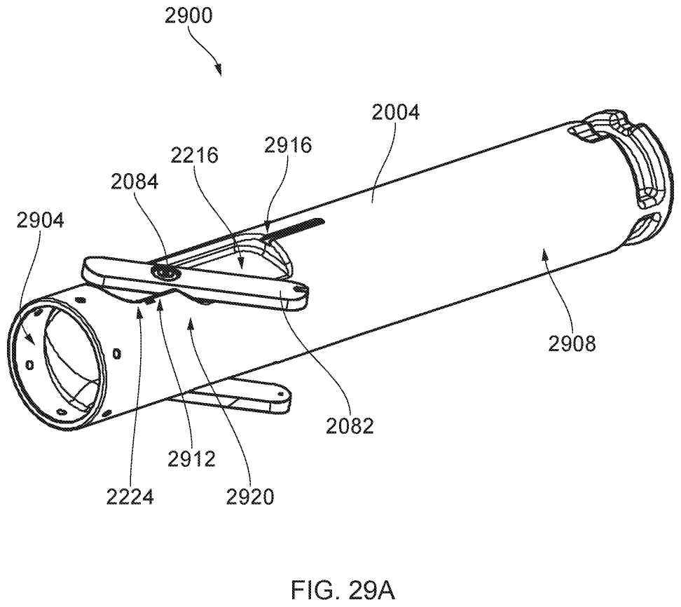

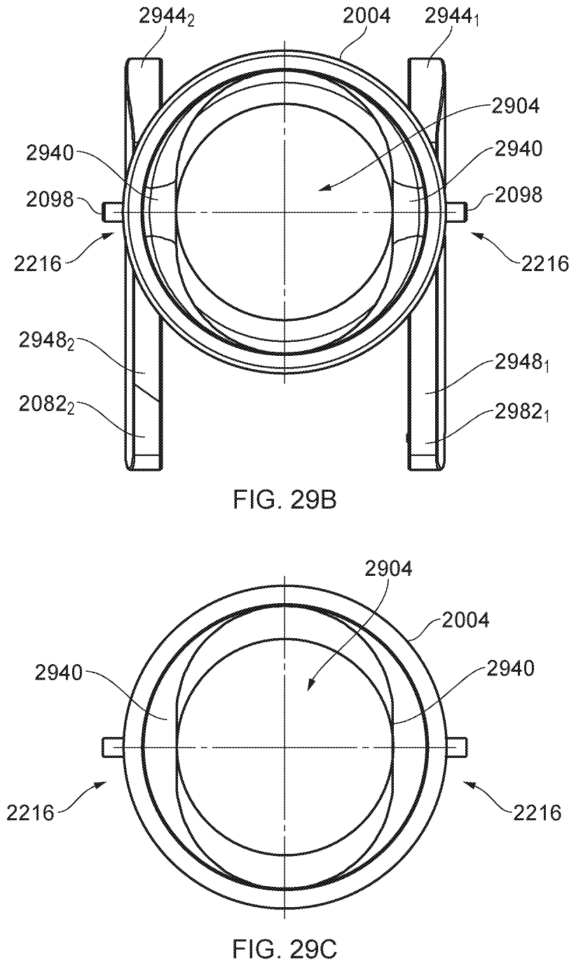

FIG. 29A illustrates a rigid support body of a cable protection system including a biasing spring in more detail;

FIG. 29B illustrates an end on view of the rigid support body of FIG. 29A when the retaining arms are not disposed in a storage position;

FIG. 29C illustrates an end on view of the rigid support body of FIG. 29A when the retaining arms are disposed in a storage position;

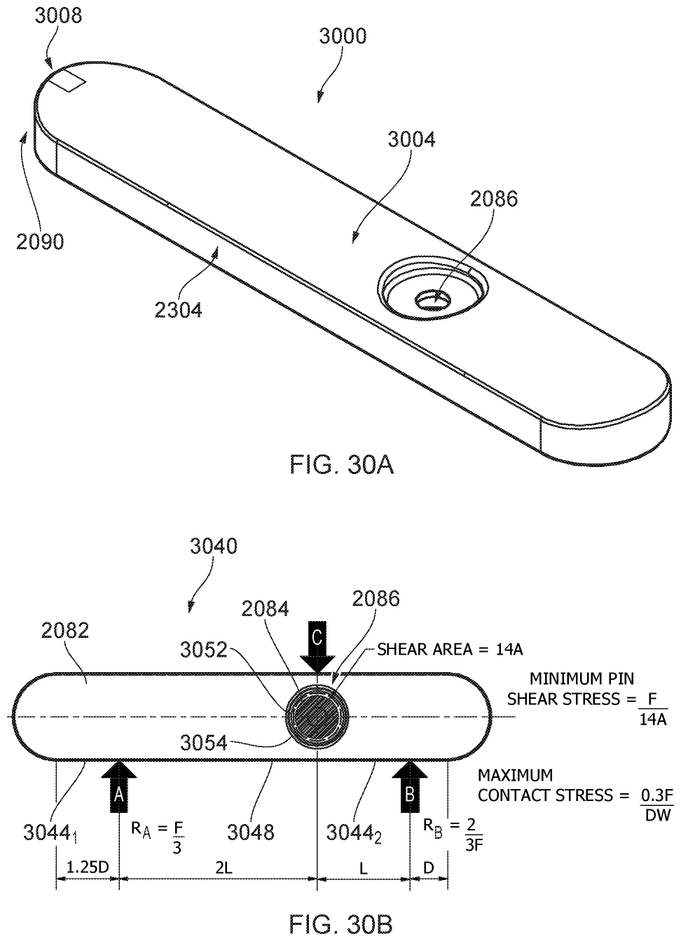

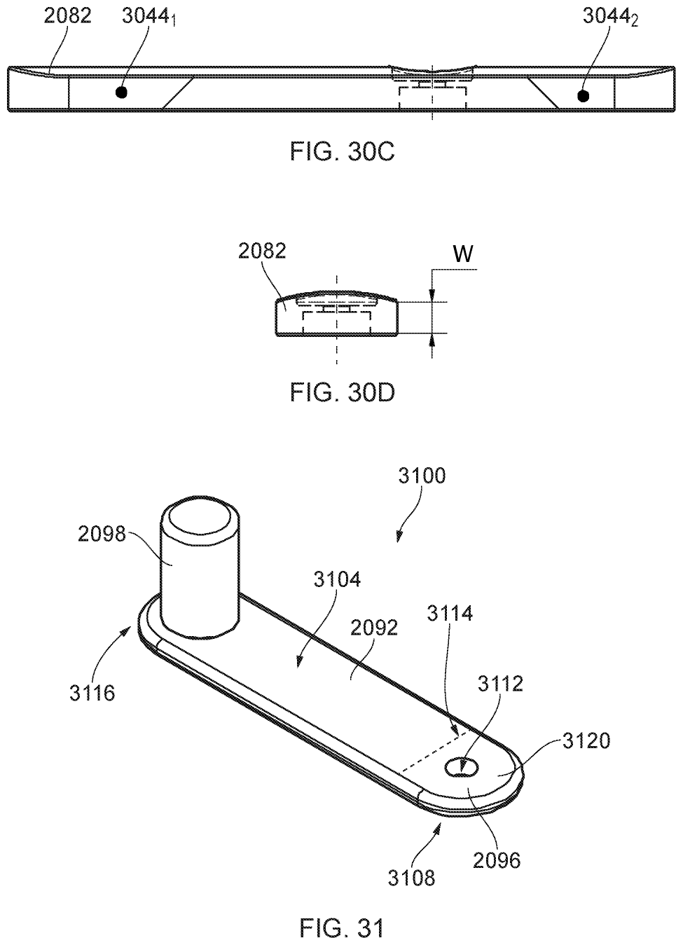

FIG. 30A illustrates the retaining arm of the cable protection system of FIGS. 20 to 29 in more detail;

FIG. 30B illustrates a further perspective view of the retaining arm of FIG. 30A;

FIG. 30C illustrates a still further perspective view of the retaining arm of FIG. 30A;

FIG. 30D illustrates another perspective view of the retaining arm of FIG. 30A;

FIG. 31 illustrates a latch arm of the cable protection system of FIGS. 20 to 30 in more detail;

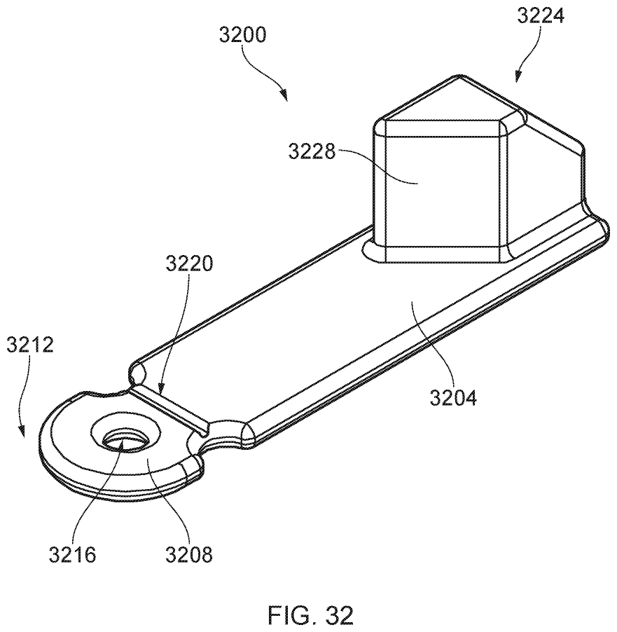

FIG. 32 illustrates an alternative latch arm for use in the cable protection system of FIGS. 20 to 30;

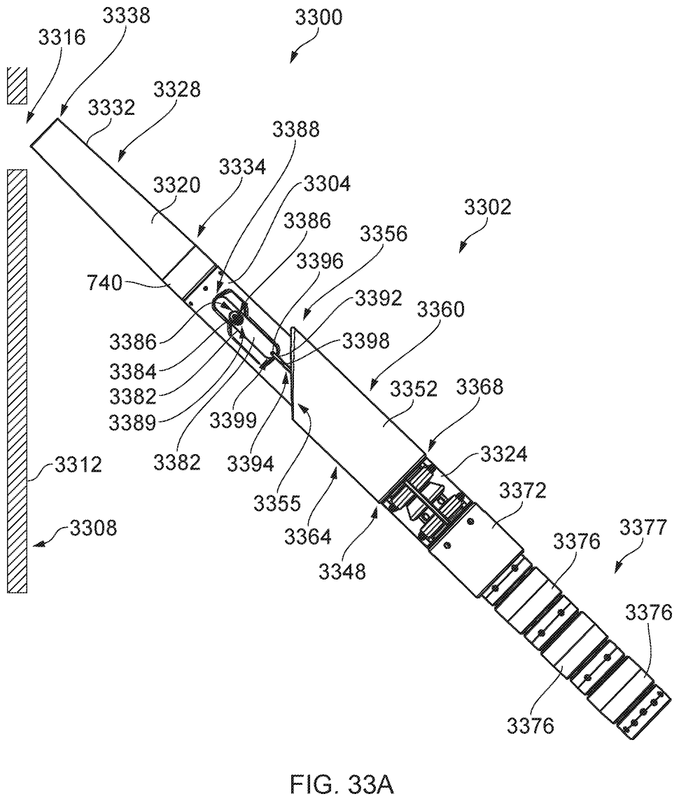

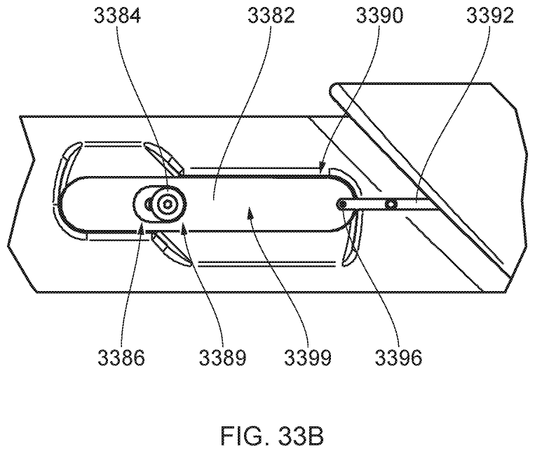

FIG. 33A illustrates another cable protection system including a retaining arm which includes an elongate eyelet slot, and a rigid support body at a first position prior to installation at a predetermined position with respect to an aperture in a wall of a monopile in which the rigid support body is located outside of a monopile;

FIG. 33B illustrates the retaining arm which includes an elongate eyelet slot of FIG. 33A in more detail;

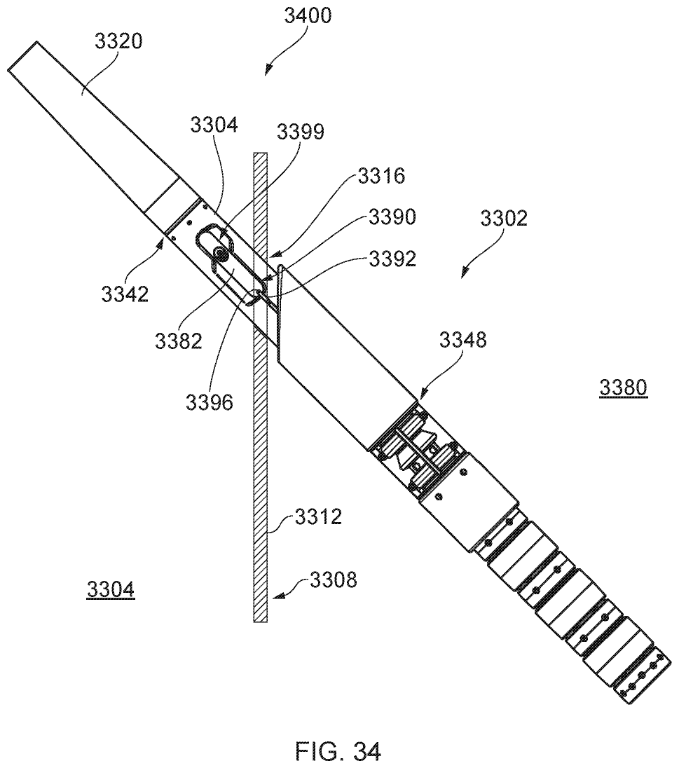

FIG. 34 illustrates the cable protection system of FIG. 33 in another position during installation as a rigid support body is passed through an aperture in a wall of a monopile;

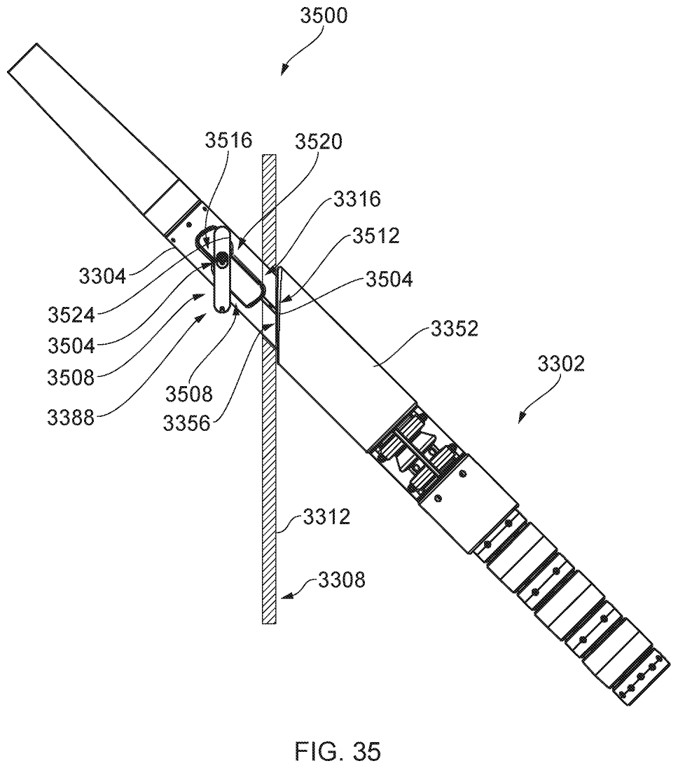

FIG. 35 illustrates the cable protection system of FIG. 33 and FIG. 34 in a further position during installation as a rigid support body is passed through an aperture in a wall of an offshore structure;

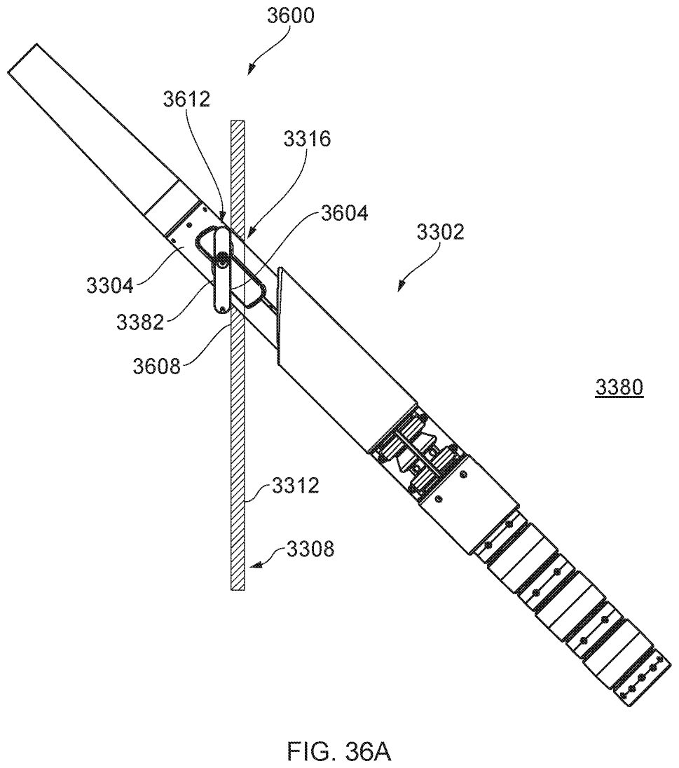

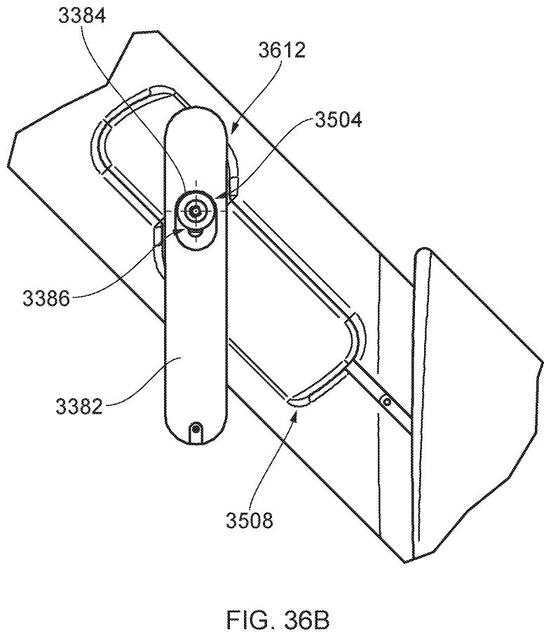

FIG. 36A illustrates the cable protection system of FIGS. 33, 34 and 35 in a retained position following release of the retaining arm;

FIG. 36B illustrates the retaining arm which includes an elongate eyelet slot of FIG. 36A in more detail;

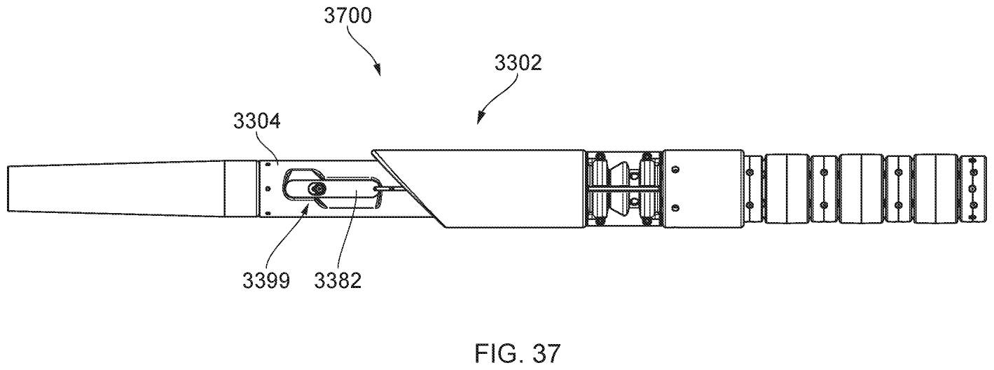

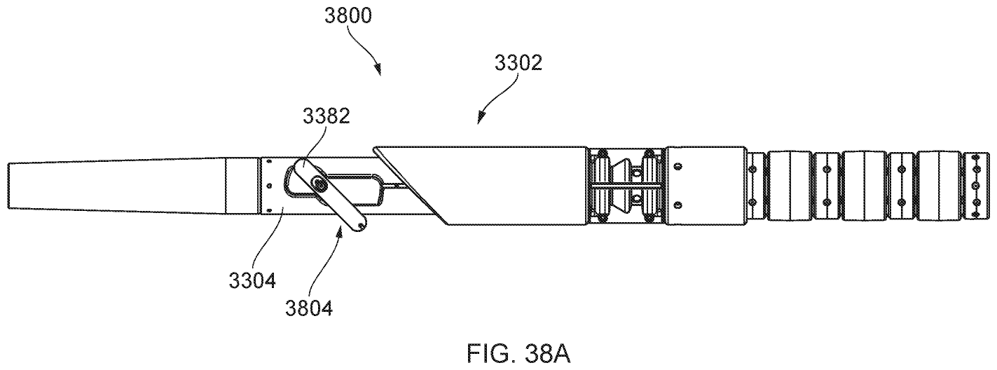

FIG. 37 illustrates another perspective view of the cable protection system of FIGS. 33 to 36 with retaining arms being arranged in the storage position;

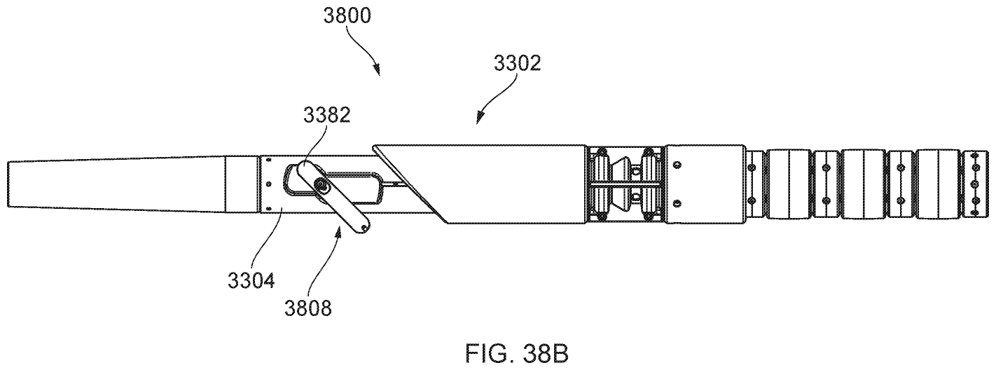

FIG. 38A illustrates the perspective view of the cable protection system of FIGS. 37, with the retaining arms being arranged in an intermediate position with the connector being arranged towards a first end of the slot;

FIG. 38B illustrates the perspective view of the cable protection system of FIGS. 37, with the retaining arms being arranged in an intermediate position with the connector being arranged towards a further end of the slot;

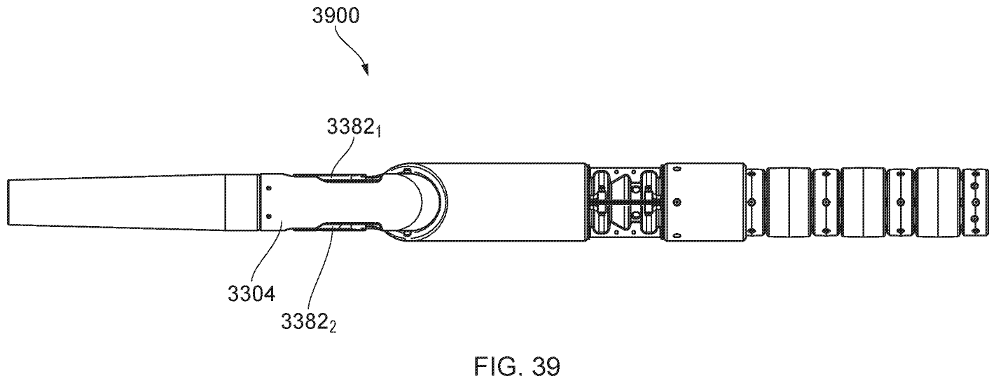

FIG. 39 illustrates a further perspective view of the cable protection system of FIG. 33;

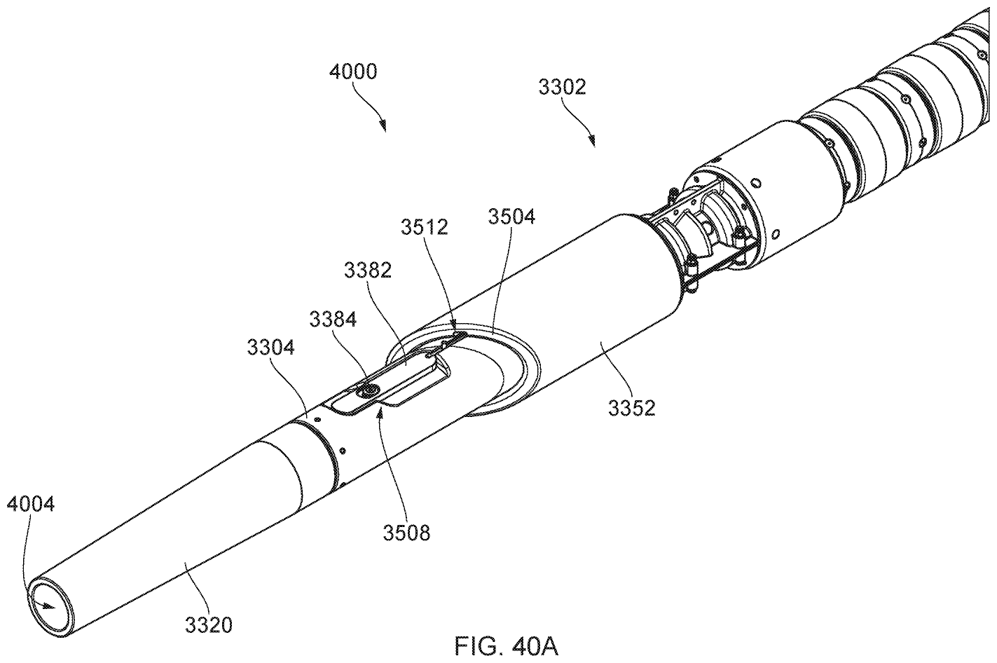

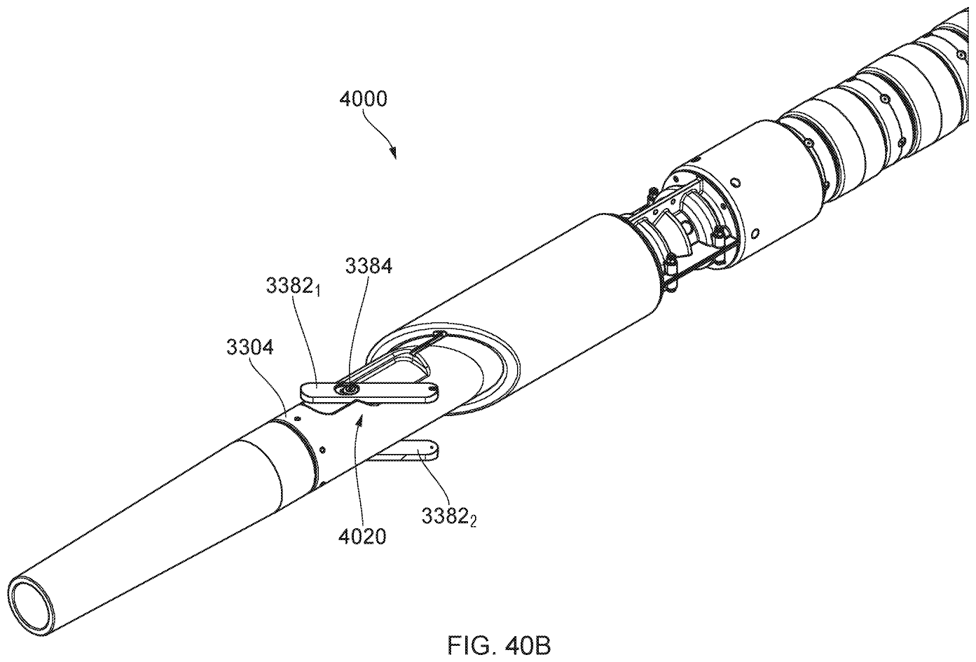

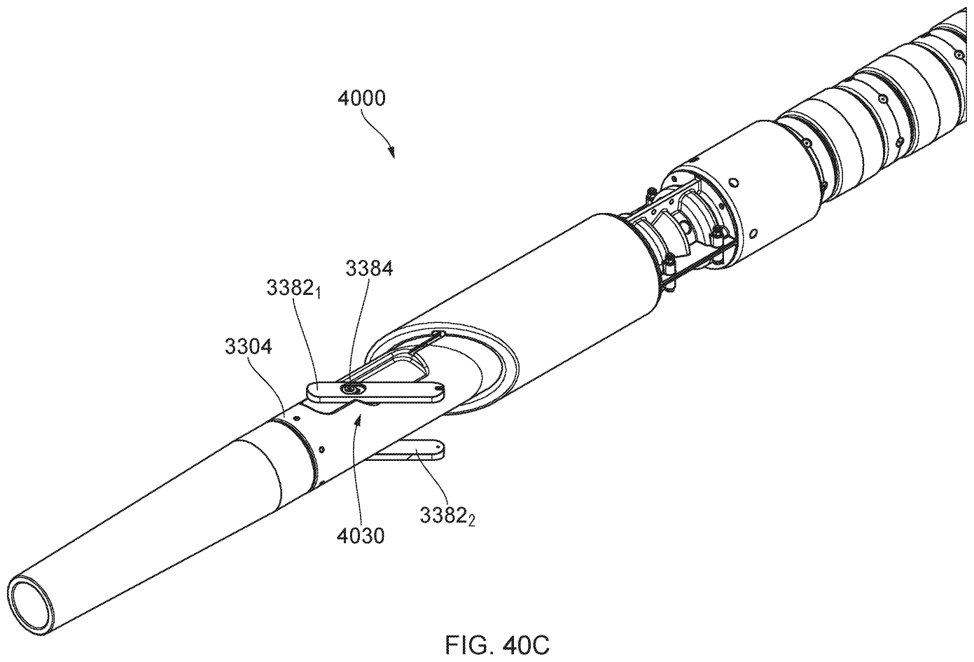

FIG. 40A illustrates a still further perspective view of a cable protection system showing the retaining arms arranged in a storage position, and a dished out side region;

FIG. 40B illustrates a still further perspective view of a cable protection system showing the retaining arms arranged in an intermediate position with the connector being arranged towards a first end of the slot, and a dished out side region;

FIG. 40C illustrates a still further perspective view of a cable protection system showing the retaining arms arranged in an intermediate position with the connector being arranged towards a further end of the slot, and a dished out side region;

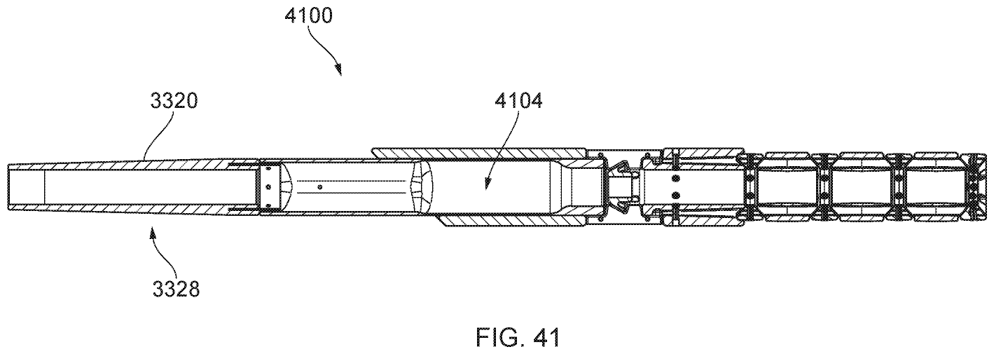

FIG. 41 illustrates a cross-sectional view of the cable protection system of FIGS. 33 to 40;

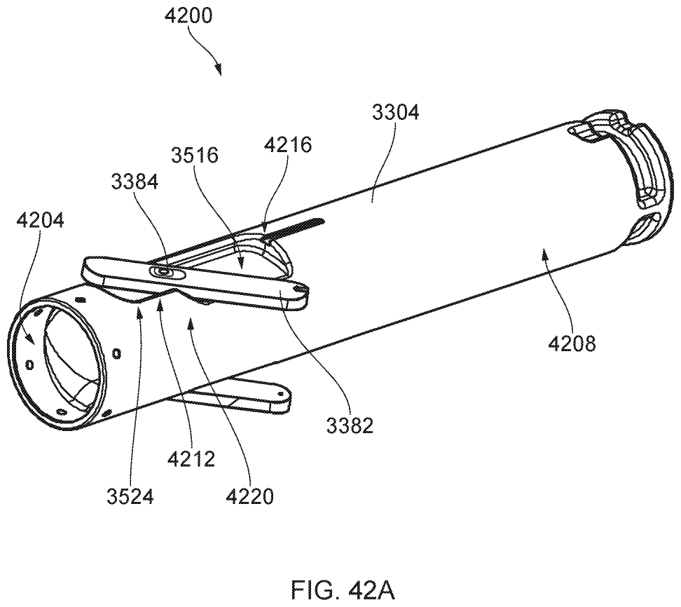

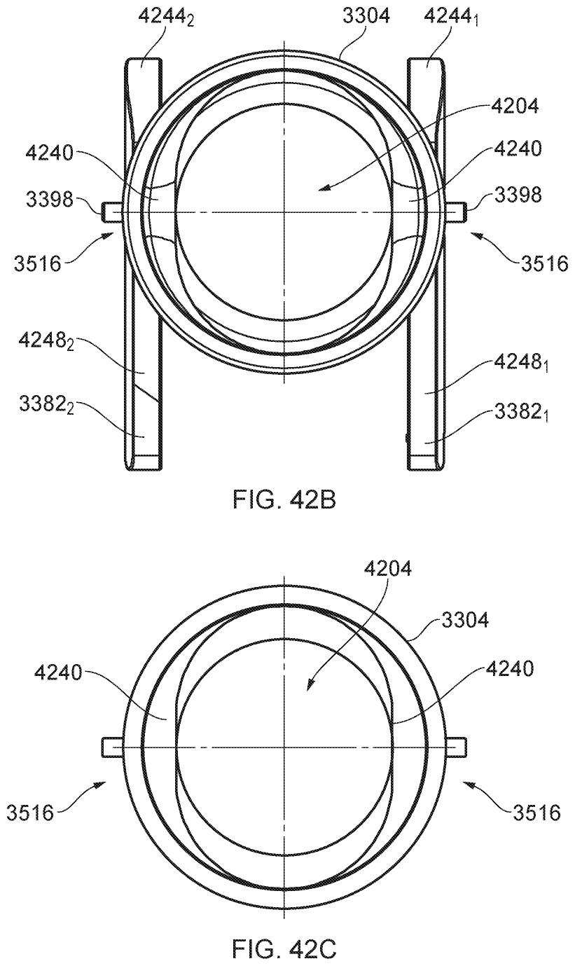

FIG. 42A illustrates a rigid support body of a cable protection system in more detail;

FIG. 42B illustrates an end on view of the rigid support body of FIG. 42A when the retaining arms are not disposed in a storage position;

FIG. 42C illustrates an end on view of the rigid support body of FIG. 42A when the retaining arms are disposed in a storage position;

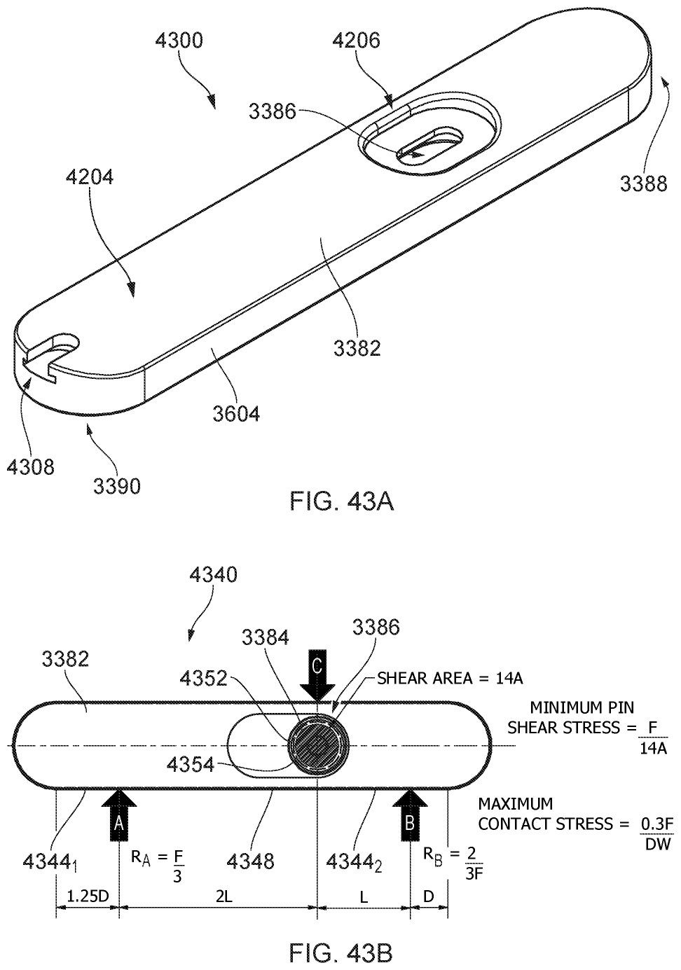

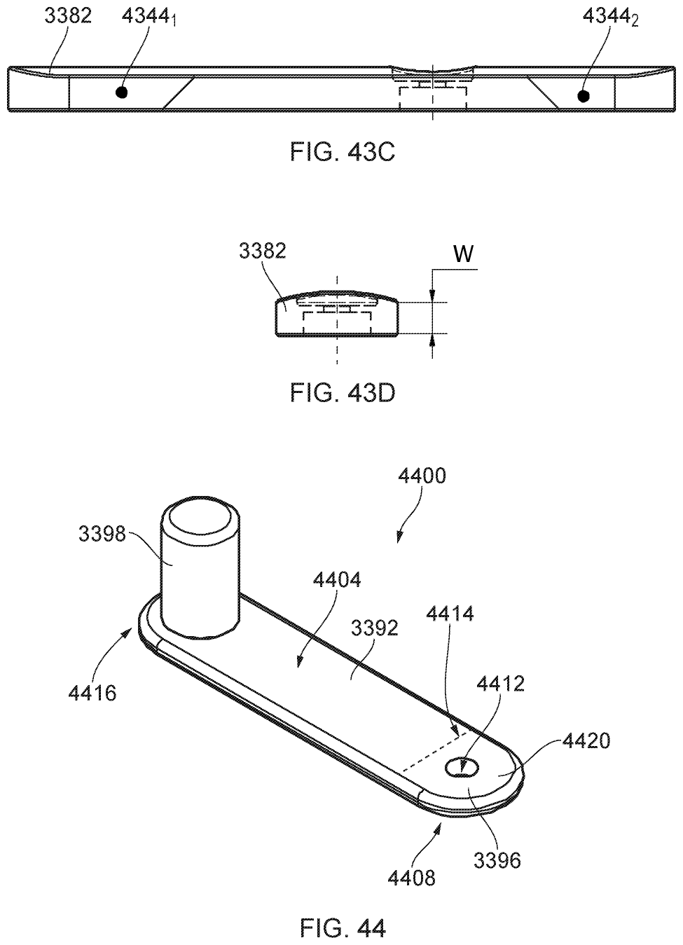

FIG. 43A illustrates the retaining arm of the cable protection system of FIGS. 33 to 42 in more detail;

FIG. 43B illustrates a further perspective view of the retaining arm of FIG. 43A;

FIG. 43C illustrates a still further perspective view of the retaining arm of FIG. 43A;

FIG. 43D illustrates another perspective view of the retaining arm of FIG. 43A;

FIG. 44 illustrates a latch arm of the cable protection system of FIGS. 33 to 43 in more detail;

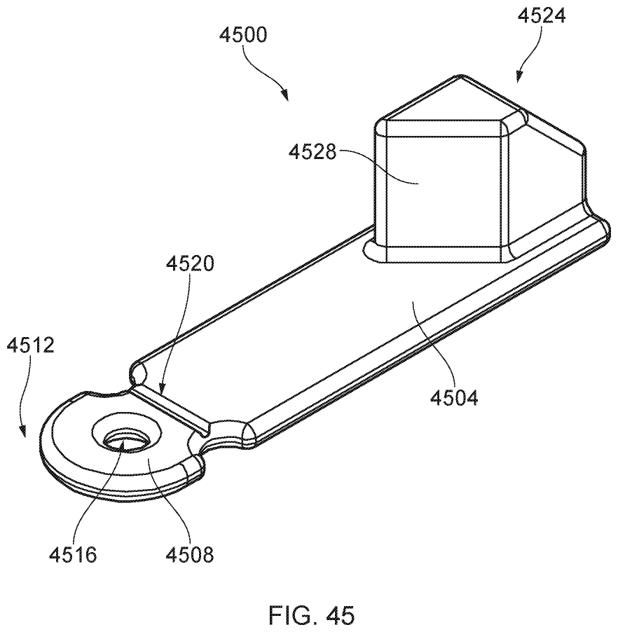

FIG. 45 illustrates an alternative latch arm for use in the cable protection system of FIGS. 33 to 44;

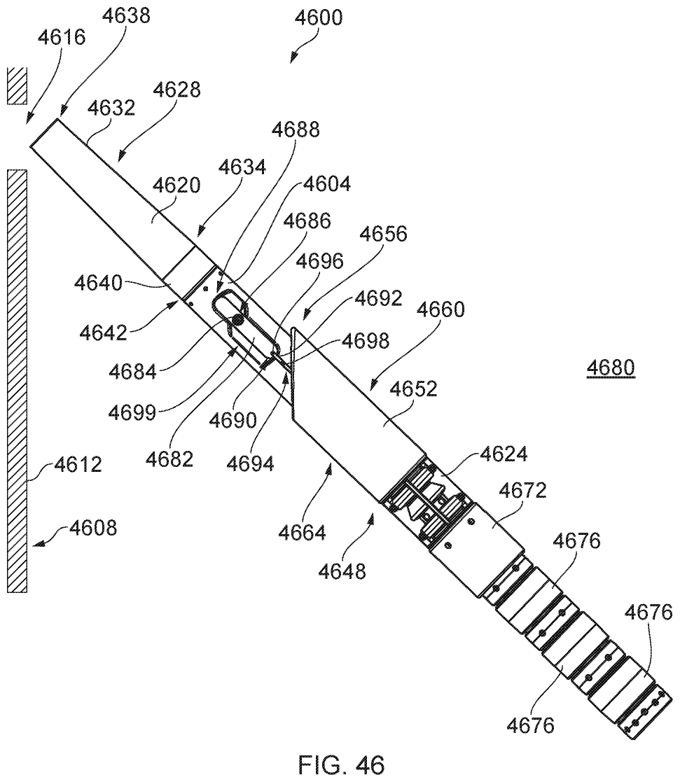

FIG. 46 illustrates another cable protection system including a rigid support body, and an axially slidable outer sleeve partially covering the support body, at a first position prior to installation at a predetermined position with respect to an aperture in a wall of a monopile in which the rigid support body is located outside of a monopile;

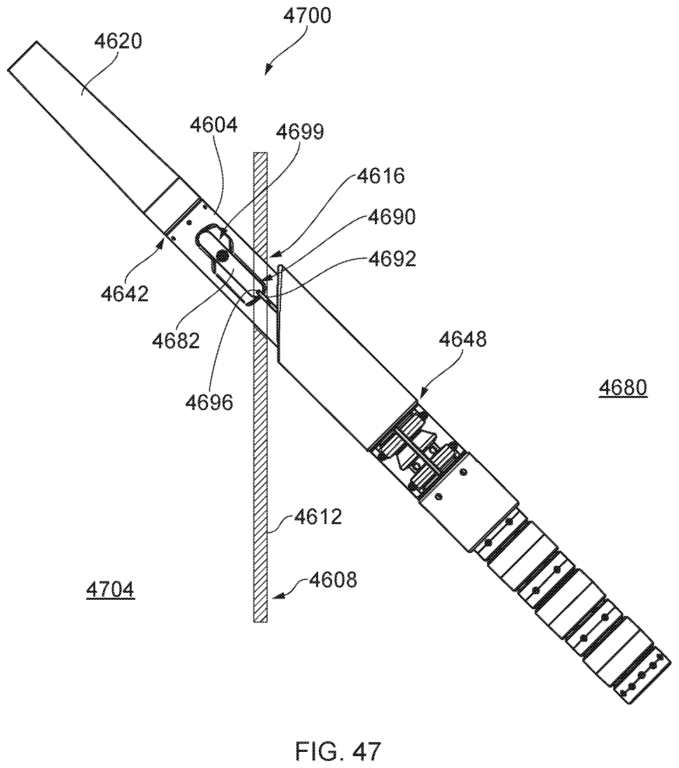

FIG. 47 illustrates the cable protection system of FIG. 46 in another position during installation as a rigid support body is passed through an aperture in a wall of a monopile;

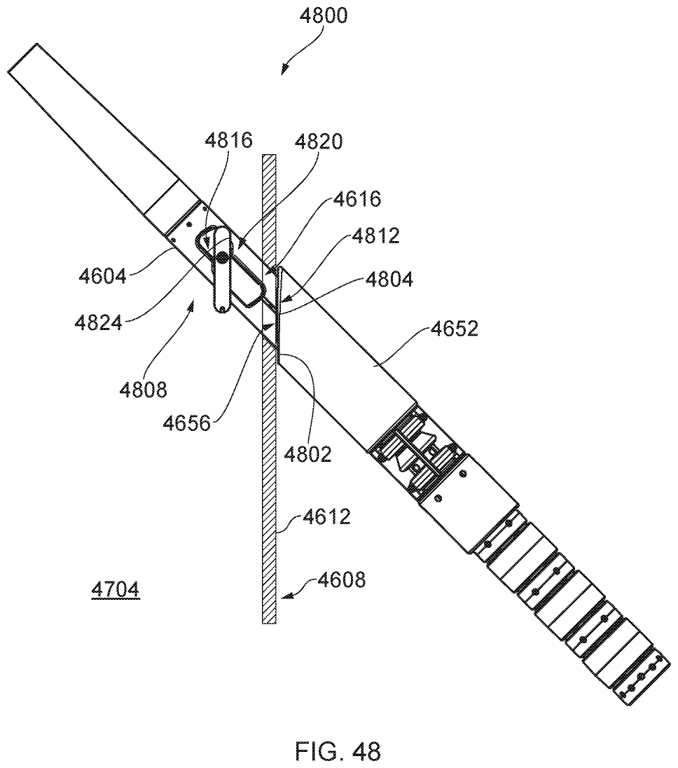

FIG. 48 illustrates the cable protection system of FIG. 46 or FIG. 47 in a further position during installation as a rigid support body is passed through an aperture in a wall of an offshore structure;

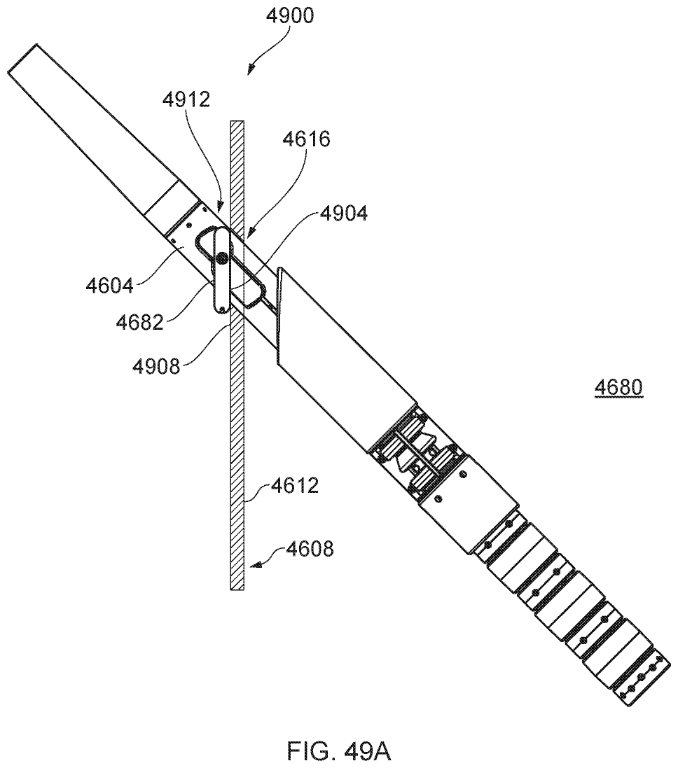

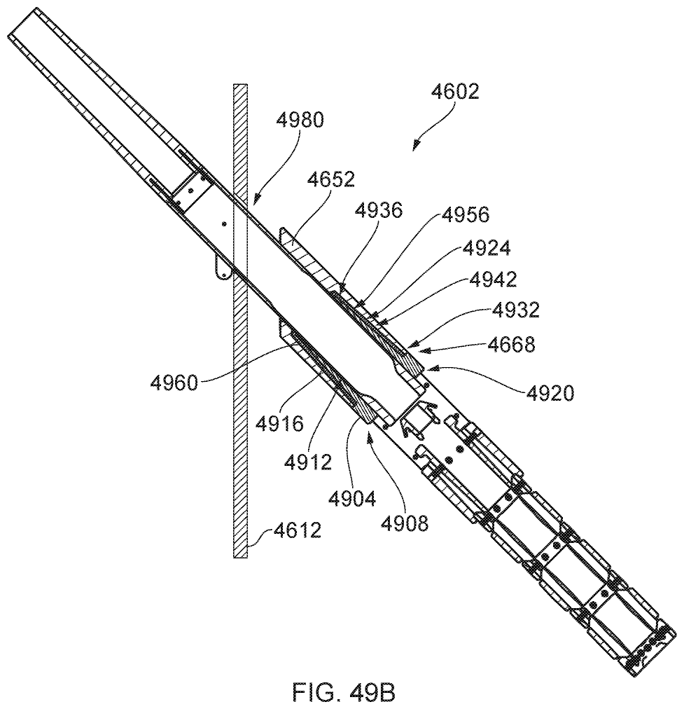

FIG. 49A illustrates the cable protection system of FIGS. 46, 47 and 48 in another position during installation in which the retaining arms are in abutment with the inner surface of the monopile wall;

FIG. 49B illustrates the cable protection system in the position of FIG. 49A in cross section;

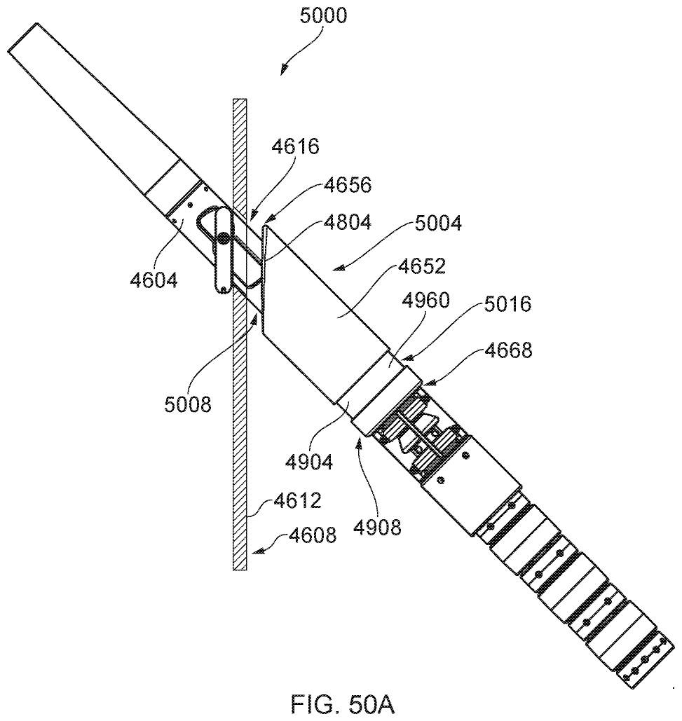

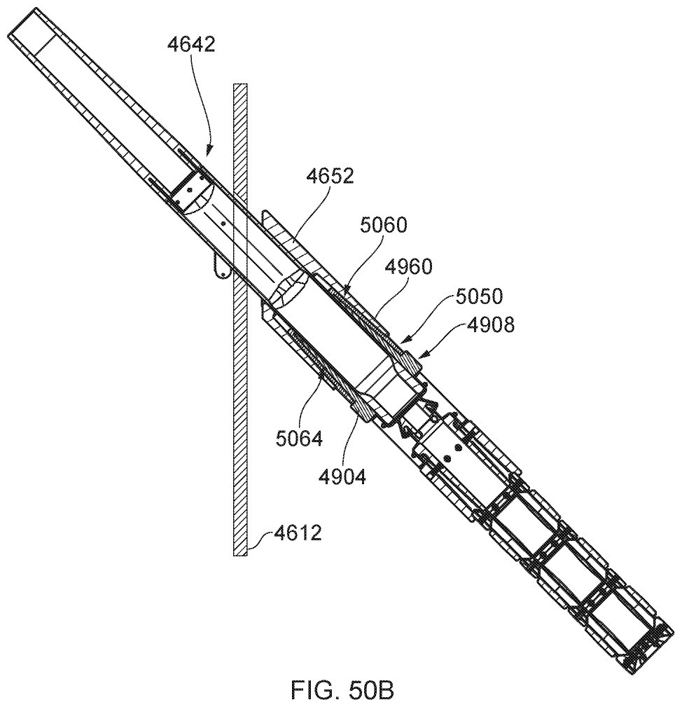

FIG. 50A illustrates the cable protection system of FIGS. 46 to 49 in another position during installation in which the retaining arms are a deployed position, the outer sleeve abutting with the outer surface of the monopile wall;

FIG. 50B illustrates the cable protection system in the position of FIG. 50A in cross section;

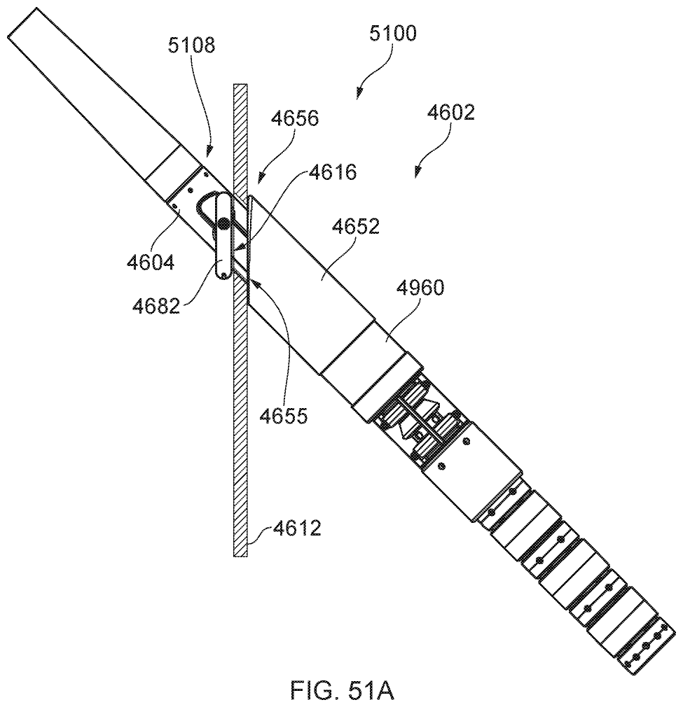

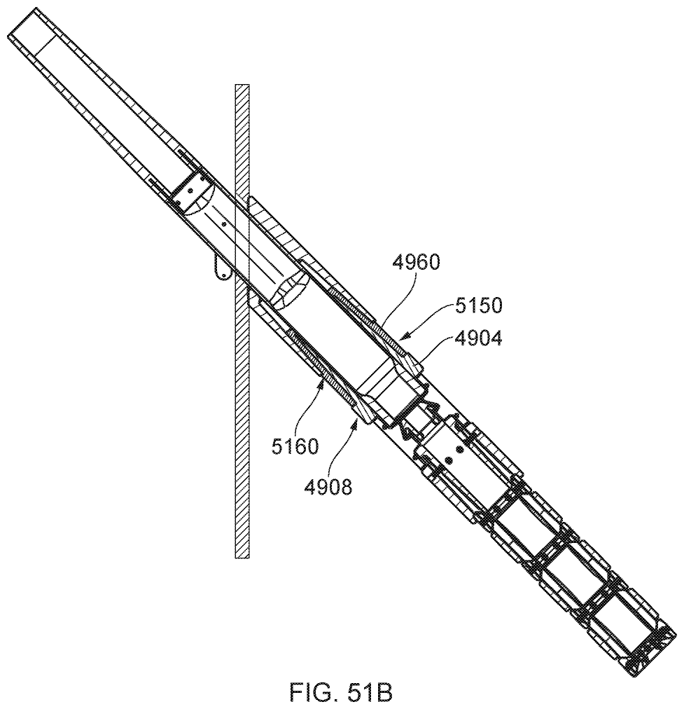

FIG. 51A illustrates the cable protection system of FIGS. 46 to 49 when the rigid support body is in a retained position following installation which the retaining arms are in abutment with the inner surface of the monopile wall and the outer sleeve has started to axially slide towards the outer surface of the monopile wall;

FIG. 51B illustrates the cable protection system in the position of FIG. 51A in cross section;

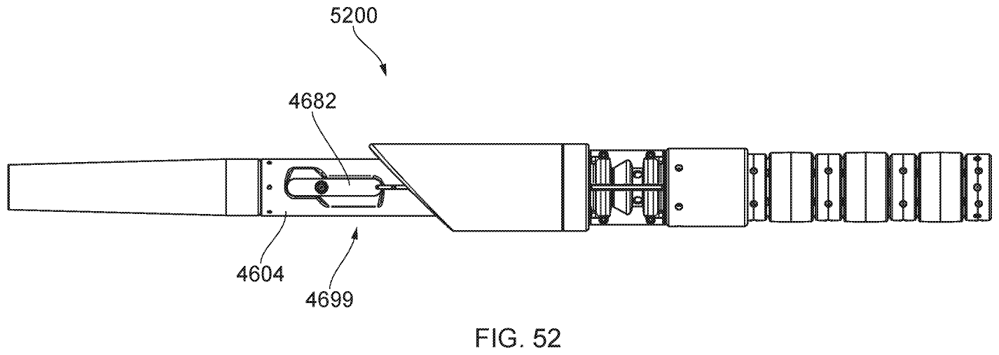

FIG. 52 illustrates another perspective view of the cable protection system of FIGS. 46 to 51 with retaining arms being arranged in the storage position;

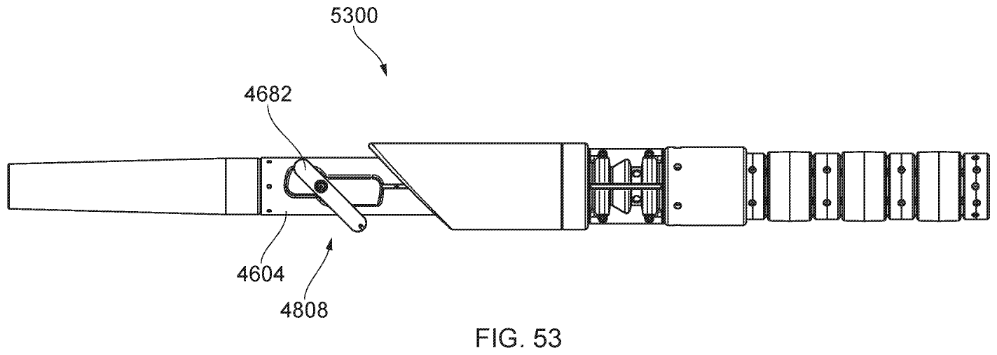

FIG. 53 illustrates another perspective view of the cable protection system of FIGS. 46 to 52 with the retaining arms being arranged in an intermediate position;

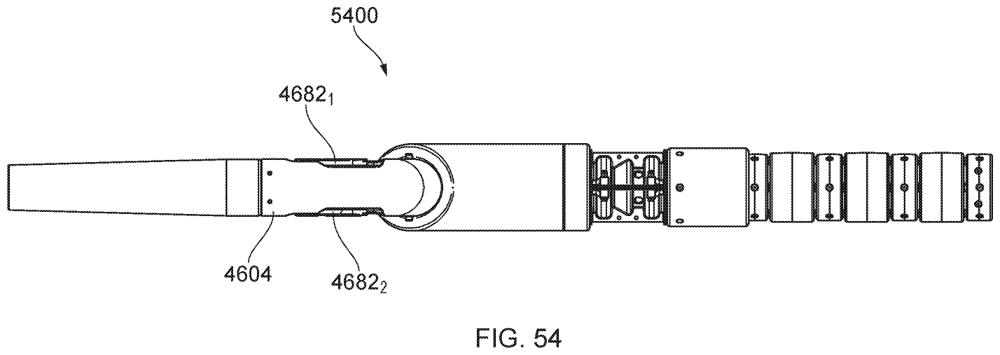

FIG. 54 illustrates a further perspective view of the cable protection system of FIG. 52;

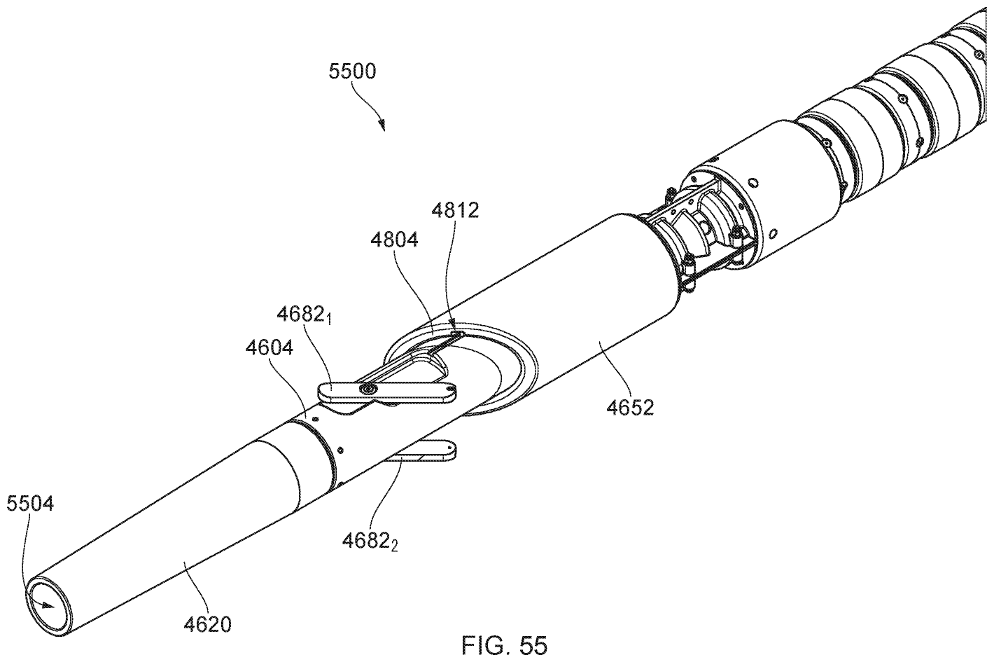

FIG. 55 illustrates a still further perspective view of a cable protection system showing retaining arms and a dished out side region;

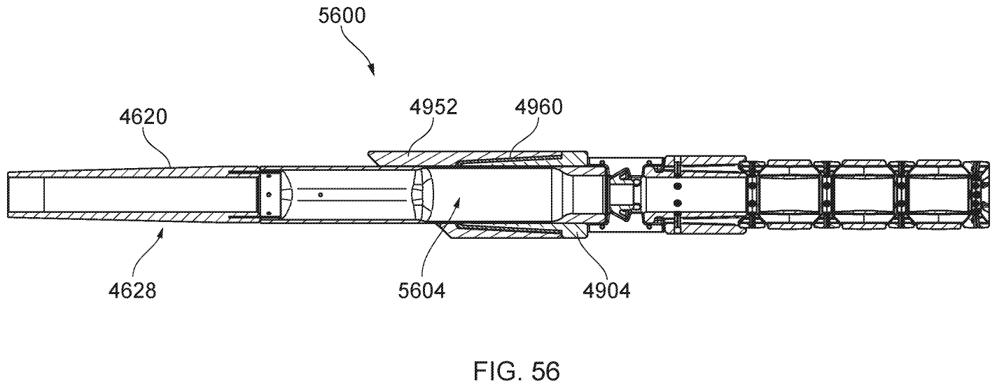

FIG. 56 illustrates a cross-sectional view of the cable protection system of FIGS. 46 to 55 when the inner sleeve is not swollen;

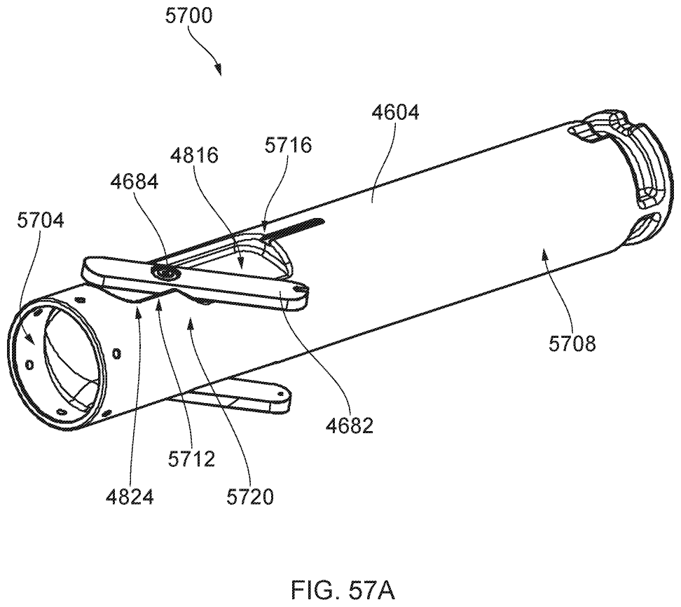

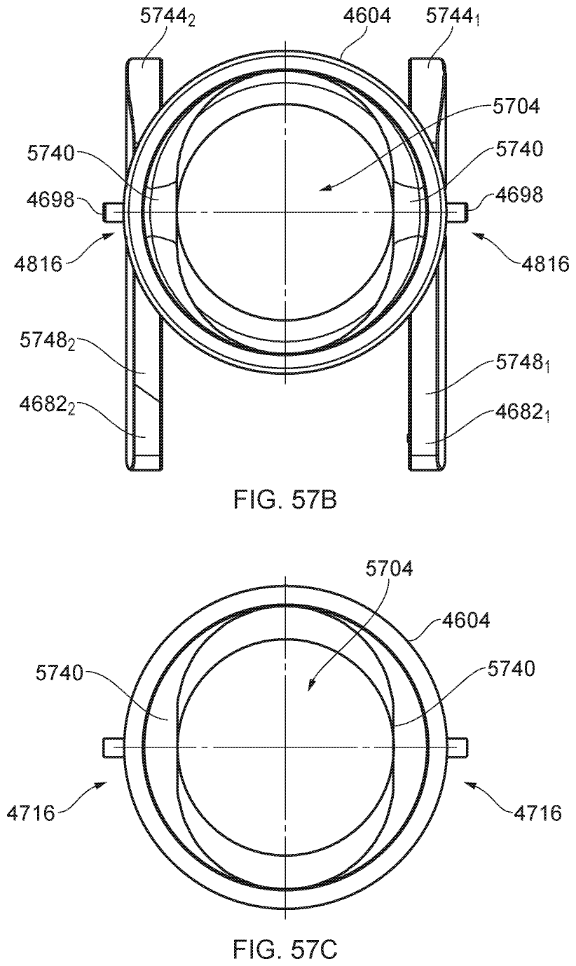

FIG. 57A illustrates a rigid support body of a cable protection system in more detail;

FIG. 57B illustrates an end on view of the rigid support body of FIG. 57A when the retaining arms are not disposed in a storage position;

FIG. 57C illustrates an end on view of the rigid support body of FIG. 57A when the retaining arms are disposed in a storage position;

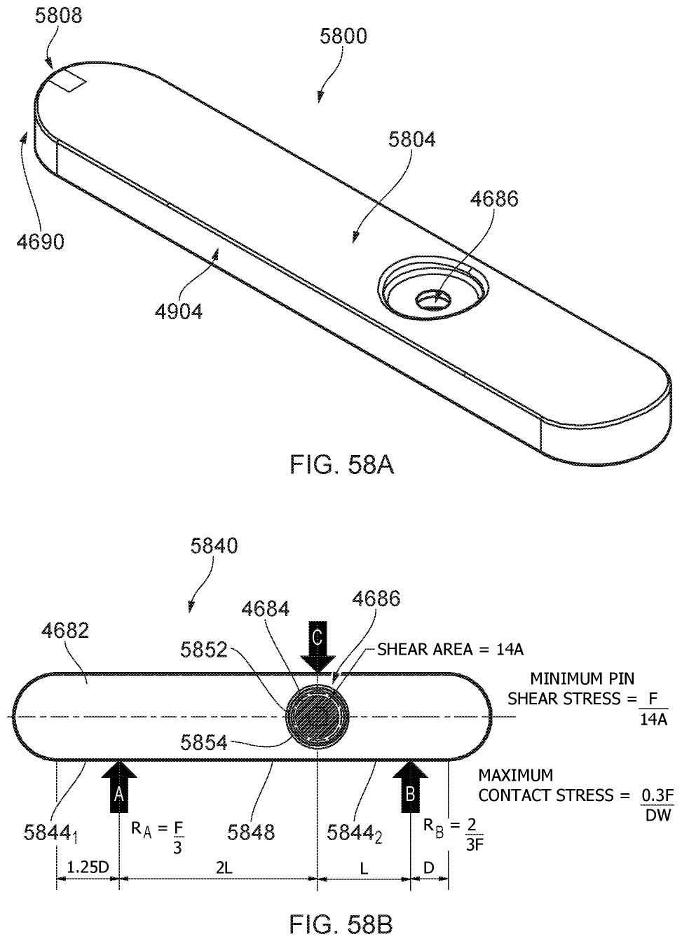

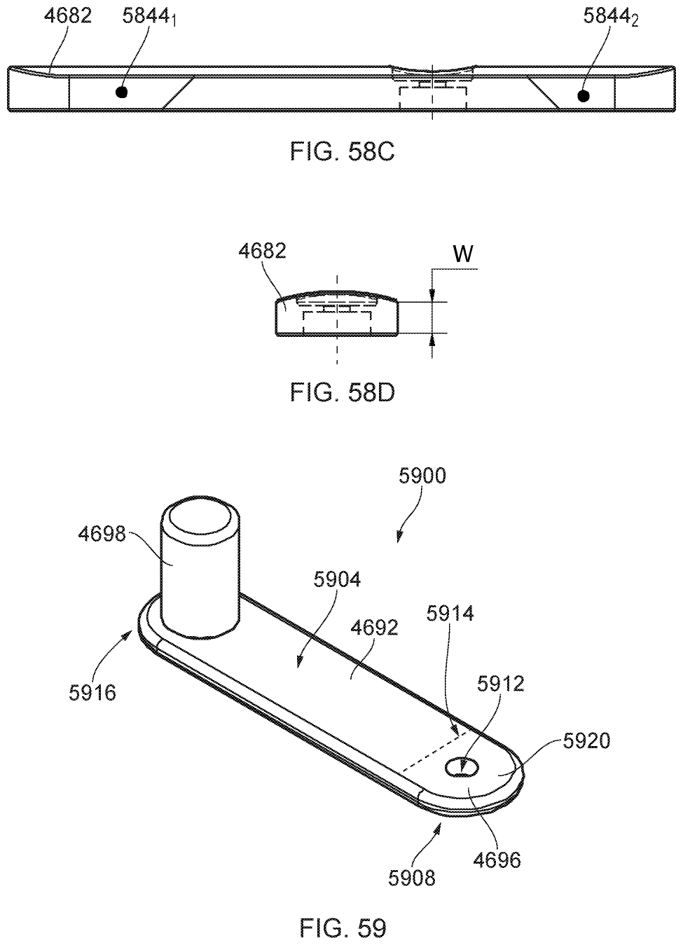

FIG. 58A illustrates the retaining arm of the cable protection system of FIGS. 46 to 57 in more detail;

FIG. 58B illustrates a further perspective view of the retaining arm of FIG. 58A;

FIG. 58C illustrates a still further perspective view of the retaining arm of FIG. 58A;

FIG. 58D illustrates another perspective view of the retaining arm of FIG. 58A;

FIG. 59 illustrates a latch arm of the cable protection system of FIGS. 46 to 58 in more detail;

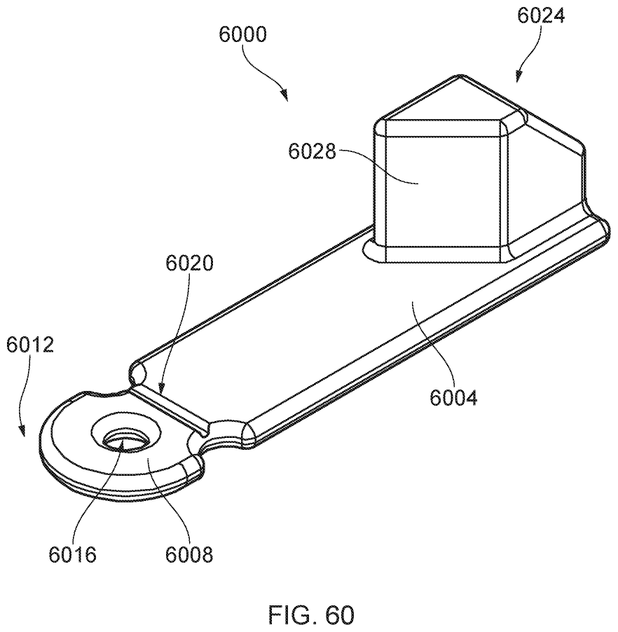

FIG. 60 illustrates an alternative latch arm for use in the cable protection system of FIGS. 46 to 59;

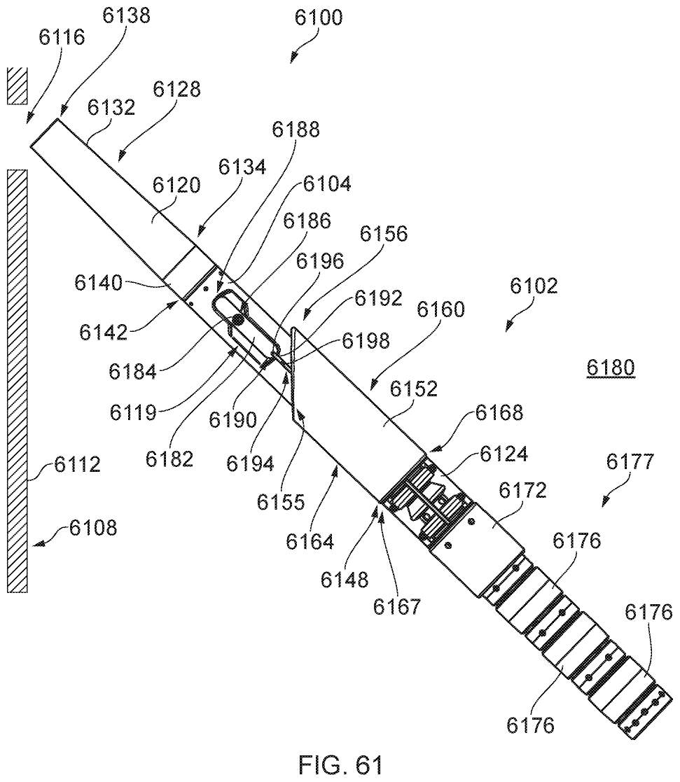

FIG. 61 illustrates a different cable protection system including a rigid support body, and an axially slidable outer sleeve partially covering the support body, at a first position prior to installation at a predetermined position with respect to an aperture in a wall of a monopile in which the rigid support body is located outside of a monopile;

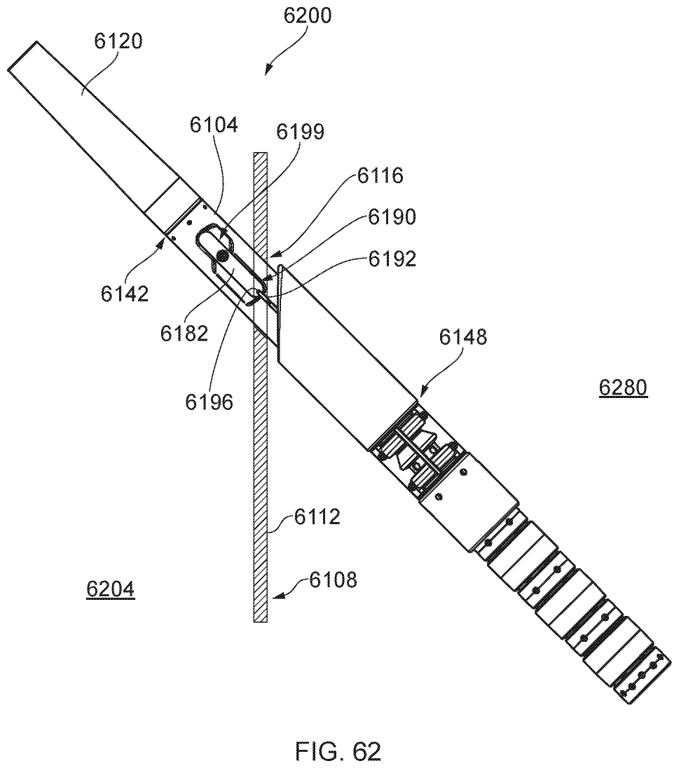

FIG. 62 illustrates the cable protection system of FIG. 61 in another position during installation as a rigid support body is passed through an aperture in a wall of a monopile;

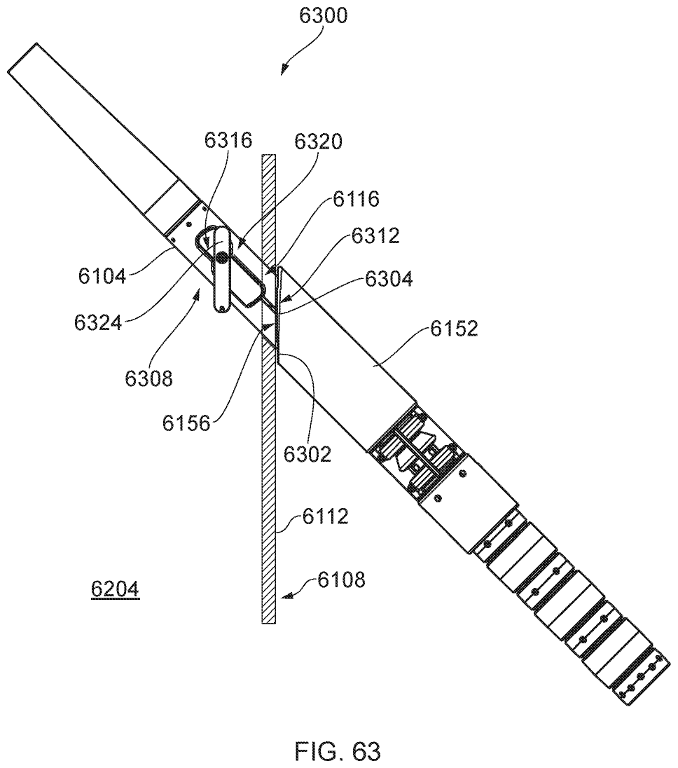

FIG. 63 illustrates the cable protection system of FIG. 61 or FIG. 62 in a further position during installation as a rigid support body is passed through an aperture in a wall of an offshore structure;

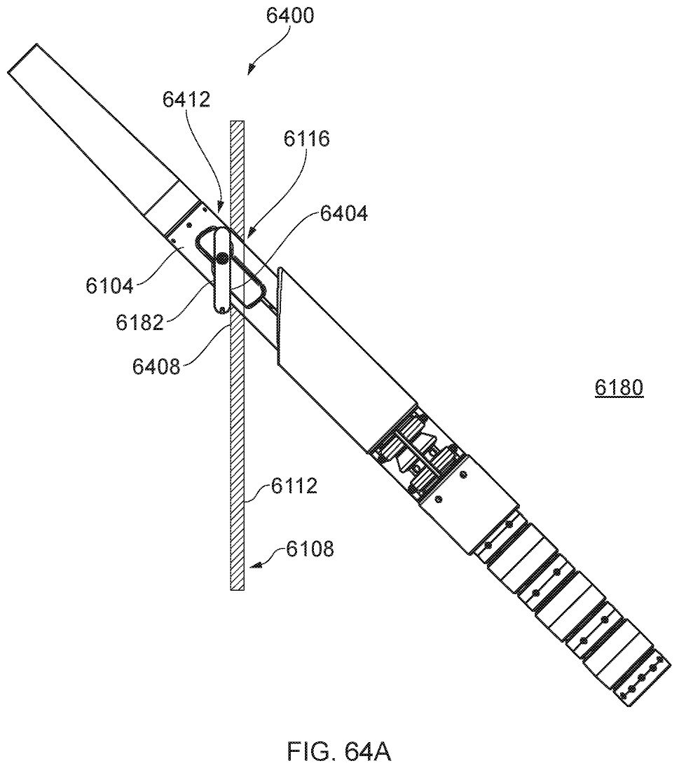

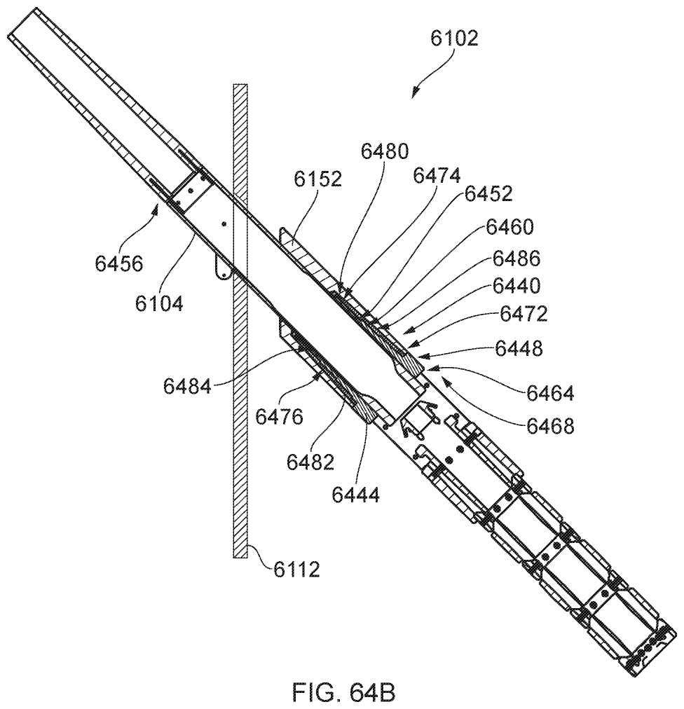

FIG. 64A illustrates the cable protection system of FIGS. 61, 62 and 63 in another position during installation in which the retaining arms are in abutment with the inner surface of the monopile wall;

FIG. 64B illustrates the cable protection system in the position of FIG. 64A in cross section;

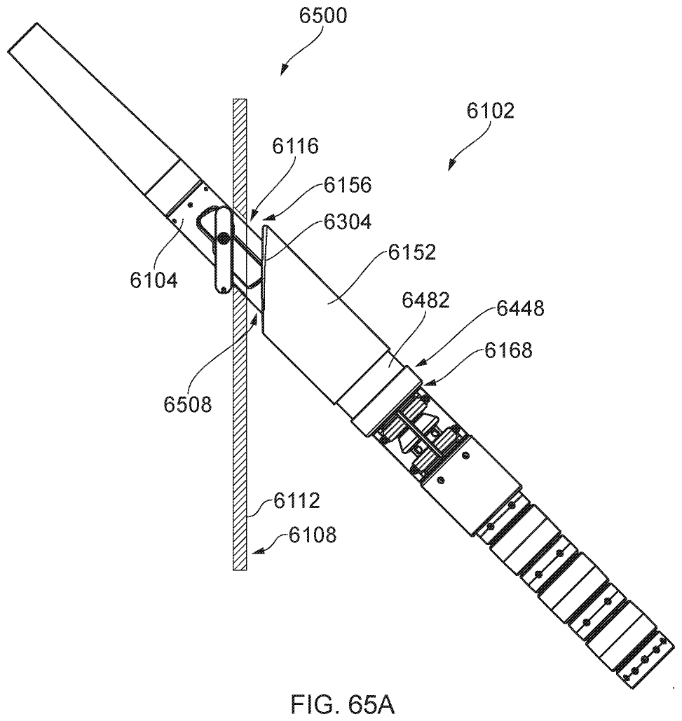

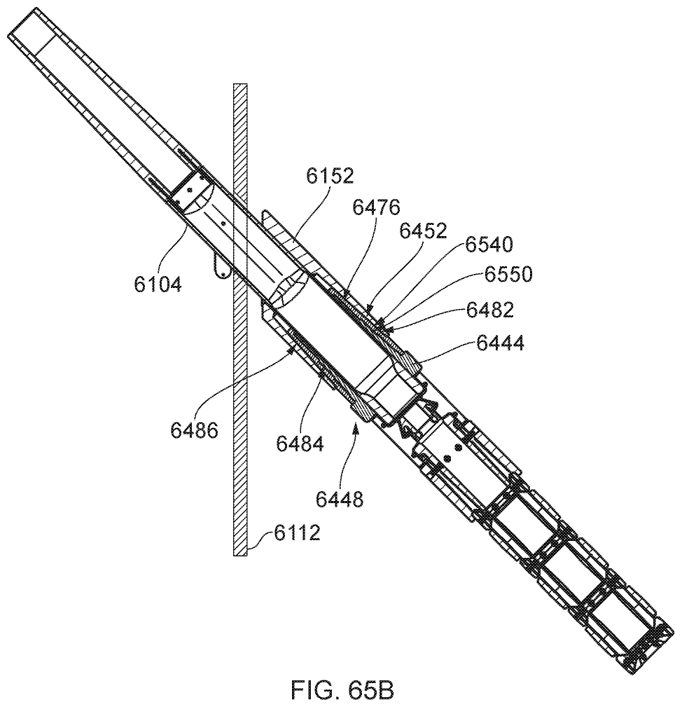

FIG. 65A illustrates the cable protection system of FIGS. 61 to 64 in another position during installation in which the retaining arms are a deployed position, the outer sleeve abutting with the outer surface of the monopile wall;

FIG. 65B illustrates the cable protection system in the position of FIG. 65A in cross section;

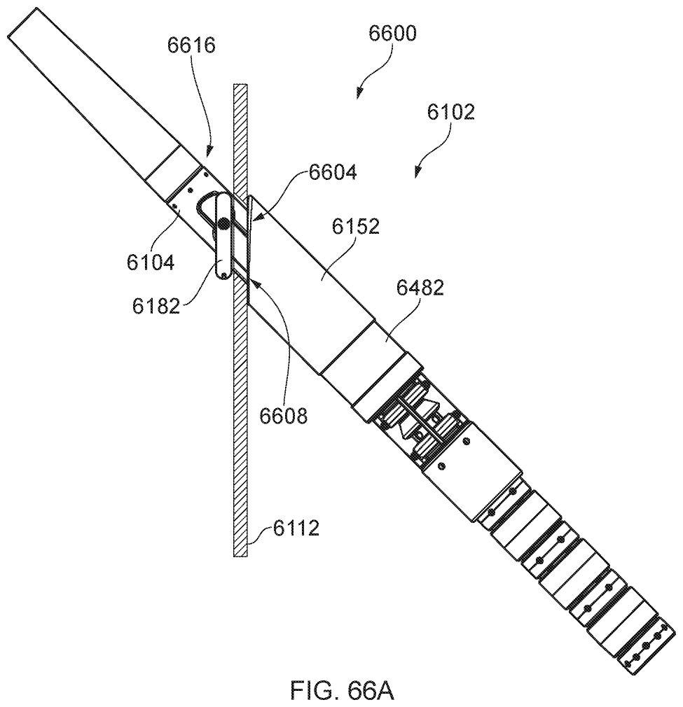

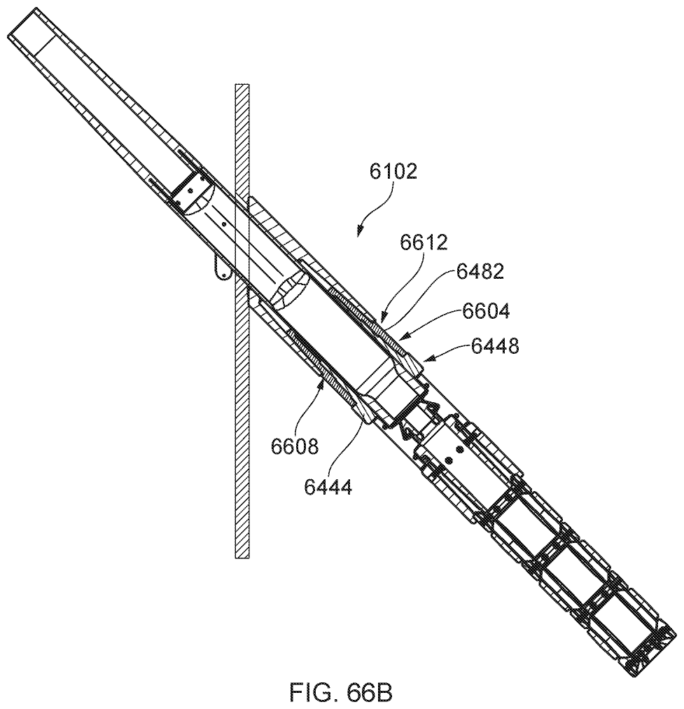

FIG. 66A illustrates the cable protection system of FIGS. 61 to 65 when the rigid support body is in a retained position following installation which the retaining arms are in abutment with the inner surface of the monopile wall and the outer sleeve has started to axially slide towards the outer surface of the monopile wall;

FIG. 66B illustrates the cable protection system in the position of FIG. 66A in cross section;

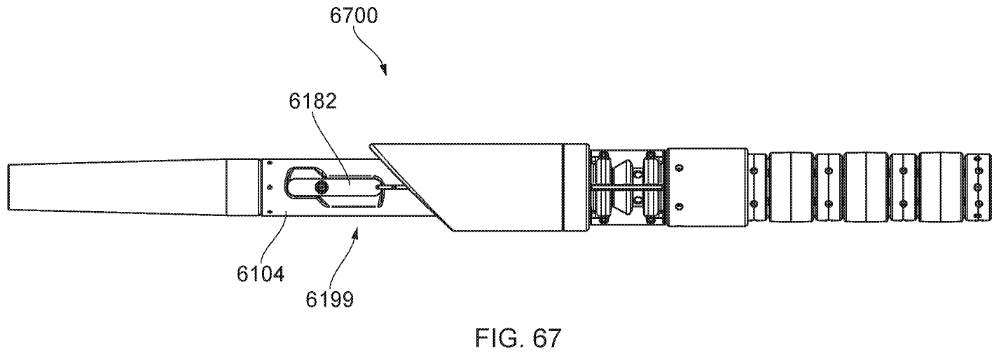

FIG. 67 illustrates another perspective view of the cable protection system of FIGS. 61 to 66 with retaining arms being arranged in the storage position;

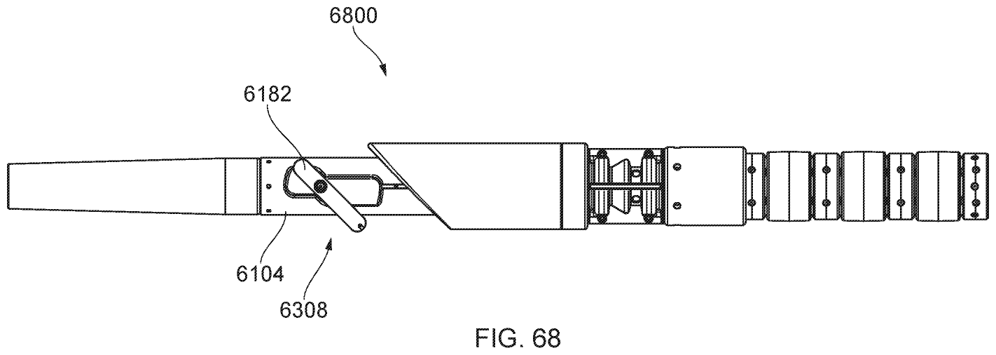

FIG. 68 illustrates another perspective view of the cable protection system of FIGS. 61 to 67 with the retaining arms being arranged in an intermediate position;

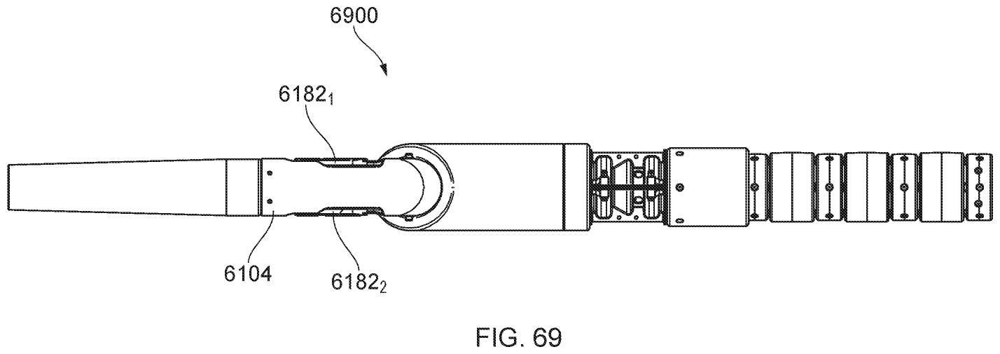

FIG. 69 illustrates a further perspective view of the cable protection system of FIG. 67;

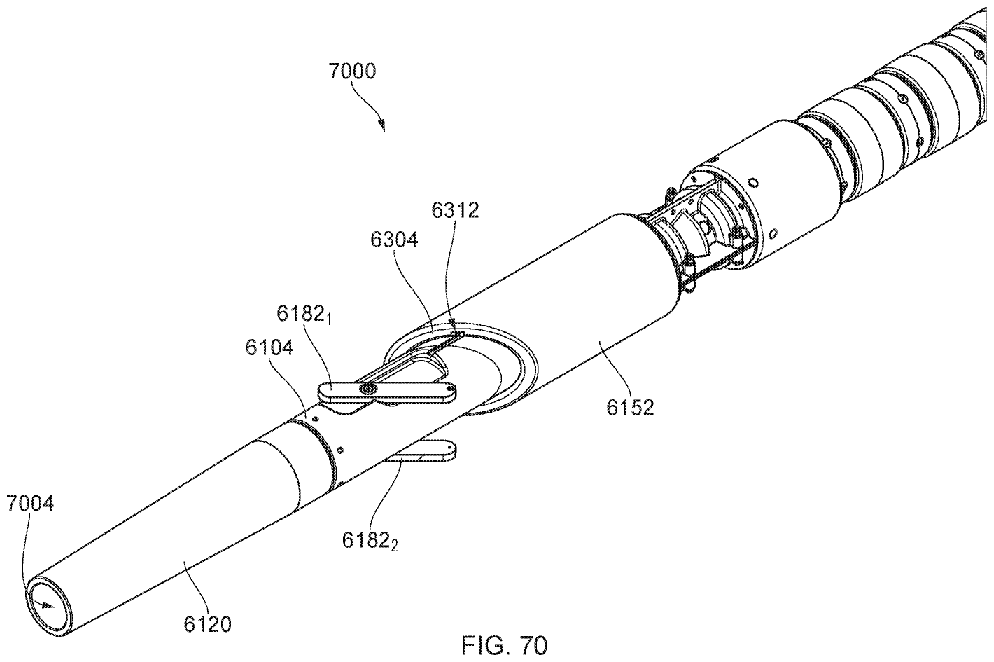

FIG. 70 illustrates a still further perspective view of a cable protection system showing retaining arms and a dished out side region;

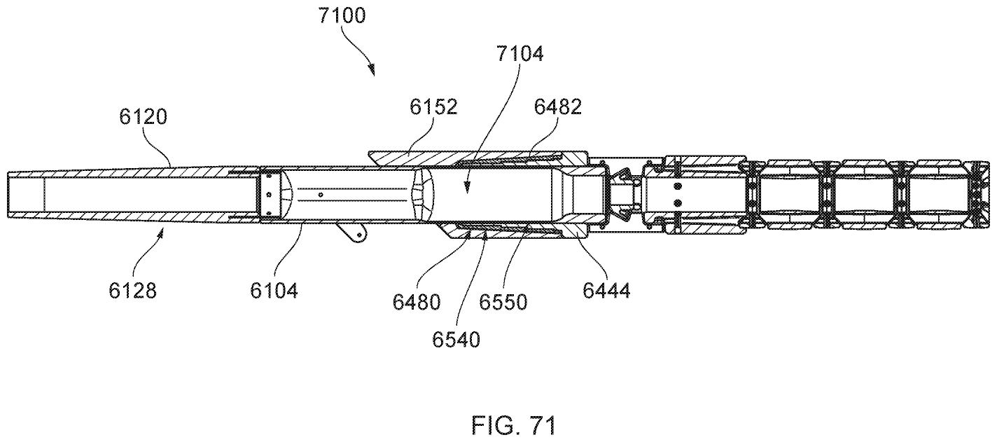

FIG. 71 illustrates a cross-sectional view of the cable protection system of FIGS. 61 to 70 when the inner sleeve is not swollen;

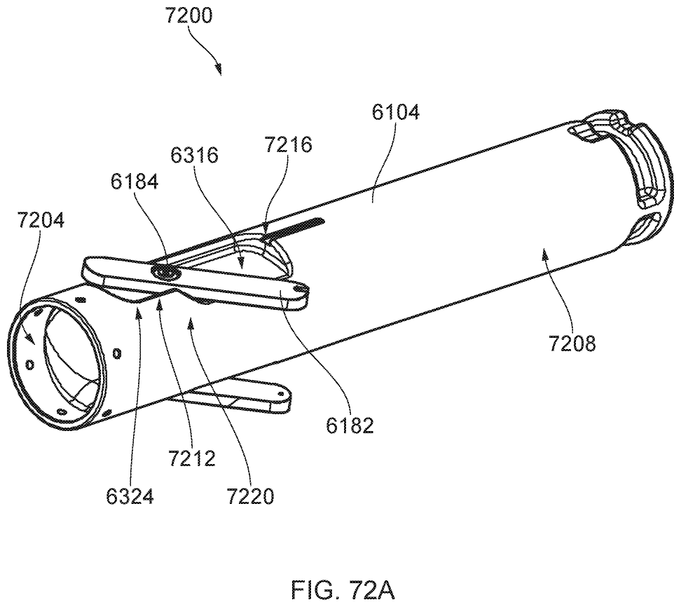

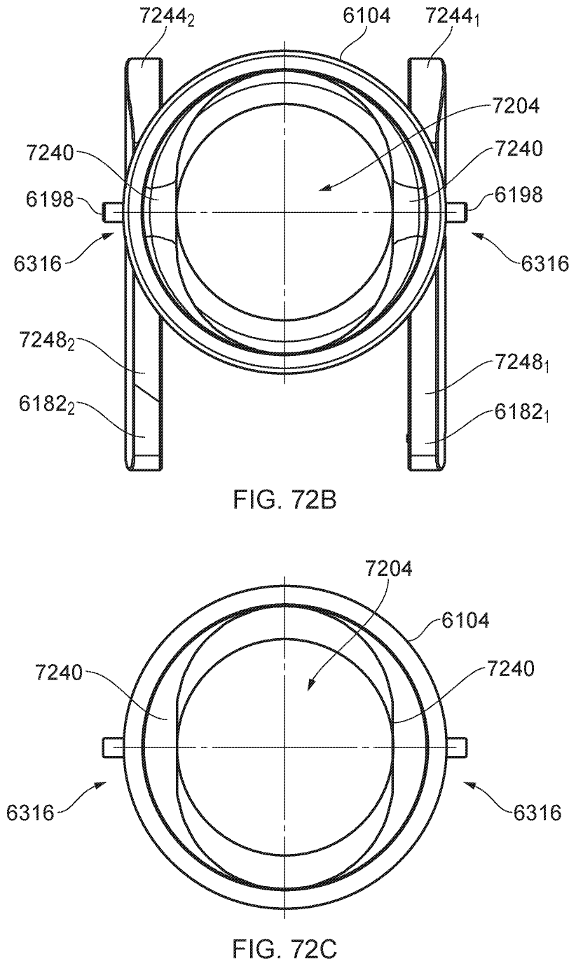

FIG. 72A illustrates a rigid support body of a cable protection system in more detail;

FIG. 72B illustrates an end on view of the rigid support body of FIG. 72A when the retaining arms are not disposed in a storage position;

FIG. 72C illustrates an end on view of the rigid support body of FIG. 72A when the retaining arms are disposed in a storage position;

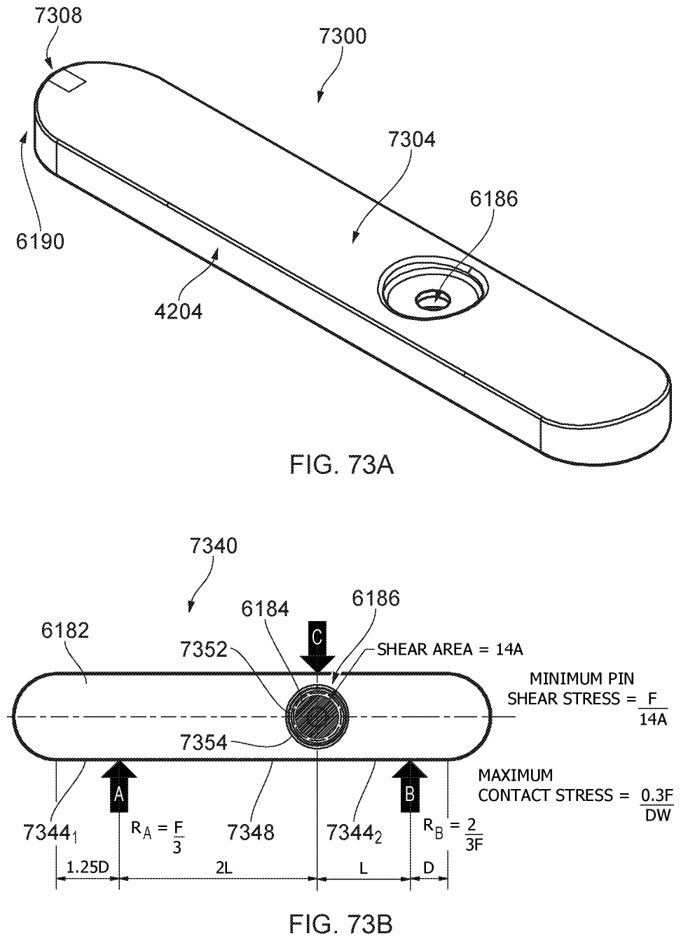

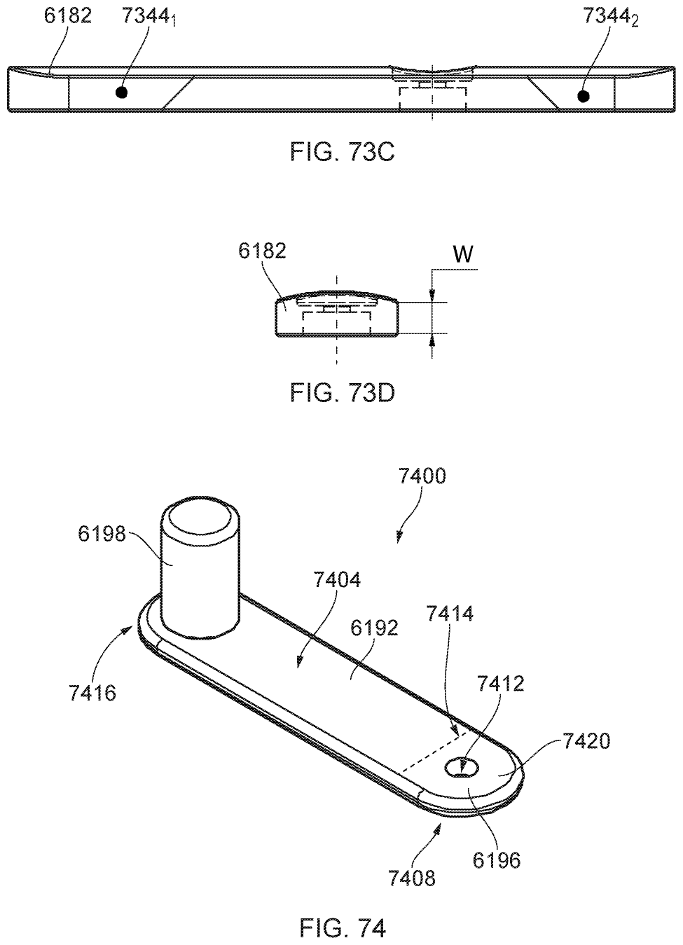

FIG. 73A illustrates the retaining arm of the cable protection system of FIGS. 61 to 72 in more detail;

FIG. 73B illustrates a further perspective view of the retaining arm of FIG. 73A;

FIG. 73C illustrates a still further perspective view of the retaining arm of FIG. 73A;

FIG. 73D illustrates another perspective view of the retaining arm of FIG. 73A;

FIG. 74 illustrates a latch arm of the cable protection system of FIGS. 61 to 73 in more detail; and

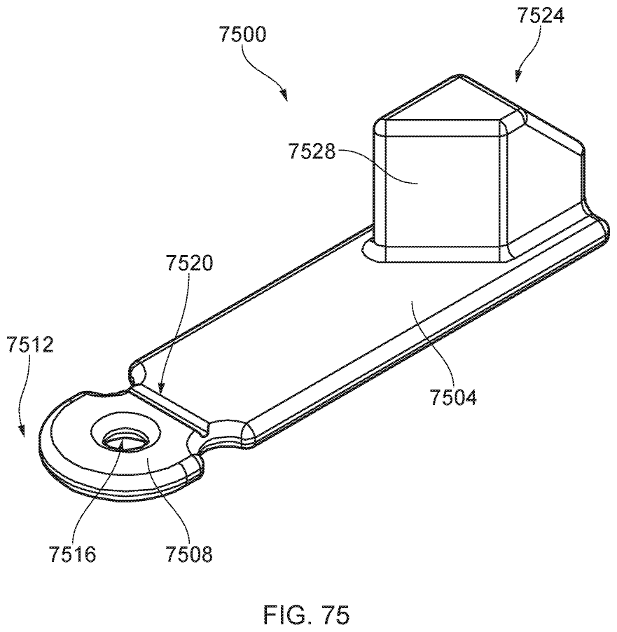

FIG. 75 illustrates an alternative latch arm for use in the cable protection system of FIGS. 61 to 74;

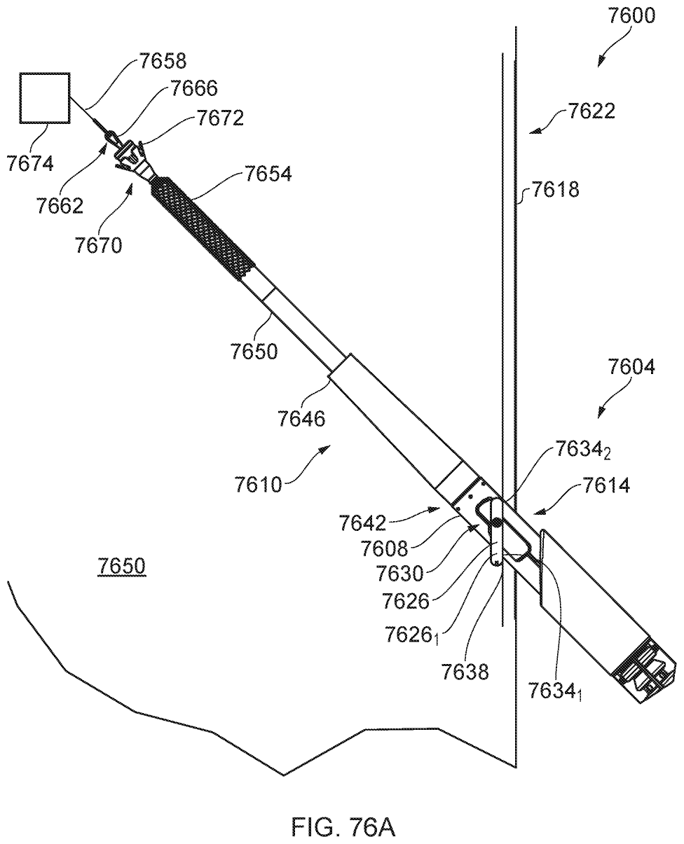

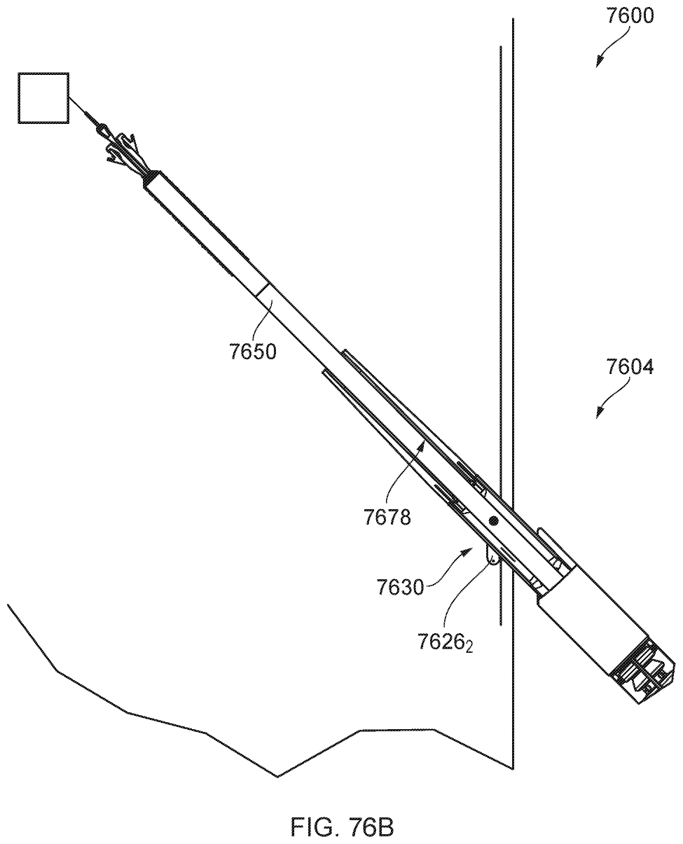

FIG. 76A illustrates a first step of a CPS decommission process;

FIG. 76B illustrates the CPS decommission step of FIG. 76A in cross section;

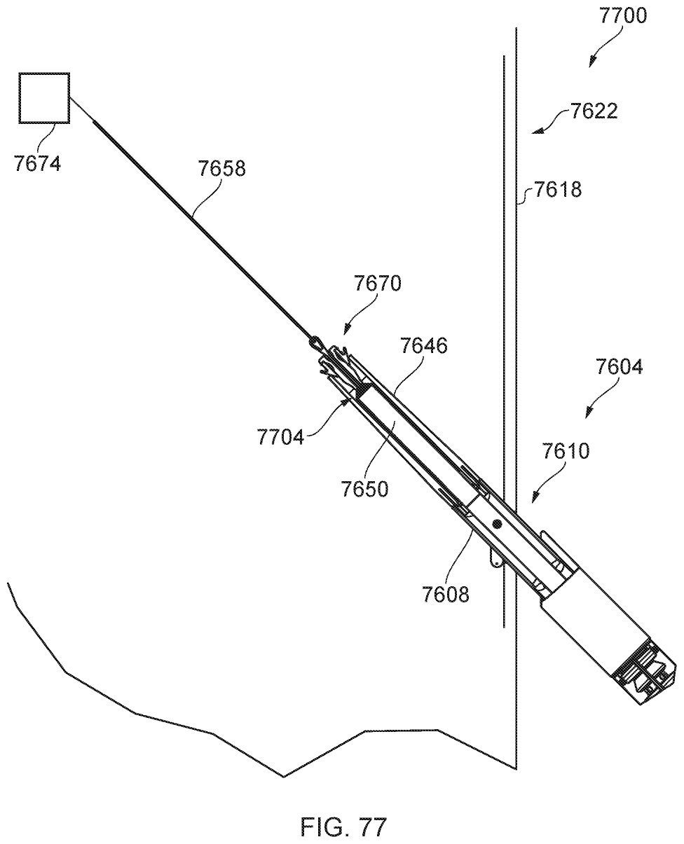

FIG. 77 illustrates a further step of the CPS decommission process of FIGS. 76A and 76B in cross section;

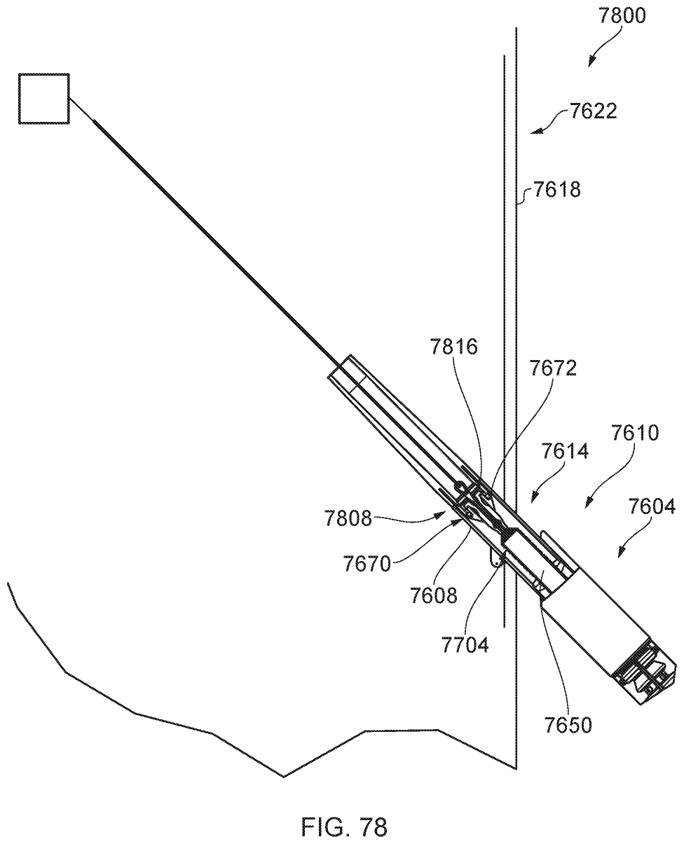

FIG. 78 illustrates a still further step of the CPS decommission process of FIGS. 76A, 76B and 77 in cross section;

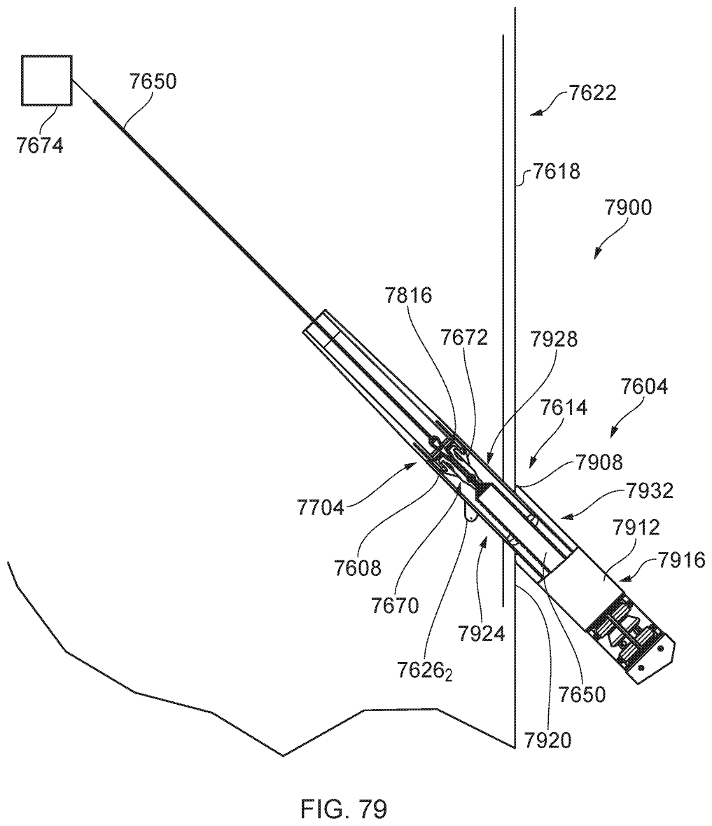

FIG. 79 illustrates another step of the CPS decommission process of FIGS. 76A to 78 in cross section;

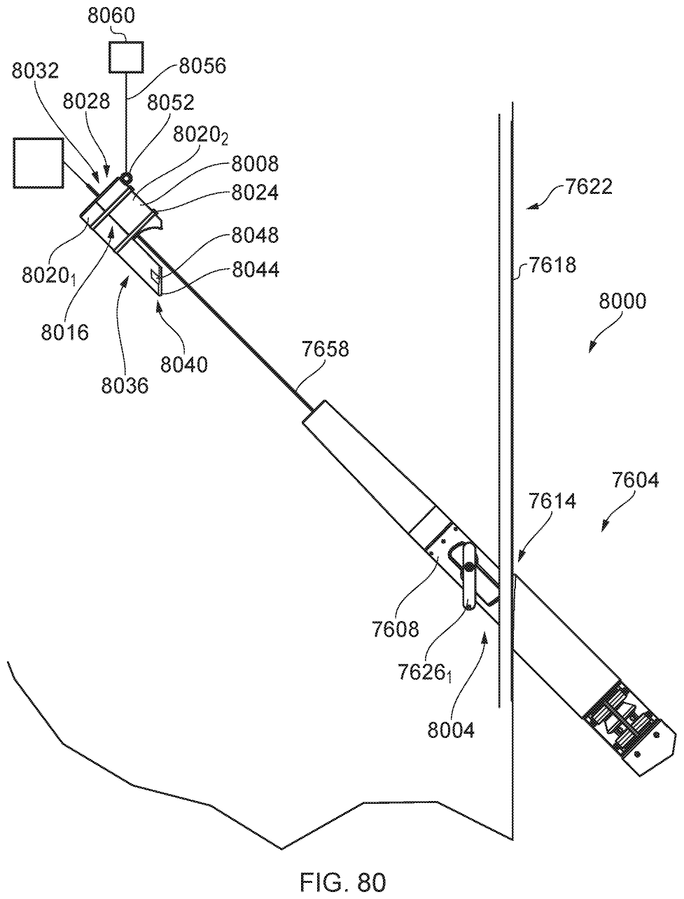

FIG. 80 illustrates another step of the CPS decommission process of FIGS. 76A to 79;

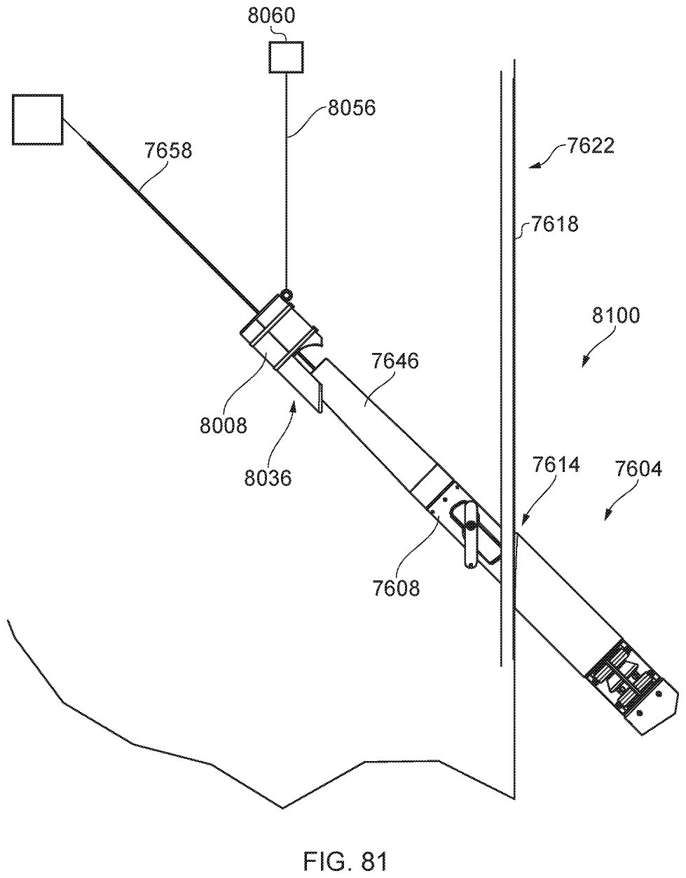

FIG. 81 illustrates another step of the CPS decommission process of FIGS. 76A to 80;

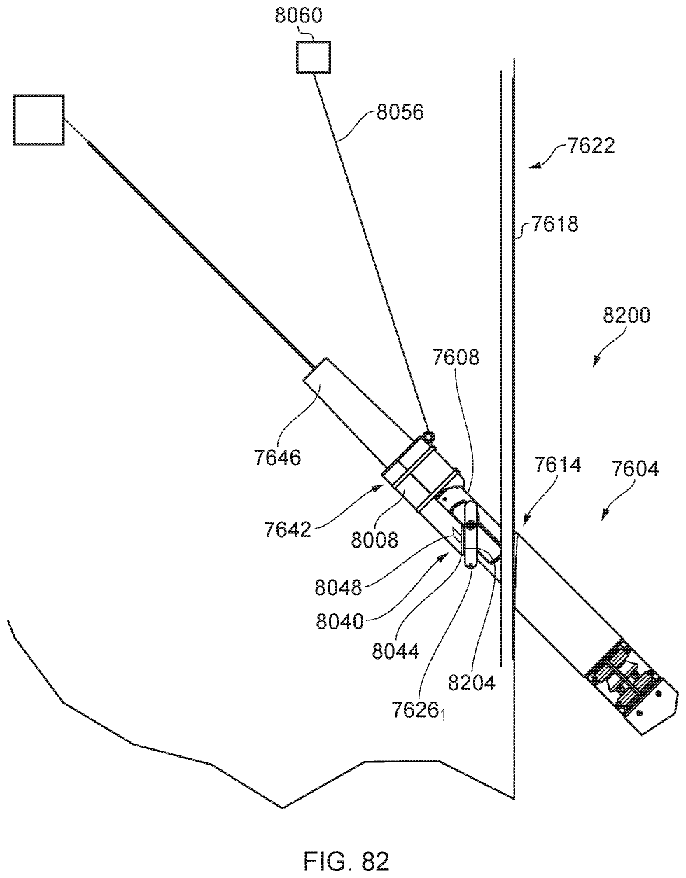

FIG. 82 illustrates another step of the CPS decommission process of FIGS. 76A to 81;

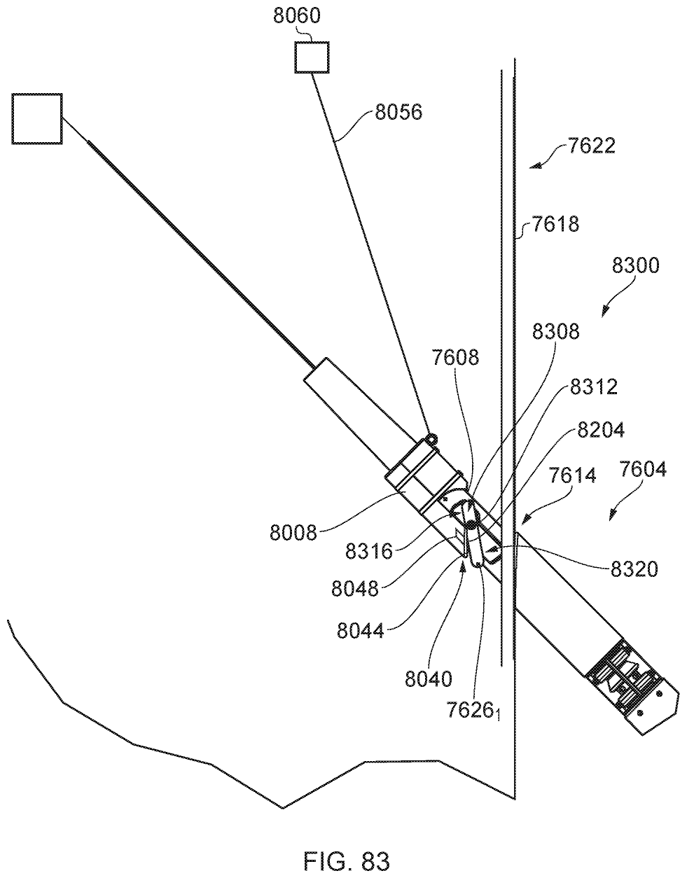

FIG. 83 illustrates another step of the CPS decommission process of FIGS. 76A to 82;

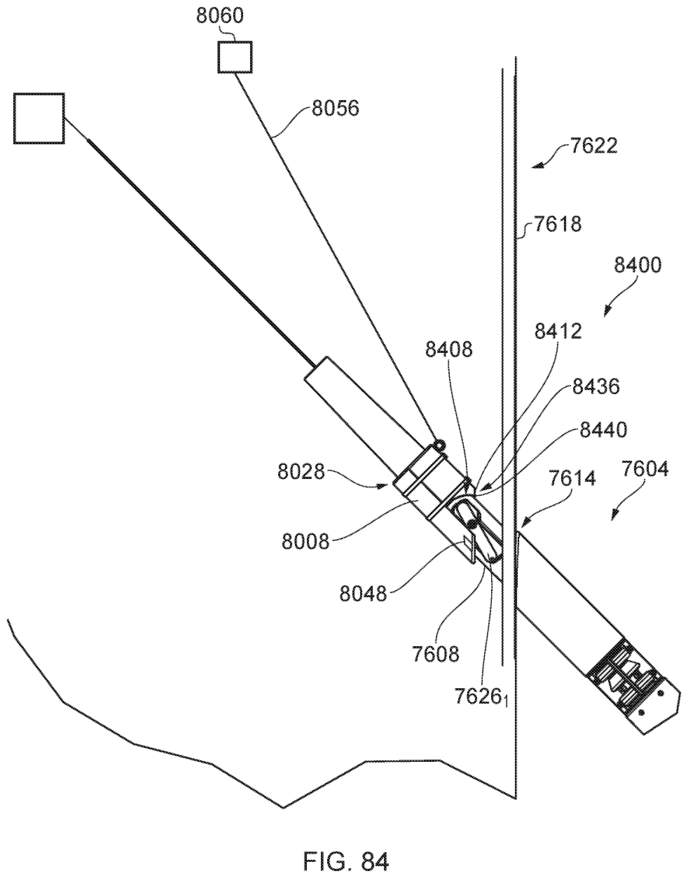

FIG. 84 illustrates another step of the CPS decommission process of FIGS. 76A to 83;

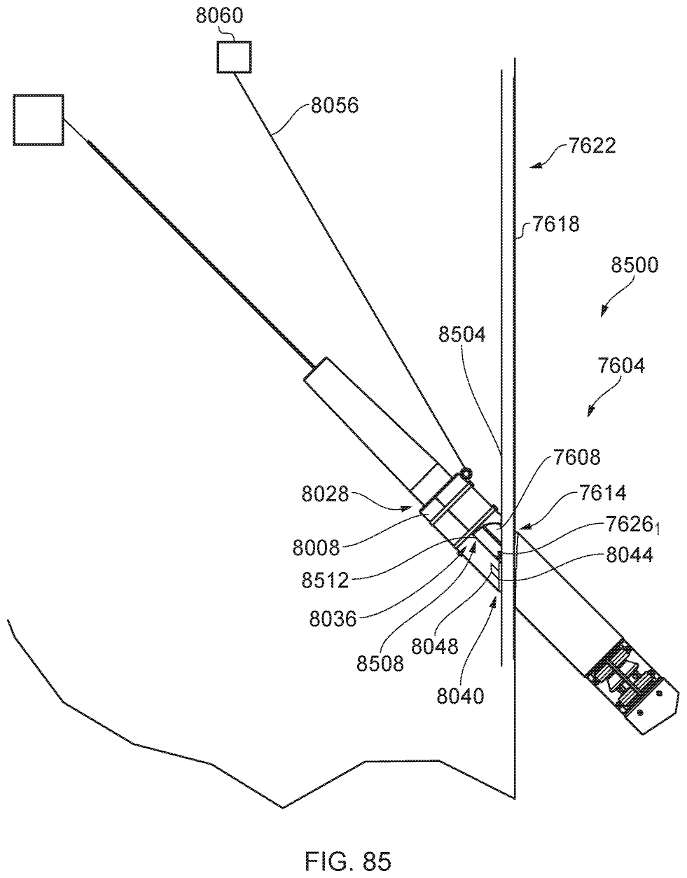

FIG. 85 illustrates another step of the CPS decommission process of FIGS. 76A to 84;

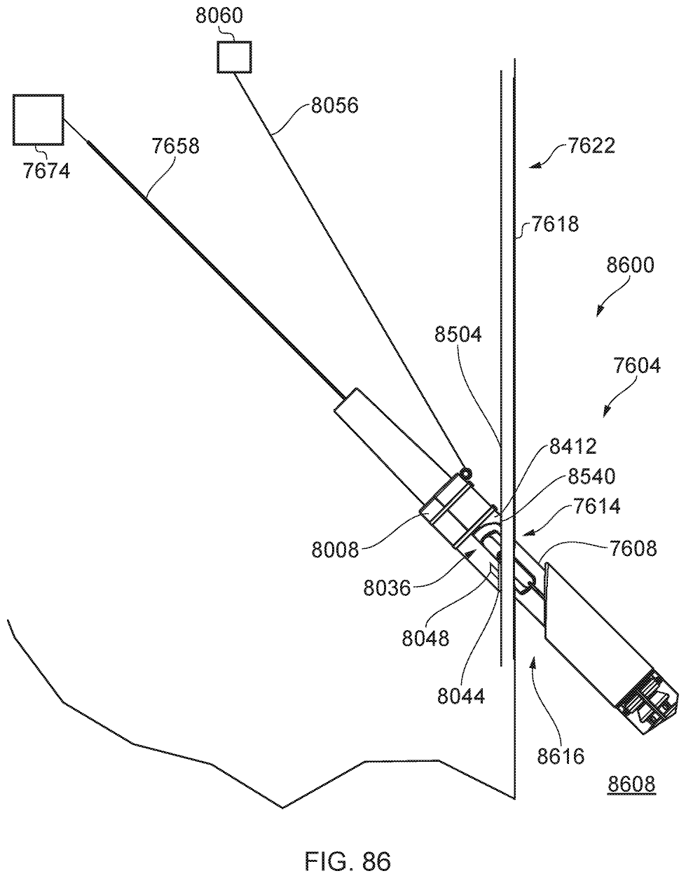

FIG. 86 illustrates another step of the CPS decommission process of FIGS. 76A to 85;

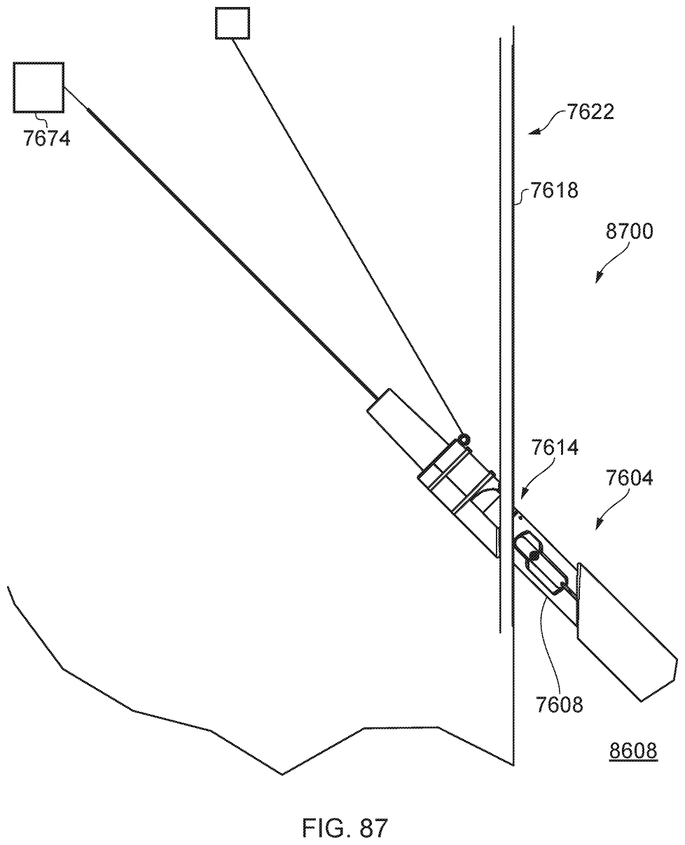

FIG. 87 illustrates another step of the CPS decommission process of FIGS. 76A to 86;

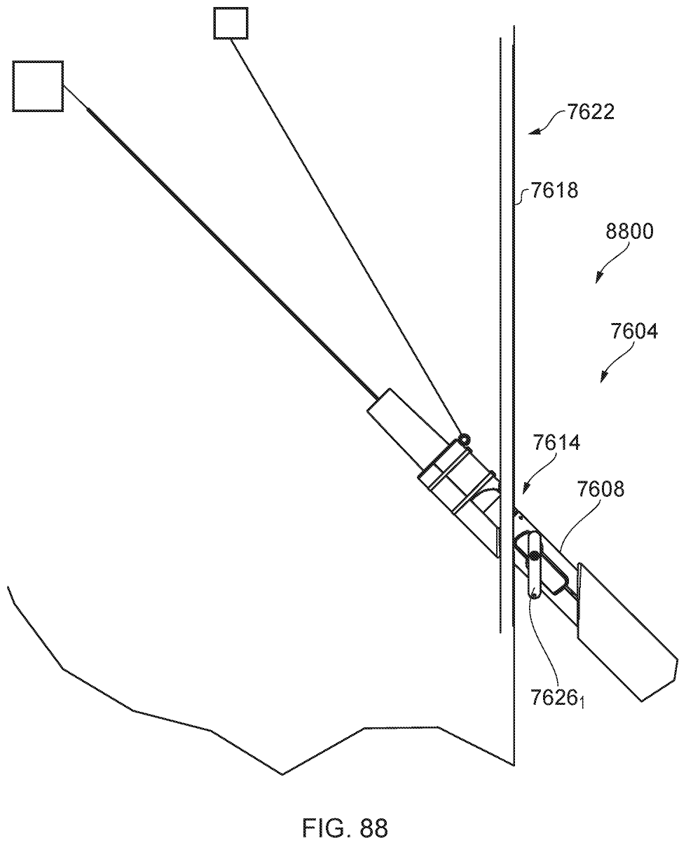

FIG. 88 illustrates another step of the CPS decommission process of FIGS. 76A to 87;

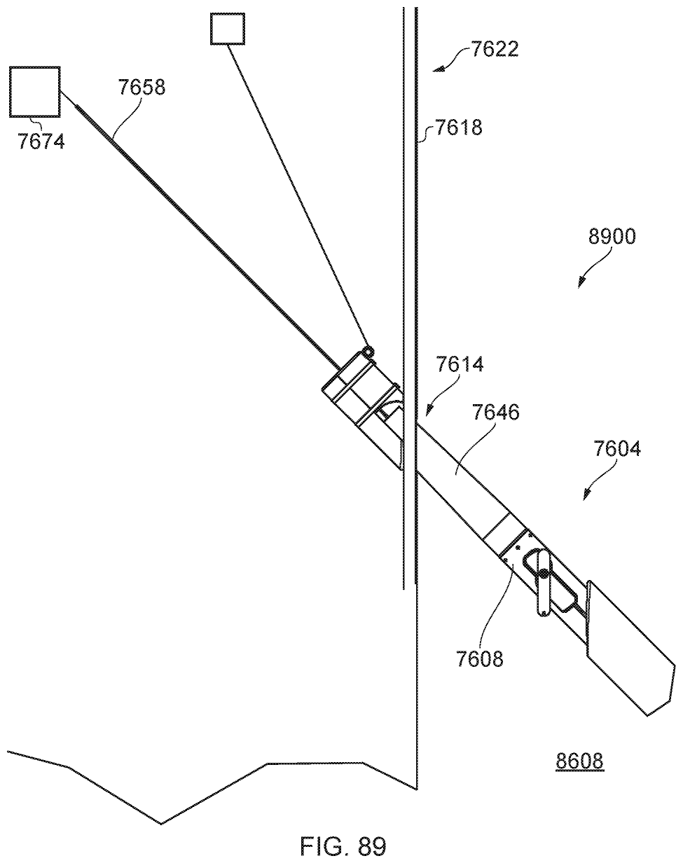

FIG. 89 illustrates another step of the CPS decommission process of FIGS. 76A to 88;

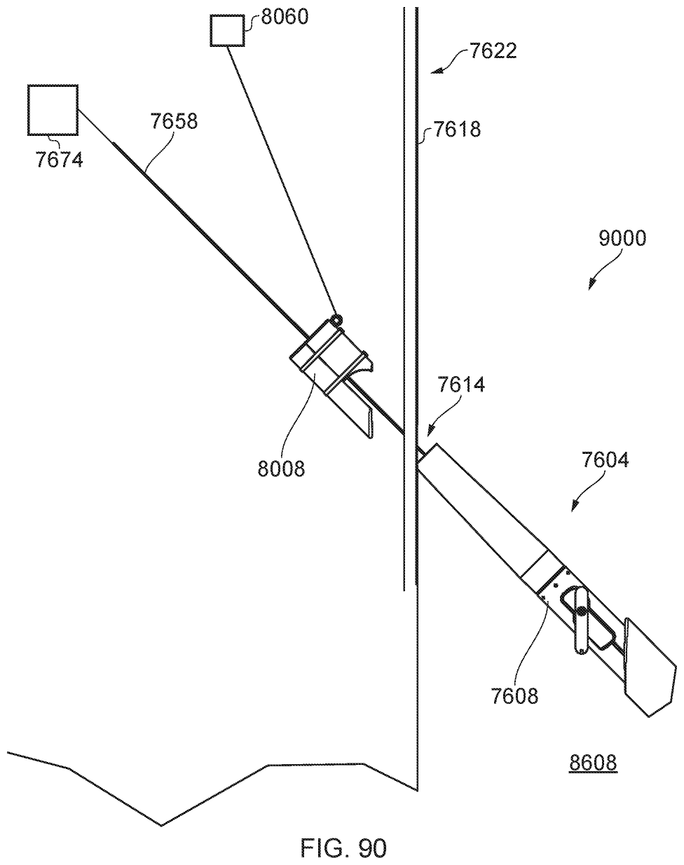

FIG. 90 illustrates another step of the CPS decommission process of FIGS. 76A to 89;

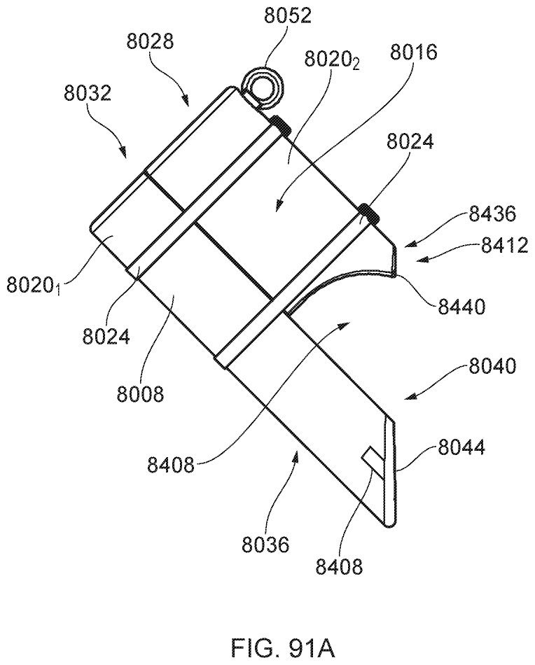

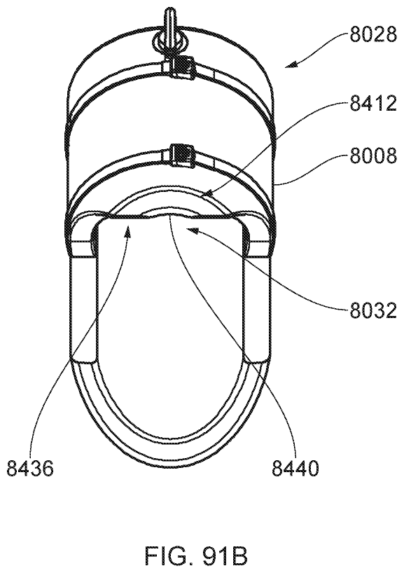

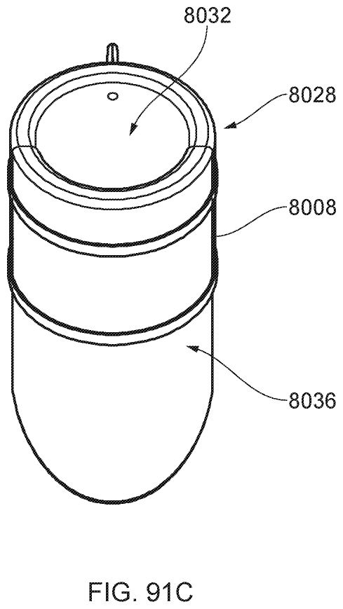

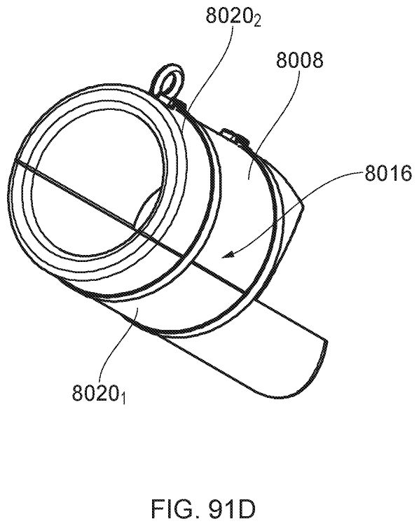

FIG. 91A illustrates the collar of FIGS. 80 to 90 in more detail;

FIG. 91B illustrates a different perspective view of the collar of FIGS. 80 to 90;

FIG. 91C illustrates a different perspective view of the collar of FIGS. 80 to 90;

FIG. 91D illustrates a different perspective view of the collar of FIGS. 80 to 90;

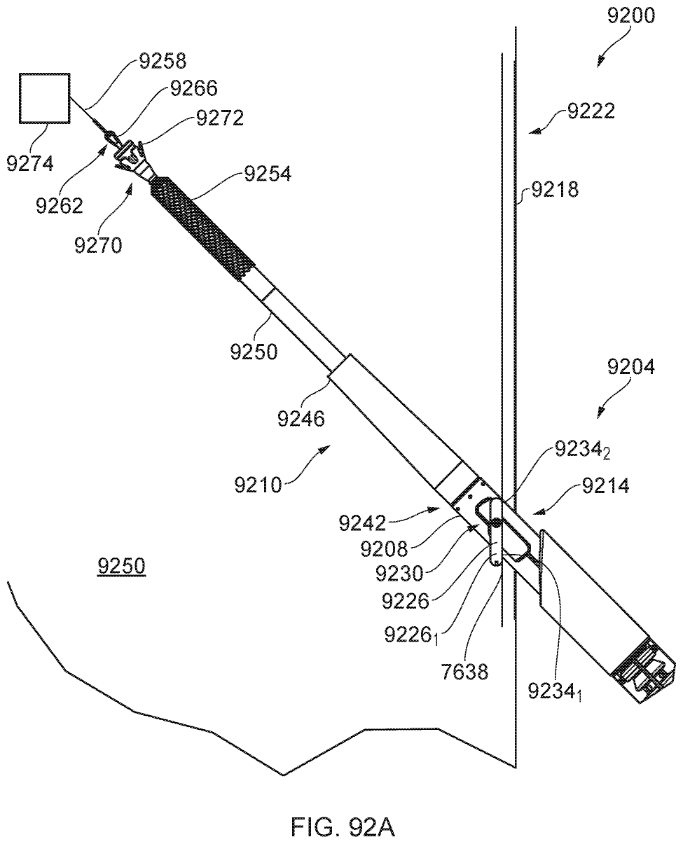

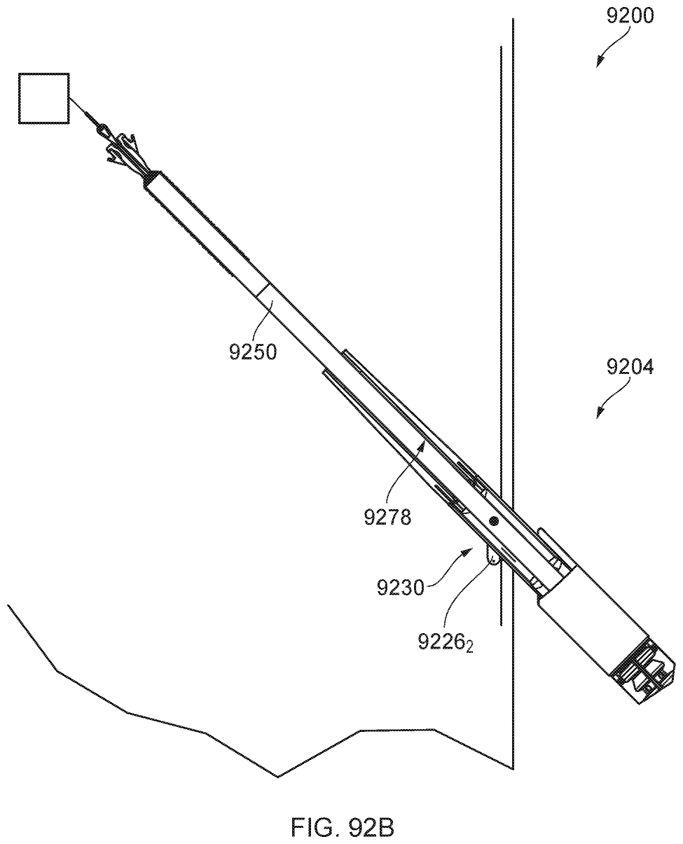

FIG. 92A illustrates a first step of another CPS decommission process;

FIG. 92B illustrates the CPS decommission step of FIG. 92A in cross section;

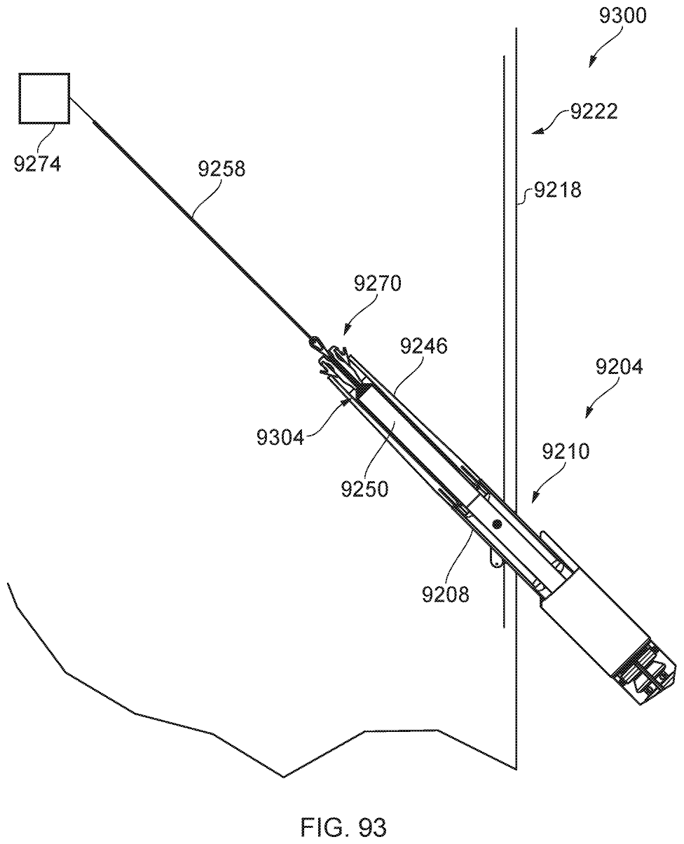

FIG. 93 illustrates a further step of the CPS decommission process of FIGS. 92A and 92B in cross section;

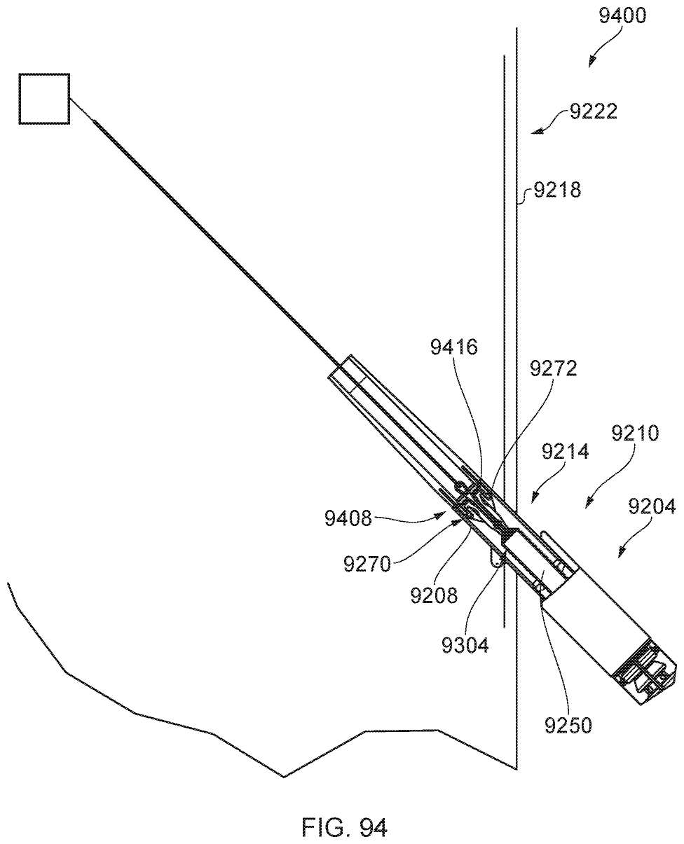

FIG. 94 illustrates a still further step of the CPS decommission process of FIGS. 92A, 92B and 93 in cross section;

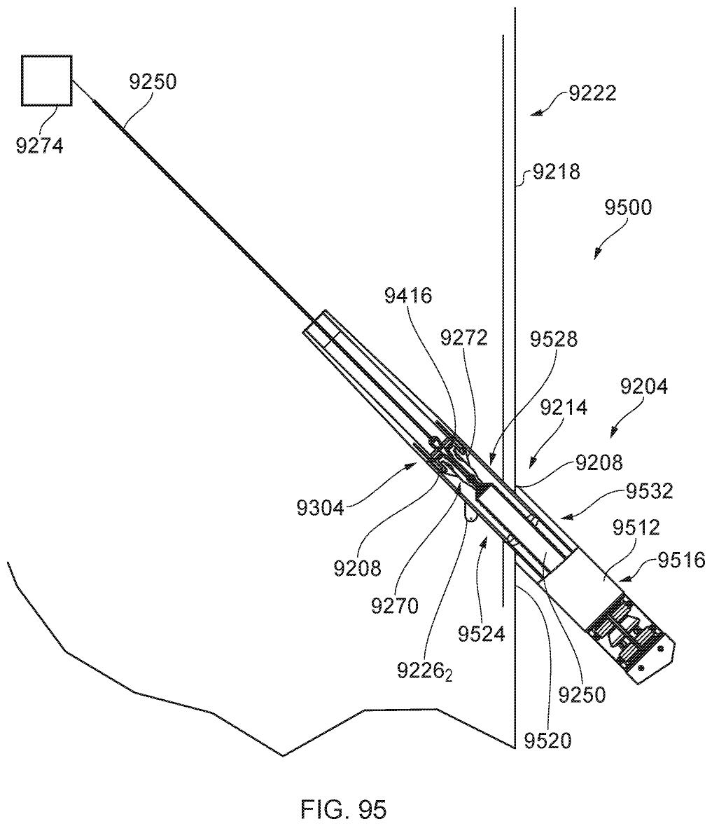

FIG. 95 illustrates another step of the CPS decommission process of FIGS. 92A to 94 in cross section;

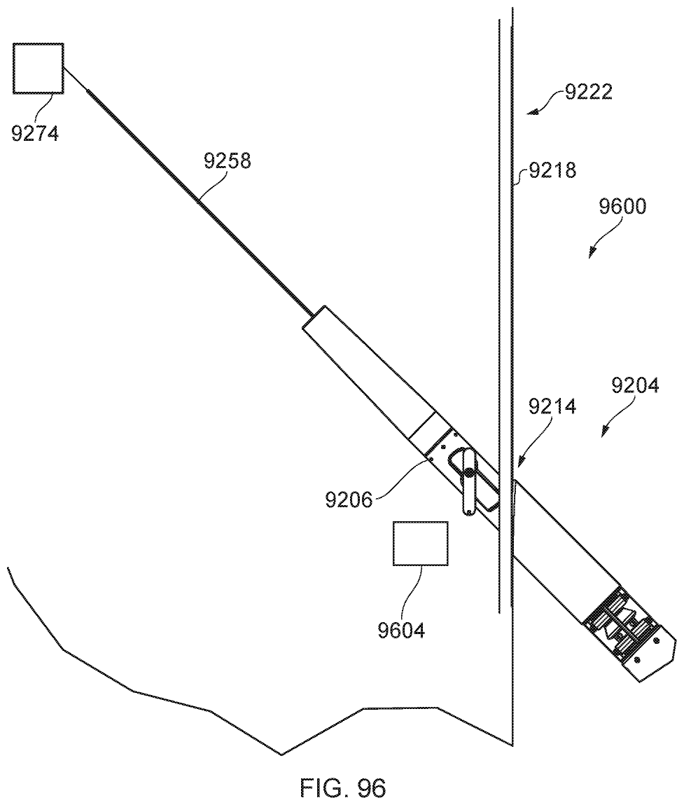

FIG. 96 illustrates another of the CPS decommission process of FIGS. 92A to 95;

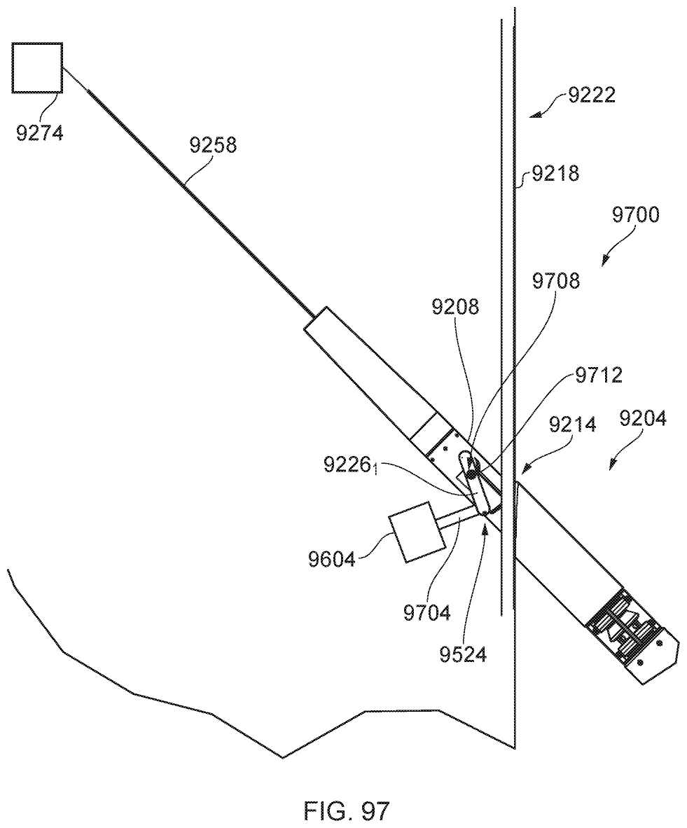

FIG. 97 illustrates another of the CPS decommission process of FIGS. 92A to 96;

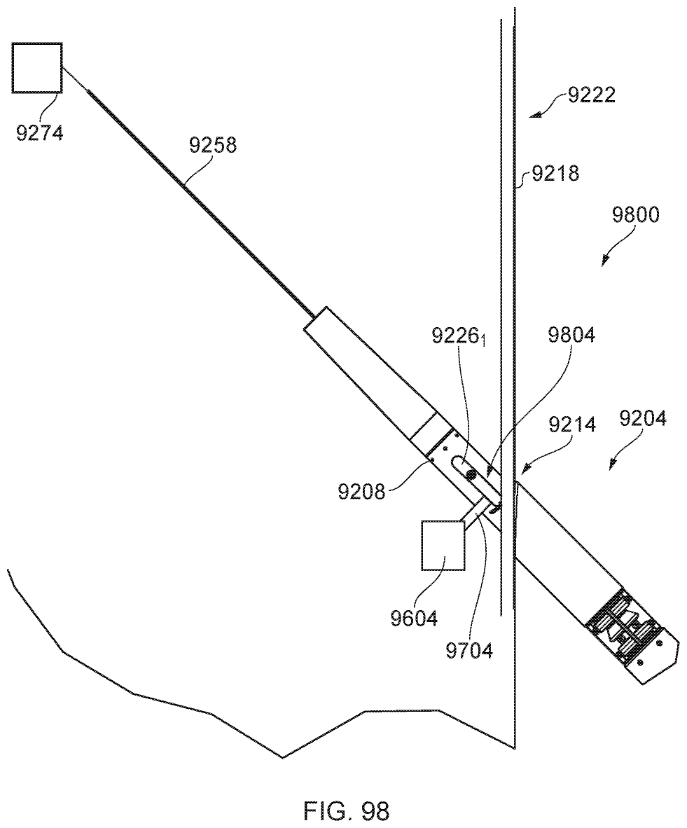

FIG. 98 illustrates another of the CPS decommission process of FIGS. 92A to 97;

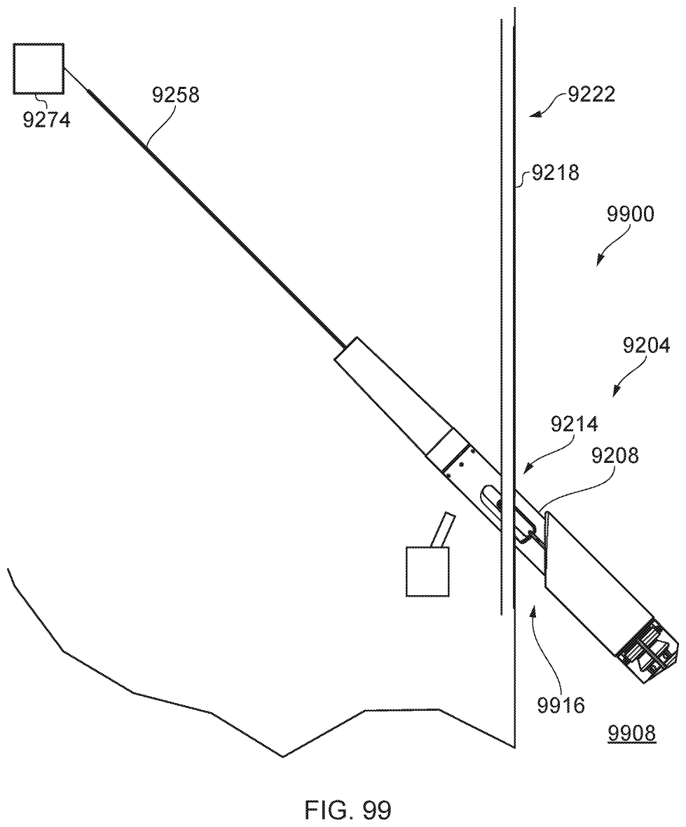

FIG. 99 illustrates another of the CPS decommission process of FIGS. 92A to 98;

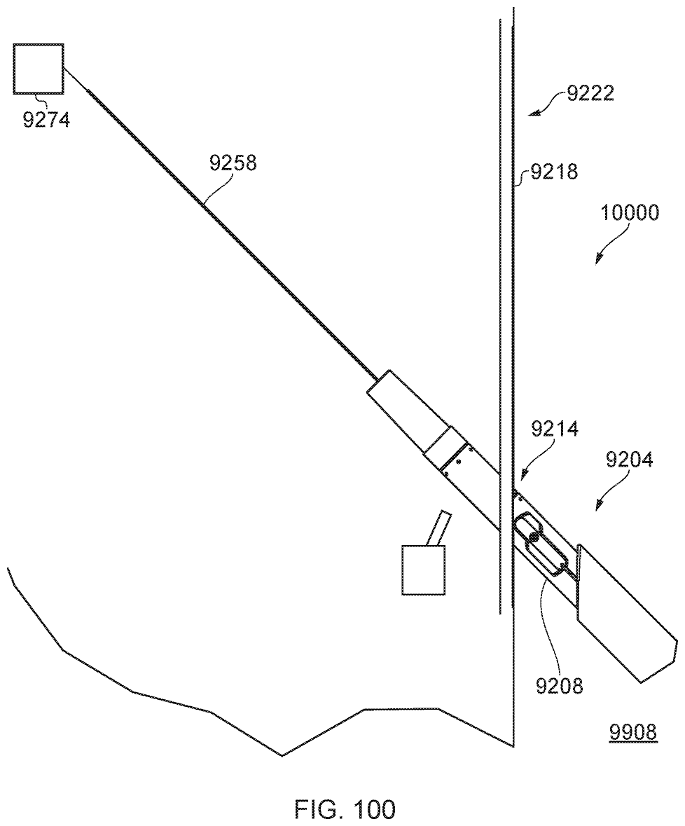

FIG. 100 illustrates another of the CPS decommission process of FIGS. 92A to 99;

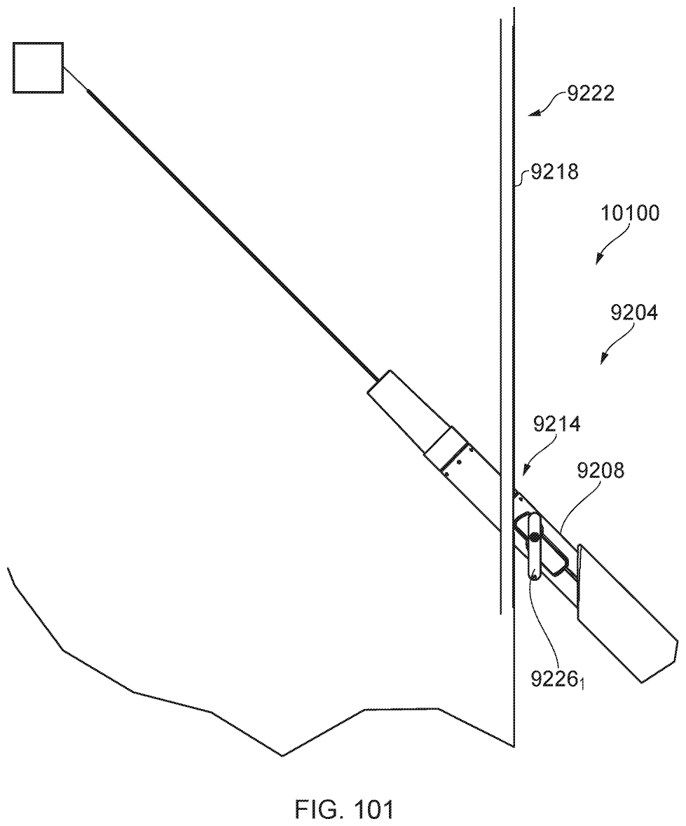

FIG. 101 illustrates another of the CPS decommission process of FIGS. 92A to 100;

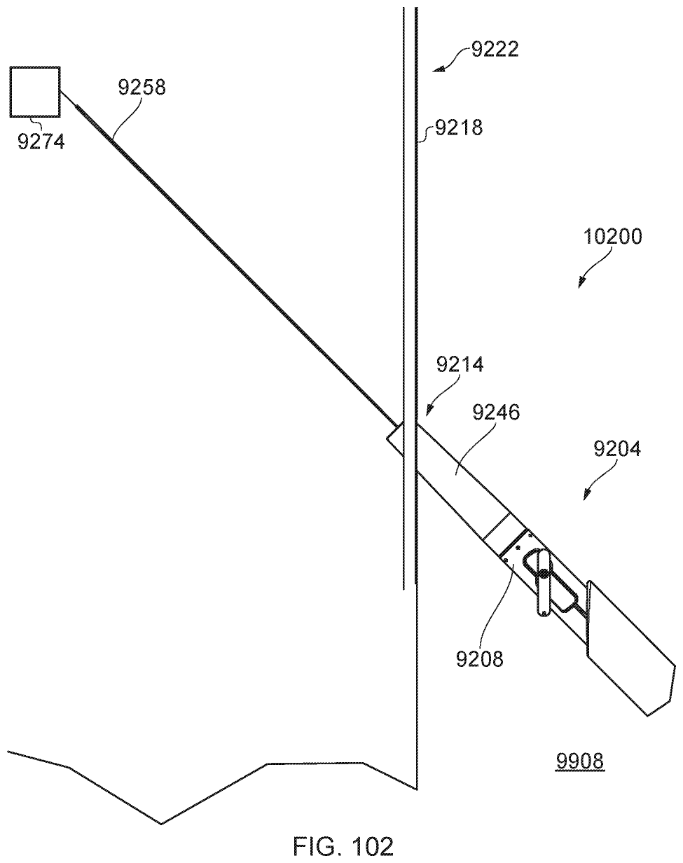

FIG. 102 illustrates another of the CPS decommission process of FIGS. 92A to 101; and

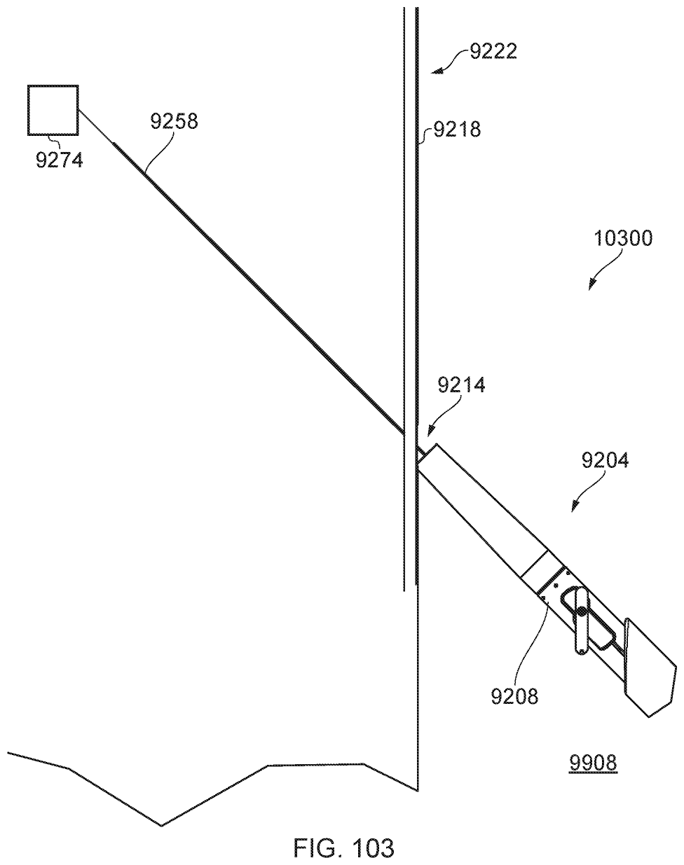

FIG. 103 illustrates another of the CPS decommission process of FIGS. 92A to 102.

In the drawings like reference numerals refer to like parts.

FIG. 1 illustrates a possible environment 100 including an offshore structure. The environment 100 includes an offshore region 104 and an onshore region 108. It will be understood that the offshore region 104 includes a fluidic environment. The fluid is seawater. It will be understood that the fluid of the environment may be other types of water, for example fresh water or brackish water, or the fluid may be a fluid that is not water. It will be understood that the fluid of the environment may include a mixture of different fluid or types of water. Aptly the fluidic environment is an aquatic environment that includes a body of water. The onshore region 108 includes a sea/land transition station 112 for transmitting electrical energy from a wind turbine generator (WTG) of the offshore region 104 to the onshore region 108 and vice versa. It will be understood that the WTG is an example of a facility. The onshore region may additionally or alternatively include further structures such as an onshore converter station for converting electrical energy into suitable forms for onshore/offshore use. The offshore region 104 includes the wind turbine generator (WTG) 116 arranged vertically upright and substantially perpendicular to a base 120 of the offshore region. In the environment shown in FIG. 1 the base is the seabed. Alternatively, the base could be a lake basin, a riverbed, an estuary bed or the like. The WTG 116 is an example of an offshore structure. The WTG 116 is an example of a facility. The WTG shown includes a monopile 124 a transition piece 128 and a turbine section 132. A portion of the monopile 126 is embedded in the base/seabed 120. The turbine section shown includes three turbine blades 134, as is illustrated in FIG. 1. It will be appreciated that any suitable number of turbine blades may instead be included in the WTG 116. It will be appreciated that the turbine blades 134 are able to spin in response to wind to thereby rotate a rotor 140. It will be understood that a generator housed inside of the turbine section 132, and connected to the rotor 140, can be rotated in response to the rotor 140 motion to generate electrical energy. Alternatively, the generator may generate electrical energy responsive to the rotation of the rotor but not itself rotate. Alternatively, only a part of the generator may rotate. The rotor 140 may optionally be connected to the generator via one of more shafts and/or one or more cogs. Optionally the connection between the rotor 140 and the generator may include a gearbox to multiply the rotational speed of the generator relative to the rotor 140 at a given ratio.

The offshore region 104 shown includes an offshore substation 144 for collecting and distributing electrical energy provided by the WTG 116. The offshore substation 144 is a further example a facility. It will be understood that a facility may include an offshore structure. Alternatively, the offshore region may only include the WTG 116 or a plurality of WTGs. A subsea electricity cable 148 connects the WTG 116 and the substation 144. A further subsea electricity cable 152 connects the substation to the transition station 112 of the onshore region 108. The cables 148, 152 are examples of submersible cables. The cables may be submarine cables. Optionally the cables 148, 152 are located on the seabed 120. It will be understood that the seabed 120 is an example of a base of the environment of the offshore region 104. Optionally the cables 148, 152 are partially or wholly embedded in the seabed 120. Optionally the cables 148, 152 float above the seabed 120. The cables 148, 152 shown each include an electricity line. The electricity line is provided by one or more wires. It will be understood that the cables 148, 152 may include multiple electricity lines. It will be understood that the cables 148, 152 may not be electricity cables. It will be understood that the cables 148, 152 may include one or more hydraulic lines. It will be understood that the cables 148, 152 may include one or more fibreoptic lines. It will be understood that the cables 148, 152 may be clad in a waterproof or water-resistant layer, for example a polymeric layer. It will be understood that the cables 148, 152 may include one or more damping materials to reduce crosstalk/interference between individual lines within the respective cable. Further cables may also connect the offshore structures 116, 144 to the onshore region 108. It will be understood that the subsea cables 148, 152 are examples of flexible elongate members. It will be understood that the cables 148, 152 facilitate transmission of electrical power, energy and/or signals. The cable connecting the WTG 116 to the substation 144 is an example of an array cable 148. Array cables 148 may connect the WTG 116 to further WTGs of an offshore wind power farm. An offshore wind power farm can include multiple WTGs. The cable connecting the substation 144 to the onshore region 108 is an example of an export cable 152. Further export cables may be connected to the substation 144. Alternatively, one or more export cables may be connected to a WTG 116. As illustrated in FIG. 1, a section of cable 156 of the of the array cable 148 enters the WTG 116 at the monopile 124.

Although FIG. 1 relates to an offshore WTG 116 in an environment including seawater, it will be appreciated that a WTG may be situated in a number of other locations. For example, a WTG may be located in a lake and may be arranged in an environment which includes freshwater. As a further example, a WTG may be located in an estuary and may be arranged in an environment that includes brackish water. It will also be understood that other types of facility may be included in an infrastructure such as FIG. 1, including floating structures, floating power generation structures, floating WTGs, tidal power structures, solar power structures, data generation structures, monitoring structures, submarine structures, maintenance structures and the like. Further examples of facilities where passage of a flexible elongate member through a wall-like part of the facility may be desired include concrete WTG foundations, gravity based WTG foundations, floating solar array foundations, tidal wave generation structures, structures associated with telecommunications systems, structures associated with hydraulic systems, structures associated with fluid transfer systems via pipes and the like, structures associated with underwater mining operations, structures associated with underwater oil and gas extraction, structures associated with fracking activities, structures associated with offshore power generation, structures associated with onshore power generation, structures associated with power distribution networks (for example substations and transformers) structures associated with portable power technologies and structures associated with venting gasses (for example venting hydrogen gas produced by hydrolysis at offshore wind turbines or solar installations). The walls of such facilities may be formed from different materials and have a variety of dimensions such as thickness. For example, a wall may be a flat metallic or round metallic element or may be a flat or round concrete element.

FIG. 2A illustrates an upper portion 200 of a WTG in more detail. As illustrated in FIG. 2A, the lowest region of the WTG shown is the monopile 204. The upper region of the WTG is the turbine section 208. Aptly, the turbine section is a turbine tower. The turbine section includes three turbine blades 212 and a rotor 216. It will be appreciated that any other suitable number of turbine blades may instead be included. Interspaced between the monopile and the turbine section is the transition piece 220.

FIG. 2B illustrates a lower portion 260 of a WTG in more detail. As is illustrated in FIG. 2B, the lowest region of the WTG is the monopile 204. The upper region of the WTG is the turbine section 208. The turbine section includes the turbine blades 212 and the rotor 216. Interspaced between the monopile and the turbine section is the transition piece 220. The monopile 204 is a support structure for supporting the transition piece 220 and the turbine section 216. The monopile includes a cylindrical wall 228 which surrounds a cavity region 232 within the monopile. The cavity is an inner region 232 associated with the monopile 204, or a region inside the monopile 204. That is to say the monopile 204 is a largely hollow structure. It will be understood that a base region of the monopile 236 is embedded within the seabed. It will be understood that the portion of the monopile not embedded in the seabed is fully or partially surrounded by a fluidic environment 240, for example in sea water. The surrounding fluidic environment is an outer region 240 associated with the monopile, and is a region outside of the wall of the monopile. Aptly this is an aquatic environment.

A subsea cable 244 extends through an aperture 248 in the wall 228 of the monopile 204. The aperture illustrated is a substantially circular through hole extending through the monopile wall. Optionally the aperture is provided by drilling. Optionally the aperture extends along an axis that is angled with respect to an axis perpendicular to the primary axis of the monopile wall. Optionally this angle is between 10 and 90 degrees. Optionally this angle is around 45 degrees. Optionally this angle is around 30 degrees. Optionally this angle is around 15 degrees. It will be understood that the monopile wall is a substantially cylindrical metallic body. Optionally the monopile wall is between 40 to 100 mm thick. As discussed in regard to FIG. 1, the subsea cable 244 is an example of a flexible elongate member. The subsea cable 244 of FIG. 2 includes an electrical line. It will be understood that the subsea cable may optionally include a hydraulic line and/or a fibreoptic line and the like. The subsea cable 244 may include an outer cladding, for example a polymeric cladding. It will be understood that the aperture 248 may be a through hole provided, by drilling for example, through the monopile wall 228. The cable 244 extends from the environment 240 into the inner region 232 of the monopile via the aperture 248. It will be understood that the subsea cable 244 may be arranged to pass through the aperture 248 at any suitable angle in relation to the primary axis of the monopile wall 228. For example, the subsea cable 244 may be arranged to extend through the aperture 248 at an angle of around 45 degrees relative to the primary axis of the monopile wall 228. As is illustrated in FIG. 2B, the cable 244 extends up through the inner region/cavity 232 of the monopile and into the transition piece 220. A cable protection system (CPS) 249 including a rigid support body 250 is arranged through the aperture 248 and surrounds a portion of the cable 244. FIG. 2B illustrates one cable 244 extending through the monopile 204 however will be understood that one, two, three or more cables can be arranged to extend through the monopile inner region 232. It will be appreciated that numerous cables or other flexible elongate members could be bundled together to pass through the aperture by being threaded through the CPS. Such a bundled cable arrangement may behave like a single cable from an installation perspective. It will be understood that a bundled flexible elongate member arrangement may include submarine cables and/or hydraulic cables and/or fibre optic cables and the like. The cable 244 extends up to a platform 252 arranged within the transition piece and towards an upper end of the transition piece. The platform 252 extends across the width of the transition piece 220 and includes a hang-off clamp 256 for securing the cable 244 in the WTG. In this way, a portion of the cable, which optionally is proximate to an end portion of the cable 244, hangs through the transition piece 220 and the monopile 204. The transition piece may optionally also include a winch 260 and a winching line 264. Optionally the winch 260 and winching line may be located in the turbine portion 208 or in the transition piece 220. It will be understood that an end of the winching line 264 is connected to the winch 260. It will be understood that a remaining end of the winching line is connectable to an end of the cable 244 for, via a tension provided by the winch, winching the cable up towards the hang off clamp or, by reducing a tension via the winch, lowering the cable through the transition piece and monopile. It will be understood that a tension could be measured in Newtons (N) and could be measured using a tension meter. The winch is selectively operated to selectively raise or lower the attached elements.

The aperture 248 is typically around 340 mm diameter and around a 45 degree inclination to the seabed, in a 40 mm to 100 mm wall, with the monopile having a diameter between 4 m to 12 m. It will be understood that the monopile diameter, aperture size and associated inclination angle, and wall thickness could be increased or decreased as future WTG manufacturing trends develop. The dimensions of the aperture and associated angle of inclination, wall thickness and monopile diameter are typically only limited by the manufacturing resources and installation vessels/methodologies. That is to say, any suitable diameter and inclination of aperture, monopile wall thickness and monopile diameter could be utilised in manufacturing where industry prejudices are not a concern. It will be understood that the angle that the rigid support body is arranged, relative to the monopile wall, when extending through the aperture is an angle of penetration or a penetration angle.

It will be understood that at least a portion of the inner surface of the wall of the monopile may include a protective layer to reduce damage and/or wear, the protective layer optionally being corrosion resistant. Such a protective layer may be a layer which reduces damage to the wall due to abutment of retaining technologies for retaining the support body of a CPS at a predetermined position.

FIG. 3 illustrates a hang-off clamp 300 in more detail. The hang-off clamp 300 includes a through bore 304 and is arranged in series with a through bore in a platform 312 of a transition piece of a WTG. That is to say that an effective through bore extends through both the hang-off clamp 300 and the platform 312. A cable 318 extends through the respective through holes/bores 304, 308 of the platform 312 and the hang-off clamp 300. The cable 318 includes an outer sheath 322 and an inner sheath 326. Optionally the outer sheath 322 comprises a polymeric material that is further optionally water resistant or waterproof. Optionally the inner sheath 326 comprises a polymeric material that is further optionally water resistant. The inner sheath 326 is arranged radially within the outer sheath 322 and extends through the outer sheath 322. As is illustrated in FIG. 3, the outer sheath 322 is terminated within the hang-off clamp bore 304 whereas the inner sheath 326 extends through the hang-off clamp 300 and extends through an upper end 330 of the hang-off clamp. It will be appreciated that at a lower end 332 of the hang-off clamp 300, the cable 318, including the outer sheath 322 and the inner sheath 326 extend from the hang-off clamp 300 towards the monopile of the WTG.

The hang-off clamp 300 includes a hang-off clamp body 334. The hang off clamp body of FIG. 3 includes two annular elements 338₁, 338₂ with a substantially flattened C-shaped cross section arranged in series. That it to say that a first annular element 338₁ is arranged on top of a further annular element 338₂. It will be understood that any suitable number of arcuate rings may be utilised in a hang-off clamp, the arcuate rings comprising a through bore. The through bore 304 of the hang-off clamp is provided/defined by the cylindrical inner surface 340₁, 340₂ of each stacked arcuate ring. The outer sheath 322 of the cable 318 extends through the further (lower) annular element 338₂ and into the first (upper) annular element 338₁. The inner surface 340₂ of the further (lower) annular element 338₂ is arranged around the outer sheath 322 of the cable and exerts a radially inwardly facing first clamping force on a portion of an outer surface 344 of the cable 318 due to a tight fitting between the outer surface 344 of the cable 318 and the inner surface 340₂ of the further (lower) annular element 338₂. This is optionally an interference fit. It will be understood that the first clamping force at least partially results from an abutting relationship between the outer surface 344 of the cable and the inner surface 340₂ of the further (lower) annular element 338₂ and is at least partly due to friction. Optionally the inner surface 340₁ of the first (upper) annular element 338₁ additionally provides a clamping force on the terminal portion of the outer surface 344 of the cable 318 that is arranged within the first annular element 338₁.

One or more armour wires 348 are arranged between the outer sheath 322 and the inner sheath 326 of the cable 318. Two armour wires 348 are illustrated in FIG. 3 but it will be understood that any suitable number of armour wires could instead be utilised. The armour wires of FIG. 3 wires are formed from a metallic material. Optionally the armour wires are formed from an alloy material. Optionally the armour wires are formed from a composite material. The armour wires 348 extend through the portion of the cable 318 that includes the outer sheath 322 and further extend beyond the terminating point 352 of the outer sheath such that the armour wires 348 extend through the hang-off clamp body and are splayed-out over a first end 356 of the first annular element 338₁, where they are terminated. It will be appreciated that the remaining end of the first annular element 338₁ is connected to the further annular element 338₂. It will be appreciated that the remaining end of the further annular element 338₂ is connected to the platform 312. A clamping ring 360 is arranged over the splayed-out wires 348, and is urged against the wires 348, to provide a further clamping force on the wires 348. The wires are thus securely clamped between the first end 356 of the first annular element 338₁ and the clamping ring 360. The cable 318 is therefore securely clamped within the hang-off clamp 300 via two distinct clamping forces and hangs at a desired position within the WTG. It will be appreciated that prior to clamping the cable 318 in the hang-off clamp 300, the cable may be winched up to a desired position in the WTG by attaching a winching line to a terminal end of the cable 318 and, via a winch, providing a tension on the winching line to lift the cable up through the monopile and transition piece of the WTG.

FIG. 4 illustrates a connection 400 between a winching line 404 and a cable 408 for pulling a cable through a WTG in a first vertical direction. This direction is illustrated by the arrow in FIG. 4. It will be appreciated that the first vertical direction is an upward direction from a region in the monopile of a WTG proximate the base of the environment (for example, the seabed or a lake basin etc.) towards the hang-off clamp or turbine portion of the WTG. A terminal end 412 of a cable 408 is arranged inside a sock/stocking grip or Chinese-finger grip 416. Other connection techniques could optionally be used. The Chinese-finger grip 416 includes a flexible interwoven material in a tubular net-like arrangement. An end portion of the grip 416 is arranged through a chamfered ferrule such that the terminal end of the grip 416 forms an eyelet 420. A portion of a coupling link 424 is threaded through the eyelet. The coupling link 424 includes a first and further arcuate coupling element 4281, 4282 which are connected via the terminal ends of each arcuate coupling element 4281, 4282. The first arcuate coupling element 4281 is threaded through the eyelet 420 prior to connecting the first coupling element 4281 and the further coupling element 4282. The further coupling element 428 is connected to a swivel device 432, optionally via a respective eyelet 436 of the of the swivel device 432.

The winching line 404 is connected to an opposite end of the swivel device 432 via another coupling link 440 which couples an eyelet 444 of the winching line 404 to a respective eyelet 448 of the swivel device in a similar way to how the Chinese-finger grip 416 is connected to the swivel 432. It will be understood that the eyelet 444 of the winching line 404 is provided by threading a terminal end 448 of the winching line 404 through a chamfered ferrule 452. The swivel is arranged to be rotatable such that a rotational motion of the cable 408 during a winching operation does not produce a twisting and an associated tension in the winching line 404 and vice versa. Optionally the swivel device 432 is disposed to allow the eyelets 436, 448 of the swivel device 432 to rotate/swivel independently of each other. Via the connection between the cable 418 and the winching line 404 illustrated in FIG. 4, the cable 408 can be winched up via a winching device/element to a desired position within the WTG.

FIG. 5 illustrates the installation 500 of a rigid support body 502 of a cable protection system (CPS) 504 at a predetermined position with respect to an aperture 508 in a wall 512 of a monopile 516. The rigid support body of FIG. 5 is located at the predetermined position with respect to the aperture in the wall. It will be understood that the monopile 516 is a part of a WTG, the WTG being an example of a facility. It will be appreciated that the monopile is submerged in a fluidic environment 520, for example seawater or fresh water or brackish water, and is partially embedded within the base 524 of the environment, for example the seabed. The fluidic environment shown in FIG. 5 is seawater and the base is the seabed. It will be appreciated that the cable protection system is arranged around a submersible electrical cable 528 that is an example of a flexible elongate member. That is to say the rigid support body 502 includes a through-bore that extends through the support body from a first end of the support body to a further end and through which a flexible elongate member is located. The rigid support body 502 of the CPS 504 is initially arranged at a first position 532 that is outside the monopile. That is to say that the rigid support body 502 is entirely located outside of the monopile 516 and in the environment 520. It will be appreciated that, either when the CPS 504 is arranged such that the rigid support body 502 is located at the first position, or prior to the rigid support body 502 being located at the first position, a first winching line is connected to a first terminal end 540 of the cable 528. A remaining end of the first winching line is connected to a first winch 544. The first winch 544 is located in an upper region of the WTG, optionally within an upper region of the transition piece. Optionally, either when the CPS is located at the first position, or prior to the CPS being located at the first position a further winching line 548 is connected to a further terminal end 552 of the cable 528. The further winching line 548 is optionally connected to a further winch 556. Optionally the further winch 556 is directly connected to the further terminal end 552 of the cable 528. The further winch 556 is located at the surface 560 of the fluidic environment 520, for example on a boat/ship 564 or other such vessel. Typically, a first tension provided on the cable via the first winch 544 is arranged to be substantially in equilibrium with a further tension on the cable provided by the further winch 556 which is opposed to the first tension, to help limit any possibly destructive and damaging free motion of the cable. That is to say that the first and further tension are substantially balanced to limit unwanted motion of the cable. It will be understood that the rigid support body may encompass a dynamic portion of the cable at a particular moment in time. That is to say, a part of the cable may be free to move within the rigid support body.

It will be appreciated that the first tension acts in a vertically upwardly direction (in a direction closely or exactly aligned with a direction of the primary axis of the WTG) proximate the first winch 544. However, as the cable is arranged to be connected to both the first and further winch 536, 548 each being located at longitudinally different positions, and as the cable 528 is threaded through the aperture 508, at least a portion of the first tension will be translated into a longitudinal component proximate to the aperture 508. That is to say that a pulling force that is oblique or perpendicular to the first tension will be incident on the portion of the cable proximate to the aperture. It will therefore be understood that by increasing the first tension, the cable 528 can be pulled further into the monopile 516 of the WTG. The rigid support body 502 is pulled along with the cable 528 and is therefore pulled into the aperture of the rigid support body to a further position. The further position of the rigid support body is a position in which a portion of the rigid support body is located within the monopile 516. The rigid support body, once pulled into the aperture, can be arranged at a predetermined position 564 in which a portion of the rigid support body 502 is arranged within the monopile. The CPS may additionally include a bend stiffener member 564, a pull-in head adaptor 568 and one or more restricting elements 572. Optionally, the cable can be secured at a hang-off clamp 576.

It will be appreciated that, during a cable and/or support body pull in operation, the first tension provides a pulling force on the cable which is provided by the first winching element being connected to the cable via the first winching line (optionally via a Chinese finger cable grip element such as the grip illustrated in FIG. 4). It will be appreciated that the first tension could be measured in Newtons (N) and could be measured using a tension meter.

It will be appreciated that, during a support body pull-in operation, the first pulling force is applied to the first terminal end of the cable in a first pulling direction which optionally is a vertically upward direction. It will be understood that, via the first pulling force, an urging force is provided to the rigid support body, due to a connection between the cable and the rigid support body which optionally is via a pull-in head, in a first penetration direction aligned with an axis of the rigid support body as the rigid support body passes through the aperture.

It will be appreciated that the further winching line is an example of a tensioning element. The tensioning element may instead include a cable engine or a clamping quadrant and the like.

It will be understood that, after pulling a portion of the support body through/into the aperture, via a further pulling force on the further winching line, the rigid support body is urged in a further penetration direction directed away from within the monopile. The penetration direction and/or the further penetration direction extends in an axis that is around 45 degrees to the primary axis associated with the wall of the monopile. By relaxing the first pulling force and allowing movement of a previously inside portion of the rigid support body out of the facility via gravity, the rigid support body is urged into a retained position. It will be understood that the further tension may be cooperatively increased to pull the support body into the retained position.

Optionally via a sealing element, the aperture is sealed around the rigid support body to thereby prevent fluid communication between the facility and the environment in at least one direction.

It will be understood when the rigid body in the retained position in which an axial position of the rigid support body with respect to a location of the aperture remains substantially unchanged, a swivel angle and/or an angle of attack, of an abutment surface of a retaining element, adopted by each retaining element responsive to environmental forces may be constantly adjusted in use. At any particular instance in time, the retaining element maintains an equilibrium position responsive to all forces exerted on the rigid support body despite at least one of a yaw and pitch and roll angle associated with an orientation of the rigid support body varying.

FIG. 6 illustrates the installation of cable protection system with respect to an aperture in a monopile wall 600 in more detail. FIG. 6 illustrates a wall 604 of a monopile 608 of a WTG. A portion 612 of the wall 604 extends into the environmental base 616. A cable extends through an aperture 624 in the wall 604. A first end of the cable 628 is secured to a first winching line 632 by a connection arrangement 636. Optionally the connection arrangement 636 is the connection of FIG. 4. An exemplary Chinese-finger grip 640 secured to the first end of the cable 628 is illustrated in FIG. 6. A rigid support body 644 of a CPS 648 is arranged within the aperture 624. It will be understood that the rigid support body 644 is arranged in a further position in which a desired portion 652 of the rigid support body is located within an inner cavity of the monopile. As illustrated in FIG. 6, a further portion 656 of the rigid support body remains outside of the monopile and in the fluidic environment 660. It will be appreciated that the rigid support body 644 has been pulled partially into the monopile 608, from an initial first position of the rigid support body in which all of the rigid support body is located outside of the monopile, as a result of pulling the cable 620 into the monopile. The rigid support body therefore moves with the cable in an installation operation. The cable may move independently of the rigid support body in further operations, such as a cable pull-in operation. The cable 620 is pulled into the monopile 618, through the aperture 624 via a first tension on the first winching line 632 provided by a first winch 664. Due to the connection 636 between the first winching line 632 and the cable 620, a retraction of the first winching line 632 by the winch 664 provides a vertical pulling force on the cable in an upward direction. Due to the arrangement of the cable 620 through the aperture 624, at least a portion of the pulling force is translated into a longitudinal component proximate the aperture 624. An angled pulling force therefore acts on the portion of the cable proximate the aperture. Due to the angled pulling force, the cable is therefore pulled in a direction that is substantially oblique or perpendicular to the vertical pulling force through the aperture. It will be appreciated that the rigid support body 644 is pulled into the aperture 624 via this angled pulling force. As is illustrated in FIG. 6, along with the rigid support body 644, the CPS 648 may include a bend stiffener, a pull-in head adaptor 676 and one or more bend restrictors 680. The first portion 652 of the rigid support body 644 may also include one or more retaining arms 684 able to retain the rigid support body 644 at the further position of the rigid support body 644. An outer sleeve may optionally cover the part or all of the surface of the further portion 656 of the rigid support body 644. Optionally the cable 620 may be secured at a hang-off clamp 692 proximate to a first end 628 of the cable 620, the hang-off clamp optionally being located in a transition piece 696 of the WTG. It will be appreciated that the portion of the cable that is located through the rigid support body at any particular instance in time is a covered portion. The covered portion is a covered region of the cable.

FIG. 7 illustrates a CPS in a first position 700, for locating a flexible elongate member at a predetermined location with respect to a monopile wall through which an aperture is provided. It will be understood that the first position 700 of the CPS 702 may be adopted prior to installation of the CPS system in a WTG. It will be understood that a rigid support body 704 of the CPS is also arranged at a first position 700 in the CPS position illustrated in FIG. 7. In the first position 700, all of the rigid support body 704 of the CPS 702 is located outside of a monopile 708, that is to say none of a rigid support body is located in a space enclosed by a wall 712 of the monopile 708, or within an aperture 716 extending through the wall 712. The first position 700 is therefore a first position of the rigid support body 704. It will be appreciated that, when a cable or other flexible elongate member is threaded through a through bore of the CPS, the installation of the CPS from the first position 700 may be achieved via the winching process described in FIGS. 5 and 6. Although a monopile or WTG is specifically referred to here, it will be understood that the system could be utilised in any suitable structure or facility that includes a wall with an aperture extending therethrough and an internal cavity. The WTG is an example of a facility, the monopile being a part of the WTG.

As is illustrated in FIG. 7, the cable protection system includes a rigid support body 704 arranged between a progressive stiffener 720 (or bend stiffener) and a pull-in head adaptor 724. The rigid support body 704 is elongate and is substantially tubular and includes a cylindrical through bore. The cylindrical through bore (not shown in FIG. 7) extends through a whole length of the rigid support body. That is to say the rigid support body includes a through-bore that extends through the support body from a first end of the support body to a further end and through which a flexible elongate member is locatable. The rigid support 704 body is formed from a metallic material. For example, a corrosion resistant alloy and the like may be used. The rigid support body 704 may optionally be formed from a polymeric material or a reinforced polymeric material. The rigid support body 704 may optionally be made from a composite material. The rigid support body 704 may optionally be manufactured from a ceramic material. The support body is rigid enough to not deform substantially. The bend stiffener 720 is also an elongate body that surrounds a substantially cylindrical through bore. As is illustrated in FIG. 7, the bend stiffener 720 includes a tapered portion 728 including a tapered outer surface. It will be appreciated that the through bore of the tapered portion 728 is substantially cylindrical and is therefore not itself tapered. The thickness of the tapered portion 728 therefore varies along its length from a flared-out end 734 arranged to be close to the rigid support body 704 to a narrow end 738 distal to the rigid support body 704. The varying thickness of the tapered portion 728 provides a non-uniform stiffness of the bend stiffener 720 along its length. It will be appreciated that, when an elongate flexible member, such as a cable or the like, is arranged radially within the bend stiffener 720, a flexibility of the elongate member is constrained at the flared-out end 734 of the tapered portion and is relatively unconstrained at the narrow end 738 of the tapered portion 728. This tapered portion 728 helps prevent a flexible elongate element, such as a cable, from exceeding a predetermined minimum bend radius that may be detrimental to the elongate element. The bend stiffener 720 may also help reduce chafing, or other destructive frictional effects, at the interface between the elongate element and the rigid support body 704. The bend stiffener 720 additionally includes a substantially annular portion 740 coupled to the flared-out end 734 of the tapered portion 728. A remaining end of the substantially annular portion is coupled to a first end 742 of the rigid support body 704. The coupling between the substantially annular portion 740 of the bend stiffener 720 and the first end 742 of the rigid support body 704 may be provided by conventional securing methods such as bolting of screwing of the like. The progressive stiffener is thus secured to the first end of the rigid support body.

A further end of the rigid support body 704 is connected to the pull-in head adaptor 724. The further end of the rigid support body is therefore secured to the pull-in head adaptor. It will be appreciated that the pull in head adaptor can house and can releasably engage with a pull-in head during a support body pull in operation. When engaged within the pull in head adaptor, the CPS system moves with the cable. Therefore, by pulling the cable into the monopile via the aperture by winching, the rigid support body is also pulled through the aperture. Aptly the pull-in head adaptor is of the type disclosed in International patent application WO2018/234761 (the proprietor of which is C-LING LIMITED).

As illustrated in FIG. 7, a region of the rigid support body 704 proximate to the further end 748 of the rigid support body is covered by an outer sleeve 752. The outer sleeve 752 is therefore located at a position distal to the first end 734 of the rigid support body 704. The outer sleeve 752 shown is manufactured from a polymeric material. The outer sleeve 752 may optionally comprise a polymeric material. The outer sleeve 752 may optionally comprise a reinforced polymeric material. The outer sleeve 752 may optionally comprise a composite material. As is illustrated in FIG. 7, the outer sleeve 752 is arranged to radially surround a portion of the rigid support body 704 and is substantially tubular. A first end of the outer sleeve 756, most proximate to the first end 734 of the rigid support body 704 is angled such that an axis associated with a face 755 of the first end 756 of the outer sleeve 752 is oblique to a primary axis of the outer sleeve 752 (and the rigid support body 704). It will therefore be appreciated that the outer sleeve 752 extends further over the rigid support body 704 on a top side 760 of the rigid support body than the bottom side 764 of the rigid support body 704, the top 760 and bottom 764 sides of the rigid support body 704 being on opposite substantially opposite sides of the rigid support body. It will be understood that the top and bottom sides of the rigid support body are simply relative terms, and that the rigid support body may be arranged in any orientation, the top side 760 of the rigid support body possibly being located on an upper surface of the rigid support body and the bottom side 764 of the rigid support body optionally being located on a lower surface of the rigid support body 704. A further end 767 of the outer sleeve member, most proximate to the further end 748 of the rigid support body 704 has a face 768 that is flat and lies in a plane perpendicular to the primary axis of the outer sleeve member (and rigid support body).

A further adaptor 772 is connected to a remaining end of the pull-in head adaptor 724 (the end of the pull-in head adaptor 724 that connects the pull-in head adaptor to a bend restrictor element 776). It will be understood that the bend restrictor element 776 is part of a bend restrictor 777 which includes multiple bend restrictor elements 776. Three bend restrictor elements 776 are shown in the bend restrictor 777 of FIG. 7. It will be understood that any number of bend restrictor elements 776 may be included in the bend restrictor 777. The further adaptor 772 may be connected to the pull-in head adaptor via a suitable securing mechanism such as screwing and/or bolting and the like. The further adaptor 772 may be connected to a bend restrictor element 776 by a securing mechanism such as screwing and/or bolting and the like. Alternatively, a bend restrictor element 776 may be a part of the further adaptor 772, that is to say a bend restrictor element 776 may be arranged at a terminal end of the adaptor 772, the bend restrictor element and the further adaptor being integrally formed. As shown in FIG. 7, the multiple bend restrictor elements 776 are arranged in series and connected in an end-to-end configuration. It will be understood that the bend restrictor 777 defines an end portion of the CPS 702 which extends into the surrounding environment 780 and away from the monopile wall 712. The bend restrictor elements 776 forming the bend restrictor 777 limit the flexibility of a portion of an elongate member arranged within each of the bend restrictor elements 776.

FIG. 7 also illustrates a retaining arm which is connected to the rigid support body 704 via a respective connector 784. It will be appreciated that, although only one retaining arm is shown in FIG. 7, the illustrated rigid support body 704 also includes another retaining arm on a diametrically opposite surface of the rigid support body 704 (or a surface extending into the page in FIG. 7). The CPS thus includes a pair of retaining arms disposed in respective substantially diametrically opposed side positions on the outer cylindrical surface of the support body. It will be understood that, although the CPS of FIG. 7 includes two retaining arms 782, any suitable number of retaining arms 782 may be utilised, the retaining arms 782 optionally being arranged at any suitable position along the rigid support body 704. One retaining arm or two retaining arms or three or four or more may optionally be utilised. It will be understood that the retaining arm 782 is an example of a retaining element and any suitable shape or configuration of retaining element can instead be utilised rather than the elongate arm-like elements shown in FIG. 7. Each of the retaining arms 782 are connected to the rigid support body 704 via a respective connector 784. That is to say a different connector 784 connects each retaining arm 782 to the rigid support body 704. It will be appreciated that each retaining arm 782 illustrated is on a respective side of the rigid support body 704 that is between, and is substantially equidistant from, the top 760 and bottom 764 sides of the rigid support body 704. It will be appreciated that so-called sides of the rigid support body refer to a regions of the cylindrical surface of the support body which extend a respective maximum and minimum distance in an x-axis and y-axis of an imaginary plane that is perpendicular to the primary axis of the rigid support body. Each retaining arm 782 is connected to the rigid support body 704, via the respective connectors 784, at a respective position of the rigid support body 704 more proximate to the first end 742 of the rigid support body than the further end 748 of the rigid support body 704. The retaining arms 782 each include an elongate retaining body which comprises a through hole 786 extending through the retaining body in a direction perpendicular to the primary axis of the retaining element to receive an end of a respective connector 784. As illustrated in FIG. 7, the through hole 786 is offset from a centre point of the retaining arm 782 and is therefore located proximate to a first end 788 of the retaining element 782. A remaining end of each connector 784 is connected to the rigid support body. It will be understood that the connector may include a shaft. It will be appreciated that the connector may include a bearing to permit swivelling of the retaining arm 782 with respect of the rigid support body 704. The through hole 786 may optionally include a bearing. The retaining arms 782 are therefore disposed to swivel about the connector 784, an end section, or alternatively any portion, of which is located in the through hole 786 of the body of the retaining arm 782. It will be appreciated that the swivelling motion of each retaining arm 782 is a rotational motion centred around the through hole 786 and connector 784. The through hole 786 of the body of each retaining arm 782 therefore constitutes a swivel region that is optionally a swivel point. That is to say that swivelling of the retaining arm 782, includes the partial spinning of the retaining arm about a particular point that is an effective swivel point. It will be appreciated that the retaining arm is supported on the rigid support body. In the arrangement illustrated in FIG. 7, the retaining arm is arranged in a storage position.

A further end 790 of each retaining arm 782 is releasably connected to a respective latch arm 792 located in an elongate recess 794 on the outer surface of the rigid support body 704. The connection between the latch arm is facilitated by a frangible connector 796. The frangible connector 796 is an example of a frangible portion of the latch arm 792. It will be appreciated that the frangible connector is located at a first end of the latch arm. Optionally the frangible portion may be located at any suitable position of the latch arm 792. Optionally the frangible portion may be a separate element and is not a part of the latch arm 792. Optionally the frangible portion may be integrally formed with the latch arm 792. It will be understood that the frangible connector 796 is releasably connected to the further end of the retaining arm. The latch arm 792 further includes an abutment pin 798 extending out from an outer surface of the latch arm 792. The abutment pin 798 shown in FIG. 7 is a part of, or is integrally formed with, the latch arm 792. The abutment pin 798 may optionally be a separate element, and not a part of the latch arm 792. The abutment pin 798 is an example of an abutment element. It will be appreciated that FIG. 7 illustrates the retaining arm 782, when connected to the latch arm 792 arranged in a storage position 799. It will be appreciated that the latch arm 792, which is associated with the rigid support body 704 is coupled to the rigid support body by being slidably located in an elongate recess (or channel) 794. The latch arm is disposed to prevent the retaining arm 782 from swivelling away from the storage position 799 at an undesired moment in time. The connection between the further end 790 of the retaining arm 782 and the latch arm 792 via the frangible connector 796 therefore prevents the retaining arm 782 from being disposed in a position that is not a storage position 799. As is illustrated in FIG. 7, in the storage position 799, the retaining arm 782 is oriented such that a primary arm axis associated with the retaining arm is parallel with, or substantially parallel with, a primary axis of the rigid support body 704. It will be appreciated that any other retaining arms of the CPS of FIG. 7 will be disposed in a similar respective storage position.

It will be understood that a respective frangible connector is releasably connected to a respective retaining arm.

It will be appreciated that the latch arm and/or frangible connector is an example of a securing constraint.

It will be appreciated that the retaining arm is reversibly urged into deployed position or intermediate position. That is to say that, aside from the abutting relationship with the monopile wall, the retaining arm is not locked in the deployed or intermediate position.

It will be appreciated that the rigid support body includes a through bore that extends through the support body from a first end of the support body to a further end of the support body and through which a cable, or any other suitable flexible elongate member, is locatable.

FIG. 8 illustrates the CPS 702 of FIG. 7 during installation 800 where the rigid support body 702 is partially passed through the aperture 712 of the monopile wall 712. It will be understood that installation may include the winching process described in FIGS. 4 and 5. This may be a part of a support body pull in process in which cable or another flexible elongate member and the rigid support body is pulled into the monopile. It will be understood that the CPS 702 has been pulled, from the first position 700 illustrated in FIG. 7, towards the monopile such that the rigid support body 704 intrudes into the aperture 716 of the wall 712 of the monopile 708. As is illustrated in FIG. 8, the bend stiffener 720 is now located within the inner region/cavity 804 of the monopile 708. FIG. 8 illustrates that the first end 742 of the rigid support body 704 is located in an inner region/cavity 804 of the monopile 708. The further end 748 of the rigid support body 704 is located outside of the of monopile 708 in an outer region associated with the monopile 708 which is in the fluidic environment 780. The outer sleeve 752 is also located outside of the monopile 708 in the environment 780. As shown in FIG. 8, a portion of the rigid support body 704 is located within the aperture 716 in the monopile wall 712. The retaining arms 782 are still disposed in the storage position 799 as discussed in relation to FIG. 7. It will therefore be understood that the further end 790 of the retaining arms are therefore connected to respective latch arms 792 via respective frangible connectors 796. As shown in FIG. 8, the storage position 799 of the arms 782 allows for the rigid support body 704 to at least partially pass through the aperture 716. That is to say that the orientation of the storage position 799 of the retaining arms does not prevent the rigid support body 704 and the retaining arms 782 from entering into the inner region 804 of the monopile 708 via the aperture 716. That is to say in the storage position the support body is locatable through an aperture in a wall of a monopile from a first position outside the monopile to a further position (such as the positions illustrated in FIG. 8 and FIG. 9, described below) in which at least a portion of the support body is within the monopile. In the position illustrated in FIG. 8, the abutment element 798 abuts against a region of the monopile wall 712 outer surface proximate the aperture 716.

FIG. 9 illustrates the CPS 702 of FIG. 7 or FIG. 8 in a further position 900 during installation through an aperture in a wall of an offshore structure. As shown in FIG. 9, in the further position the rigid support body 704 has been pulled still further into the inner region 804 of the monopile 708, through the aperture 716 of the monopile wall 712 relative to the position illustrated ion FIG. 8. It will be appreciated that the rigid support body has been urged further into the monopile via the aperture. It will be therefore understood that in the further position 900, a portion of the rigid support body 704 is located within the monopile 708. As is illustrated, in the further position 900, the first end 756 of the outer sleeve 752 abuts against an outer surface 902 of the monopile wall 712 proximate the aperture 716. The surface of the outer sleeve 752 at the first end 756 is therefore an end region that is a wall abutment surface 904. It will be appreciated that a diameter of the outer sleeve 752 is wider than a diameter of the rigid support body 704. The diameter of the outer sleeve member 752 is designed such that it is wider than a diameter of the aperture 716 in the monopile wall 712. It will therefore be appreciated that the abutting relationship between the wall abutment surface 904 of the outer sleeve 752 prevents the rigid support body 704, and the CPS, from being pulled any further into the monopile 708. In this sense, due to the position of the first end 756 of the outer sleeve 752 the further position 900 of the rigid support body 704 is a position at a maximum displacement towards, and into, the monopile 708 through the aperture 716. Abutment with the outer sleeve acts as a stop to prevent any further inward motion. It will be appreciated that the aperture 716 may be designed to receive the rigid support body 704 at an angle that is oblique to the primary axis associated with the monopile wall 712. Optionally this angle is around 45 degrees. As indicated with respect to FIG. 7, the first end 756, and thus the wall abutment surface 756, of the outer sleeve 752 extends in an axis that is oblique to the primary axis associated with the rigid support body 704. The oblique angle of the wall abutment surface 904 is complimentary with the aperture 716 such that abutment between the wall abutment surface 904 and the outer surface of the wall 902 occurs at a desired angle. Optionally this angle is around 45 degrees. Optionally the oblique angle of the wall abutment surface 904 is around 45 degrees with respect to the primary axis associated with the rigid support body 704. If the wall is a curved wall (as is often the case with a monopile for a WTG) the abutment surface 904 may be curved in a cooperating manner to help maximise an engaged surface. Alternatively, one or more prominent points can be formed in the abutment surface.

As shown in FIG. 9, in the further position 900 of the rigid support body 704, the retaining arm 782 is no longer oriented in the storage position 799. The retaining arm 782 is instead disposed in an intermediate position 908. It will be understood that the retaining arm 782 has rotatably swivelled from the storage position to the intermediate position 908. As discussed with regard to FIG. 7, it will be appreciated that swivelling of the retaining arm includes at least partially rotating or spinning the retaining arm about a swivel region that is a swivel point. The swivel point is associated with a through bore into which a respective connector can intrude. It will be appreciated that, for the retaining arm 782 to be able to rotate to the intermediate position 908. As the abutment element 798 associated with the latch arm 782 was in an abutting relationship with the outer surface 902 of the wall in FIG. 8, as the rigid support body 702 is urged further into the aperture 716 an abutment force is provided on the abutment element 798 due to the contact between the abutment element 798 and the outer surface 902. It will be understood that the abutment force increases as a force pulling the rigid support body 704 into the monopile 708, such as a tension due to a winching operation and the like, increases.

When the abutment force exceeds a threshold force, the frangible connection 796 between the further end 790 of the retaining arm 782 and the latch arm 792 breaks due to the frangible connector 796 and the abutment element 798 being connected by the latch arm 792. It will be understood that the frangible connector 796 may include a pin and eyelet arrangement. Aptly the pin is an elongate pin member, and the eyelet is a socket body. Alternatively, the frangible connection may include a juxtaposition of materials with varying mechanical properties to promote fracture of the material at a particular point and under a particular force. Alternatively, the frangible connection 796 may include a geometrically varied region, for example a region of reduced thickness/width. It will be understood that a particular cracking force required to be exerted on the frangible connection 796 for the frangible connection 796 to break can be specified in manufacture and therefore the threshold force may be a predetermined threshold force. Following disconnection of the latch arm 792 and the retaining arm 782, the latch arm is free to axially slide in the channel/recess 794 of the rigid support body 704 and is pushed towards the further end 748 of the rigid support body and under the outer sleeve 752 due to the continued abutment between the abutment element 798 and the outer surface 902 of the monopile wall 712. It will be understood that the latch arm 792 is slidable along an axis of sliding with respect to the support body 704, the latch arm 792 being slidably disposed in an elongate recess 794 in an outer surface of the support body 704. It will be understood that the axis of sliding extends in a direction that is substantially parallel with, but spaced apart from, a primary axis associated with the central through-bore that extends through the rigid support body 704. It will also be understood that the latch arm 792 slides in a first direction of motion away from a retaining arm 782 supported on the rigid support body 704 when the rigid support body 704 passes through the aperture to thereby release the retaining arm from a storage position 799 when the retaining element 782 is within the monopile. The abutment element 798 intrudes into a recess 912, which is an accommodating recess, in the wall abutment surface 904 of the outer sleeve 752 to permit the wall abutment surface 904 to abut flush against the outer surface 902 of the monopile wall 712. It will be appreciated that the threshold force could be measured in Newtons (N). It will be understood that the cracking force could be measured in Newtons (N). It will be understood that the cracking force could be measured by applying known force to the frangible connection, optionally via the abutment element, until the frangible connection breaks. It will be appreciated that the threshold force could be measured by applying known force to the frangible connection, optionally via the abutment element, until the frangible connection breaks. It will be appreciated that the cracking force may be a shear force. It will be appreciated that the frangible connection may shear at the shear force. It will be appreciated that the cracking force may be a break-free force which may correspond or be proportional to a break free tension applied to a winching line to pull the CPS into the monopile and release a retaining arm from a storage position. It will be appreciated that breaking the frangible connection may include a compete shear of a part of the frangible connection that is a complete break of a part of the frangible connection resulting in a complete separation of a respective retaining arm and latch arm. It will be appreciated that the frangible connection may be brittle and shears at around a shear force. It will be appreciated that the frangible connection may be substantially brittle and is substantially resistant to deformation, distorting, elongation, bending and the like.

As indicated in the above paragraph, following disconnection of the retaining arm 782 and the latch arm 792, the retaining arm is free to rotatably swivel from the storage position 799 to the intermediate position. In the intermediate position, the primary axis associated with the retaining arm 782 is oblique to the primary axis associated with the rigid support body 704. The primary axis associated with the retaining arm is optionally substantially parallel to the primary axis associated with the monopile wall 712. Due to the through hole 786 of the retaining arm 782 in which the connector 784 being arranged offset to a centre point of the retaining arm, most proximate to the first end 788 of the retaining arm 782, the retaining arm swivels from the storage position 799 to the intermediate position 908 due to gravity. It will be understood that alternatively or additionally the retaining arm 782 may be biased towards the intermediate position by one of more biasing elements such as a spring. As shown in FIG. 9, the retaining arm 782 is arranged in a dished out region 916 of the rigid support body 704. Each “dished out” region is a scalloped or cut out section in the otherwise generally cylindrical surface of the rigid support body. An adjacent non-dished out portion 920 provides an abutment surface 924 that stops the retaining arm 782 from swivelling beyond a predetermined position. Aptly this is a torsional spring located in, or associated with, the connector.

It will be appreciated that the frangible connector of the latch arm may optionally be cracked by an ROV and the like.

FIG. 10 illustrates the CPS 702 of FIGS. 7, 8 and 9 where the rigid support body 702 is arranged in a retained position 1000 following installation. As shown in FIG. 10, in the retained position the rigid support body 704 is arranged further towards the outer region associated with the monopile 708, or the environment 780, when compared with the further position of the rigid support 704 illustrated in FIG. 9. This may be achieved, for example, by relaxing or reducing a tension associated with a winching line via a winch that is coupled to, and/or providing a tension on, a cable arranged through the CPS. As is illustrated in FIG. 10 a first abutment surface 1004 of the retaining arm 782 is arranged to move into an abutting relationship with an inner surface 1008 of the monopile wall 712 proximate the aperture 716. The first abutment surface 1004 of the retaining arm 782 therefore constitutes a wall abutment surface of the retaining arm 782. The retaining arm 782, disposed in an abutting relationship with the inner monopile surface 1008 therefore retains the rigid support body 704 at the retained position 1000, where a portion of the rigid support body 704 is within the monopile 708. That is to say the retaining arm 782, disposed in an abutting relationship with the inner surface 1008 of the monopile 708 prevents the rigid support body from moving wholly out of the facility and returning to its first position 700 where all of the rigid support body is located outside of the monopile and in the environment 780. It will be understood that when the retaining arm 782 is disposed in an abutting relationship with the inner surface 1008 of the monopile wall 708, the retaining arm 782 is in a deployed position 1012. The wall abutment surface is therefore disposed to abut against the inner surface of the wall of the monopile proximate to the aperture in the wall of the monopile. It will therefore be understood that in the deployed position the retaining arm is disposed to prevent the support body passing fully through the aperture from the further position or the retained position to the first position, and to locate the rigid support body at a predetermined position with respect to the aperture.

It also be appreciated that the connector 786 selectively allows the retaining arm 782 to swivel from a storage position 799 towards a deployed position 1012, for example on a shaft of the connector 786. The deployed position 1012 of the retaining arm 782 is thus an equilibrium position in which one or more regions of a respective retaining arm abuts a region of an inner surface of the wall and an angle of swivel of respective retaining arms 782 is determined responsive to a reaction between the wall and at least a mass of a cable extending through the rigid support body 702 and the support body 702 itself. It will be appreciated that the CPS 702 including the rigid support body 704 with associated one or more retaining arms 782 (connected via respective connectors 784) is an example of apparatus for locating a rigid support body at a predetermined location with respect to an aperture in a wall of a facility, such as a WTG. With reference to FIG. 9, it will be understood that swivelling the retaining arm 782 or arms from a storage position 799 towards and ultimately to a deployed position 1012 occurs via an intermediate position 908 that is any position between the storage and deployed positions.

It will be appreciated that in the deployed position the retaining arm, which is an example of a retaining element, is disposed to prevent the support body passing fully through the aperture from the further position to the first position and to locate the rigid support body at a predetermined position with respect to the aperture.

It will be appreciated that the position shown of the rigid support body shown in FIG. 10 is a predetermined position of the rigid support body. That is to say the predetermined position of the rigid support body is an equilibrium position wherein the rigid support body extends through the aperture and the retaining arms are in abutment with the inner surface of the monopile wall. It will be appreciated that in the predetermined position, the retaining arms are arranged in the deployed position.

It will be appreciated that both retaining arms may be simultaneously selectively swivelled from the storage position towards the deployed position (via an intermediate position).

In the arrangement shown in FIG. 10, the retained position (and predetermined position) of the support body is a position in which in which the retaining element is located in a deployed position, and the support body is at an oblique angle in respect of a vertical axis associated with the monopile, the angle being about around 45 degrees.

It will be understood that each respective retaining arm can swivel through a variety of intermediate position towards the deployed position. Some of these intermediate positions may include positions of the retaining arm at different angles of swivel (relative to a primary axis associated with the rigid support body). It will also be understood that angle of swivel is determined responsive to a reaction between the wall and at least a mass of the flexible elongate element and the support body. It will be understood therefore that intermediate positions of the retaining arm are positions between the storage position and the deployed position.

FIG. 11 illustrates another perspective view 1100 of the CPS 702 of FIGS. 7 to 10 with the retaining arms 782 being arranged in the storage position 799.

FIG. 12 illustrates another perspective view 1200 if the CPS 702 of FIGS. 7 to 10 with the retaining arms being arranged in an intermediate position 908 or deployed position.

FIG. 13 illustrates a further perspective view 1300 of the CPS 702 of FIG. 11. It will be appreciated that FIG. 13 shows the CPS from the so-called bottom side 764 of the rigid support body 704. As shown in FIG. 13, two retaining arms 782₁, 782₂ are connected to the rigid support body 704 and these are arranged on diametrically opposite sides of the rigid support body 704. It will be appreciated that each retaining arm 782₁, 782₂ is associated with a respective latch arm 792.

FIG. 14 illustrates a still further perspective view 1400 of the CPS 702 of FIGS. 7 to 13. FIG. 14 illustrates the through bore 1404 extending through the bend stiffener 720. It will be appreciated that a through bore extends through the whole CPS. FIG. 14 also clearly illustrates the two retaining arms 782₁, 782₂ connected to the rigid support body 704. It will be understood that the perspective view in FIG. 14 illustrates the retaining arms 782₁, 782₂ in the intermediate position 908 or if local conditions are appropriate the deployed position. FIG. 14 additionally illustrates the recess 912 in the wall abutment surface 904 of the outer sleeve 752 in more detail. FIG. 14 also illustrates that the pair of retaining arms 782₁, 782₂ are disposed in a spaced apart relationship on opposed sides of the rigid support body 704. It will be appreciated that each retaining arm 782₁, 782₂ is connected to the support body 704 via a respective connector 784. It will be appreciated that each connector 784 may include a bearing and shaft to allow the retaining arm 782 to swivel with respect to the rigid support body 704. In such an arrangement, either the bearing or shaft can be connected to a respective retaining arm and a remainder of the bearing or shaft can be connected to the rigid support body or vice versa. It will be appreciated that a pair of latch arms are also included in the CPS of FIG. 14, each of the latch arms being associated with a respective one of the pair of the retaining arms 782₁, 782₂. It will be understood that the pair of latch arms are disposed in a spaced apart relationship on opposed sides of the rigid support body 704.

FIG. 15 illustrates a cross-sectional view 1500 of the CPS 702 of FIGS. 7 to 14. FIG. 15 shows that a through bore 1404 extends through the entire length of CPS. FIG. 14 additionally helps illustrate the non-uniform thickness of the tapered region of the bend stiffener 720.

FIG. 16A illustrates the rigid support body 704 of the CPS 702 of FIGS. 7 to 15 in more detail. It will be appreciated that, aside from the connectors 784 and retaining arms 782, FIG. 16 illustrates an isolated rigid support body for the sake of explanation only. FIG. 16 illustrates the rigid support body 704 when not connected to the bend stiffener 720 or the pull in head adaptor 724, and when not partially covered by the outer sleeve 752. The rigid support body is a generally cylindrical and integrally formed unit. A through bore 1604 extends through the rigid support body 704. It will be understood that a cable, or other flexible elongate member, can be threaded through the rigid support body. The outer surface of the rigid support body 1608 may abut against the inner surface of the aperture 716 of a monopile wall 712 in use. Alternatively, the outer surface diameter may be undersized to assist clearance during installation and decommissioning. If a new aperture is used in the wall, the rigid support body may be non-cylindrical. For example, manufacturing trends may develop to utilise a triangular or oval or elliptical or square aperture. It will be appreciated that the outer surface 1608 of the rigid support body 704 is generally cylindrical. The outer surface 1608 may therefore include a substantially resistant and/or robust material to help avoid damage to the rigid support body in use. Optionally the outer surface of the rigid support body may be coated/covered with a protective and/or water resistant/proof and/or corrosion resistant cladding/coating. As is illustrated in FIG. 16, the outer cylindrical surface includes a dished out surface region 916. It will be understood that each retaining element is connected via a respective connector at a respective dished out surface region. It will be understood that each dished out surface region 916 includes a first dished out end region 1612 and a further dished out end region 1616. As is shown in FIG. 16, the first dished out end region 612 and the further dished out end region 1616 are disposed on opposed sides of a respective connector 784 location. FIG. 16 also illustrates a respective non dished out region 1620 of the outer surface 1608 of the rigid support body proximate to the first and further dished out end regions. The non dished out region 1620 includes an abutment surface 924. It will be understood that the abutment surface 924 provides a stop to prevent swivelling motion of a respective retaining arm 782 beyond a preset place. As is illustrated in FIG. 16, a pair of retaining arms 782 are disposed in respective substantially diametrically opposed side positions on the outer cylindrical surface 1608. It will be appreciated, but not shown in FIG. 16, that a further dished out portion 1616 is located on the reverse side of the rigid support body 704 (facing into the page in FIG. 16). It will be appreciated that both retaining arms 782 may swivel together or may swivel independently of each other. Biasing elements with common or different biasing forces can be used to help control how each retaining arm moves once released.

FIG. 16B illustrates an end on view of the rigid support body 704 when the retaining arms 782₁, 782₂ are not disposed in the storage position. As shown in FIG. 16B. the rigid support body 704 includes a through bore 1604 extending through the support body. In order to maintain the integrity of the support body in use, due to abutment with the monopile wall and corrosion etc, the tubular rigid support body 704 must be of a minimum thickness. The thickness of the support body in FIG. 16B is 15 mm. Optionally the thickness of the support body may be 12 mm. Optionally the thickness of the support body is between 1 mm and 100 mm thickness. The support body has a bore 1604 diameter 200 mm. Optionally the bore 1604 diameter is between 100 and 500 mm. The bore diameter is tailored to the cable that is to be threaded through the support body. It with reference to FIGS. 7 to 15, it will be appreciated that the support body includes two dished out surface regions 916 proximate to respective retaining arms. In order to maintain the required thickness of the support body, the bore 1604 narrows throughout the portion of the support body that includes the dished out surface regions 916. Two inwardly extending wall regions 1640, each arranged at a respective dished out surface region 916, therefore maintain the thickness of the support body throughout each dished out surface region of the rigid support body. FIG. 16B also helps to illustrate that each retaining arm 782₁, 782₂ includes two wall abutment surfaces 1644₁, 1644₂, 1648₁, 1648₂ that abut with an inner surface of the monopile wall when the retaining arm is arranged in a deployed position in use. FIG. 16B additionally helps to illustrate the position of the abutment elements that are abutment pins of each latch arm 792.

FIG. 16C illustrates an end on view of the rigid support body 702 of FIG. 16A when the retaining arms are disposed in a storage position. FIG. 16C helps illustrate the inwardly extending wall regions 1640 of the through bore. It will be appreciated that the inwardly extending wall regions 1640 are only present through the portion of the rigid support body that includes the dished out surface regions 916 and therefore the inwardly extending wall portions 1640 do not extend throughout the whole length of the rigid support body.

FIG. 17A illustrates the retaining arm 782 of the CPS 702 of FIGS. 7 to 16 in more detail. FIG. 17A shows an isolated retaining arm 1700. The retaining arm 782 is an example of a retaining element. The retaining arm 784 includes an elongate retaining body 1704. The elongate body 1704 is associated with a principal arm axis and arranged to swivel about the through hole 786 that is a swivel point that is on the principal arm axis but offset from a centre point on the arm axis along a length of the retaining arm 782. The retaining arm is formed from a metallic material. Optionally the retaining body may be manufactured from an alloy material. Optionally the retaining body may be made from any other suitable material. For example, the material could be composite, polymeric, ceramic or the like. The retaining body 1704 includes a through hole 786. It will be understood that the through hole is able to receive a connector to connect the through hole to a rigid support body. The through hole may include, or be associated with, a bearing to facilitate swivelling of the retaining arm about the through hole 786 which is therefore a swivel point. The through hole 786 may include a low-friction or frictionless inner surface to facilitate swivelling. As indicated above, the through hole 784 is located proximate to the first end 788 of the retaining arm 782. It will be appreciated that the through hole 784 is an example of an eyelet having a circular cross section through the retaining arm 782 and is located on the principal axis of the retaining arm 782. A coupling region 1708 is located at the further end 790 of the retaining arm 782. The coupling region 1708 is coupled to a respective latch arm 792 via a frangible connector 798 when the retaining arm 782 is in the storage position 799. The coupling region illustrated in FIG. 17A is a recess for receiving a pin. The retaining arm includes a wall abutment surface 1004 for abutting against an inner surface 1008 of a monopile wall 712 when the retaining arm 782 is disposed in the deployed position 1012. Optionally the wall abutment surface 1004 wall abutment surface may be covered in a protective cladding for protecting the inner surface 1008 of a monopile wall 712 in use. It will be appreciated that the first end 788 and the further end 790 of the retaining arm 782 are spaced apart across the elongate body 1704. That is to say that the first and further ends of each retaining arm are spaced apart on opposite sides of the retaining arm. It will be understood that the retaining arm includes a principal arm axis that is the primary axis associated with the retaining arm. It will be understood that the through hole is a round eyelet. Aptly, the round eyelet may be a blind hole disposed to receive a respective connector.

FIG. 17B illustrates a different perspective view 1740, that is a top-down view, of the retaining arm of FIG. 17A. As is illustrated in FIG. 17B, the retaining arm 782 includes a through hole 786 that is located a position along a primary axis associated with the retaining arm that is axially offset from a centre point of the retaining arm primary axis. That is to say that the through hole is located more proximate to a first end of the retaining arm than a further end of the retaining arm. The retaining arm receives a connector 784 that may include a shaft and/or bearing and/or spigot. With reference to FIGS. 7 to 10, it will be appreciated that in use, when the retaining arm is released from a storage position (by cracking a frangible part that is part of or associated with a latch arm, the latch arm being associated with the retaining arm), the offset positioning of the through hole (and associated connecter) enables the retaining arm to swivel from the storage position to an intermediate or deployed position. That is to say that, as the through hole, which is an example of a swivel point or swivel region, is offset with respect to the centre of mass (and centre of gravity) of the retaining arm, a rotational force that is a restoring torque is exerted upon the retaining arm to swivel the retaining arm away from the storage position which, in the absence of a connection between the retaining arm and a respective latch arm, is a non-equilibrium position. The retaining arm illustrated in FIGS. 17A and 17B has a through hole diameter of approximately 50 mm to receive a cylindrical connector spigot with a diameter also of approximately 50 mm. It will be understood that any other suitable dimensions of through hole and cooperating connector could instead be utilised.

FIG. 17B also helps illustrate the position of two wall abutment regions 1744₁, 1744₂ of a wall abutment surface 1748 of the retaining arm. The wall abutment regions are axially located on either side of the portion of the retaining body that includes the through hole. It will be appreciated that the wall abutment regions abut against an inner surface of the monopile wall in use when the retaining arm is located in a deployed position (illustrated in FIG. 10). Arrow A indicates a force incident on a first wall abutment region 1744₁ due to an abutting relationship with the inner surface of the monopile wall and Arrow B indicates a force incident on the further wall abutment region 1744₂ due to an abutting relationship with the inner surface of the monopile wall in use, and when the retaining arm is oriented in the deployed position (as illustrated in FIG. 10). It will be appreciated that the whole weight of the CPS may be distributed among any number of retaining arms utilised in the CPS that are in a deployed position. Alternatively, a winch may provide a tension that partially supports the CPS weight via a winching line connected to a cable where a covered part of the cable extends through the rigid support body of the CPS. Alternatively, a winching line may be connected to the CPS itself. It will therefore be appreciated that substantial load can be applied to the monopile wall via each wall abutment region of each retaining arm. With reference to Newton's third law of motion, the monopile wall thus exerts an identical but opposed force on each wall abutment region of the wall abutment surface of the retaining arm. It will be appreciated that the combined force exerted on the first and further wall abutment region is transferred to engaged surface regions 1752, 1754 of the through hole and the connector (the spigot) which are most proximate to the wall abutment surface of the retaining arm. It will therefore be appreciated that the weight of the CPS may be supported by a number of connectors associated with each retaining arm situated in a deployed position. It will be appreciated that, in the CPS embodiment described herein, two retaining arms (the first a further retaining arms) are utilised and therefore the weight of the CPS is support by the first and further connectors that are associated with the respective first and further retaining arms. It will therefore be appreciated that a portion of the CPS weight (which may be around half of the CPS weight that is not further supported by other methods or devices or mechanisms) is supported by the connector shown in FIG. 17B when the retaining arm of FIG. 17B is oriented in a deployed position in use. The weight incident on the retaining arm in use is illustrated by arrow C.

It will be appreciated that, when compared with prior art retaining systems discussed with regard to technological background above, the load path from the location of abutting wall abutment regions of the retaining arm to the load supporting region of the connector is relatively short. Furthermore, due to the orientation of the retaining arms (that are able to swivel), the force exerted on the connector is directed substantially through the connector in a direction perpendicular to an axis associated with the connector, and is predominantly a shear force. That is to say, the degree to which rotational moments are applied to the connector are limited. Thus, the present arrangement and relatively short load path result in a more efficient retaining system which is less prone to failure than current prior art solutions. It will be appreciated that, utilising the two retaining arms described in the present CPS embodiment yields four wall abutment regions. The retaining arm arrangement is therefore a much more efficient use of material than prior art solutions, such as latch arm solutions discussed above. In fact, the retaining arm arrangement disclosed herein, which utilises two retaining arms, is around 21 times more efficient than some currently adopted prior art solutions.

As discussed in the background section above, prior art CPS retaining solutions typically support the weight of the CPS at a particular point, or a particular number of points, for example a terminal end of a latch or a surface of a ball. These points are typically of limited surface area and therefore exhibit significant point loading on the inner surface of the monopile wall. It will be appreciated that higher contact stresses imparted on an inner surface of a monopile wall typically results in a higher rate of corrosion and therefore a reduced lifetime of an associated WTG. Such point loading of prior art approaches discussed above yields considerably higher contact stresses between retaining elements and the inner surface of the monopile wall. The beam loading of each (of the two) retaining arms utilised in the present CPS embodiment significantly reduces that contact stresses imparted on the monopile wall by distributing the weight of the CPS over four wall abutment regions (two on each retaining arm). It will be understood that at least some of these wall abutment regions may additionally have a larger surface area than abutment surfaces in prior art retaining elements thereby further decreasing stresses imparted on the monopile wall. Such an arrangement helps limit corrosion of the abutting regions of the monopile wall thereby helping to extend the lifetime of a WTG associated with the monopile. It will be appreciated that the high point loading of some prior art retaining solutions results in brinelling and other aberrant effects of abutment under load at the latch-monopile wall contact surfaces which increases the rate of corrosion.

Some prior art retaining solutions include a latch system which generates loading incident on a supporting point, which is often a pin proximate a terminal end of a latch, of around 1.5 times the force applied to the monopile wall by the abutment surface of the latch divided by the area of the latch abutment surface in contact with the monopile wall (Load=1.5×Force/Area). The present latch arm arrangement however, due to the geometry and relative dimensions of the latch arms illustrated in FIG. 17B, generates a load on the connector that is one fourteenth of the force applied to the monopile wall by the abutment surface regions of the arms divided by the area of the combined abutment regions of the arms in contact with the monopile wall ( 1/14×Force/Area). It will be appreciated that, when compared with prior art systems, the present retaining arrangement results in a considerable reduction of loading stresses.

For example, some retaining arms provide two areas of contact between the wall abutment surface of the retaining arm and an inner surface of the monopile wall, the areas of contact being arranged at the interface between the retaining arm and the monopile wall at either side of the swivel region. When the swivel region is offset axially with respect to the retaining arm (that is to say, not equidistant from each terminal end of the retaining arm) the effective areas of contact may be located at a distance of 2 L and L (L being an arbitrary distance) from the swivel region (taken along the wall abutment face of the retaining arm) respectively. The effective areas of contact may each be at a distance of 1.25 D and D (D being an arbitrary distance) from respective most proximate terminal ends of the wall abutment surface of the retaining arm. In a dual retaining arm system, in which a retaining arm is arranged on either side of a rigid support body is illustrated in FIGS. 7 to 14, for example, there are 4 areas of contact between the retaining arms and the inner surface of the monopile wall (two areas of contact on each retaining arm). Thus, for an arbitrary force F (indicated by C in FIG. 17B) that is a load incident on each of the retaining arms due to the weight of the CPS system (and associated apparatus, for example the flexible elongate member) when the CPS is retained, by the arms, at a position at least partly through the aperture of the monopile wall, the resulting reaction forces at each of the effective areas of contact may be around R_{A}=F/3 (indicated by A in FIG. 17B) and R_{B}=⅔ F (indicated by B in FIG. 17B) respectively. The shear area may be around 14A (A being an arbitrary area). A minimum shear stress incident on the connector located at the swivel region may be around F/14A. A maximum contact stress between the monopile wall and the retaining arm may be around 0.3 F/DW (where W is the width of the wall abutment surface of the retaining arm).

It can be shown that, for some prior art latch systems which utilise point loading in which all the force, F, associated with the retaining of a CPS in a monopile is incident at a single effective area of contact of the latch (in abutment with an inner surface of a monopile wall), the shear area may be around 2A. It can be shown that the minimum shear stress incident on a pin of the latch is around 3 F/2A. It can be shown that the minimum contact stress between the monopile wall and the latch is around 0.6 F/DW (where D is the length of the wall abutment surface of the latch and W is the width of the wall abutment surface of the latch).

Thus, as indicated above, the load on a connector associated with a retaining arm is one fourteenth of the load associated on a pin of a prior art latch, and the use of a retaining arm system is 21 times more efficient than a prior art latch system.

It will be understood that, in the present CPS embodiment, the size of the connector is not as constrained by space within the CPS and/or monopile and therefore the connector can readily by enlarged to provide additional strength (resilience to the loading of the CPS) if necessary.

It will further be appreciated that the use of two retaining arms, arranged at substantially opposite sides of the rigid support body helps limit, reduce or avoid misalignment of the system in use. It will be understood that misalignment of prior art systems can result in aberrant increases in loading on retaining latches (and components associated with such latches such as supporting elements) and/or the inner surface of the monopile wall and can ultimately result in damage. Such misalignment includes rotational and axial misalignment of the rigid support body with respect to a desired angle of penetration of the rigid support body through the aperture in the monopile wall when the rigid support body is arranged in a predetermined position or a retained position. This is due to the symmetrical arrangement of the two retaining arms. It will be appreciated that, should the rigid support body be rotationally misaligned in the aperture (such that each retaining arm is not arrange on substantially horizontally opposed sides of the support body), the force on each retaining arm will not be evenly distributed. The retaining arms will additionally not be swivelled away from the storage position to the same degree. That is to say that, at a particular instance in time, one of the retaining arms will be swivelled further away from the position of the retaining arms when arranged in the storage position than the other arm. At least partly due to the uneven distribution of such forces, the arms generate a restoring torque which acts to equilibrate the forces incident on each of the arms. This restoring torque thus acts to reduce misalignment of the rigid support body. The restoring torque thus acts to urge the rigid support body towards the predetermined position and acts to urge the retaining arms towards the deployed position. It will be appreciated that the restoring torque could be measured in Newton metres (Nm).

FIG. 17C illustrates a still further perspective view of the retaining arm of FIG. 17A. It will be appreciated that FIG. 17C illustrates a side-on view of the retaining arm. FIG. 17C helps illustrate the wall abutment regions of the wall abutment surface of the retaining arm. FIG. 17C also helps illustrate the geometry of the through hole, a cross section of which is indicated by the dotted lines in FIG. 17C.

FIG. 17D illustrates another perspective view of the retaining arm of FIG. 17A. It will be appreciated that FIG. 17D illustrates an end-on view of the retaining arm.

FIG. 18 illustrates the latch arm 792 of the CPS 702 of FIGS. 7 to 17 in more detail. It will be appreciated that FIG. 18 illustrates a single latch arm 792 in isolation. The latch arm 792 includes an elongate latch arm body 1804. The frangible connector 796 is located at a first end 1808 of the latch arm 782. The frangible connector 796 optionally includes an eyelet or a socket body 1820 for receiving an elongate pin and a narrowed region 1812 between the eyelet and the latch arm body 1804. Alternatively, the frangible connector may include an elongate pin for connection to a respective socket in a retaining arm. A perforation line may optionally also be used. It will be understood that the narrowed region 1812 is a weakened region that is designed to fracture/break/crack when subjected to a predetermined threshold force before any of the other elements associated with the latch arm 792 break. It will be appreciated that the latch arm 792 may instead include a different frangible portion which can be connected to a retaining arm. Optionally a frangible portion is located within the body 1804 of the latch arm 792 such that the latch arm is breakable at a predetermined position, or cracking point, of the latch arm 792. The abutment element is located proximate to a further end 1816 of the latch arm 792. The abutment element 798 of FIG. 18 is a peg member that extends away from the latch arm 792. It will be appreciated that the abutment element 798 moves with the latch arm 792. It will be appreciated that the abutment element 798 may instead be a protrusion or different geometry, for example triangular or rectangular and the like, or may be a recess in the latch arm 792 that engages with a mating protrusion associated with a monopile wall, or the wall of any other suitable facility. With reference to FIGS. 9 and 14, it will be appreciated that the peg 798 can be located in a cooperating (or accommodating) recess 914 in an inner surface (the surface of the outer sleeve in contact with the support body) of an outer sleeve 752 coupled to the rigid support body 704.

It will be appreciated that, when slidably disposed in a recess 796 of a rigid support body 704 (or otherwise coupled to the rigid support body) and in use during a pull-in process of the like in which the rigid support body 704 is urged into a monopile 708 via an aperture 716 in a monopile wall 712, the peg 798, (which moves with the latch arm) abuts against the outer surface of the monopile wall 712. It will be understood that, as the support body is urged into the monopile, due to the abutting relationship between the monopile wall 712 and the peg 798, an abutment force acts on the peg 798 acting away from the wall 712. It will be understood that the abutment force is generated in response to the peg 798 abutting an outer surface of the wall 712 of the monopile 708 proximate to the aperture 716 as a portion of the rigid support body 704 is urged through the aperture 716. When the abutment force overcomes a predetermined threshold force, which is a cracking force required to crack the frangible connector 798 and can therefore be specified in manufacture of the latch arm 792, the frangible connector 798 is cracked. That is to say that the frangible connector breaks responsive to the abutment force. Following the cracking of the frangible connector 798, it will be understood that the latch arm 792 slides in the first direction of motion due to the abutment of the monopile wall 716 against the abutment peg 798. At this point the latch arm no longer holds the respective retaining arm in place. It will therefore be appreciated that, when the abutment force exceeds the predetermined threshold force, sliding of the latch arm 792, and swivelling of the retaining arms 782 from a storage position to a deployed or intermediate position is permitted. It will be appreciated that when the latch arm 792 is connected to a respective retaining arm 782 via the frangible connector 798, which prevents slidable motion of the latch arm 792 in the recess of the rigid support body 704, the latch arm 792 prevents swivelling of the respective retaining arm 782 from a storage position to an intermediate or deployed position. When the frangible connection is broken, slidable motion of the latch arm is permitted.

It will be understood that the undesired release of the retaining arm from the storage position is achieved by holding the retaining element in the storage position via a respective latch arm that is connected to the respective retaining element via the frangible portion that comprises a frangible connector.

It will be appreciated that the abutment element of FIG. 18 is generally cylindrical. Optionally the abutment element may be any other shape. The abutment element may be a peg member. It will be appreciated that, in use, a cylindrical abutment element engages and abuts against an outer surface of a monopile wall at a consistent set-off distance and therefore offers some control over the position of the CPS relative to the monopile wall and associated aperture when the abutment element is expected to engage with the monopile wall. The generally cylindrical arrangement of the abutment element helps ensure consistent engagement between the monopile wall and abutment element as the abutment element will generally always engage the monopile wall at a curved outer surface of the generally cylindrical body of the abutment element.

It will be appreciated that an elongate pin member may instead constitute a frangible portion of the latch arm of FIG. 18. The elongate pin may be arranged to extend through a through-hole located at and end of the latch arm distal to the abutment element. The elongate pin may be polymeric or wooden or the like. The elongate pin may be substantially brittle and thus may completely shear when a sufficient force is applied to the pin. It will be appreciated that the pin may shear when a shearing force/cracking force of around 3000 N is incident on the pin. It will be appreciated that the pin may shear when a shearing/cracking force of between 2000 N and 10000 N is incident on the pin. It will be appreciated that the shearing force required to shear the pin may be relatively similar when the pin is dry and when the pin is wet. It will be appreciated that the pin may shear under a well-defined shearing/cracking force which corresponds or is related to a predetermined threshold force which may be generated by applying a tension to a winching line to pull the CPS into an aperture of a wall of a monopile such that an abutment element of the latch arm abuts against an outer surface of the monopile wall to transfer force to the pin. It will be appreciated that the pin may shear across a thinnest diameter of the pin, the axis of shearing aptly being around 90 degrees to the primary axis of the pin.

FIG. 19 illustrates another example of a latch arm 1900 for use in the CPS of FIGS. 7 to 17. The latch arm 1900 includes an elongate latch arm body 1904. A frangible connector 1908 is located at a first end 1912 of the latch arm 1900. The frangible connector 1908 includes an eyelet 1916, for receiving a pin, and a narrowed region 1920 between the eyelet 1916 and the latch arm body 1904. It will be understood that the narrowed region 1920 is designed to fracture/break when subjected to a predetermined threshold force before any of the other elements associated with the latch arm 1900 break. The abutment element 1922 is located at a further end 1924 of the latch arm 792. The abutment element 1922 is a protruding wedge located at the terminus of the further end 1924 of the latch arm 1900. The abutment element 1922 includes an abutment face 1928 for abutting against monopile wall in use.

As shown in FIG. 19, the abutment face 1928 is angled to make line contact with the monopile outer wall. The narrowed region 1920 is a frangible region and is a deliberate stress concentration region. Incorporation of the narrowed region determines where the component will consistently fail (the latch arm will consistently crack at the narrowed region such that the latch arm consistently shears at the narrowed region such that the latch arm completely breaks at the narrowed region). The angled abutment face 1928 also prevents or reduces the risk of false triggers (releasing the retaining arm from a storage position too soon or at an undesired moment in time, which would result in an inability to insert the CPS into the aperture, or reduce the ease by which the CPS can be inserted into the aperture) when the support body (CPS) is dragged along/over/across large rocks and/or debris and/or scour protection apparatus and the like before it is pulled into the aperture. The angled abutment face therefore provides a degree of protection against undesired shearing of the frangible portion of the latch arm due to, for example, scouring against surfaces/objects in an environment in which the CPS is arranged.

It will be understood that the abutment face 1926 of the wedge is oblique to a primary axis of the latch arm which at least partly cooperates with the outer surface of a monopile wall against which the abutment face abuts. For example, the abutment face at least partly cooperates with a curved outer surface of a monopile wall. It would be understood that the oblique abutment surface helps ensure that the abutment element abuts with the outer surface of the monopile wall at a desired orientation. It will be appreciated that the oblique abutment face, that is substantially flat defines a particular surface area of contact between the outer surface of the monopile wall and the abutment element. Thus, the oblique abutment face, which is at least partly complimentary to an outer surface of a monopile wall provides a greater control of the pulling force on the elongate flexible member (and thus on the CPS respectively) required to achieve a predetermined threshold force and crack (that is, to shear or completely break) the frangible portion of the latch arm. It will be appreciated that this is due to the fact that a reasonable estimation can be made as to the area of the abutment element and monopile wall that are in contact when the oblique surface of the abutment element abuts against the monopile wall. As indicated previously, the pulling force and predetermined threshold force could be measured in Newtons (N).

Aptly the latch arm is disposed to break at the frangible portion when exposed to a force of around 3000 N. Aptly the latch arm may be disposed to break at the frangible portion when exposed to a force of between 2000 and 10000 N.

It will be appreciated that an elongate pin member may instead constitute a frangible portion of the latch arm of FIG. 19. The elongate pin may be arranged to extend through a through-hole located at and end of the latch arm distal to the abutment element. The elongate pin may be polymeric or wooden or the like. The elongate pin may be substantially brittle and thus may completely shear when a sufficient force is applied to the pin. It will be appreciated that the pin may shear when a shearing force/cracking force of around 3000 N is incident on the pin. It will be appreciated that the pin may shear when a shearing/cracking force of between 2000 N and 10000 N is incident on the pin. It will be appreciated that the shearing force required to shear the pin may be relatively similar when the pin is dry and when the pin is wet. It will be appreciated that the pin may shear under a well-defined shearing/cracking force which corresponds or is related to a predetermined threshold force which may be generated by applying a tension to a winching line to pull the CPS into an aperture of a wall of a monopile such that an abutment element of the latch arm abuts against an outer surface of the monopile wall to transfer force to the pin. It will be appreciated that the pin may shear across a thinnest diameter of the pin, the axis of shearing aptly being around 90 degrees to the primary axis of the pin.

FIG. 20 illustrates an alternative CPS 2002 in a first position 2000. The CPS 2002 is for locating a flexible elongate member at a predetermined location with respect to a monopile wall through which an aperture is provided. This CPS includes one or more springs 2003 to bias respective retaining arms. It will be understood that the first position 2000 of the CPS 2002 may be adopted prior to installation of the CPS system in a WTG. In the first position 2000, all of a rigid support body 2004 of the CPS 2002 is located outside of a monopile 2008, that is to say none of the rigid support body is located in a space enclosed by a wall 2012 of the monopile 2008, or within an aperture 2016 extending through the wall 2012. The first position 2000 is therefore a first position of the rigid support body 2004. It will be appreciated that, when a cable or other flexible elongate member is threaded through a through bore of the CPS, the installation of the CPS from the first position 2000 may be achieved via the winching process described in FIGS. 5 and 6. Although a monopile or WTG is specifically referred to here, it will be understood that the system could be utilised in any suitable structure or facility that includes a wall with an aperture extending therethrough and an internal cavity. The WTG is an example of a facility, the monopile being a part of the WTG.

As is illustrated in FIG. 20, the cable protection system includes a rigid support body 2004 arranged between a progressive stiffener 2020 (or bend stiffener) and a pull-in head adaptor 2024. The rigid support body 2004 is elongate and is substantially tubular and includes a cylindrical through bore. The cylindrical through bore (not shown in FIG. 1) extends through a whole length of the rigid support body. That is to say the rigid support body includes a through-bore that extends through the support body from a first end of the support body to a further end and through which a flexible elongate member is locatable. The rigid support 2004 body is formed from a metallic material. For example, a corrosion resistant alloy and the like may be used. The rigid support body 2004 may optionally be formed from a polymeric material or a reinforced polymeric material. The rigid support body 2004 may optionally be made from a composite material. The rigid support body 2004 may optionally be manufactured from a ceramic material. The support body is rigid enough to not deform significantly. The bend stiffener 2020 is also an elongate body that surrounds a substantially cylindrical through bore. As is illustrated in FIG. 20, the bend stiffener 2020 includes a tapered portion 2028 including a tapered outer surface. It will be appreciated that the through bore of the tapered portion 2028 is substantially cylindrical and is therefore not itself tapered. The thickness of the tapered portion 2028 therefore varies along its length from a flared-out end 2034 arranged to be close to the rigid support body 2004 to a narrow end 2038 distal to the rigid support body 2004. The varying thickness of the tapered portion 2028 provides a non-uniform stiffness of the bend stiffener 2020 along its length. It will be appreciated that, when an elongate flexible member, such as a cable or the like, is arranged radially within the bend stiffener 2020, a flexibility of the elongate member is constrained at the flared-out end 2034 of the tapered portion and is relatively unconstrained at the narrow end 2038 of the tapered portion 2028. This tapered portion 2028 helps prevent a flexible elongate element, such as a cable, from exceeding a predetermined minimum bend radius that may be detrimental to the elongate element. The bend stiffener 2020 may also help reduce chafing, or other destructive frictional effects, at the interface between the elongate element and the rigid support body 2004. The bend stiffener 2020 additionally includes a substantially annular portion 2040 coupled to the flared-out end 2034 of the tapered portion 2028. A remaining end of the substantially annular portion is coupled to a first end 2042 of the rigid support body 2004. The coupling between the substantially annular portion 2040 of the bend stiffener 2020 and the first end 2042 of the rigid support body 2004 may be provided by conventional securing methods such as bolting of screwing of the like. The progressive stiffener is thus secured to the first end of the rigid support body.

A further end of the rigid support body 2004 is connected to the pull-in head adaptor 2024. The further end of the rigid support body is therefore secured to the pull-in head adaptor. It will be appreciated that the pull in head adaptor can house and can releasably engage with a pull-in head during a support body pull in operation. When engaged within the pull in head adaptor, the CPS system moves with the cable. Therefore, by pulling the cable into the monopile via the aperture by winching, the rigid support body is also pulled through the aperture.

As illustrated in FIG. 20, a region of the rigid support body 2004 proximate to the further end 2048 of the rigid support body is covered by an outer sleeve 2052. The outer sleeve 2052 is therefore located at a position distal to the first end 2034 of the rigid support body 2004. The outer sleeve 2052 shown is manufactured from a polymeric material. The outer sleeve 2052 may optionally comprise a polymeric material. The outer sleeve 2052 may optionally comprise a reinforced polymeric material. The outer sleeve 2052 may optionally comprise a composite material. As is illustrated in FIG. 20, the outer sleeve 2052 is arranged to radially surround a portion of the rigid support body 2004 and is substantially tubular. A first end of the outer sleeve 2056, most proximate to the first end 2034 of the rigid support body 2004 is angled such that an axis associated with a face 2055 of the first end 2056 of the outer sleeve 2052 is oblique to a primary axis of the outer sleeve 2052 (and the rigid support body 2004). It will therefore be appreciated that the outer sleeve 2052 extends further over the rigid support body 2004 on a top side 2060 of the rigid support body than the bottom side 2064 of the rigid support body 2004, the top 2060 and bottom 2064 sides of the rigid support body 2004 being on opposite substantially opposite sides of the rigid support body. It will be understood that the top and bottom sides of the rigid support body are simply relative terms, and that the rigid support body 2004 may be arranged in any orientation, the top side 2060 of the rigid support body possibly being located on an upper surface of the rigid support body and the bottom side 2064 of the rigid support body optionally being located on a lower surface of the rigid support body 2004. A further end 2068 of the outer sleeve member, most proximate to the further end 2048 of the rigid support body 2004 is substantially has a face 2067 that is flat and lies in a plane perpendicular to the primary axis of the outer sleeve member (and rigid support body).

A further adaptor 2072 is connected to a remaining end of the pull-in head adaptor 2024 (the end of the pull-in head adaptor 2024 that connects the pull-in head adaptor to a bend restrictor element 2076). It will be understood that the bend restrictor element 2076 is part of a bend restrictor 2077 which includes multiple bend restrictor elements 2076. Three bend restrictor elements 2076 are shown in the bend restrictor 2077 of FIG. 20. It will be understood that any number of bend restrictor elements 2076 may be included in the bend restrictor 2077. The further adaptor 2072 may be connected to the pull-in head adaptor via a suitable securing mechanism such as screwing and/or bolting and the like. The further adaptor 2072 may be connected to a bend restrictor element 2076 by a securing mechanism such as screwing and/or bolting and the like. Alternatively, a bend restrictor element 2076 may be a part of the further adaptor 2072, that is to say a bend restrictor element 2076 may be arranged at a terminal end of the adaptor 2072, the bend restrictor element and the further adaptor being integrally formed. As shown in FIG. 20, the multiple bend restrictor elements 2076 are arranged in series and connected in an end-to-end configuration. It will be understood that the bend restrictor 2077 defines an end portion of the CPS 2002 which extends into the surrounding environment 2080 and away from the monopile wall 2012. The bend restrictor elements 2076 forming the bend restrictor 2077 limit the flexibility of a portion of an elongate member arranged within each of the bend restrictor elements 2076.

FIG. 20 also illustrates a retaining arm which is connected to the rigid support body 2004 via a respective connector 2084. It will be appreciated that, although only one retaining arm is shown in FIG. 20, the illustrated rigid support body 2004 also includes another retaining arm on a diametrically opposite surface of the rigid support body 2004 (on a surface extending into the page in FIG. 20). It will be understood that, although the CPS of FIG. 20 includes two retaining arms 2082, any suitable number of retaining arms 2082 may be utilised, the retaining arms 2082 optionally being arranged at any suitable position along the rigid support body 2004. One retaining arm or two retaining arms or three or four or more may optionally be utilised. It will be understood that the retaining arm 2082 is an example of a retaining element and any suitable shape or configuration of retaining element can instead be utilised rather than the elongate arm-like elements shown in FIG. 20. Each of the retaining arms 2082 are connected to the rigid support body 2004 via a respective connector 2084. That is to say a different connector 2084 connects each retaining arm 2082 to the rigid support body 2004. It will be appreciated that each retaining arm 2082 illustrated is on a respective side of the rigid support body 2004 that is between, and is substantially equidistant from, the top 2060 and bottom 2064 sides of the rigid support body 2004. It will be appreciated that so-called sides of the rigid support body refer to regions of the cylindrical surface of the support body which extend a respective maximum and minimum distance in an x-axis and y-axis of an imaginary plane that is perpendicular to the primary axis of the rigid support body. Each retaining arm 2082 is connected to the rigid support body 2004, via the respective connectors 2084, at a respective position of the rigid support body 2004 more proximate to the first end 2042 of the rigid support body than the further end 2048 of the rigid support body 2004. The retaining arms 2082 each include an elongate retaining body which comprises a through hole 2086 extending through the retaining body in a direction perpendicular to the primary axis of the retaining element to receive an end of a respective connector 2084. As illustrated in FIG. 20, the through hole 2086 is offset from a centre point of the retaining arm 2082 and is therefore located proximate to a first end 2088 of the retaining arm 2082. A remaining end of each connector 2084 is connected to the rigid support body. It will be understood that the connector may include a shaft. It will be appreciated that the connector may include a bearing to permit swivelling of the retaining arm 2082 with respect of the rigid support body 2004. The through hole 2086 may optionally include a bearing. The retaining arms 2082 are therefore disposed to swivel about the connector 2084, an end of which is located in the through hole 2086 of the body of the retaining arm 2082. It will be appreciated that the swivelling motion of each retaining arm 2082 is a rotational motion centred around the through hole 2086 and connector 2084. The through hole 2086 of the body of each retaining arm 2082 therefore constitutes a swivel region that is optionally a swivel point. That is to say that swivelling of the retaining arm 2082, includes the partial spinning of the retaining arm about a particular point that is an effective swivel point. As indicated previously, the rigid support body 2004 includes a biasing spring 2003 associated with and connected to the retaining arm 2082. The spring 2003 is an example of a biasing element. Optionally the biasing element is a hydraulic piston. Optionally the spring is a rotational torsion spring that is arranged within the through hole of the retaining arm and is connected to the retaining arm and the connector. Optionally any other suitable biasing element may be utilised. Optionally, for each retaining arm utilised in the CPS, the rigid support body includes a respective spring.

A further end 2090 of each retaining arm 2082 is releasably connected to a respective latch 2092 arm located in an elongate recess 2094 on the outer surface of the rigid support body 2004. The connection between the latch arm is facilitated by a frangible connector 2096. The frangible connector 2096 is an example of a frangible portion of the latch arm 2092. Optionally the frangible portion may be located at any suitable position of the latch arm 2092. Optionally the frangible portion may be a separate element and is not a part of the latch arm 2092. Optionally the frangible portion may be integrally formed with the latch arm 2092. It will be understood that the frangible connector is releasably connected to the further end of the retaining arm. The latch arm 2092 further includes an abutment pin 2098 extending out from an outer surface of the latch arm 2092. The abutment pin 2098 may optionally be a part of, or integrally formed with, the latch arm 2092. The abutment pin 2098 may optionally be a separate element, and not a part of the latch arm 2092. The abutment pin 2098 is an example of an abutment element. It will be appreciated that FIG. 20 illustrates the retaining arm 2082, when connected to the latch arm 2092 arranged in a storage position 2099. It will be appreciated that the latch arm 2092, which is associated with the rigid support body 2004, is coupled to the rigid support body by being slidably located in an elongate recess/channel 2094. The latch arm is disposed to prevent the retaining arm 2082 from swivelling away from the storage position 2099 at an undesired moment in time. The connection between the further end 2090 of the retaining arm 2082 and the latch arm 2092 via the frangible connection/connector 2096 therefore prevents the retaining arm 2082 from being disposed in a position that is not the storage position 2099. As is illustrated in FIG. 20, in the storage position 2099, the retaining arm 2082 is oriented such that a primary arm axis associated with the retaining body is parallel with, or substantially parallel with, a primary axis of the rigid support body 2004. It will be appreciated that any other retaining arms of the CPS of FIG. 20 will be disposed in a similar respective storage position. It will be understood that, when the retaining arm 2082 is in the storage position 2099, the spring 2003 or other suitable biasing element if utilised, acts to urge the retaining arm 2082 away from the storage position. It will be understood that the spring of FIG. 20 is in a compressed state when the retaining arm is in the storage position. As illustrated in FIG. 20, the spring 2003 is arranged below the retaining arm 2082 and proximate to the first end of the retaining arm. Optionally the spring 2003 is located at a different position with respect to the retaining arm such that the spring can, from a compressed state, or from an extended (stretched) state urge the retaining arm away from the storage position. For example the spring may be arranged above the retaining arm and proximate the first end of the retaining arm, the spring being in a stretched state when the retaining arm is in the storage position. For example, a rotational torsion spring may be arranged in the through hole of a retaining arm and may be connected to the connector and the retaining arm such that when the retaining arm is in in the storage position, the spring is in an extended state and acts to bias the retaining arm away from the storage position.

FIG. 21 illustrates the CPS 2002 of FIG. 20 during installation 2100 where the rigid support body 2002 is partially passed through the aperture 2012 of the monopile wall 2012. It will be understood that installation may include the winching process described in FIGS. 4 and 5. This may be a part of a support body pull in process in which cable or another flexible elongate member and rigid support body is pulled into the monopile. It will be understood that the CPS 2002 has been pulled, from the first position 2000 illustrated in FIG. 20, towards the monopile such that the rigid support body 2004 intrudes into the aperture 2016 of the wall 2012 of the monopile 2008. As is illustrated in FIG. 21, the bend stiffener 2020 is now located within the inner region/cavity 2104 of the monopile 2008. FIG. 21 illustrates that the first end 2042 of the rigid support body 2004 is located in an inner region/cavity 2104 of the monopile 2008. The further end 2048 of the rigid support body 2004 is located outside of the of monopile 2008 in an outer region associated with the monopile 2008 which is in the fluidic environment 2080. The outer sleeve 2052 is also located outside of the monopile 2008 in the environment 2080. As shown in FIG. 21, a portion of the rigid support body 2004 is located within the aperture 2016 in the monopile wall 2012. The retaining arms 2082 are still disposed in the storage position 2099 as discussed in relation to FIG. 20. It will therefore be understood that the further end 2090 of the retaining arms are therefore connected to respective latch arms 2092 via respective frangible connectors 2096. As shown in FIG. 21, the storage position 2099 of the arms 2082 allows for the rigid support body 2004 to at least partially pass through the aperture 2016. That is to say that the orientation of the storage position 2099 of the retaining arms does not prevent the rigid support body 2004 and the retaining arms 2082 from entering into the inner region 2104 of the monopile 2008 via the aperture 2016. That is to say in the storage position the support body is locatable through an aperture in a wall of a monopile from a first position outside the monopile to a further position (such as the positions illustrated in FIG. 21 and FIG. 22, described below) in which at least a portion of the support body is within the monopile. In the position illustrated in FIG. 21, the abutment element 2098 abuts against a region of the monopile wall 2012 outer surface proximate the aperture 2016.

FIG. 22 illustrates the CPS 2202 of FIG. 20 or FIG. 21 in a further position 2200 during installation through an aperture in a wall of an offshore structure. As shown in FIG. 22, in the further position the rigid support body 2204 has been pulled still further into the inner region 2104 of the monopile 2008, through the aperture 2016 of the monopile wall 2012 relative to the position illustrated ion FIG. 21. It will be appreciated that the rigid support body has been urged further into the monopile via the aperture. It will be therefore understood that in the further position 2200, a portion of the rigid support body 2004 is located within the monopile 2008. As is illustrated, in the further position 2200, the first end 2056 of the outer sleeve 2052 abuts against an outer surface 2202 of the monopile wall 2012 proximate the aperture 2016. The surface of the outer sleeve 2052 at the first end 2056 is therefore an end region that is a wall abutment surface 2204. It will be appreciated that a diameter of the outer sleeve 2052 is wider than a diameter of the rigid support body 2004. The diameter of the outer sleeve member 2052 is designed such that it is wider than a diameter of the aperture 2016 in the monopile wall 2012. It will therefore be appreciated that the abutting relationship between the wall abutment surface 2204 of the outer sleeve 2052 prevents the rigid support body 2004, and the CPS, from being pulled any further into the monopile 2008. In this sense, due to the position of the first end 2056 of the outer sleeve 2052 the further position 2200 of the rigid support body 2004 is a position at a maximum displacement towards, and into, the monopile 2008 through the aperture 2016. Abutment with the outer sleeve acts as a stop to prevent any further unwanted motion. It will be appreciated that the aperture 2016 may be designed to receive the rigid support body 2004 at an angle that is oblique to the primary axis associated with the monopile wall 2012. Optionally this angle is around 45 degrees. As indicated with respect to FIG. 20, the first end 2056, and thus the wall abutment surface 2056, of the outer sleeve 2052 extends in an axis that is oblique to the primary axis associated with the rigid support body 2004. The oblique angle of the wall abutment surface 2204 is complimentary with the aperture 2016 such that abutment between the wall abutment surface 2204 and the outer surface of the wall 2202 occurs at a desired angle. Optionally this angle is around 45 degrees. Optionally the oblique angle of the wall abutment surface 2204 is around 45 degrees with respect to the primary axis associated with the rigid support body 2004. If the wall is a curved wall (as is often the case with a monopile for a WTG) the abutment surface may be curved in a co-operating manner to help maximise an engaged surface. Alternatively one or more prominent points can be formed in the abutment surface.

As shown in FIG. 22, in the further position 2200 of the rigid support body 2004, the retaining arm 2082 is no longer oriented in the storage position 2099. The retaining arm 2082 is instead disposed in an intermediate position 2208. It will be understood that the retaining arm 2082 has rotatably swivelled from the storage position to the intermediate position 2208. As discussed with regard to FIG. 20, it will be appreciated that swivelling of the retaining arm includes at least partially rotating or spinning the retaining arm about a swivel region that is a swivel point. The swivel point is associated with a through bore into which a respective connector can intrude. It will be appreciated that, for the retaining arm 2082 to be able to rotate to the intermediate position 2208. As the abutment element 2098 associated with the latch arm 2082 was in an abutting relationship with the outer surface 2202 of the wall in FIG. 21, as the rigid support body 2002 is urged further into the aperture 2016 an abutment force is provided on the abutment element 2098 due to the contact between the abutment element 2098 and the outer surface 2202. It will be understood that the abutment force increases as a force pulling the rigid support body 2004 into the monopile 2008, such as a tension due to a winching operation and the like, increases.

When the abutment force exceeds a threshold force, the frangible connection 2096 between the further end 2090 of the retaining arm 2082 and the latch arm 2092 breaks due to the frangible connector 2096 and the abutment element 2098 being connected by the latch arm 2092. It will be understood that the frangible connector 2096 may include a pin and eyelet arrangement. Alternatively, the frangible connection may include a juxtaposition of materials with varying mechanical properties to promote fracture of the material at a particular point and under a particular force. Alternatively, the frangible connection 2096 may include a geometrically varied region, for example a region of reduced thickness/width. It will be understood that a particular cracking force required to be exerted on the frangible connection 2096 for the frangible connection 2096 to break can be specified in manufacture and therefore the threshold force may be a predetermined threshold force. Following disconnection of the latch arm 2092 and the retaining arm 2082, the latch arm is free to axially slide in the channel/recess 2094 of the rigid support body 2004 and is pushed towards the further end 2048 of the rigid support body and under the outer sleeve 2052 due to the continued abutment between the abutment element 2098 and the outer surface 2202 of the monopile wall 2012. It will be understood that the latch arm 2092 is slidable along an axis of sliding with respect to the support body 2004, the latch arm 2092 being slidably disposed in an elongate recess 2094 in an outer surface of the support body 2004. It will be understood that the axis of sliding extends in a direction that is substantially parallel with, but spaced apart from, a primary axis associated with the central through-bore that extends through the rigid support body 2004. It will also be understood that the latch arm 2092 slides in a first direction of motion away from a retaining arm 2082 supported on the rigid support body 2004 when the rigid support body 2004 passes through the aperture to thereby release the retaining arm from a storage position 2099 when the retaining element 2082 is within the monopile. The abutment element 2098 intrudes into a recess 2212 in the wall abutment surface 2204 of the outer sleeve 2052 to permit the wall abutment surface 2204 to abut flush against the outer surface 2202 of the monopile wall 2012. It will be appreciated that the threshold force could be measured in Newtons (N). It will be understood that the cracking force could be measured in Newtons (N). It will be understood that the cracking force could be measured by applying known force to the frangible connection, optionally via the abutment element, until the frangible connection breaks. It will be appreciated that the threshold force could be measured by applying known force to the frangible connection, optionally via the abutment element, until the frangible connection breaks. It will be appreciated that the cracking force may be a shear force. It will be appreciated that the frangible connection may shear at the shear force. It will be appreciated that the cracking force may be a break-free force which may correspond or be proportional to a break free tension applied to a winching line to pull the CPS into the monopile and release a retaining arm from a storage position. It will be appreciated that breaking the frangible connection may include a compete shear of a part of the frangible connection that is a complete break of a part of the frangible connection resulting in a complete separation of a respective retaining arm and latch arm. It will be appreciated that the frangible connection may be brittle and shears at around a shear force. It will be appreciated that the frangible connection may be substantially brittle and is substantially resistant to deformation, distorting, elongation, bending and the like.

As indicated in the above paragraph, following disconnection of the retaining arm 2082 and the latch arm 2092, the retaining arm is free to rotatably swivel from the storage position 2099 to the intermediate position. In the intermediate position, the primary axis associated with the retaining arm 2082 is oblique to the primary axis associated with the rigid support body 2004. The primary axis associated with the retaining arm is optionally substantially parallel to the primary axis associated with the monopile wall 2012. Due to the through hole 2086 of the retaining arm 2082 in which the connector 2084 being arranged offset to a centre point of the retaining arm, most proximate to the first end 2088 of the retaining arm 2082, the retaining arm swivels from the storage position 2099 to the intermediate position 2208 due to the spring 2003 acting to urge the retaining arm 2082 away from the storage position 2099. It will be understood that the retaining arm 2082 may be biased towards the intermediate position by one or more biasing elements such as a further spring. Optionally, the retaining arm swivels under the influence of gravity alongside a biasing force provided by the spring. As shown in FIG. 22, the retaining arm 2082 is arranged in a dished out region 2216 of the rigid support body 2004. An adjacent non-dished out portion 2220 provides an abutment surface 2224 that stops the retaining arm 2082 from swivelling beyond a predetermined position, the predetermined position being the intermediate position 2008. It will be appreciated that each “dished out” region is a scalloped or cut out section in the otherwise generally cylindrical surface of the rigid support body.

FIG. 23 illustrates the CPS 2002 of FIGS. 20, 21 and 22 where the rigid support body 2002 is arranged in a retained position 2300 following installation. As shown in FIG. 23, in the retained position the rigid support body 2004 is arranged further towards the outer region associated with the monopile 2008, or the environment 2080, when compared with the further position of the rigid support 2004 illustrated in FIG. 22. This may be achieved, for example, by relaxing or reducing a tension associated with a winching line via a winch that is coupled to, and/or providing a tension on, a cable arranged through the CPS. As is illustrated in FIG. 23 a first abutment surface 2304 of the retaining arm 2082 is arranged to move into an abutting relationship with an inner surface 2308 of the monopile wall 2012 proximate the aperture 2016. The first abutment surface 2304 of the retaining arm 2082 therefore constitutes a wall abutment surface of the retaining arm 2082. The retaining arm 2082, disposed in an abutting relationship with the inner monopile surface 2308 therefore retains the rigid support body 2004 at the retained position 2300, where a portion of the rigid support body 2004 is within the monopile 2008. That is to say the retaining arm 2082, disposed in an abutting relationship with the inner surface 2308 of the monopile 2008 prevents the rigid support body from moving wholly out of the facility and returning to its first position 2000 where all of the rigid support body is located outside of the monopile and in the environment 2080. It will be understood that when the retaining arm 2082 is disposed in an abutting relationship with the inner surface 2308 of the monopile wall 2008, the retaining arm 2082 is in a deployed position 2312. The wall abutment surface is therefore disposed to abut against the inner surface of the wall of the monopile proximate to the aperture in the wall of the monopile. It will therefore be understood that in the deployed position the retaining arm is disposed to prevent the support body passing fully through the aperture from the further position or the retained position to the first position, and to locate the rigid support body at a predetermined position with respect to the aperture.

It also be appreciated that the connector 2086 selectively allows the retaining arm 2082 to swivel from a storage position 2099 towards a deployed position 2312, for example on a shaft of the connector 2086. The deployed position 2312 of the retaining arm 2082 is thus an equilibrium position in which one or more regions of a respective retaining arm abuts a region of an inner surface of the wall and an angle of swivel of respective retaining arms 2082 is determined responsive to a reaction between the wall and at least a mass of a cable extending through the rigid support body 2002 and the support body 2002 itself. It will be appreciated that the CPS 2002 including the rigid support body 2004 with associated retaining arms 2082 (connected via respective connectors 2084) is an example of apparatus for locating a rigid support body at a predetermined location with respect to an aperture in a wall of a facility, such as a WTG. With reference to FIG. 22, it will be understood that swivelling the retaining arm 2082 or arms from a storage position 2099 towards and ultimately to a deployed position 2312 occurs via an intermediate position 908 that is any position between the storage and deployed positions.

It will be appreciated that the position shown of the rigid support body shown in FIG. 23 is a predetermined position of the rigid support body. That is to say the predetermined position of the rigid support body is an equilibrium position wherein the rigid support body extends through the aperture and the retaining arms are in abutment with the inner surface of the monopile wall. It will be appreciated that in the predetermined position, the retaining arms are arranged in the deployed position.

FIG. 24 illustrates another perspective view 2400 of the CPS 2002 of FIGS. 20 to 23 with the retaining arms 2082 being arranged in the storage position 2099.

FIG. 25 illustrates another perspective view 2500 if the CPS 2002 of FIGS. 20 to 23 with the retaining arms being arranged in an intermediate position 2208 or deployed position.

FIG. 26 illustrates a further perspective view 2600 of the CPS 2002 of FIG. 24. It will be appreciated that FIG. 26 shows the CPS from the so-called bottom side 2064 of the rigid support body 2004. As shown in FIG. 26, two retaining arms 2082₁, 2082₂ are connected to the rigid support body 2004 and these are arranged on diametrically opposite sides of the rigid support body 2004. It will be appreciated that each retaining arm 2082₁, 2082₂ is associated with a respective latch arm 2092.

FIG. 27 illustrates a still further perspective view 2700 of the CPS 2002. FIG. 27 illustrates the through bore 2704 extending through the bend stiffener 2020. It will be appreciated that a through bore extends through the whole CPS. FIG. 27 also clearly illustrates the two retaining arms 2082₁, 2082₂ connected to the rigid support body 2004. It will be understood that the perspective view in FIG. 27 illustrates the retaining arms 2082₁, 2082₂ in the intermediate position 2208 or if the local conditions are appropriate the deployed position. FIG. 27 additionally illustrates the recess 2212 in the wall abutment surface 2204 of the outer sleeve 2052 in more detail. FIG. 27 also illustrates that the pair of retaining arms 2082₁, 2082₂ are disposed in a spaced apart relationship on opposed sides of the rigid support body 2004. It will be appreciated that each retaining arm 2082₁, 2082₂ is connected to the support body 2004 via a respective connector 2084. It will be appreciated that each connector 2084 may include a bearing and shaft to allow the retaining arm 2082 to swivel with respect to the rigid support body 2004. In such an arrangement, either the bearing or shaft can be connected to a respective retaining arm and a remainder of the bearing or shaft can be connected to the rigid support body or vice versa. It will be appreciated that a pair of latch arms are also included in the CPS of FIG. 27, each of the latch arms being associated with a respective one of the pair of the retaining arms 2082₁, 2082₂. It will be understood that the pair of latch arms are disposed in a spaced apart relationship on opposed sides of the rigid support body 2004.

FIG. 28 illustrates a cross-sectional view 2800 of the CPS 2002 of FIGS. 20 to 27. FIG. 28 shows that a through bore 2704 extends through the entire length of CPS. FIG. 28 additionally helps illustrate the non-uniform thickness of the tapered region of the bend stiffener 2020.

FIG. 29A illustrates the rigid support body 2004 of the CPS 2002 of FIGS. 20 to 28 in more detail. It will be appreciated that, aside from the connectors 2084 and retaining arms 2082, FIG. 29A illustrates an isolated rigid support body for the sake of explanation only. FIG. 29A illustrates the rigid support body 2004 when not connected to the bend stiffener 2020 or the pull in head adaptor 2024, and when not partially covered by the outer sleeve 2052. The rigid support body is a generally cylindrical and integrally formed unit. A through bore 2904 extends through the rigid support body 2004. It will be understood that a cable, or other flexible elongate member, can be threaded through the rigid support body. The outer surface of the rigid support body 2908 may abut against the inner surface of the aperture 2016 of a monopile wall 2012 in use. Alternatively the outer surface diameter may be undersized to assist clearance during installation and decommissioning. If a non-circular aperture is used in the wall, the rigid support body may be non-cylindrical. It will be appreciated that the outer surface 2908 of the rigid support body 2004 is generally cylindrical. The outer surface 2908 may therefore include a substantially resistant and/or robust material to help avoid damage to the rigid support body in use. Optionally the outer surface of the rigid support body may be coated/covered with a protective and/or water resistant/proof and/or corrosion resistant cladding/coating. As is illustrated in FIG. 29A, the outer cylindrical surface includes a dished out surface region 2214. It will be understood that each retaining element is connected via a respective connector at a respective dished out surface region. It will be understood that each dished out surface region 2216 includes a first dished out end region 2912 and a further dished out end region 2916. As is shown in FIG. 29A, the first dished out end region 2912 and the further dished out end region 2916 are disposed on opposed sides of a respective connector 2084 location. FIG. 29A also illustrates a respective non dished out region 2920 of the outer surface 2908 of the rigid support body proximate to the first and further dished out end regions. The non dished out region 2920 includes an abutment surface 2216. It will be understood that the abutment surface 2216 provides a stop to prevent swivelling motion of a respective retaining arm 2082 beyond a preset place. As is illustrated in FIG. 29A, a pair of retaining arms 2082 are disposed in respective substantially diametrically opposed side positions on the outer cylindrical surface 2908. It will be appreciated, but not shown in FIG. 29A, that a further dished out portion 2916 is located on the reverse side of the rigid support body 2004 (facing into the page in FIG. 29). It will be appreciated that both retaining arms 2982 may swivel together or may swivel independently of each other. It will be appreciated that respective biasing elements associated with each retaining arm may have/provide/exert common or different biasing forces to control how each retaining arm moves once released.

FIG. 29B illustrates an end on view of the rigid support body 2004 when the retaining arms 2082₁, 2082₂ are not disposed in the storage position. As shown in FIG. 29B. the rigid support body 2004 includes a through bore 2904 extending through the support body. In order to maintain the integrity of the support body in use, due to abutment with the monopile wall and corrosion etc, the tubular rigid support body 2004 must be of a minimum thickness. The thickness of the support body in FIG. 16B is 15 mm. Optionally the thickness of the support body may be 12 mm. Optionally the thickness of the support body is between 1 mm and 100 mm thickness. The support body has a bore 2904 diameter 200 mm. Optionally the bore 2904 diameter is between 100 and 500 mm. The bore diameter is tailored to the cable that is to be threaded through the support body. It with reference to FIGS. 20 to 28, it will be appreciated that the support body includes two dished out surface regions 2216 proximate to respective retaining arms. In order to maintain the required thickness of the support body, the bore 2904 narrows throughout the portion of the support body that includes the dished out surface regions 2216. Two inwardly extending wall regions 2940, each arranged at a respective dished out surface region 2216, therefore maintain the thickness of the support body throughout each dished out surface region of the rigid support body. FIG. 29B also helps to illustrate that each retaining arm 2082₁, 2082₂ includes two wall abutment surfaces 2944₁, 2944₂, 2948₁, 2948₂ that abut with an inner surface of the monopile wall when the retaining arm is arranged in a deployed position in use. FIG. 29B additionally helps to illustrate the position of the abutment elements that are abutment pins of each latch arm 2092.

FIG. 29C illustrates an end on view of the rigid support body 2002 of FIG. 29A when the retaining arms are disposed in a storage position. FIG. 29C helps illustrate the inwardly extending wall regions 2940 of the through bore. It will be appreciated that the inwardly extending wall regions 2940 are only present through the portion of the rigid support body that includes the dished out surface regions 2216 and therefore the inwardly extending wall portions 2940 do not extend throughout the whole length of the rigid support body.

FIG. 30A illustrates the retaining arm 2082 of the CPS 2002 of FIGS. 20 to 29 in more detail. FIG. 30A shows an isolated retaining arm 3000. The retaining arm 2082 is an example of a retaining element. The retaining arm 2084 includes an elongate retaining body 3004. The elongate body 3004 is associated with a principal arm axis and arranged to swivel about the through hole 2086 that is a swivel point that is on the principal arm axis but offset from a centre point on the arm axis along a length of the retaining arm 2082. The retaining arm is formed from a metallic material. Optionally the retaining body may be manufactured from an alloy material. Optionally the retaining body may be made from any other suitable material. For example, the material could be composite, polymeric, ceramic, or the like. The retaining body 3004 includes a through hole 2086. It will be understood that the through hole is able to receive a connector to connect the through hole to a rigid support body. The through hole may include, or be associated with, a bearing to facilitate swivelling of the retaining arm about the through hole 2086 which is therefore a swivel point. The through hole 2086 may include a low-friction or frictionless inner surface to facilitate swivelling. As indicated above, the through hole 2084 is located proximate to the first end 2088 of the retaining arm 2082. It will be appreciated that the through hole 2084 is an example of an eyelet having a circular cross section through the retaining arm 2082 and is located on the principal axis of the retaining arm 2082. A coupling region 3008 is located at the further end 2090 of the retaining arm 2082. The coupling region 3008 is coupled to a respective latch arm 2092 via a frangible connector 2098 when the retaining arm 2082 is in the storage position 2099. The coupling region illustrated in FIG. 30A is a recess for receiving a pin. The retaining arm includes a wall abutment surface 2304 for abutting against an inner surface 2308 of a monopile wall 2012 when the retaining arm 782 is disposed in the deployed position 1012. Optionally the wall abutment surface 2304 wall abutment surface may be covered in a protective cladding for protecting the inner surface 2308 of a monopile wall 2012 in use. It will be appreciated that the first end 2088 and the further end 2090 of the retaining arm 2082 are spaced apart across the elongate body 3004.

FIG. 30B illustrates a different perspective view 3040, that is a top-down view, of the retaining arm of FIG. 30A. As is illustrated in FIG. 30B, the retaining arm 2082 includes a through hole 2086 that is located a position along a primary axis associated with the retaining arm that is axially offset from a centre point of the retaining arm primary axis. That is to say that the through hole is located more proximate to a first end of the retaining arm than a further end of the retaining arm. The retaining arm receives a connector 2084 that may include a shaft and/or bearing and/or spigot. With reference to FIGS. 20 to 23, it will be appreciated that in use, when the retaining arm is released from a storage position (by cracking a frangible part that is part of or associated with a latch arm, the latch arm being associated with the retaining arm), the offset positioning of the through hole (and associated connecter) enables the retaining arm to swivel from the storage position to an intermediate or deployed position. That is to say that, as the through hole, which is an example of a swivel point or swivel region, is offset with respect to the centre of mass (and centre of gravity) of the retaining arm, a rotational force that is a restoring torque, alongside the biasing effect of the spring, is exerted upon the retaining arm to swivel the retaining arm away from the storage position which, in the absence of a connection between the retaining arm and a respective latch arm, is a non-equilibrium position. The retaining arm illustrated in FIGS. 30A and 30B has a through hole diameter of approximately 50 mm to receive a cylindrical connector spigot with a diameter also of approximately 50 mm. It will be understood that any other suitable dimensions of through hole and cooperating connector could instead be utilised.

FIG. 30B also helps illustrate the position of two wall abutment regions 3044₁, 3044₂ of a wall abutment surface 3048 of the retaining arm. The wall abutment regions are axially located on either side of the portion of the retaining body that includes the through hole. It will be appreciated that the wall abutment regions abut against an inner surface of the monopile wall in use when the retaining arm is located in a deployed position (illustrated in FIG. 23). Arrow A indicates a force incident on a first wall abutment region 3044₁ due to an abutting relationship with the inner surface of the monopile wall and Arrow B indicates a force incident on the further wall abutment region 3044₂ due to an abutting relationship with the inner surface of the monopile wall in use, and when the retaining arm is oriented in the deployed position (as illustrated in FIG. 23). It will be appreciated that the whole weight of the CPS may be distributed among any number of retaining arms utilised in the CPS that are in a deployed position. Alternatively, a winch may provide a tension that partially supports the CPS weight via a winching line connected to a cable where a covered part of the cable extends through the rigid support body of the CPS. Alternatively, a winching line may be connected to the CPS itself. It will therefore be appreciated that substantial load can be applied to the monopile wall via each wall abutment region of each retaining arm. With reference to Newton's third law of motion, the monopile wall thus exerts an identical but opposed force on each wall abutment region of the wall abutment surface of the retaining arm. It will be appreciated that the combined force exerted on the first and further wall abutment region is transferred to engaged surface regions 3052, 3054 of the through hole and the connector (the spigot) which are most proximate to the wall abutment surface of the retaining arm. It will therefore be appreciated that the weight of the CPS may be supported by a number of connectors associated with each retaining arm situated in a deployed position. It will be appreciated that, in the CPS embodiment described herein, two retaining arms (the first a further retaining arms) are utilised and therefore the weight of the CPS is support by the first and further connectors that are associated with the respective first and further retaining arms. It will therefore be appreciated that a portion of the CPS weight (which may be around half of the CPS weight that is not further supported by other methods or devices or mechanisms) is supported by the connector shown in FIG. 30B when the retaining arm of FIG. 30B is oriented in a deployed position in use. The weight incident on the retaining arm in use is illustrated by arrow C.

It will be appreciated that, when compared with prior art retaining systems discussed with regard to technological background above, the load path from the location of abutting wall abutment regions of the retaining arm to the load supporting region of the connector is relatively short. Furthermore, due to the orientation of the retaining arms (that are able to swivel), the force exerted on the connector is directed substantially through the connector in a direction perpendicular to an axis associated with the connector, and is predominantly a shear force. That is to say, the degree to which rotational moments are applied to the connector are limited. Thus, the present arrangement and relatively short load path result in a more efficient retaining system which is less prone to failure than current prior art solutions. It will be appreciated that, utilising the two retaining arms described in the present CPS embodiment yields four wall abutment regions. The retaining arm arrangement is therefore a much more efficient use of material than prior art solutions, such as latch arm solutions discussed above. In fact, the retaining arm arrangement disclosed herein, which utilises two retaining arms, is 21 times more efficient than some currently adopted prior art solutions.

As discussed in the background section above, prior art CPS retaining solutions typically support the weight of the CPS at a particular point, or a particular number of points, for example a terminal end of a latch or a surface of a ball. These points are typically of limited surface area and therefore exhibit significant point loading on the inner surface of the monopile wall. It will be appreciated that higher contact stresses imparted on an inner surface of a monopile wall typically results in a higher rate of corrosion and therefore a reduced lifetime of an associated WTG. Such point loading of prior art approaches discussed above yields considerably higher contact stresses between retaining elements and the inner surface of the monopile wall. The beam loading of each (of the two) retaining arms utilised in the present CPS embodiment significantly reduces that contact stresses imparted on the monopile wall by distributing the weight of the CPS over four wall abutment regions (two on each retaining arm). It will be understood that at least some of these wall abutment regions may additionally have a larger surface area than abutment surfaces in prior art retaining elements thereby further decreasing stresses imparted on the monopile wall. Such an arrangement helps limit corrosion of the abutting regions of the monopile wall thereby helping to extend the lifetime of a WTG associated with the monopile. It will be appreciated that the high point loading of some prior art retaining solutions results in brinelling and other aberrant effects of abutment under load at the latch-monopile wall contact surfaces which increases the rate of corrosion.

Some prior art retaining solutions include a latch system which generates loading incident on a supporting point, which is often a pin proximate a terminal end of a latch, of around 1.5 times the force applied to the monopile wall by the abutment surface of the latch divided by the area of the latch abutment surface in contact with the monopile wall (Load=1.5×Force/Area). The present latch arm arrangement however, due to the geometry and relative dimensions of the latch arms illustrated in FIG. 30B, generates a load on the connector that is one fourteenth of the force applied to the monopile wall by the abutment surface regions of the arms divided by the area of the combined abutment regions of the arms in contact with the monopile wall ( 1/14×Force/Area). It will be appreciated that, when compared with prior art systems, the present retaining arrangement results in a considerable reduction of loading stresses.

For example, some retaining arms provide two areas of contact between the wall abutment surface of the retaining arm and an inner surface of the monopile wall, the areas of contact being arranged at the interface between the retaining arm and the monopile wall at either side of the swivel region. When the swivel region is offset axially with respect to the retaining arm (that is to say, not equidistant from each terminal end of the retaining arm) the effective areas of contact may be located at a distance of 2 L and L (L being an arbitrary distance) from the swivel region (taken along the wall abutment face of the retaining arm) respectively. The effective areas of contact may each be at a distance of 1.25 D and D (D being an arbitrary distance) from respective most proximate terminal ends of the wall abutment surface of the retaining arm. In a dual retaining arm system, in which a retaining arm is arranged on either side of a rigid support body, there are 4 areas of contact between the retaining arms and the inner surface of the monopile wall (two areas of contact on each retaining arm). Thus, for an arbitrary force F (indicated by C in FIG. 30B) that is a load incident on each of the retaining arms due to the weight of the CPS system (and associated apparatus, for example the flexible elongate member) when the CPS is retained, by the arms, at a position at least partly through the aperture of the monopile wall, the resulting reaction forces at each of the effective areas of contact may be around R_{A}=F/3 (indicated by A in FIG. 30B) and R_{B}=⅔F (indicated by B in FIG. 30B) respectively. The shear area may be around 14A (A being an arbitrary area). A minimum shear stress incident on the connector located at the swivel region may be around F/14A. A maximum contact stress between the monopile wall and the retaining arm may be around 0.3 F/DW (where W is the width of the wall abutment surface of the retaining arm).

It can be shown that, for some prior art latch systems which utilise point loading in which all the force, F, associated with the retaining of a CPS in a monopile is incident at a single effective area of contact of the latch (in abutment with an inner surface of a monopile wall), the shear area may be around 2A. It can be shown that the minimum shear stress incident on a pin of the latch is around 3 F/2A. It can be shown that the minimum contact stress between the monopile wall and the latch is around 0.6 F/DW (where D is the length of the wall abutment surface of the latch and W is the width of the wall abutment surface of the latch). Thus, as indicated above, the load on a connector associated with a retaining arm is one fourteenth of the load associated on a pin of a prior art latch, and the use of a retaining arm system is 21 times more efficient than a prior art latch system.

It will be understood that, in the present CPS embodiment, the size of the connector is not as constrained by space within the CPS and/or monopile and therefore the connector can readily by enlarged to provide additional strength (resilience to the loading of the CPS) if necessary.

It will further be appreciated that the use of two retaining arms, arranged at substantially opposite sides of the rigid support body helps limit, reduce or avoid misalignment of the system in use. It will be understood that misalignment of prior art systems can result in aberrant increases in loading on retaining latches (and components associated with such latches such as supporting elements) and/or the inner surface of the monopile wall and can ultimately result in damage. Such misalignment includes rotational and axial misalignment of the rigid support body with respect to a desired angle of penetration of the rigid support body through the aperture in the monopile wall when the rigid support body is arranged in a predetermined position or a retained position. This is due to the symmetrical arrangement of the two retaining arms. It will be appreciated that, should the rigid support body be rotationally misaligned in the aperture (such that each retaining arm is not arrange on substantially horizontally opposed sides of the support body), the force on each retaining arm will not be evenly distributed. The retaining arms will additionally not be swivelled away from the storage position to the same degree. That is to say that, at a particular instance in time, one of the retaining arms will be swivelled further away from the position of the retaining arms when arranged in the storage position than the other arm. At least partly due to the uneven distribution of such forces, the arms generate a restoring torque which acts to equilibrate the forces incident on each of the arms. This restoring torque thus acts to reduce misalignment of the rigid support body. The restoring torque thus acts to urge the rigid support body towards the predetermined position and acts to urge the retaining arms towards the deployed position. It will be appreciated that the biasing effect of the spring may also help reduce misalignment, acts to urge the retaining arms towards the deployed position and acts to urge the rigid support body towards the predetermined position.

FIG. 30C illustrates a still further perspective view of the retaining arm of FIG. 30A. It will be appreciated that FIG. 30C illustrates a side-on view of the retaining arm. FIG. 30C helps illustrate the wall abutment regions of the wall abutment surface of the retaining arm. FIG. 30C also helps illustrate the geometry of the through hole, a cross section of which is indicated by the dotted lines in FIG. 30C.

FIG. 30D illustrates another perspective view of the retaining arm of FIG. 30A. It will be appreciated that FIG. 30D illustrates an end-on view of the retaining arm.

FIG. 31 illustrates the latch arm 2092 of the CPS 2002 of FIGS. 20 to 20 in more detail. It will be appreciated that FIG. 31 illustrates a single latch arm 2092 in isolation. The latch arm 2092 includes an elongate latch arm body 2104. The frangible connector 2096 is located at a first end 2108 of the latch arm 2082. The frangible connector 2096 optionally includes an eyelet or a socket body 2120 for receiving an elongate pin and a narrowed region 3112 between the eyelet and the latch arm body 3104. Alternatively, the frangible connector may include an elongate pin for connection to a respective socket in a retaining arm. A perforation line may optionally also be used. It will be understood that the narrowed region 3112 is a weakened region that is designed to fracture/break when subjected to a predetermined threshold force before any of the other elements associated with the latch arm 2092 break. It will be appreciated that the latch arm 2092 may instead include a different frangible portion which can be connected to a retaining arm. Optionally a frangible portion is located within the body 3104 of the latch arm 2092 such that the latch arm is breakable at a predetermined position, or cracking point, of the latch arm 2092. The abutment element is located proximate to a further end 3116 of the latch arm 2092. The abutment element 2098 of FIG. 31 is a peg member that extends away from the latch arm 2092. It will be appreciated that the abutment element 2098 moves with the latch arm 2092. It will be appreciated that the abutment element 2098 may instead be a protrusion or different geometry, for example triangular or rectangular and the like, or may be a recess in the latch arm 2092 that engages with a mating protrusion associated with a monopile wall, or the wall of any other suitable facility. With reference to FIGS. 22 and 27, it will be appreciated that the peg 2098 can be located in a cooperating (or accommodating) recess 2214 in an inner surface (the surface of the outer sleeve in contact with the support body) of an outer sleeve 2052 coupled to the rigid support body 2004.

It will be appreciated that, when slidably disposed in a recess 2096 of a rigid support body 2004 (or otherwise coupled to the rigid support body) and in use during a pull-in process of the like in which the rigid support body 2004 is urged into a monopile 2008 via an aperture 2016 in a monopile wall 2012, the peg 2098, (which moves with the latch arm) abuts against the outer surface of the monopile wall 2012. It will be understood that, as the support body is urged into the monopile, due to the abutting relationship between the monopile wall 2012 and the peg 2098, an abutment force acts on the peg 2098 acting away from the wall 2012. It will be understood that the abutment force is generated in response to the peg 2098 abutting an outer surface of the wall 2012 of the monopile 2008 proximate to the aperture 2016 as a portion of the rigid support body 2004 is urged through the aperture 2016. When the abutment force overcomes a predetermined threshold force, which is a cracking force required to crack the frangible connector 2098 and can therefore be specified in manufacture of the latch arm 2092, the frangible connector 2098 is cracked. That is to say that the frangible connector breaks responsive to the abutment force. Following the cracking of the frangible connector 2098, it will be understood that the latch arm 2092 slides in the first direction of motion due to the abutment of the monopile wall 2016 against the abutment peg 2098. At this point the latch arm no longer holds the respective retaining arm in place. It will therefore be appreciated that, when the abutment force exceeds the predetermined threshold force, sliding of the latch arm 2092, and swivelling of the retaining arms 2082 from a storage position to a deployed or intermediate position is permitted. It will be appreciated that when the latch arm 2092 is connected to a respective retaining arm 2082 via the frangible connector 2098, which prevents slidable motion of the latch arm 2092 in the recess of the rigid support body 2004, the latch arm 2092 prevents swivelling of the respective retaining arm 2082 from a storage position to an intermediate or deployed position.

It will be appreciated that the abutment element of FIG. 31 is generally cylindrical. Optionally the abutment element may be any other shape. The abutment element may be a peg member. It will be appreciated that, in use, a cylindrical abutment element engages and abuts against an outer surface of a monopile wall at a consistent set-off distance and therefore offers some control over the position of the CPS relative to the monopile wall and associated aperture when the abutment element is expected to engage with the monopile wall. The generally cylindrical arrangement of the abutment element helps ensure consistent engagement between the monopile wall and abutment element as the abutment element will generally always engage the monopile wall at a curved outer surface of the generally cylindrical body of the abutment element.

It will be appreciated that an elongate pin member may instead constitute a frangible portion of the latch arm of FIG. 31. The elongate pin may be arranged to extend through a through-hole located at and end of the latch arm distal to the abutment element. The elongate pin may be polymeric or wooden or the like. The elongate pin may be substantially brittle and thus may completely shear when a sufficient force is applied to the pin. It will be appreciated that the pin may shear when a shearing force/cracking force of around 3000 N is incident on the pin. It will be appreciated that the pin may shear when a shearing/cracking force of between 2000 N and 10000 N is incident on the pin. It will be appreciated that the shearing force required to shear the pin may be relatively similar when the pin is dry and when the pin is wet. It will be appreciated that the pin may shear under a well-defined shearing/cracking force which corresponds or is related to a predetermined threshold force which may be generated by applying a tension to a winching line to pull the CPS into an aperture of a wall of a monopile such that an abutment element of the latch arm abuts against an outer surface of the monopile wall to transfer force to the pin. It will be appreciated that the pin may shear across a thinnest diameter of the pin, the axis of shearing aptly being around 90 degrees to the primary axis of the pin.

FIG. 32 illustrates another example of a latch arm 3200 for use in the CPS of FIGS. 20 to 30. The latch arm 1900 includes an elongate latch arm body 3204. A frangible connector 3208 is located at a first end 3212 of the latch arm 3200. The frangible connector 3208 includes an eyelet 1916, for receiving a pin, and a narrowed region 1920 between the eyelet 3216 and the latch arm body 3204. It will be understood that the narrowed region 3220 is designed to fracture/break when subjected to a predetermined threshold force before any of the other elements associated with the latch arm 3200 break. The abutment element 3222 is located at a further end 3224 of the latch arm 3200. The abutment element 3222 is a protruding wedge located at the terminus of the further end 3224 of the latch arm 3200. The abutment element 1922 includes an abutment face 3228 for abutting against monopile wall in use.

It will be understood that the abutment face 1926 of the wedge is oblique to a primary axis of the latch arm which at least partly cooperates with the outer surface of a monopile wall against which the abutment face abuts. For example, the abutment face at least partly cooperates with a curved outer surface of a monopile wall. It would be understood that the oblique abutment surface helps ensure that the abutment element abuts with the outer surface of the monopile wall at a desired orientation. It will be appreciated that the oblique abutment face, that is substantially flat defines a particular surface area of contact between the outer surface of the monopile wall and the abutment element. Thus, the oblique abutment face, which is at least partly complimentary to an outer surface of a monopile wall provides a greater control of the pulling force on the elongate flexible member (and thus on the CPS respectively) required to achieve a predetermined threshold force and crack (that is, to shear or completely break) the frangible portion of the latch arm. It will be appreciated that this is due to the fact that a reasonable estimation can be made as to the area of the abutment element and monopile wall that are in contact when the oblique surface of the abutment element abuts against the monopile wall. As indicated previously, the pulling force and predetermined threshold force could be measured in Newtons (N).

Aptly the latch arm is disposed to break at the frangible portion when exposed to a force of between 2000 and 10000 N, aptly around 3000 N.

It will be appreciated that an elongate pin member may instead constitute a frangible portion of the latch arm of FIG. 32. The elongate pin may be arranged to extend through a through-hole located at and end of the latch arm distal to the abutment element. The elongate pin may be polymeric or wooden or the like. The elongate pin may be substantially brittle and thus may completely shear when a sufficient force is applied to the pin. It will be appreciated that the pin may shear when a shearing force/cracking force of around 3000 N is incident on the pin. It will be appreciated that the pin may shear when a shearing/cracking force of between 2000 N and 10000 N is incident on the pin. It will be appreciated that the shearing force required to shear the pin may be relatively similar when the pin is dry and when the pin is wet. It will be appreciated that the pin may shear under a well-defined shearing/cracking force which corresponds or is related to a predetermined threshold force which may be generated by applying a tension to a winching line to pull the CPS into an aperture of a wall of a monopile such that an abutment element of the latch arm abuts against an outer surface of the monopile wall to transfer force to the pin. It will be appreciated that the pin may shear across a thinnest diameter of the pin, the axis of shearing aptly being around 90 degrees to the primary axis of the pin.

FIG. 33A illustrates another alternative CPS 3302, for locating a flexible elongate member at a predetermined location with respect to a monopile wall through which an aperture is provided. The CPS 3302 is illustrated in a first position 3300. It will be understood that the first position 3300 of the CPS 3302 may be prior to installation of the CPS system in a WTG. In the first position 3300, all of the rigid support body 3304 of the CPS 3302 is located outside of a monopile 3308, that is to say none of a rigid support body is located in a space enclosed by a wall 3312 of the monopile 3308, or within an aperture 3316 extending through the wall 3312. The first position 3300 is therefore a first position of the rigid support body 3304. It will be appreciated that, when a cable of other flexible elongate member is threaded through a through bore of the CPS, the installation of the CPS from the first position 3300 may be achieved via the winching process described in FIGS. 5 and 6. Although a monopile or WTG is specifically referred to here, it will be understood that the system could be utilised in any suitable structure or facility that includes a wall with an aperture extending therethrough and an internal cavity. The WTG is an example of a facility, the monopile being a part of the WTG.

As is illustrated in FIG. 33A, the cable protection system includes a rigid support body 3304 arranged between a progressive stiffener 3320 (or bend stiffener) and a pull-in head adaptor 3324. The rigid support body 3304 is elongate and is substantially tubular and includes a cylindrical through bore. The cylindrical through bore (not shown in FIG. 33A) extends through a whole length of the rigid support body. That is to say the rigid support body includes a through-bore that extends through the support body from a first end of the support body to a further end and through which a flexible elongate member is locatable. The rigid support 3304 body is formed from a metallic material. For example, a corrosion resistant alloy and the like may be used. The rigid support body 3304 may optionally be formed from a polymeric material or a reinforced polymeric material. The rigid support body 3304 may optionally be made from a composite material. The rigid support body 3304 may optionally be manufactured from a ceramic material. The bend stiffener 3320 is also an elongate body that surrounds a substantially cylindrical through bore. As is illustrated in FIG. 33A, the bend stiffener 3320 includes a tapered portion 3328 including a tapered outer surface. It will be appreciated that the through bore of the tapered portion 3328 is substantially cylindrical and is therefore not itself tapered. The thickness of the tapered portion 3328 therefore varies along its length from a flared-out end 3334 arranged to be close to the rigid support body 3304 to a narrow end 3338 distal to the rigid support body 3304. The varying thickness of the tapered portion 3328 provides a non-uniform stiffness of the bend stiffener 3320 along its length. It will be appreciated that, when an elongate flexible member, such as a cable or the like, is arranged radially within the bend stiffener 3320, a flexibility of the elongate member is constrained at the flared-out end 3334 of the tapered portion and is relatively unconstrained at the narrow end 738 of the tapered portion 3328. This tapered portion 3328 helps prevent a flexible elongate element, such as a cable, from exceeding a predetermined minimum bend radius that may be detrimental to the elongate element. The bend stiffener 3320 may also help reduce chafing, or other destructive frictional effects, at the interface between the elongate element and the rigid support body 3304. The bend stiffener 3320 additionally includes a substantially annular portion 3340 coupled to the flared-out end 3334 of the tapered portion 3328. A remaining end of the substantially annular portion is coupled to a first end 3342 of the rigid support body 3304. The coupling between the substantially annular portion 3340 of the bend stiffener 3320 and the first end 3342 of the rigid support body 3304 may be provided by conventional securing methods such as bolting of screwing of the like. The progressive stiffener is thus secured to the first end of the rigid support body.

A further end of the rigid support body 3304 is connected to the pull-in head adaptor 3324. The further end of the rigid support body is therefore secured to the pull-in head adaptor. It will be appreciated that the pull in head adaptor can house and can releasably engage with a pull-in head during a support body pull in operation. When engaged within the pull in head adaptor, the CPS system moves with the cable. Therefore, by pulling the cable into the monopile via the aperture by winching, the rigid support body is also pulled through the aperture.

As illustrated in FIG. 33A, a region of the rigid support body 3304 proximate to the further end 3348 of the rigid support body is covered by an outer sleeve 3352. The outer sleeve 3352 is therefore located at a position distal to the first end 3334 of the rigid support body 3304. The outer sleeve 3352 shown is manufactured from a polymeric material. The outer sleeve 3352 may optionally comprise a polymeric material. The outer sleeve 3352 may optionally comprise a reinforced polymeric material. The outer sleeve 3352 may optionally comprise a composite material. As is illustrated in FIG. 33A, the outer sleeve 3352 is arranged to radially surround a portion of the rigid support body 3304 and is substantially tubular. A first end of the outer sleeve 3356, most proximate to the first end 3334 of the rigid support body 3304 is angled such that an axis associated with a face 3355 of the first end 3356 of the outer sleeve 3352 is oblique to a primary axis of the outer sleeve 3352 (and the rigid support body 3304). It will therefore be appreciated that the outer sleeve 3352 extends further over the rigid support body 3304 on a top side 3360 of the rigid support body than the bottom side 3364 of the rigid support body 3304, the top 3360 and bottom 3364 sides of the rigid support body 3304 being on opposite substantially opposite sides of the rigid support body. It will be understood that the top and bottom sides of the rigid support body are simply relative terms, and that rigid support body may be arranged in any orientation, the top side 3360 of the rigid support body possibly being located on an upper surface of the rigid support body and the bottom side 3364 of the rigid support body optionally being located on a lower surface of the rigid support body 3304.

A further adaptor 3372 is connected to a remaining end of the pull-in head adaptor 3324 (the end of the pull-in head adaptor 3324 that connects the pull-in head adaptor to a bend restrictor element 3376. It will be understood that the bend restrictor element 3376 is part of a bend restrictor 3377 which includes multiple bend restrictor elements 3376. Three bend restrictor elements 3376 are shown in the bend restrictor 3377 of FIG. 33A. It will be understood that any number of bend restrictor elements 3376 may be included in the bend restrictor 3377. The further adaptor 3372 may be connected to the pull-in head adaptor via suitable securing mechanisms such as screwing and/or bolting and the like. The further adaptor 3372 may be connected to a bend restrictor element 3376 by securing mechanisms such as screwing and/or bolting and the like. Alternatively, a bend restrictor element 3376 may be a part of the further adaptor 3372, that is to say a bend restrictor element 3376 may be arranged at a terminal end of the adaptor 3372, the bend restrictor element and the further adaptor being integrally formed. As shown in FIG. 33A, the multiple bend restrictor elements 3376 are arranged in series and connected in an end-to-end configuration. It will be understood that the bend restrictor 3377 defines an end portion of the CPS 3302 which extends into the surrounding environment 3380 and away from the monopile wall 3312. The bend restrictor elements 3376 forming the bend restrictor 3377 limit the flexibility of a portion of an elongate member arranged within each of the bend restrictor elements 3376.

FIG. 33A also illustrates a retaining arm which is connected to the rigid support body 3304 via a respective connector 3384. It will be appreciated that, although only one retaining arm is shown in FIG. 33A, the rigid support body 3304 also includes another retaining arm on a diametrically opposite surface of the rigid support body 3304 (the surface extending into the page). It will be understood that, although the CPS of FIG. 33A includes two retaining arms 338₂, any suitable number of retaining arms 338₂ may be utilised, the retaining arms 338₂ optionally being arranged at any suitable position along the rigid support body 3304. It will be understood that the retaining arm 338₂ is an example of a retaining element and any suitable shape or configuration of retaining element can instead be utilised. Each of the retaining arms 338₂ are connected to the rigid support body 3304 via a respective connector 3384. That is to say a different connector 3384 connects each retaining arm 338₂ to the rigid support body 3304. It will be appreciated that each retaining arm 338₂ is on a respective side of the rigid support body 3304 that between, and is substantially equidistant from, the top 3360 and bottom 3364 sides of the rigid support body 3304. It will be appreciated that so-called side of the rigid support body refer to a regions of the cylindrical surface of the support body which extend a respective maximum and minimum distance in an x-axis and y-axis of an imaginary plane that is perpendicular to the primary axis of the rigid support body. Each retaining arm 338₂ is connected to the rigid support body 3304, via the respective connectors 3384, at a position of the rigid support body 3304 more proximate to the first end 3342 of the rigid support body than the further end 3348 of the rigid support body 3304. The retaining arms 338₂ include an elongate retaining body which includes an elongate slot eyelet 3386 through the retaining body in a direction perpendicular to the primary axis of the retaining element to receive a respective connector 3384. The primary axis associated with the slot eyelet 3376 is parallel to the primary axis associated with the elongate body of the retaining arm 338₂. As is illustrated in FIG. 33A, the slot eyelet 3384 is round ended on both ends. As illustrated in FIG. 33A, the elongate slot eyelet 3386 is offset from a centre point of the retaining arm 338₂ and is therefore located more proximate to a first end 3388 of the retaining arm 338₂ than a remaining end. A remaining end of each connector 3384 is connected to the rigid support body. It will be understood that the connector may include a shaft. It will be appreciated that the connector may incorporate a bearing to permit swivelling of the retaining arm 338₂ with respect of the rigid support body 3304. The slot eyelet 3386 may optionally include a bearing. The retaining arms 338₂ are therefore disposed to swivel about the connector 3384, an end of which is located in the slot eyelet 3386 of the body of the retaining arm 338₂. It will be appreciated that the swivelling motion of each retaining arm 338₂ is rotational motion centred around the slot eyelet 3386 and connector 3384. The slot eyelet 3386 of the body of each retaining arm 338₂ therefore constitutes a swivel region. That is to say that swivelling of the retaining arm 338₂, includes the partial spinning of the retaining arm about a particular position of the connector in the slot eyelet at a particular moment in time.

As indicated in the above paragraph, the retaining arms 338₂ are able to swivel about the connector 3384 and an end of the connector 3384 is located at a position within the slot eyelet 3386 of the body of the retaining arm 338₂. In the first position 3300 of the rigid support body 3304 illustrated in FIG. 33A, it will be appreciated that the connector 3384 is disposed at a first eyelet end 3389 of the elongate slot eyelet 3376 most proximate to a further end 3390 of the retaining arm 338₂, the further end 3390 of the retaining arm 338₂ being on an opposite end of the first end 3388. It will be appreciated that the end of the connecter disposed within the elongate slot eyelet is axially slidable in one dimension (along the primary axis associated with the elongate slot eyelet) within the elongate slot eyelet. It will be appreciated that the slot eyelet is an elongated eyelet.

A further end 3390 of each retaining arm 338₂ is connected to a respective latch 3392 arm located in an elongate recess 3394 on the outer surface of the rigid support body 3304. The connection between the latch arm is facilitated by a frangible connector 3396. The frangible connector 3396 is an example of a frangible portion of the latch arm 3392. Optionally the frangible portion may be located at any suitable position of the latch arm 3392. Optionally the frangible portion may be a separate element and is not a part of the latch arm 3392. Optionally the frangible portion may be integrally formed with the latch arm 3392. It will be understood that the frangible connector is releasably connected to the further end of the retaining arm. The latch arm 3392 further includes an abutment pin 3398 extending out from an outer surface of the latch arm 3392. The abutment pin 3398 may optionally be a part of, or integrally formed with, the latch arm 3392. The abutment pin 3398 may optionally be a separate element, and not a part of the latch arm 3392. The abutment pin 3398 is an example of an abutment element. It will be appreciated that FIG. 33A illustrates the retaining arm 338₂, when connected to the latch arm 3392 arranged in a storage position 3399. It will be appreciated that the latch arm 3392, which is associated with the rigid support body 3304 being coupled to the rigid support body by being slidably located in the elongate recess (channel) 3394, is disposed to prevent the retaining arm 338₂ from swivelling away from the storage position 3399. The connection between the further end 3390 of the retaining arm 338₂ and the latch arm 3392 via the frangible connection via the frangible connector 3396 therefore prevents the retaining arm 338₂ from being disposed in a position that is not the storage position 3399. As is illustrated in FIG. 33A, in the storage position 3399, the retaining arm 338₂ is oriented such that a primary axis of the retaining body is parallel with, or substantially parallel with, a primary axis of the rigid support body 3304. It will be appreciated that any other retaining arms of the CPS of FIG. 33A will be disposed in a similar storage position. As is illustrated in FIG. 33A, when the retaining arm 3304 is locked in the storage position 3399 due to the connection between the further end 3390 of the retaining arm 338₂ and the latch arm 3392, the connector 3384 is confined to the first end 3389 of the elongate slot eyelet of the retaining arm 338₂, towards the further end 3390 of the retaining arm 338₂. That is to say that the connector cannot slide along the slot eyelet away from the first end of the slot which is most proximate to the further end of the retaining arm.

FIG. 33B illustrates the retaining arm 338₂ shown in FIG. 33A in more detail. As shown in FIG. 33B, the retaining arm 338₂ is locked in the storage position 3399 due to the connection between the further end 3390 of the retaining arm 338₂ and the latch arm 3392 via the frangible connector 3396. The connector is located in the elongate slot eyelet 3376 and is confined at the first end 3389 of the slot eyelet 3376.

FIG. 34 illustrates the CPS 3302 of FIG. 33A during installation 3400 where the rigid support body 3302 is partially passed through the aperture 3312 of the monopile wall 3312. It will be understood that installation may include the winching process described in FIGS. 4 and 5. This may be a part of a pull in process in which cable or another flexible elongate member is pulled into the monopile. It will be understood that the CPS 3302 has been pulled, from the first position 3300 illustrated in FIG. 33A, towards the monopile such that the rigid support body 3304 intrudes into the aperture 3316 of the wall 3312 of the monopile 3308. As is illustrated in FIG. 34, the bend stiffener 3320 is located within the inner region (cavity) 3404 of the monopile 3308. FIG. 34 illustrates that the first end 3342 of the rigid support body 3304 is located in an inner region 3404 of the monopile 3308. The further end 3348 of the rigid support body 3304 is located outside of the of monopile 3308 in an outer region associated with the monopile 3308 which is in the environment 3380. The outer sleeve 3352 is also located outside of the monopile 3308 in the environment 3380. As shown in FIG. 34, a portion of the rigid support body 3304 is located within the aperture 3316 in the monopile wall 3312. The retaining arms 338₂ are disposed in the storage position 3399 as discussed in relation to FIG. 33A. It will therefore be understood that the further end 3390 of the retaining arms are therefore connected to respective latch arms 3392 via respective frangible connectors 3396. As shown in FIG. 34, the storage position 3399 of the arms 338₂ allows for the rigid support body 3304 to at least partially pass through the aperture 3316. That is to say that the orientation of the storage position 3399 does not prevent the rigid support body 3304 and the retaining arms 338₂ from entering into the inner region 3404 of the monopile 3308 via the aperture 3316. That is to say in the storage position the support body is locatable through an aperture in a wall of a monopile from a first position outside the monopile to a further position (such as the positions illustrated in FIG. 35 and FIG. 36A, described below) in which at least a portion of the support body is within the monopile. In the position illustrated in FIG. 34, the abutment element 3398 abuts against a region of the monopile wall 3312 outer surface proximate the aperture 3316.

FIG. 35 illustrates the CPS 3302 of FIG. 33A or FIG. 34 in a further position 3500 during installation through an aperture in a wall of an offshore structure. As shown in FIG. 35, in the further position the rigid support body 3304 has been pulled further into the inner region 8344 of the monopile 3308, through the aperture 3316 of the monopile wall 3312 relative to the position illustrated in FIG. 34. It will be appreciated that the rigid support body has been urged further into the monopile via the aperture. It will be therefore understood that in the further position 3500, a portion of the rigid support body 3304 is located within the monopile 3308. As is illustrated, in the further position 3500, the first end 3356 of the outer sleeve 3352 abuts against an outer surface 3502 of the monopile wall 3312 proximate the aperture 3316. The surface of the outer sleeve 3352 at the first end 3356 is therefore an end region that is a wall abutment surface 3504. It will be appreciated that a diameter of the outer sleeve 3352 is wider than a diameter of the rigid support body 3304. The diameter of the outer sleeve member 3352 is designed such that it is wider than a diameter of the aperture 3316 in the monopile wall 3312. It will therefore be appreciated that the abutting relationship between the wall abutment surface 3504 of the outer sleeve 3352 prevents the rigid support body 3304, and the CPS, from being pulled any further into the monopile 3308. In this sense, due to the position of the first end 3356 of the outer sleeve 3352 the further position 3500 of the rigid support body 3304 is a position at a maximum displacement towards, and into, the monopile 3308 through the aperture 3316. It will be appreciated that the aperture 3316 may be designed to receive the rigid support body 3304 at an angle that is oblique to the primary axis associated with the monopile wall 3312. Optionally this angle is around 45 degrees. As indicated with respect to FIG. 33A, the first end 3356, and thus the wall abutment surface 3356, of the outer sleeve 3352 extends in an axis that is oblique to the primary axis associated with the rigid support body 3304. The oblique angle of the wall abutment surface 3504 is complimentary with the aperture 3316 such that abutment between the wall abutment surface 3504 and the outer surface of the wall 3502 occurs at a desired angle. Optionally this angle is around 45 degrees. Optionally the oblique angle of the wall abutment surface 3504 is around 45 degrees with respect to the primary axis associated with the rigid support body 3304.

As shown in FIG. 35, in the further position 3500 of the rigid support body 3304, the retaining arm 338₂ is no longer oriented in the storage position 3399. The retaining arm 338₂ is instead disposed in an intermediate position 3508. It will be understood that the retaining arm 338₂ has rotatably swivelled from the storage position to the intermediate position 3508. As discussed with regard to FIG. 33a, it will be appreciated that swivelling of the retaining arm includes at least partially rotating or spinning the retaining arm about a swivel region. The swivel region includes the elongate slot eyelet into which a respective connector can intrude. It will be appreciated that, for the retaining arm 338₂ to be able to rotate to the intermediate position 3508. the retaining arm 338₂ and the latch arm 3392. As the abutment element 3398 associated with the latch arm 338₂ was in an abutting relationship with the outer surface 3502 of the wall in FIG. 34, as the rigid support body 3302 is urged further into the aperture 3316 an abutment force is provided on the abutment element 3398 due to the contact between the abutment element 3398 and the outer surface 3502. It will be understood that the abutment force increases as a force pulling the rigid support body 3304 into the monopile 3308, such as a tension due to a winching operation and the like, increases.

When the abutment force exceeds a threshold force, the frangible connection 3396 between the further end 3390 of the retaining arm 338₂ and the latch arm 3392 breaks due to the frangible connector 3396 and the abutment element 3398 being connected by the latch arm 3392. It will be understood that the frangible connector 3396 may include a pin and eyelet arrangement. Alternatively, the frangible connection may include a juxtaposition of materials with varying mechanical properties to promote fracture of the material at a particular point and under a particular force. Alternatively, the frangible connection 3396 may include a geometrically varied region, for example a region of reduced thickness/width. It will be understood that a particular cracking force required to be exerted on the frangible connection 3396 for the frangible connection 3396 to break can be specified in manufacture and therefore the threshold force may be a predetermined threshold force. Following disconnection of the latch arm 3392 and the retaining arm 338₂, the latch arm is free to axially slide in the channel (or recess) 3394 of the rigid support body 3304 and is pushed towards the further end 3348 of the rigid support body and under the outer sleeve 3352 due to the abutment between the abutment element 3398 and the outer surface 3502 of the monopile wall 3312. It will be understood that the latch arm 3392 is slidable along an axis of sliding with respect to the support body 3304, the latch arm 3392 being slidably disposed in the elongate recess 3394 in an outer surface of the support body 3304. It will be understood that the axis of sliding extends in a direction that is substantially parallel with, but spaced apart from, a primary axis associated with the central through-bore that extends through the rigid support body 3304. It will also be understood that the latch arm 3392 slides in a first direction of motion away from a retaining arm 338₂ supported on the rigid support body 3304 when the rigid support body 3304 passes through the aperture to thereby release the retaining arm from a storage position 3399 when the retaining element 338₂ is within the monopile. The abutment element 3398 intrudes into a recess 3512 in the wall abutment surface 3504 of the outer sleeve 3352 to permit the wall abutment surface 3504 to abut against the outer surface 3502 of the monopile wall 3312. It will be appreciated that the threshold force could be measured in Newtons (N). It will be understood that the cracking force could be measured in Newtons (N). It will be understood that the cracking force could be measured by applying known force to the frangible connection, optionally via the abutment element, until the frangible connection breaks. It will be appreciated that the threshold force could be measured by applying known force to the frangible connection, optionally via the abutment element, until the frangible connection breaks. It will be appreciated that the cracking force may be a shear force. It will be appreciated that the frangible connection may shear at the shear force. It will be appreciated that the cracking force may be a break-free force which may correspond or be proportional to a break free tension applied to a winching line to pull the CPS into the monopile and release a retaining arm from a storage position. It will be appreciated that breaking the frangible connection may include a compete shear of a part of the frangible connection that is a complete break of a part of the frangible connection resulting in a complete separation of a respective retaining arm and latch arm. It will be appreciated that the frangible connection may be brittle and shears at around a shear force. It will be appreciated that the frangible connection may be substantially brittle and is substantially resistant to deformation, distorting, elongation, bending and the like.

As indicated in the above paragraph, following disconnection of the retaining arm 338₂ and the latch arm 3392, the retaining arm is free to rotatably swivel from the storage position 3399 to the intermediate position. In the intermediate position, the primary axis associated with the retaining arm 338₂ is oblique to the primary axis associated with the rigid support body 3304. The primary axis associated with the retaining arm is optionally substantially parallel to the primary axis associated with the monopile wall 3312. Due to the through hole 3386, that is a slot eyelet, of the retaining arm 338₂ in which the connector 3384 is arranged being arranged offset to a centre point of the retaining arm, most proximate to the first end 3388 of the retaining arm 338₂, the retaining arm swivels from the storage position 799 to the intermediate position 3508 due to gravity. It will be understood that the retaining arm 338₂ may be biased towards the intermediate position by one of more biasing elements such as a spring. As shown in FIG. 35, the retaining arm 338₂ is arranged in a dished out region 3516 of the rigid support body 3304. An adjacent non-dished out portion 3520 provides an abutment surface 3524 that stops the retaining arm 338₂ from swivelling beyond a predetermined position, the predetermined position being the intermediate position 3508.

As is illustrated in FIG. 35, in an intermediate position of the retaining arm 338₂ (shown in FIG. 35), the connector 3384 is now disposed at a further end 3504 of the elongate slot eyelet 3376 of the retaining arm body, proximate to the first end 3388 of the retaining arm 338₂. Upon release of the latch arm 3392, and the swivelling of the retaining arm 338₂ away from the storage position 3399, the retaining arm 338₂ is free to slide down the connector 3384 due a combination of gravity and the axial offset of the swivel region from a centre point of the retaining arm, towards first end of the retaining arm 3388. In effect, the connector is able to slide up the elongate slot eyelet of the retaining arm towards the first end of the retaining arm. In this position, due to the geometry of the abutment surface of the non-dished out portion of the rigid support body, the retaining arm cannot accidently swivel back towards the storage position unless the retaining arm is first lifted against gravity such that the connector is disposed towards the further end of the retaining arm, and the first end of the slot. In particular, an abutment section 3508 of a non-dished out region of the rigid support body proximate to the further end of the retaining arm prevents the retaining arm from swivelling back to the storage position when the connector is located at the further end of the slot eyelet. This arrangement of the retaining arm, including a slotted eyelet in the swivel region, thus helps mitigate any accidental deactivation of the retaining arm. Which might inadvertently result in the rigid support body (and CPS) moving out of the facility.

FIG. 36A illustrates the CPS 3302 of FIGS. 33, 34 and 35 where the rigid support body 3302 is arranged in a retained position 3600 following installation. As shown in FIG. 36A, in the retained position the rigid support body 3304 is arranged further towards the outer region associated with the monopile 3308, or the environment 3380, when compared with the further position of the rigid support 3304 illustrated in FIG. 35. This may be achieved, for example, by relaxing or reducing a tension associated with a winching line via a winch that is coupled to, and providing a tension on, a cable arranged through the CPS. As is illustrated in FIG. 36A a first abutment surface 3604 of the retaining arm 338₂ is arranged in an abutting relationship with an inner surface 3608 of the monopile wall 3312 proximate the aperture 3316. The first abutment surface 3604 of the retaining arm 338₂ therefore constitutes a wall abutment surface of the retaining arm 338₂. The retaining arm 338₂, disposed in an abutting relationship with the inner monopile surface 3608 therefore retains the rigid support body 3304 at the retained position 3600, where a portion of the rigid support body 3304 is within the monopile 3308. That is to say the retaining arm 338₂, disposed in an abutting relationship with the inner surface 3608 of the monopile 3308 prevents the rigid support body from returning to its first position 3300 where all of the rigid support body is located outside of the monopile and in the environment 3380. It will be understood that when the retaining arm 338₂ is disposed in an abutting relationship with the inner surface 3608 of the monopile wall 3308, the retaining arm 338₂ is in a deployed position 3612. The wall abutment surface is therefore disposed to abut against the inner surface of the wall of the monopile proximate to the aperture in the wall of the monopile. It will therefore be understood that in the deployed position the retaining arm is disposed to prevent the support body passing fully through the aperture from the further position or the retained position to the first position, and to locate the rigid support body at a predetermined position with respect to the aperture.

It also be appreciated that the connector 3386 selectively allows the retaining arm 338₂ to swivel from a storage position 3399 to a deployed position 3612, for example on a shaft of the connector 3386. The deployed position 3612 of the retaining arm 338₂ is thus an equilibrium position in which a region of a respective retaining arm abuts a region of an inner surface of the wall and an angle of swivel of respective retaining arms 338₂ is determined responsive to a reaction between the wall and at least a mass of a cable extending through the rigid support 3302 and the support body 3302 itself. It will be appreciated that the CPS 3302 including the rigid support body 3304 with associated retaining arms 338₂ (connected via respective connectors 3384) is an example of apparatus for locating a rigid support body at a predetermined location with respect to an aperture in a wall of a facility, such as a WTG. With reference to FIG. 35, it will be understood that swivelling the retaining arm 338₂ or arms from a storage position 3399 to a deployed position 3612 occurs via an intermediate position 3508 that is a position between the storage and deployed positions.

It will be appreciated that the position shown of the rigid support body shown in FIG. 36 is a predetermined position of the rigid support body. That is to say the predetermined position of the rigid support body is an equilibrium position wherein the rigid support body extends through the aperture and the retaining arms are in abutment with the inner surface of the monopile wall. It will be appreciated that in the predetermined position, the retaining arms are arranged in the deployed position.

FIG. 36B illustrates the retaining arm 338₂ shown in FIG. 36A in more detail. As shown in FIG. 36A, the retaining arm 338₂ is arranged in the deployed position 3612. It will be understood that the retaining arm and the latch arm are therefore not connected. The connector is located within the further end 3504 of the elongate slot eyelet 3376. An abutment portion 3508 of a non-dished out region of the rigid support body prevents the retaining arm returning to the storage position when the connector is located at the further end of the slot eyelet. In the deployed position 312 areas of an abutment surface of a retaining arm abut against the inner surface of the wall. An angle of swivel taken up by each arm is responsive to the forces (gravity and currents in the surrounding environment for example) acting on the rigid support body and CPS.

FIG. 37 illustrates another perspective view 3700 of the CPS 702 of FIGS. 33 to 36 with the retaining arms 338₂ being arranged in the storage position 3399.

FIG. 38A illustrates the perspective view 3800 if the CPS 3302 of FIG. 37 however the retaining arms are arranged in an intermediate position 3804. In the intermediate position of FIG. 38A the connector is located towards the first end of the elongate slot eyelet.

FIG. 38B illustrates the perspective view 3800 if the CPS 3302 of FIGS. 37 and 38A however the retaining arms are arranged in a different intermediate position 3808, or a deployed position if installed in a facility such as a WTG and retaining against an inner wall in an equilibrium position. In the position of FIG. 38B the connector is located towards the further end of the elongate slot eyelet. It will be appreciated that the first end of the elongate slot eyelet is a first eyelet end and the further end of the elongate slot eyelet is a further eyelet end.

FIG. 39 illustrates a further perspective view 3900 of the CPS 3302 of FIG. 37. It will be appreciated that FIG. 13 shows the CPS from the so-called bottom side 3364 of the rigid support body 3304. As shown in FIG. 39, two retaining arms 33821, 33822 are connected to the rigid support body 3304 arranged on diametrically opposite sides of the rigid support body 3304. It will be appreciated that each retaining arm 33821, 33822 is associated with a respective latch arm 3392.

FIG. 40A illustrates a still further perspective view 4000 of the CPS 3302 of FIGS. 33 to 39. FIG. 40 illustrates the through bore 4004 extending through the bend stiffener 3320. It will be appreciated that the through bore 4004 extends through the whole CPS. It will be understood that the perspective view in FIG. 40 illustrates the retaining arms 338₂ in the storage position 3508. FIG. 14 additionally illustrates the recess 3512 in the wall abutment surface 350404 of the outer sleeve 3352 in more detail.

FIG. 40B illustrates the perspective view 4000 if the CPS 3302 of FIG. 40A however the retaining arms are arranged in an intermediate position 4020. In the intermediate position 4020 of FIG. 40B the connector is located towards the first end of the elongate slot eyelet. FIG. 40B also illustrates that the pair of retaining arms 33821, 33822 are disposed in a spaced apart relationship on opposed sides of the rigid support body 3304. It will be appreciated that each retaining arm 33821, 33822 is connected to the support body 3304 via a respective connector 3384. It will be appreciated that each connector 3384 may include a bearing and shaft to allow the retaining arm 338₂ to swivel with respect to the rigid support body 3304. In such an arrangement, either the bearing or shaft can be connected to a respective retaining arm and a remainder of the bearing or shaft can be connected to the rigid support body. It will be appreciated that a pair of latch arms are also included in the CPS of FIG. 14, each of the latch arms being associated with a respective one of the pair of the retaining arms 33821, 33822. It will be understood that the pair of latch arms are disposed in a spaced apart relationship on opposed sides of the rigid support body 3304. In the position of FIG. 40B the connector is located at the first end of the slot eyelet.

FIG. 40C illustrates the perspective view 4000 if the CPS 702 of FIGS. 40A and 40B, however the retaining arms 33821, 33822 are arranged in a different intermediate position 4030 or a deployed position. In the position of FIG. 40C the connector 3384 is located towards the further end of the elongate slot eyelet.

FIG. 41 illustrates a cross-sectional view 4100 of the CPS 3302 of FIGS. 33 to 40. FIG. 41 shows that the through bore 4104 extends through the entire length of CPS. FIG. 41 additionally helps illustrate the non-uniform thickness of the tapered region of the bend stiffener 3320.

FIG. 42A illustrates the rigid support body 3304 of the CPS 3302 of FIGS. 33 to 41 in more detail. It will be appreciated that, aside from the connectors 3384 and retaining arms 338₂, FIG. 42A illustrates an isolated rigid support body. FIG. 42A illustrates the rigid support body 3304 when not connected to the bend stiffener 3320 or the pull in head adaptor 3324, and when not partially covered by the outer sleeve 3352. The rigid support body is a generally cylindrical and integrally formed unit. A through bore 4204 extends through the rigid support body 3304. It will be understood that a cable, or other flexible elongate member, can be threaded through the rigid support body. The outer surface of the rigid support body 4208 may abut against the inner surface of the aperture 3316 of a monopile wall 3312 in use. It will be appreciated that the outer surface 4208 of the rigid support body 3304 is generally cylindrical. The outer surface 4208 may therefore include a substantially resistant and/or robust material to help avoid damage to the rigid support body in use. Optionally the outer surface of the rigid support body may be coated/covered with a protective and/or water resistant/proof and/or corrosion resistant cladding/coating. As is illustrated in FIG. 42A, the outer cylindrical surface includes a dished out surface region 3514. It will be understood that each retaining element is connected via a respective connector at a respective dished out surface region. It will be understood that each dished out surface region 3516 includes a first dished out end region 4212 and a further dished out end region 4216. As is shown in FIG. 42A, the first dished out end region 4212 and the further dished out end region 4216 are disposed on opposed sides of a respective connector 3384 location. FIG. 42A also illustrates a respective non dished out region 4220 of the outer surface 4208 of the rigid support body proximate to the first and further dished out end regions. The non dished out region 4220 includes an abutment surface 3516. It will be understood that the abutment surface 3516 provides a stop to prevent swivelling motion of a respective retaining arm 338₂ beyond a preset place. As is illustrated in FIG. 42A, a pair of retaining arms 338₂ are disposed in respective substantially diametrically opposed side positions on the outer cylindrical surface 4208. It will be appreciated, but not shown in FIG. 42, that a further dished out portion 4216 is located on the reverse side of the rigid support body 3304 (facing substantially into the page in FIG. 42A). It will be appreciated that both retaining arms 338₂ may swivel together or may swivel independently of each other.

FIG. 42B illustrates an end on view of the rigid support body 3304 when the retaining arms 3382₁, 3382₂ are not disposed in the storage position. As shown in FIG. 42B. the rigid support body 3304 includes a through bore 4204 extending through the support body. In order to maintain the integrity of the support body in use, due to abutment with the monopile wall and corrosion etc, the tubular rigid support body 3304 must be of a minimum thickness. The thickness of the support body in FIG. 42B is 15 mm. Optionally the thickness of the support body may be 12 mm. Optionally the thickness of the support body is between 1 mm and 100 mm thickness. The support body has a bore 44204 diameter 200 mm. Optionally the bore 4204 diameter is between 100 and 500 mm. The bore diameter is tailored to the cable that is to be threaded through the support body. It with reference to FIGS. 33 to 41, it will be appreciated that the support body includes two dished out surface regions 3516 proximate to respective retaining arms. In order to maintain the required thickness of the support body, the bore 4204 narrows throughout the portion of the support body that includes the dished out surface regions 3516. Two inwardly extending wall regions 4240, each arranged at a respective dished out surface region 3516, therefore maintain the thickness of the support body throughout each dished out surface region of the rigid support body. FIG. 42B also helps to illustrate that each retaining arm 3382₁, 3382₂ includes two wall abutment surfaces 4244₁, 4244₂, 4248₁, 4248₂ that abut with an inner surface of the monopile wall when the retaining arm is arranged in a deployed position in use. FIG. 42B additionally helps to illustrate the position of the abutment elements that are abutment pins of each latch arm 3392.

FIG. 42C illustrates an end on view of the rigid support body 3302 of FIG. 42A when the retaining arms are disposed in a storage position. FIG. 42C helps illustrate the inwardly extending wall regions 4240 of the through bore. It will be appreciated that the inwardly extending wall regions 4240 are only present through the portion of the rigid support body that includes the dished out surface regions 4216 and therefore the inwardly extending wall portions 4240 do not extend throughout the whole length of the rigid support body.

FIG. 43A illustrates the retaining arm 338₂ of the CPS 702 of FIGS. 33 to 42 in more detail. FIG. 43A shows an isolated retaining arm 4300. The retaining arm 338₂ is an example of a retaining element. The retaining arm 338₂ includes an elongate retaining body 4204 which includes the elongate slot eyelet 3386. The elongate body 4204 is associated with a principal arm axis and arranged to swivel about the swivel region 4206 that includes the elongate slot eyelet 3386 on principal arm axis but offset from a centre point on the arm axis along a length of the retaining arm 338₂. It will be understood that the retaining arm swivels about the position of the connector in the slot eyelet at a given instance in time. It will be understood that the connector is axially slidable in the slot eyelet. It will be understood that the slot eyelet is able to receive an end of the connector to connect the swivel region to a rigid support body. The slot eyelet may include, or be associated with, a bearing to facilitate swivelling of the retaining arm about its position in the slot eyelet 3386 which is therefore an instantaneous swivel point. The slot eyelet 3386 may include a low-friction or frictionless inner surface to facilitate swivelling. As indicated, the slot eyelet 3384 is located proximate to the first end 3388 of the retaining arm 338₂. The retaining arm is formed from a metallic material. Optionally the retaining body may be manufactured from an alloy material. Optionally the retaining body may be made from any other suitable material. A coupling region 4308 is located at the further end 3390 of the retaining arm 338₂. The coupling region 4308 is coupled to a respective latch arm 3392 via a frangible connector 3398 when the retaining arm 338₂ is in the storage position 3399. The coupling region illustrated in FIG. 43A is a recess for receiving a pin. The retaining arm includes a wall abutment surface 3604 for abutting against an inner surface 3608 of a monopile wall 3312 when the retaining arm 338₂ is disposed in the deployed position 3612. Optionally the wall abutment surface 3604 wall abutment surface may be covered in a protective cladding for protecting the inner surface 3608 of a monopile wall 3312 in use. It will be appreciated that the first end 3388 and the further end 3390 of the retaining arm 338₂ are spaced apart across the elongate body 4304.

FIG. 43B illustrates a different perspective view 4340, that is a top-down view, of the retaining arm of FIG. 43A. As is illustrated in FIG. 43B, the retaining arm 338₂ includes a slot 3386 that is located a position along a primary axis associated with the retaining arm that is axially offset from a centre point of the retaining arm primary axis. That is to say that the slot is located more proximate to a first end of the retaining arm than a further end of the retaining arm. The retaining arm receives a connector 3384 that may include a shaft and/or bearing and/or spigot. With reference to FIGS. 33 to 36, it will be appreciated that in use, when the retaining arm is released from a storage position (by cracking a frangible part that is part of or associated with a latch arm, the latch arm being associated with the retaining arm), the offset positioning of the slot (and associated connector) enables the retaining arm to swivel from the storage position to an intermediate or deployed position. That is to say that, as the slot, which is an example of swivel region, is offset with respect to the centre of mass (and centre of gravity) of the retaining arm, a rotational force that is a restoring torque is exerted upon the retaining arm to swivel the retaining arm away from the storage position which, in the absence of a connection between the retaining arm and a respective latch arm, is a non-equilibrium position. The retaining arm illustrated in FIGS. 43A and 43B has a slot diameter of approximately 50 mm to receive a cylindrical connector spigot with a diameter also of approximately 50 mm. It will be understood that any other suitable dimensions of slot and cooperating connector could instead be utilised.

FIG. 43B also helps illustrate the position of two wall abutment regions 4344₁, 4344₂ of a wall abutment surface 4348 of the retaining arm. The wall abutment regions are axially located on either side of the portion of the retaining body that includes the slot. It will be appreciated that the wall abutment regions abut against an inner surface of the monopile wall in use when the retaining arm is located in a deployed position (illustrated in FIG. 36). Arrow A indicates a force incident on a first wall abutment region 4344₁ due to an abutting relationship with the inner surface of the monopile wall and Arrow B indicates a force incident on the further wall abutment region 4344₂ due to an abutting relationship with the inner surface of the monopile wall in use, and when the retaining arm is oriented in the deployed position (as illustrated in FIG. 36). It will be appreciated that the whole weight of the CPS may be distributed among any number of retaining arms utilised in the CPS that are in a deployed position. Alternatively, a winch may provide a tension that partially supports the CPS weight via a winching line connected to a cable where a covered part of the cable extends through the rigid support body of the CPS. Alternatively, a winching line may be connected to the CPS itself. It will therefore be appreciated that substantial load can be applied to the monopile wall via each wall abutment region of each retaining arm. With reference to Newton's third law of motion, the monopile wall thus exerts an identical but opposed force on each wall abutment region of the wall abutment surface of the retaining arm. It will be appreciated that the combined force exerted on the first and further wall abutment region is transferred to engaged surface regions 4252, 4254 of the slot and the connector (the spigot) which are most proximate to the wall abutment surface of the retaining arm. It will therefore be appreciated that the weight of the CPS may be supported by a number of connectors associated with each retaining arm situated in a deployed position. It will be appreciated that, in the CPS embodiment described herein, two retaining arms (the first a further retaining arms) are utilised and therefore the weight of the CPS is support by the first and further connectors that are associated with the respective first and further retaining arms. It will therefore be appreciated that a portion of the CPS weight (which may be around half of the CPS weight that is not further supported by other methods or devices or mechanisms) is supported by the connector shown in FIG. 42B when the retaining arm of FIG. 42B is oriented in a deployed position in use. The weight incident on the retaining arm in use is illustrated by arrow C.

It will be appreciated that, when compared with prior art retaining systems discussed with regard to technological background above, the load path from the location of abutting wall abutment regions of the retaining arm to the load supporting region of the connector is relatively short. Furthermore, due to the orientation of the retaining arms (that are able to swivel), the force exerted on the connector is directed substantially through the connector in a direction perpendicular to an axis associated with the connector, and is predominantly a shear force. That is to say, the degree to which rotational moments are applied to the connector are limited. Thus, the present arrangement and relatively short load path result in a more efficient retaining system which is less prone to failure than current prior art solutions. It will be appreciated that, utilising the two retaining arms described in the present CPS embodiment yields four wall abutment regions. The retaining arm arrangement is therefore a much more efficient use of material than prior art solutions, such as latch arm solutions discussed above. In fact, the retaining arm arrangement disclosed herein, which utilises two retaining arms, is 21 times more efficient than some currently adopted prior art solutions.

As discussed in the background section above, prior art CPS retaining solutions typically support the weight of the CPS at a particular point, or a particular number of points, for example a terminal end of a latch or a surface of a ball. These points are typically of limited surface area and therefore exhibit significant point loading on the inner surface of the monopile wall. It will be appreciated that higher contact stresses imparted on an inner surface of a monopile wall typically results in a higher rate of corrosion and therefore a reduced lifetime of an associated WTG. Such point loading of prior art approaches discussed above yields considerably higher contact stresses between retaining elements and the inner surface of the monopile wall. The beam loading of each (of the two) retaining arms utilised in the present CPS embodiment significantly reduces that contact stresses imparted on the monopile wall by distributing the weight of the CPS over four wall abutment regions (two on each retaining arm). It will be understood that at least some of these wall abutment regions may additionally have a larger surface area than abutment surfaces in prior art retaining elements thereby further decreasing stresses imparted on the monopile wall. Such an arrangement helps limit corrosion of the abutting regions of the monopile wall thereby helping to extend the lifetime of a WTG associated with the monopile. It will be appreciated that the high point loading of some prior art retaining solutions results in brinelling and other aberrant effects of abutment under load at the latch-monopile wall contact surfaces which increases the rate of corrosion.

Some prior art retaining solutions include a latch system which generates loading incident on a supporting point, which is often a pin proximate a terminal end of a latch, of around 1.5 times the force applied to the monopile wall by the abutment surface of the latch divided by the area of the latch abutment surface in contact with the monopile wall (Load=1.5×Force/Area). The present latch arm arrangement however, due to the geometry and relative dimensions of the latch arms illustrated in FIG. 43B, generates a load on the connector that is one fourteenth of the force applied to the monopile wall by the abutment surface regions of the arms divided by the area of the combined abutment regions of the arms in contact with the monopile wall ( 1/14×Force/Area). It will be appreciated that, when compared with prior art systems, the present retaining arrangement results in a considerable reduction of loading stresses.

For example, some retaining arms provide two areas of contact between the wall abutment surface of the retaining arm and an inner surface of the monopile wall, the areas of contact being arranged at the interface between the retaining arm and the monopile wall at either side of the swivel region. When the swivel region is offset axially with respect to the retaining arm (that is to say, not equidistant from each terminal end of the retaining arm) the effective areas of contact may be located at a distance of 2 L and L (L being an arbitrary distance) from the swivel region (taken along the wall abutment face of the retaining arm) respectively. The effective areas of contact may each be at a distance of 1.25 D and D (D being an arbitrary distance) from respective most proximate terminal ends of the wall abutment surface of the retaining arm. In a dual retaining arm system, in which a retaining arm is arranged on either side of a rigid support body is, there are 4 areas of contact between the retaining arms and the inner surface of the monopile wall (two areas of contact on each retaining arm). Thus, for an arbitrary force F (indicated by C in FIG. 43B) that is a load incident on each of the retaining arms due to the weight of the CPS system (and associated apparatus, for example the flexible elongate member) when the CPS is retained, by the arms, at a position at least partly through the aperture of the monopile wall, the resulting reaction forces at each of the effective areas of contact may be around R_{A}=F/3 (indicated by A in FIG. 43B) and R_{B}=⅔F (indicated by B in FIG. 43B) respectively. The shear area may be around 14A (A being an arbitrary area). A minimum shear stress incident on the connector located at the swivel region may be around F/14A. A maximum contact stress between the monopile wall and the retaining arm may be around 0.3 F/DW (where W is the width of the wall abutment surface of the retaining arm).

It can be shown that, for some prior art latch systems which utilise point loading in which all the force, F, associated with the retaining of a CPS in a monopile is incident at a single effective area of contact of the latch (in abutment with an inner surface of a monopile wall), the shear area may be around 2A. It can be shown that the minimum shear stress incident on a pin of the latch is around 3 F/2A. It can be shown that the minimum contact stress between the monopile wall and the latch is around 0.6 F/DW (where D is the length of the wall abutment surface of the latch and W is the width of the wall abutment surface of the latch). Thus, as indicated above, the load on a connector associated with a retaining arm is one fourteenth of the load associated on a pin of a prior art latch, and the use of a retaining arm system is 21 times more efficient than a prior art latch system.

It will be understood that, in the present CPS embodiment, the size of the connector is not as constrained by space within the CPS and/or monopile and therefore the connector can readily by enlarged to provide additional strength (resilience to the loading of the CPS) if necessary.

It will further be appreciated that the use of two retaining arms, arranged at substantially opposite sides of the rigid support body helps limit, reduce or avoid misalignment of the system in use. It will be understood that misalignment of prior art systems can result in aberrant increases in loading on retaining latches (and components associated with such latches such as supporting elements) and/or the inner surface of the monopile wall and can ultimately result in damage. Such misalignment includes rotational and axial misalignment of the rigid support body with respect to a desired angle of penetration of the rigid support body through the aperture in the monopile wall when the rigid support body is arranged in a predetermined position or a retained position. This is due to the symmetrical arrangement of he two retaining arms. It will be appreciated that, should the rigid support body be rotationally misaligned in the aperture (such that each retaining arm is not arrange on substantially horizontally opposed sides of the support body), the force on each retaining arm will not be evenly distributed. The retaining arms will additionally not be swivelled away from the storage position to the same degree. That is to say that, at a particular instance in time, one of the retaining arms will be swivelled further away from the position of the retaining arms when arranged in the storage position than the other arm. At least partly due to the uneven distribution of such forces, the arms generate a restoring torque which acts to equilibrate the forces incident on each of the arms. This restoring torque thus acts to reduce misalignment of the rigid support body. The restoring torque thus acts to urge the rigid support body towards the predetermined position and acts to urge the retaining arms towards the deployed position.

FIG. 43C illustrates a still further perspective view of the retaining arm of FIG. 43A. It will be appreciated that FIG. 43C illustrates a side-on view of the retaining arm. FIG. 43C helps illustrate the wall abutment regions of the wall abutment surface of the retaining arm. FIG. 43C also helps illustrate the geometry of the slot, a cross section of which is indicated by the dotted lines in FIG. 43C.

FIG. 43D illustrates another perspective view of the retaining arm of FIG. 43A. It will be appreciated that FIG. 43D illustrates an end-on view of the retaining arm.

FIG. 44 illustrates the latch arm 3392 of the CPS 3302 of FIGS. 33 to 42 in more detail. It will be appreciated that FIG. 44 illustrates a latch arm 3392 in isolation. The latch arm 3392 includes an elongate latch arm body 4404. The frangible connector 3396 is located at a first end 4408 of the latch arm 338₂. The frangible connector 3396 is optionally an includes an eyelet or a socket body 4420 for receiving an elongate pin and a narrowed region 4412 between the eyelet and the latch arm body 4404. Alternatively, the frangible connector may include an elongate pin for connection to a respective socket in a retaining arm. It will be understood that the narrowed region 4412 is designed to fracture/break when subjected to a predetermined threshold force before any of the other elements associated with the latch arm 3392 break. It will be appreciated that the latch arm 3392 may instead include a different frangible portion which can be connected to a retaining arm. Optionally a frangible portion is located within the body 4404 of the latch arm 3392 such that the latch arm is breakable at a predetermined position, or cracking point, of the latch arm 3392. The abutment element is located proximate to a further end 4416 of the latch arm 3392. The abutment element 3398 of FIG. 44 is a peg member that extends away from the latch arm 3392. It will be appreciated that the abutment element 3398 moves with the latch arm 3392. It will be appreciated that the abutment element 3398 may instead be a protrusion of different geometry, for example triangular or rectangular and the like, or may be a recess in the latch arm 3392 that engages with a protrusion associated with a monopile wall, or the wall of any other suitable facility. With reference to FIGS. 35 and 40, it will be appreciated that peg 3398 can be located in a cooperating (or accommodating) recess 3514 in an inner surface (the surface of the outer sleeve in contact with the support body) of an outer sleeve 3352 coupled to the rigid support body 3304.

It will be appreciated that, when slidably disposed in a recess 3396 of a rigid support body 3304 (or coupled to the rigid support body) and in use during a pull-in process of the like in which the rigid support body 3304 is urged into a monopile 3308 via an aperture 3316 in a monopile wall 3312, the peg 3398, (which moves with the latch arm) abuts against the outer surface of the monopile wall 3312. It will be understood that, as the support body is urged into the monopile, due to the abutting relationship between the monopile wall 3312 and the peg 3398, an abutment force acts on the peg 3398 acting away from the wall 3312. It will be understood that the abutment force in generated in response to the peg 3398 abutting an outer surface of the wall 3312 of the monopile 3308 proximate to the aperture 3316 as a portion of the rigid support body 3304 is urged through the aperture 3316. When the abutment force overcomes a predetermined threshold force, which is a cracking force required to crack the frangible connector 3398 and can therefore be specified in manufacture of the latch arm 3392, the frangible connector 3398 is cracked. That is to say that the frangible connector breaks responsive to the abutment force. Following the cracking of the frangible connector 3398, it will be understood that the latch arm 3392 slides in the first direction of motion due to the abutment of the monopile wall 3316 against the abutment peg 3398. It will therefore be appreciated that, when the abutment force exceeds the predetermined threshold force, sliding of the latch arm 3392, and swivelling of the retaining arms 338₂ from a storage position to a deployed or intermediate position is permitted. It will be appreciated that when the latch arm 3392 is connected to a respective retaining arm 338₂ via the frangible connector 3398, which prevents slidable motion of the latch arm 3392 in the recess of the rigid support body 3304, the latch arm 3392 prevents swivelling of the respective retaining arm 338₂ from a storage position to an intermediate or deployed position.

It will be appreciated that the abutment element of FIG. 44 is generally cylindrical. Optionally the abutment element may be any other shape. The abutment element may be a peg member. It will be appreciated that, in use, a cylindrical abutment element engages and abuts against an outer surface of a monopile wall at a consistent set-off distance and therefore offers some control over the position of the CPS relative to the monopile wall and associated aperture when the abutment element is expected to engage with the monopile wall. The generally cylindrical arrangement of the abutment element helps ensure consistent engagement between the monopile wall and abutment element as the abutment element will generally always engage the monopile wall at a curved outer surface of the generally cylindrical body of the abutment element.

It will be appreciated that an elongate pin member may instead constitute a frangible portion of the latch arm of FIG. 44. The elongate pin may be arranged to extend through a through-hole located at and end of the latch arm distal to the abutment element. The elongate pin may be polymeric or wooden or the like. The elongate pin may be substantially brittle and thus may completely shear when a sufficient force is applied to the pin. It will be appreciated that the pin may shear when a shearing force/cracking force of around 3000 N is incident on the pin. It will be appreciated that the pin may shear when a shearing/cracking force of between 2000 N and 10000 N is incident on the pin. It will be appreciated that the shearing force required to shear the pin may be relatively similar when the pin is dry and when the pin is wet. It will be appreciated that the pin may shear under a well-defined shearing/cracking force which corresponds or is related to a predetermined threshold force which may be generated by applying a tension to a winching line to pull the CPS into an aperture of a wall of a monopile such that an abutment element of the latch arm abuts against an outer surface of the monopile wall to transfer force to the pin. It will be appreciated that the pin may shear across a thinnest diameter of the pin, the axis of shearing aptly being around 90 degrees to the primary axis of the pin.

FIG. 45 illustrates another example of a latch arm 1900 for use in the CPS of FIGS. 7 to 17. The latch arm 1900 includes an elongate latch arm body 1904. A frangible connector 1908 is located at a first end 1912 of the latch arm 1900. The frangible connector 1908 includes an eyelet 1916 for receiving a pin and a narrowed region 1920 between the eyelet 1916 and the latch arm body 1904. It will be understood that the narrowed region 1920 is designed to fracture/break when subjected to a predetermined threshold force before any of the other elements associated with the latch arm 1900 break. The abutment element 1922 is located at a further end 1924 of the latch arm 792. The abutment element 1922 is a protruding wedge located at the terminus of the further end 1924 of the latch arm 1900. The abutment element 1922 includes an abutment face 1928 for abutting against monopile wall in use.

It will be understood that the abutment face 1926 of the wedge is oblique to a primary axis of the latch arm which at least partly cooperates with the outer surface of a monopile wall against which the abutment face abuts. For example, the abutment face at least partly cooperates with a curved outer surface of a monopile wall. It would be understood that the oblique abutment surface helps ensure that the abutment element abuts with the outer surface of the monopile wall at a desired orientation. It will be appreciated that the oblique abutment face, that is substantially flat defines a particular surface area of contact between the outer surface of the monopile wall and the abutment element. Thus, the oblique abutment face, which is at least partly complimentary to an outer surface of a monopile wall provides a greater control of the pulling force on the elongate flexible member (and thus on the CPS respectively) required to achieve a predetermined threshold force and crack (that is, to shear or completely break) the frangible portion of the latch arm. It will be appreciated that this is due to the fact that a reasonable estimation can be made as to the area of the abutment element and monopile wall that are in contact when the oblique surface of the abutment element abuts against the monopile wall. As indicated previously, the pulling force and predetermined threshold force could be measured in Newtons (N).

Aptly the latch arm is disposed to break at the frangible portion when exposed to a force of between 2000 and 10000 N, aptly around 3000 N.

It will be appreciated that an elongate pin member may instead constitute a frangible portion of the latch arm of FIG. 45. The elongate pin may be arranged to extend through a through-hole located at and end of the latch arm distal to the abutment element. The elongate pin may be polymeric or wooden or the like. The elongate pin may be substantially brittle and thus may completely shear when a sufficient force is applied to the pin. It will be appreciated that the pin may shear when a shearing force/cracking force of around 3000 N is incident on the pin. It will be appreciated that the pin may shear when a shearing/cracking force of between 2000 N and 10000 N is incident on the pin. It will be appreciated that the shearing force required to shear the pin may be relatively similar when the pin is dry and when the pin is wet. It will be appreciated that the pin may shear under a well-defined shearing/cracking force which corresponds or is related to a predetermined threshold force which may be generated by applying a tension to a winching line to pull the CPS into an aperture of a wall of a monopile such that an abutment element of the latch arm abuts against an outer surface of the monopile wall to transfer force to the pin. It will be appreciated that the pin may shear across a thinnest diameter of the pin, the axis of shearing aptly being around 90 degrees to the primary axis of the pin.

FIG. 46 illustrates a CPS 4602, for locating a flexible elongate member at a predetermined location with respect to a monopile wall through which an aperture is provided, in a first position 4600. It will be understood that the first position 4600 of the CPS 4602 may be prior to installation of the CPS system in a WTG. In the first position 4600, all of the rigid support body 4604 of the CPS 4602 is located outside of a monopile 4608, that is to say none of a rigid support body is located in a space enclosed by a wall 4612 of the monopile 4608, or within an aperture 4616 extending through the wall 4612. The first position 4600 is therefore a first position of the rigid support body 4604. It will be appreciated that, when a cable of other flexible elongate member is threaded through a through bore of the CPS, the installation of the CPS from the first position 4600 may be achieved via the winching process described in FIGS. 5 and 6. Although a monopile or WTG is specifically referred to here, it will be understood that the system could be utilised in any suitable structure or facility that includes a wall with an aperture extending therethrough and an internal cavity. The WTG is an example of a facility, the monopile being a part of the WTG.

As is illustrated in FIG. 46, the cable protection system includes a rigid support body 4604 arranged between a progressive stiffener 4620 (or bend stiffener) and a pull-in head adaptor 4624. The rigid support body 4604 is elongate and is substantially tubular and includes a cylindrical through bore. The cylindrical through bore (not shown in FIG. 46) extends through a whole length of the rigid support body. That is to say the rigid support body includes a through-bore that extends through the support body from a first end of the support body to a further end and through which a flexible elongate member is locatable. The rigid support 4604 body is formed from a metallic material. For example, a corrosion resistant alloy and the like may be used. The rigid support body 4604 may optionally be formed from a polymeric material or a reinforced polymeric material. The rigid support body 4604 may optionally be made from a composite material. The rigid support body 4604 may optionally be manufactured from a ceramic material. The bend stiffener 4620 is also an elongate body that surrounds a substantially cylindrical through bore. As is illustrated in FIG. 46, the bend stiffener 4620 includes a tapered portion 4628 including a tapered outer surface. It will be appreciated that the through bore of the tapered portion 4628 is substantially cylindrical and is therefore not itself tapered. The thickness of the tapered portion 4628 therefore varies along its length from a flared-out end 4634 arranged to be close to the rigid support body 4604 to a narrow end 4638 distal to the rigid support body 4604. The varying thickness of the tapered portion 4628 provides a non-uniform stiffness of the bend stiffener 4620 along its length. It will be appreciated that, when an elongate flexible member, such as a cable or the like, is arranged radially within the bend stiffener 4620, a flexibility of the elongate member is constrained at the flared-out end 4634 of the tapered portion and is relatively unconstrained at the narrow end 4638 of the tapered portion 4628. This tapered portion 4628 helps prevent a flexible elongate element, such as a cable, from exceeding a predetermined minimum bend radius that may be detrimental to the elongate element. The bend stiffener 4620 may also help reduce chafing, or other destructive frictional effects, at the interface between the elongate element and the rigid support body 4604. The bend stiffener 4620 additionally includes a substantially annular portion 4640 coupled to the flared-out end 4634 of the tapered portion 4628. A remaining end of the substantially annular portion is coupled to a first end 4642 of the rigid support body 4604. The coupling between the substantially annular portion 4640 of the bend stiffener 4620 and the first end 4642 of the rigid support body 4604 may be provided by conventional securing methods such as bolting of screwing of the like. The progressive stiffener is thus secured to the first end of the rigid support body.

A further end of the rigid support body 4604 is connected to the pull-in head adaptor 4624. The further end of the rigid support body is therefore secured to the pull-in head adaptor. It will be appreciated that the pull in head adaptor can house and can releasably engage with a pull-in head during a support body pull in operation. When engaged within the pull in head adaptor, the CPS system moves with the cable. Therefore, by pulling the cable into the monopile via the aperture by winching, the rigid support body is also pulled through the aperture.

As illustrated in FIG. 46, a region of the rigid support body 4604 proximate to the further end 4648 of the rigid support body is covered by an outer sleeve 4652. The outer sleeve 4652 is therefore located at a position distal to the first end 4634 of the rigid support body 4604. The outer sleeve 4652 shown is manufactured from a polymeric material. The outer sleeve 4652 may optionally comprise a polymeric material. The outer sleeve 4652 may optionally comprise a reinforced polymeric material. The outer sleeve 4652 may optionally comprise a composite material. As is illustrated in FIG. 46, the outer sleeve 4652 is arranged to radially surround a portion of the rigid support body 4604 and is substantially tubular. A first end of the outer sleeve 4656, most proximate to the first end 4634 of the rigid support body 4604 is angled such that an axis associated with a face 4655 of the first end 4656 of the outer sleeve 4652 is oblique to a primary axis of the outer sleeve 4652 (and the rigid support body 4604). It will therefore be appreciated that the outer sleeve 4652 extends further over the rigid support body 4604 on a top side 4660 of the rigid support body than the bottom side 4664 of the rigid support body 4604, the top 4660 and bottom 4664 sides of the rigid support body 4604 being on opposite substantially opposite sides of the rigid support body. It will be understood that the top and bottom sides of the rigid support body are simply relative terms, and that rigid support body may be arranged in any orientation, the top side 4660 of the rigid support body possibly being located on an upper surface of the rigid support body and the bottom side 4664 of the rigid support body optionally being located on a lower surface of the rigid support body 4604.

A further adaptor 4672 is connected to a remaining end of the pull-in head adaptor 4624 (the end of the pull-in head adaptor 4624 that connects the pull-in head adaptor to a bend restrictor element 4676. It will be understood that the bend restrictor element 4676 is part of a bend restrictor 4677 which includes multiple bend restrictor elements 4676. Three bend restrictor elements 4676 are shown in the bend restrictor 4677 of FIG. 46. It will be understood that any number of bend restrictor elements 4676 may be included in the bend restrictor 4677. The further adaptor 4672 may be connected to the pull-in head adaptor via suitable securing mechanisms such as screwing and/or bolting and the like. The further adaptor 4672 may be connected to a bend restrictor element 4676 by securing mechanisms such as screwing and/or bolting and the like. Alternatively, a bend restrictor element 4676 may be a part of the further adaptor 4672, that is to say a bend restrictor element 4676 may be arranged at a terminal end of the adaptor 4672, the bend restrictor element and the further adaptor being integrally formed. As shown in FIG. 46, the multiple bend restrictor elements 4676 are arranged in series and connected in an end-to-end configuration. It will be understood that the bend restrictor 4677 defines an end portion of the CPS 4602 which extends into the surrounding environment 4680 and away from the monopile wall 4612. The bend restrictor elements 4676 forming the bend restrictor 4677 limit the flexibility of a portion of an elongate member arranged within each of the bend restrictor elements 4676.

FIG. 46 also illustrates a retaining arm which is connected to the rigid support body 4604 via a respective connector 4684. It will be appreciated that, although only one retaining arm is shown in FIG. 46 the rigid support body 4604 also includes another retaining arm on a diametrically opposite surface of the rigid support body 4604 (the surface extending into the page). It will be understood that, although the CPS of FIG. 46 includes two retaining arms 4682, any suitable number of retaining arms 4682 may be utilised, the retaining arms 4682 optionally being arranged at any suitable position along the rigid support body 4604. It will be understood that the retaining arm 4682 is an example of a retaining element and any suitable shape or configuration of retaining element can instead be utilised. Each of the retaining arms 4682 are connected to the rigid support body 4604 via a respective connector 4684. That is to say a different connector 4684 connects each retaining arm 4682 to the rigid support body 4604. It will be appreciated that each retaining arm 4682 is on a respective side of the rigid support body 4604 that between, and is substantially equidistant from, the top 4660 and bottom 4664 sides of the rigid support body 4604. It will be appreciated that so-called side of the rigid support body refer to a regions of the cylindrical surface of the support body which extend a respective maximum and minimum distance in an x-axis and y-axis of an imaginary plane that is perpendicular to the primary axis of the rigid support body. Each retaining arm 4682 is connected to the rigid support body 4604, via the respective connectors 4684, at a position of the rigid support body 4604 more proximate to the first end 4642 of the rigid support body than the further end 4648 of the rigid support body 4604. The retaining arms 4682 include an elongate retaining body which comprises a through hole 4686 extending through the retaining body in a direction perpendicular to the primary axis of the retaining element to receive an end of a respective connector 4684. As illustrated in FIG. 46, the through hole 4686 is offset from a centre point of the retaining arm 4682 and is therefore located proximate to a first end 4688 of the retaining element 4682. A remaining end of each connector 4684 is connected to the rigid support body. It will be understood that the connector may include a shaft. It will be appreciated that the connector may include a bearing to permit swivelling of the retaining arm 4682 with respect of the rigid support body 4604. The through hole 4686 may optionally include a bearing. The retaining arms 4682 are therefore disposed to swivel about the connector 4684, an end of which is located in the through hole 4686 of the body of the retaining arm 4682. It will be appreciated that the swivelling motion of each retaining arm 4682 is rotational motion centred around the through hole 4686 and connector 4684. The through hole 4686 of the body of each retaining arm 4682 therefore constitutes a swivel region that is optionally a swivel point. That is to say that swivelling of the retaining arm 4682, includes the partial spinning of the retaining arm about a particular point that is the swivel point.

A further end 4690 of each retaining arm 4682 is connected to a respective latch 4692 arm located in an elongate recess 4694 on the outer surface of the rigid support body 4604. The connection between the latch arm is facilitated by a frangible connector 4696. The frangible connector 4696 is an example of a frangible portion of the latch arm 4692. Optionally the frangible portion may be located at any suitable position of the latch arm 4692. Optionally the frangible portion may be a separate element and is not a part of the latch arm 4692. Optionally the frangible portion may be integrally formed with the latch arm 4692. It will be understood that the frangible connector is releasably connected to the further end of the retaining arm. The latch arm 4692 further includes an abutment pin 4698 extending out from an outer surface of the latch arm 4692. The abutment pin 4698 may optionally be a part of, or integrally formed with, the latch arm 4692. The abutment pin 798 may optionally be a separate element, and not a part of the latch arm 4692. The abutment pin 4698 is an example of an abutment element. It will be appreciated that FIG. 46 illustrates the retaining arm 4682, when connected to the latch arm 4692 arranged in a storage position 4699. It will be appreciated that the latch arm 4692, which is associated with the rigid support body 4604 being coupled to the rigid support body by being slidably located in the elongate recess/channel 4694, is disposed to prevent the retaining arm 4682 from swivelling away from the storage position 4699. The connection between the further end 4690 of the retaining arm 4682 and the latch arm 4692 via the frangible connection/connector 4696 therefore prevents the retaining arm 4682 from being disposed in a position that is not the storage position 4699. As is illustrated in FIG. 7, in the storage position 4699, the retaining arm 4682 is oriented such that a primary axis of the retaining body is parallel with, or substantially parallel with, a primary axis of the rigid support body 4604. It will be appreciated that any other retaining arms of the CPS of FIG. 46 will be disposed in a similar storage position.

FIG. 47 illustrates the CPS 4602 of FIG. 46 during installation 4700 where the rigid support body 4602 is partially passed through the aperture 4612 of the monopile wall 4612. It will be understood that installation may include the winching process described in FIGS. 4 and 5. This may be a part of a pull in process in which cable or another flexible elongate member is pulled into the monopile. It will be understood that the CPS 4602 has been pulled, from the first position 4600 illustrated in FIG. 46, towards the monopile such that the rigid support body 4604 intrudes into the aperture 4616 of the wall 4612 of the monopile 4608. As is illustrated in FIG. 47, the bend stiffener 4620 is located within the inner region/cavity 4704 of the monopile 4608. FIG. 47 illustrates that the first end 4642 of the rigid support body 4604 is located in an inner region/cavity 4704 of the monopile 4608. The further end 4648 of the rigid support body 4604 is located outside of the of monopile 4608 in an outer region associated with the monopile 4608 which is in the environment 4680. The outer sleeve 4652 is also located outside of the monopile 4608 in the environment 4680. As shown in FIG. 47, a portion of the rigid support body 4604 is located within the aperture 4616 in the monopile wall 4612. The retaining arms 4682 are disposed in the storage position 4699 as discussed in relation to FIG. 46. It will therefore be understood that the further end 4690 of the storage arms are therefore connected to respective latch arms 4692 via respective frangible connectors 4696. As shown in FIG. 47, the storage position 4699 of the arms 4682 allows for the rigid support body 4604 to at least partially pass through the aperture 4616. That is to say that the orientation of the storage position 4699 does not prevent the rigid support body 4604 and the retaining arms 4682 from entering into the inner region 4704 of the monopile 4608 via the aperture 4616. That is to say in the storage position the support body is locatable through an aperture in a wall of a monopile from a first position outside the monopile to a further position (such as the positions illustrated in FIG. 48 and FIG. 49A, described below) in which at least a portion of the support body is within the monopile. In the position illustrated in FIG. 47, the abutment element 4698 abuts against the monopile wall 4612 proximate the aperture 4616.

FIG. 48 illustrates the CPS 4602 of FIG. 46 or FIG. 47 in a further position 4800 during installation through an aperture in a wall of an offshore structure. As shown in FIG. 48 in the further position the rigid support body 4604 has been pulled further into the inner region 4704 of the monopile 4608, through the aperture 4616 of the monopile wall 4612 relative to the position illustrated ion FIG. 47. It will be appreciated that the rigid support body has been urged further into the monopile via the aperture. It will be therefore understood that in the further position 4700, a portion of the rigid support body 4604 is located within the monopile 4608. As is illustrated, in the further position 4800, the first end 4656 of the outer sleeve 4652 abuts against an outer surface 4802 of the monopile wall 4612 proximate the aperture 4616. The surface of the outer sleeve 4652 at the first end 4656 is therefore an end region that is a wall abutment surface 4804. It will be appreciated that a diameter of the outer sleeve 4652 is wider than a diameter of the rigid support body 4604. The diameter of the outer sleeve member 4652 is designed such that it is wider than a diameter of the aperture 4616 in the monopile wall 4612. It will therefore be appreciated that the abutting relationship between the wall abutment surface 4804 of the outer sleeve 4652 prevents the rigid support body 4604, and the CPS, from being pulled any further into the monopile 4608. In this sense, due to the position of the first end 4656 of the outer sleeve 4652 the further position 4800 of the rigid support body 4604 is a position at a maximum displacement towards, and into, the monopile 4608 through the aperture 4616. It will be appreciated that the aperture 4616 may be designed to receive the rigid support body 4604 at an angle that is oblique to the primary axis associated with the monopile wall 4612. Optionally this angle is around 45 degrees. As indicated with respect to FIG. 46, the first end 4656, and thus the wall abutment surface 4656, of the outer sleeve 4652 extends in an axis that is oblique to the primary axis associated with the rigid support body 4604. The oblique angle of the wall abutment surface 4804 is complimentary with the aperture 4616 such that abutment between the wall abutment surface 4804 and the outer surface of the wall 4802 occurs at a desired angle. Optionally this angle is around 45 degrees. Optionally the oblique angle of the wall abutment surface 4804 is around 45 degrees with respect to the primary axis associated with the rigid support body 4604.

As shown in FIG. 48, in the further position 4800 of the rigid support body 4604, the retaining arm 4682 is no longer oriented in the storage position 4699. The retaining arm 4682 is instead disposed in an intermediate position 4808. It will be understood that the retaining arm 4682 has rotatably swivelled from the storage position to the intermediate position 4808. As discussed with regard to FIG. 46, it will be appreciated that swivelling of the retaining arm includes at least partially rotating or spinning the retaining arm about a swivel region that is a swivel point. The swivel point includes a through bore into which a respective connector can intrude. It will be appreciated that, for the retaining arm 4682 to be able to rotate to the intermediate position 4808. the retaining arm 4682 and the latch arm 4692. As the retaining element 4698 associated with the latch arm 4682 was in an abutting relationship with the outer surface 4802 of the wall in FIG. 48, as the rigid support body 4604 is urged further into the aperture 4616 an abutment force is provided on the abutment element 4698 due to the contact between the abutment element 4698 and the outer surface 4802. It will be understood that the abutment force increases as a force pulling the rigid support body 4604 into the monopile 4608, such as a tension due to a winching operation and the like, increases.

When the abutment force exceeds a threshold force, the frangible connection 4696 between the further end 4690 of the retaining arm 4682 and the latch arm 4692 breaks due to the frangible connector 4696 and the abutment element 4698 being connected by the latch arm 4692. It will be understood that the frangible connector 4696 may include a pin and eyelet arrangement. Alternatively, the frangible connection may include a juxtaposition of materials with varying mechanical properties to promote fracture of the material at a particular point and under a particular force. Alternatively, the frangible connection 4696 may include a geometrically varied region, for example a region of reduced thickness/width. It will be understood that a particular cracking force required to be exerted on the frangible connection 4696 for the frangible connection 4696 to break can be specified in manufacture and therefore the threshold force may be a predetermined threshold force. Following disconnection of the latch arm 4692 and the retaining arm 4682, the latch arm is free to axially slide in the channel/recess 4694 of the rigid support body 4604 and is pushed towards the further end 4648 of the rigid support body and under the outer sleeve 4652 due to the abutment between the abutment element 4698 and the outer surface 4802 of the monopile wall 4612. It will be understood that the latch arm 4692 is slidable along an axis of sliding with respect to the support body 4604, the latch arm 4692 being slidably disposed in an elongate recess 4694 in an outer surface of the support body 4604. It will be understood that the axis of sliding extends in a direction that is substantially parallel with, but spaced apart from, a primary axis associated with the central through-bore that extends through the rigid support body 4604. It will also be understood that the latch arm 4692 slides in a first direction of motion away from a retaining arm 4682 supported on the rigid support body 4604 when the rigid support body 4604 passes through the aperture to thereby release the retaining arm from a storage position 4699 when the retaining element 4682 is within the monopile. The abutment element 4698 intrudes into a recess 4812 in the wall abutment surface 4804 of the outer sleeve 4652 to permit the wall abutment surface 4804 to abut against the outer surface 4802 of the monopile wall 4612. It will be appreciated that the threshold force could be measured in Newtons (N). It will be understood that the cracking force could be measured in Newtons (N). It will be understood that the cracking force could be measured by applying known force to the frangible connection, optionally via the abutment element, until the frangible connection breaks. It will be appreciated that the threshold force could be measured by applying known force to the frangible connection, optionally via the abutment element, until the frangible connection breaks. It will be appreciated that the cracking force may be a shear force. It will be appreciated that the frangible connection may shear at the shear force. It will be appreciated that the cracking force may be a break-free force which may correspond or be proportional to a break free tension applied to a winching line to pull the CPS into the monopile and release a retaining arm from a storage position. It will be appreciated that breaking the frangible connection may include a compete shear of a part of the frangible connection that is a complete break of a part of the frangible connection resulting in a complete separation of a respective retaining arm and latch arm. It will be appreciated that the frangible connection may be brittle and shears at around a shear force. It will be appreciated that the frangible connection may be substantially brittle and is substantially resistant to deformation, distorting, elongation, bending and the like.

As indicated in the above paragraph, following disconnection of the retaining arm 4682 and the latch arm 4692, the retaining arm is free to rotatably swivel from the storage position 4699 to the intermediate position. In the intermediate position, the primary axis associated with the retaining arm 4682 is oblique to the primary axis associated with the rigid support body 4604. The primary axis associated with the retaining arm is optionally substantially parallel to the primary axis associated with the monopile wall 4612. Due to the through hole 4686 of the retaining arm 4682 in which the connector 4684 is arranged being arranged offset to a centre point of the retaining arm, most proximate to the first end 4688 of the retaining arm 4682, the retaining arm swivels from the storage position 4699 to the intermediate position 4808 due to gravity. It will be understood that the retaining arm 4682 may be biased towards the intermediate position by one of more biasing elements such as a spring. As shown in FIG. 48, the retaining arm 4682 is arranged in a dished out region 4816 of the rigid support body 4604. An adjacent non-dished out portion 4820 provides an abutment surface 4824 that stops the retaining arm 4682 from swivelling beyond a predetermined position, the predetermined position being the intermediate position 4808.

FIG. 49A illustrates the CPS of FIGS. 46, 47 and 48 in another intermediate position 4900. In the intermediate position of FIG. 49, the rigid support body 4604 is arranged further towards the outer region associated with the monopile 4608, or the environment 4680, when compared with the further position of the rigid support 4604 illustrated in FIG. 48. This may be achieved, for example, by relaxing or reducing a tension associated with a winching line via a winch that is coupled to, and providing a tension on, a cable arranged through the CPS. As is illustrated in FIG. 49A a first abutment surface 4904 of the retaining arm 4682 is arranged in an abutting relationship with an inner surface 4908 of the monopile wall 4612 proximate the aperture 4616. The first abutment surface 4904 of the retaining arm 4682 therefore constitutes a wall abutment surface of the retaining arm 4682. The retaining arm 4682, disposed in an abutting relationship with the inner monopile surface 4908 therefore retains the rigid support body 4604 at a retained, where a portion of the rigid support body 4604 is within the monopile 4608. That is to say the retaining arm 4682, disposed in an abutting relationship with the inner surface 4908 of the monopile 4608 prevents the rigid support body from returning to its first position 4600 where all of the rigid support body is located outside of the monopile and in the environment 4680. The wall abutment surface of the retaining arm is therefore disposed to abut against the inner surface of the wall of the monopile proximate to the aperture in the wall of the monopile. It will therefore be understood that in the position illustrated in FIG. 49A, the retaining arm is disposed in an intermediate position 4912 where the retaining arm prevents the support body passing fully through the aperture from towards the first position of FIG. 46, and to locate the rigid support body at a retained position with respect to the aperture.

It also be appreciated that the connector 4686 selectively allows the retaining arm 4682 to swivel from a storage position 4699 to the position illustrated in FIG. 49A 4912, for example on a shaft of the connector 4686. The position illustrated in FIG. 49A 4912 of the retaining arm 4682 is thus an equilibrium position in which a region of a respective retaining arm abuts a region of an inner surface of the wall and an angle of swivel of respective retaining arms 4682 is determined responsive to a reaction between the wall and at least a mass of a cable extending through the rigid support body 4602 and the support body 4602 itself. It will be appreciated that the CPS 4602 including the rigid support body 4604 with associated retaining arms 4682 (connected via respective connectors 4684) is an example of apparatus for locating a rigid support body at a retained or predetermined location with respect to an aperture in a wall of a facility, such as a WTG. The position illustrated in FIG. 49A however is a retained position.

FIG. 49B illustrates the position of the CPS 4602 of FIG. 49A in cross section. As is shown in FIG. 49B, the outer sleeve 4652 is arranged towards the further end of the rigid support body and radially surrounds a section of the rigid support body proximate to the further end of the rigid support body. As shown in FIG. 49B, an inner sleeve 4904 is also arranged radially around the rigid support body at the further end of the rigid support body. The inner sleeve includes a flared out inner sleeve base part 4908 most proximate to the further end of the rigid support body. The base part 4908 is substantially rectangular in cross section and is not covered by the outer sleeve 4652. The inner sleeve 4904 also includes an inner sleeve tapered part 4912 extending from the base part 4908 towards the first end of the rigid support body and includes a tapered outer surface 4916. As shown in FIG. 49B, due to the tapered outer surface 4916, the inner sleeve gets thinner towards the first end of the rigid support body. That is to say that the tapered part 4912 of the inner sleeve 4916 flares out towards the base part 4908 and towards the further end of the rigid support body. The inner sleeve 4904 is made of a polymeric material. Optionally the inner sleeve is formed a metallic material, for example an alloy material. Optionally the inner sleeve is part of the rigid support body and optionally is integrally formed with the rigid support body. It will be understood that the inner sleeve 4904 moves with the rigid support body. That is to say that the inner sleeve does not move relative to the rigid support body. The terminal end of the inner sleeve 4904 at the inner sleeve base part 4908 has a face 4920 that is flat and lies in a plane perpendicular to the primary axis of the rigid support body 4604.

A terminal end 4932 of the outer sleeve 4652 proximate to the further end 4648 of the support body 4602 abuts against, or at least contacts, the base 4908 part of the inner sleeve 4904. The base part 4908 of the inner sleeve therefore provides a stop such that the outer sleeve 4652 cannot axially slide further towards the further end 4642 of the support body 4604. An inner surface 4936 of the outer sleeve member 4652 includes a tapered part 4942 of the outer sleeve member. As shown in FIG. 49B the tapered part 4942 of the outer sleeve is complimentary with the tapered part 4912 of the inner sleeve 4908. That is to say that the tapered region 4942 of the outer sleeve 4652 flares out in an opposite direction to the tapered region 4912 of the inner sleeve 4904. The tapered part of the outer sleeve therefore flares out towards the first end of the rigid support body and a thickness of the outer sleeve narrows towards the further end of the support body along the tapered part. It will be understood that at least part of the tapered part of the outer sleeve radially faces, and is radially adjacent to, the tapered part of the inner sleeve. The tapered parts of the inner and outer sleeves are separated by a gap that is an expansion region 4956. It will therefore be understood that the respective tapered parts of the inner and outer sleeves flare out smoothly in a substantially parallel spaced apart relationship inclined with respect to a primary axis associated with a through-bore of the rigid support body 4602. A swellable sleeve 4960 is located in the expansion region 4952 between the inner and outer sleeve. It will be appreciated that the swellable sleeve 4960 is an example of a swellable member. The swellable sleeve 4960 is formed from hydrophilic material. It will however be understood that the swellable sleeve may be formed from any material that can swell or expand when exposed to water (which may be seawater, freshwater or brackish water for example). It will be appreciated that the tapered parts of the outer and inner sleeve flare out towards respective exterior facing end regions associated with the rigid support body. It will be appreciated that in the position shown in FIG. 49B, there is a gap a gap 4980 present between the first end of the outer sleeve and the monopile wall 4612.

It will be appreciated that the base portion is integrally formed with the rigid support body, is associated with the further drive surface and is located at a first terminal end of the further drive surface. Aptly the base portion may be a separate component, not being integrally formed with the support body. The base portion includes a radially extending flange region. Optionally, a lip portion is associated with the further drive surface and is located at a further terminal end of the further drive surface of the inner sleeve. The lip portion may include a flared-out region and may be integrally formed with the rigid support body. It will be appreciated that the swellable sleeve, which is a swellable material when in a non-swollen state is confined between the flared-out region of the lip portion and the flange region of the base portion.

It will be appreciated that the further drive surface includes a radially outwards facing surface portion of an outer surface of the rigid support body.

Optionally, it will be appreciated that further drive surface of the inner sleeve may be substantially flat in cross section view (generally cylindrical), not including a tapered surface. Optionally it will be appreciated that the first drive surface of the outer sleeve may be substantially flat in cross section view (generally cylindrical, not including a tapered surface. Optionally it will be appreciated that the swellable sleeve. Optionally it will be appreciated that the swellable sleeve may arranged in an expansion region that is defined by a cut-away portion of the inner sleeve outer surface and outer sleeve inner surface leaving a generally cylindrical gap in which the swellable sleeve is arranged. Optionally the swellable sleeve is constrained between the base at one end of the swellable sleeve and lips of the inner sleeve and outer sleeve at the other end of the swellable sleeve, the lips being provided by the edges of the cut-away portions of the inner and outer sleeve respectively. Optionally, the lip face (that is oriented towards the swellable sleeve) of the inner and/or outer sleeve may constitute one or more still further drive surfaces. Optionally expansion of the swellable sleeve, due to water intake, would provide a force due to swelling of the sleeve on the first drive surface of the outer sleeve and on the lip face of the outer sleeve to thereby urge the outer sleeve in a direction towards the monopile and away from the base of the inner sleeve, the lip face optionally being a still further drive surface. Optionally that part of the swellable sleeve remains constrained between the base and lip of the inner sleeve and thus the expansion of the swellable sleeve must be directed radially outwardly and, in a region of the swellable sleeve not constrained by the lip of the inner sleeve, in a direction towards the monopile, thus expansion of the swellable sleeve moves the outer sleeve towards the monopile. Optionally further expansion of the swellable sleeve moves the outer sleeve further towards the monopile such that a portion of the swellable sleeve is exposed (that is to say that the outer sleeve does not cover a portion of the swellable sleeve). Optionally the expanded swellable sleeve prevents the outer sleeve from moving in a direction away from the monopile.

FIG. 50A illustrates the CPS of FIGS. 46 to 49 in another intermediate position 5000. It will be understood that in the intermediate position 5000 of FIG. 50, the rigid support body 4604 is arranged at the same, or a similar, position with respect to the aperture 4616 of the wall 4612 of the monopile 4608 in the position 4900 of FIG. 49. It will however be appreciated that the outer sleeve 4652 has been urged over the surface of the rigid support body 4604 and towards the wall 4612 of the monopile. That is to say that the outer sleeve 4652 has axially slid up the support body towards the monopile 4608. The outer sleeve is located in an intermediate position 5004. It will therefore be appreciated that in the position 5000 of FIG. 50, a gap 5008 between the wall abutment surface 4804 at the first end 4656 of the outer sleeve 4652 is smaller than the respective gap 4980 in the intermediate position 4900 of FIG. 49. It will be appreciated that the urging of the outer sleeve 4652 towards the wall 4612 occurs when the support body 4604 is immersed in a fluidic environment, such as water including seawater, fresh water and brackish water. This is due to the swelling of the swellable sleeve 4960 located radially between the inner sleeve 4904 and the outer sleeve 4652. It will be appreciated that the swellable sleeve 4960 may swell in one or more dimensions. The swellable sleeve of FIG. 50A swells substantially evenly in all three dimensions however it will be appreciated that a swellable sleeve that only expands in one dimension, or expands in a particular dimension to a greater degree than other dimensions, may be utilised. As shown in FIG. 50A, the base 4908 of the inner sleeve 4904 (and the inner sleeve as a whole) does not move with the outer sleeve and remains in a fixed position with respect to the rigid support body 4604. It will be appreciated that, due to the axial motion of the outer sleeve towards the monopile 4608, a section 5016 of the swellable sleeve 4960 is now not covered by the outer sleeve 4652 in the position of FIG. 50A. That is to say that a section of the swellable sleeve is located adjacent to, and between, the outer sleeve and the base of the inner sleeve in an axial direction parallel to the primary axis of the rigid support body.

FIG. 50B illustrates the position of the CPS 4602 of FIG. 50A in cross section. FIG. 50B illustrates how the swellable sleeve 4960 has swollen (expanded in all 3 dimensions) due to immersion in seawater. It will be appreciated that the swellable sleeve may alternatively be confined by the base of the inner sleeve and a lip associated with the further drive surface and may therefore expand in only two dimensions. The base 4908 of the inner sleeve 4904 however provides an abutment surface 5050 which prevents the swellable sleeve from expanding into any space towards the further end of the rigid support body. It will be appreciated that expansion of the swellable member 4960 along the primary axis of the rigid support body thus must expand in a direction towards the first end of the rigid support body (towards the monopile wall). It will therefore be appreciated that expansion of the swellable sleeve 4960 along the axis of the rigid support body 4602 acts to urge the outer sleeve towards the monopile wall 4612.

It will be appreciated that radial expansion of the swellable sleeve 4960 also acts to urge the outer sleeve 4652 towards the monopile wall. As the swellable sleeve 4960 expands in a radial direction, it abuts against both the tapered part of the inner sleeve and the tapered part of the outer sleeve. Due to the complimentary arrangement of the respective tapered parts of the inner and outer sleeves, being oriented at an oblique angle with respect to the primary axis of the rigid support body, and being arranged to flare out in opposite directions, a radially outwardly facing force due to the abutment of the swellable sleeve 4960 between the inner and outer sleeves is at least partly transformed into an axial component of force incident on the outer sleeve 4652 which acts along the axis of the rigid support body 4604 and towards the first end 4642 of the rigid support body 4602. The tapered part of the outer sleeve therefore constitutes a radially inwardly facing first drive surface 5060 and the tapered part of the inner sleeve 4904 constitutes a radially outwardly facing further drive surface 5064. As the swellable member 4960 swells in a radial direction, the force exerted on the first drive surface due to the abutting relationship of the swellable sleeve 4960 with both the first 5060 and further 5064 drive surface acts to urge the outer sleeve 4652 in a first direction of motion towards the monopile wall 4212. It will be appreciated that the radial force and any axial component thereof could be measured in Newtons (N) and could be determined based the expandable properties of the swellable sleeve.

It will be appreciated that a drive force is provided on the first drive surface. The drive force is responsive to the swelling of the swellable sleeve. That is to say that the drive force is a product of the swelling expansion of the due to the confinement of the swellable sleeve in the expansion region. The drive force acts to urge the outer sleeve in the first direction of motion that is oriented towards the monopile wall. It will be appreciated that the drive force could be measured in Newtons (N) and could be determined based on the expandable properties of the swellable sleeve. Aptly the drive force is between 100 kN and 1 MN.

It will be understood that the first drive surface includes a radially inward facing surface portion of an inner surface of the outer sleeve.

It will be appreciated that the swellable material can expand (or be enlarged) in either 1, 2 or 3 dimensions in response to taking up water from the surrounding environment.

It will be appreciated that when the outer sleeve is urged in the first direction of motion towards the monopile wall, the outer sleeve is disconnected from the base portion (or base region) which is a part of, or associated with, the inner sleeve which is a part of, or associated with, the rigid support body.

It will be understood that, as the swellable sleeve expands within the expansion region due to immersion in, and uptake of, water, the swellable member is urged into an abutting relationship with the radially extending flange region of the base portion. The swellable member cannot therefore expand further towards the base region and all expansion of the swellable member sue to swelling must be directed away from the base.

FIG. 51A illustrates the cable protection system 4602 of FIGS. 46 to 49 when the rigid support body 4604 is in a retained position 5100 following installation which the retaining arms 4682 are in abutment with the inner surface 5104 of the monopile wall and the outer sleeve 4652 has started to axially slide towards the outer surface 4802 of the monopile wall 4612. As is illustrated in FIG. 51A, the wall 4612 abutment surface 4655 at the first end 4656 of the outer sleeve 4652 is in an abutting relationship with the monopile wall. It will be appreciated that, due to further swelling of the swellable sleeve 4960, the outer sleeve 4652 has been urged further along the rigid support body 4604 in a first direction of motion towards the monopile wall 4612 relative to the position shown in FIG. 50 described above. It will be appreciated that the retaining arms 4682 of the CPS shown in FIG. 51 are in a deployed position 5108 that is an equilibrium position. With reference to FIG. 9, it will be understood that swivelling the retaining arm 4682 or arms from a storage position 4699 to a deployed position 5108 occurs via an intermediate position 4808 that is a position between the storage and deployed positions. The rigid support body 4604 is thus in a predetermined position 5100 in FIG. 51A. The abutment of the outer sleeve 4652 against the monopile wall, in conjunction with the deployed position of the retaining arms, secures the rigid support body 4604 of the CPS 4602 at the retained position. Unwanted motion of the rigid support body within, or proximate to, the aperture 4616, due to environmental fluctuations such as wave cycles and the like, in the monopile wall is therefore limited.

FIG. 51B illustrates the position of the CPS 4602 of FIG. 51A in cross section. As illustrated in FIG. 50B, the swellable sleeve 4960 has further expanded when compared to the position of FIG. 50B. The further swelling of the swellable sleeve 4960 shown in FIG. 51B occurs via immersion in seawater for a longer period of time than the position of FIG. 50B. As illustrated in FIG. 51B, the swellable sleeve 4960 has radially expanded into an exposed region 5150 between the base 4908 of the inner sleeve 4904 and a further terminal end of the outer sleeve such that the further terminal end of the outer sleeve abuts against a catch point 5160 in the swellable sleeve. The outer sleeve cannot slide back down the support body towards the further end of the support body to return to the position shown in FIG. 49.

It will be appreciated that the outer sleeve is urged into said abutting relationship with the outer surface of the monopile wall, narrowing a spaced apart distance between the end of the outer sleeve and a wall abutment surface of at least one retaining element that is in an abutting relationship with an inner surface of the wall, thereby squeezing the wall between the retaining element and the outer sleeve. An end region of the outer sleeve is therefore urged against the monopile wall.

Due to the arrangement of the retaining arms on the inner surface of the monopile wall and the outer sleeve on the outer surface of the monopile wall, axial sliding of the outer sleeve squeezes the monopile wall. As the wall is squeezed, a clamping force is generated that secures the rigid support body at a predetermined position with respect to the aperture. It will be appreciated that the clamping force could be measured in Newtons (N) and could be determined based on the swellable properties of the swellable sleeve.

It will be appreciated that the predetermined position of the rigid support body in the embodiment described in FIGS. 46 to 51 is the position illustrated in FIG. 51. That is to say the predetermined position of the rigid support body is an equilibrium position wherein the rigid support body extends through the aperture, the retaining arms are in abutment with the inner surface of the monopile wall and the outer sleeve is in abutment with the outer surface of the monopile wall. It will be appreciated that in the predetermined position, the retaining arms are arranged in the deployed position.

FIG. 52 illustrates another perspective view 5200 of the CPS 4602 of FIGS. 46 to 49 with the retaining arms 4682 being arranged in the storage position 4699.

FIG. 53 illustrates another perspective view 5300 if the CPS 702 of FIGS. 46 to 49 with the retaining arms being arranged in an intermediate position 4808.

FIG. 54 illustrates a further perspective view 5400 of the CPS 4602 of FIG. 52. It will be appreciated that FIG. 54 shows the CPS from the so-called bottom side 4664 of the rigid support body 4604. As shown in FIG. 54, two retaining arms 4682₁, 4682₂ are connected to the rigid support body 4604 arranged on diametrically opposite sides of the rigid support body 4604. It will be appreciated that each retaining arm 4682₁, 4682₂ is associated with a respective latch arm 4692.

FIG. 55 illustrates a still further perspective view 5500 of the CPS 4602 of FIGS. 46 to 54. FIG. 55 illustrates the through bore 5504 extending through the bend stiffener 4620. It will be appreciated that the through bore 5504 extends through the whole CPS. FIG. 55 also clearly illustrates the two retaining arms 4682₁, 4682₂ connected to the rigid support body 4604. It will be understood that the perspective view in FIG. 55 illustrates the retaining arms 4682₁, 4682₂ in the intermediate position 4808. FIG. 55 additionally illustrates the recess 4812 in the wall abutment surface 4804 of the outer sleeve 4652 in more detail. FIG. 55 also illustrates that the pair of retaining arms 4682₁, 4682₂ are disposed in a spaced apart relationship on opposed sides of the rigid support body 4604. It will be appreciated that each retaining arm 4682₁, 4682₂ is connected to the support body 4604 via a respective connector 4684. It will be appreciated that each connector 4684 may include a bearing and shaft to allow the retaining arm 4682 to swivel with respect to the rigid support body 4604. In such an arrangement, either the bearing or shaft can be connected to a respective retaining arm and a remainder of the bearing or shaft can be connected to the rigid support body. It will be appreciated that a pair of latch arms are also included in the CPS of FIG. 55, each of the latch arms being associated with a respective one of the pair of the retaining arms 4682₁, 4682₂. It will be understood that the pair of latch arms are disposed in a spaced apart relationship on opposed sides of the rigid support body 4604.

FIG. 56 illustrates a cross-sectional view 5600 of the CPS 4602 of FIGS. 46 to 44. FIG. 56 shows that the through bore 5604 extends through the entire length of CPS. FIG. 56 additionally helps illustrate the non-uniform thickness of the tapered region 4628 of the bend stiffener 4620. FIG. 56 helps illustrate that arrangement of the inner sleeve 4904, including a further drive surface that is a radially outwardly facing surface and is oblique to the primary axis associated with the rigid support body, and the outer sleeve 4652, including a complimentary further drive surface that is a radially inwardly facing drive surface and is oblique to the primary axis of the rigid support body. As illustrated in FIG. 56. The respective axes of the first and further drive surface are substantially parallel and are spaced apart via an expansion region. The swellable sleeve 4960 is arranged in the expansion region.

FIG. 57A illustrates the rigid support body 4604 of the CPS 4602 of FIGS. 46 to 56 in more detail. It will be appreciated that, aside from the connectors 4684 and retaining arms 4682, FIG. 57A illustrates an isolated rigid support body. FIG. 57A illustrates the rigid support body 4604 when not connected to the bend stiffener 4620 or the pull in head adaptor 4624, and when not partially covered by the outer sleeve 4652. The rigid support body is a generally cylindrical and integrally formed unit. A through bore 5704 extends through the rigid support body 4604. It will be understood that a cable, or other flexible elongate member, can be threaded through the rigid support body. The outer surface of the rigid support body 5708 may abut against the inner surface of the aperture 4616 of a monopile wall 4612 in use. It will be appreciated that the outer surface 5708 of the rigid support body 4604 is generally cylindrical. The outer surface 5708 may therefore include a substantially resistant and/or robust material to help avoid damage to the rigid support body in use. Optionally the outer surface of the rigid support body may be coated/covered with a protective and/or water resistant/proof and/or corrosion resistant cladding/coating. As is illustrated in FIG. 57A, the outer cylindrical surface includes a dished out surface region 4814. It will be understood that each retaining element is connected via a respective connector at a respective dished out surface region. It will be understood that each dished out surface region 4816 includes a first dished out end region 5712 and a further dished out end region 5716. As is shown in FIG. 57A, the first dished out end region 5712 and the further dished out end region 5716 are disposed on opposed sides of a respective connector 4684 location. FIG. 57A also illustrates a respective non dished out region 5720 of the outer surface 5708 of the rigid support body proximate to the first and further dished out end regions. The non dished out region 5720 includes an abutment surface 4816. It will be understood that the abutment surface 4816 provides a stop to prevent swivelling motion of a respective retaining arm 4682 beyond a preset place. As is illustrated in FIG. 57A, a pair of retaining arms 4682 are disposed in respective substantially diametrically opposed side positions on the outer cylindrical surface 5708. It will be appreciated, but not shown in FIG. 57A, that a further dished out portion 5716 is located on the reverse side of the rigid support body 4604 (facing into the page in FIG. 57A). It will be appreciated that both retaining arms 4682 may swivel together or may swivel independently of each other.

FIG. 57B illustrates an end on view of the rigid support body 4604 when the retaining arms 4682₁, 4682₂ are not disposed in the storage position. As shown in FIG. 57B. the rigid support body 4604 includes a through bore 5704 extending through the support body. In order to maintain the integrity of the support body in use, due to abutment with the monopile wall and corrosion etc, the tubular rigid support body 4604 must be of a minimum thickness. The thickness of the support body in FIG. 57B is 15 mm. Optionally the thickness of the support body may be 12 mm. Optionally the thickness of the support body is between 1 mm and 100 mm thickness. The support body has a bore 5704 diameter 200 mm. Optionally the bore 5704 diameter is between 100 and 500 mm. The bore diameter is tailored to the cable that is to be threaded through the support body. It with reference to FIGS. 46 to 56, it will be appreciated that the support body includes two dished out surface regions 4816 proximate to respective retaining arms. In order to maintain the required thickness of the support body, the bore 5704 narrows throughout the portion of the support body that includes the dished out surface regions 4816. Two inwardly extending wall regions 5740, each arranged at a respective dished out surface region 4816, therefore maintain the thickness of the support body throughout each dished out surface region of the rigid support body. FIG. 57B also helps to illustrate that each retaining arm 4682₁, 4682₂ includes two wall abutment surfaces 5744₁, 5744₂, 5748₁, 5748₂ that abut with an inner surface of the monopile wall when the retaining arm is arranged in a deployed position in use. FIG. 57B additionally helps to illustrate the position of the abutment elements that are abutment pins of each latch arm 4692.

FIG. 57C illustrates an end on view of the rigid support body 4602 of FIG. 57A when the retaining arms are disposed in a storage position. FIG. 57C helps illustrate the inwardly extending wall regions 5740 of the through bore. It will be appreciated that the inwardly extending wall regions 5740 are only present through the portion of the rigid support body that includes the dished out surface regions 4816 and therefore the inwardly extending wall portions 5740 do not extend throughout the whole length of the rigid support body.

FIG. 58A illustrates the retaining arm 4682 of the CPS 702 of FIGS. 46 to 57 in more detail. FIG. 58A shows an isolated retaining arm 5800. The retaining arm 4682 is an example of a retaining element. The retaining arm 4684 includes an elongate retaining body 5804. The elongate body 5804 is associated with a principal arm axis and arranged to swivel about the through hole 4686 that is a swivel point that is on the principal arm axis but offset from a centre point on the arm axis along a length of the retaining arm 4682. The retaining arm is formed from a metallic material. Optionally the retaining body may be manufactured from an alloy material. Optionally the retaining body may be made from any other suitable material. The retaining body 5804 includes a through hole 4686. It will be understood that the through hole is able to receive a connector to connect the through hole to a rigid support body. The through hole may include, or be associated with, a bearing to facilitate swivelling of the retaining arm about the through hole 4686 which is therefore a swivel point. The through hole 4686 may include a low-friction or frictionless inner surface to facilitate swivelling. As indicated above, the through hole 4684 is located proximate to the first end 4688 of the retaining arm 4682. It will be appreciated that the through hole 4684 is an example of an eyelet having a circular cross section through the retaining arm 4682 and is located on the principal axis of the retaining arm 4682. A coupling region 5808 is located at the further end 4690 of the retaining arm 4682. The coupling region 5808 is coupled to a respective latch arm 4692 via a frangible connector 4698 when the retaining arm 4682 is in the storage position 4699. The coupling region illustrated in FIG. 58A is a recess for receiving a pin. The retaining arm includes a wall abutment surface 4904 for abutting against an inner surface 4908 of a monopile wall 4612 when the retaining arm 4682 is disposed in the deployed position 4912. Optionally the wall abutment surface 4904 wall abutment surface may be covered in a protective cladding for protecting the inner surface 4908 of a monopile wall 4612 in use. It will be appreciated that the first end 4688 and the further end 4690 of the retaining arm 4682 are spaced apart across the elongate body 5804.

FIG. 58B illustrates a different perspective view 5840, that is a top-down view, of the retaining arm of FIG. 58A. As is illustrated in FIG. 58B, the retaining arm 4682 includes a through hole 4686 that is located a position along a primary axis associated with the retaining arm that is axially offset from a centre point of the retaining arm primary axis. That is to say that the through hole is located more proximate to a first end of the retaining arm than a further end of the retaining arm. The retaining arm receives a connector 4684 that may include a shaft and/or bearing and/or spigot. With reference to FIGS. 46 to 49, it will be appreciated that in use, when the retaining arm is released from a storage position (by cracking a frangible part that is part of or associated with a latch arm, the latch arm being associated with the retaining arm), the offset positioning of the through hole (and associated connecter) enables the retaining arm to swivel from the storage position to an intermediate or deployed position. That is to say that, as the through hole, which is an example of a swivel point or swivel region, is offset with respect to the centre of mass (and centre of gravity) of the retaining arm, a rotational force that is a restoring torque is exerted upon the retaining arm to swivel the retaining arm away from the storage position which, in the absence of a connection between the retaining arm and a respective latch arm, is a non-equilibrium position. The retaining arm illustrated in FIGS. 58A and 58B has a through hole diameter of approximately 50 mm to receive a cylindrical connector spigot with a diameter also of approximately 50 mm. It will be understood that any other suitable dimensions of through hole and cooperating connector could instead be utilised.

FIG. 58B also helps illustrate the position of two wall abutment regions 5844₁, 5844₂ of a wall abutment surface 5848 of the retaining arm. The wall abutment regions are axially located on either side of the portion of the retaining body that includes the through hole. It will be appreciated that the wall abutment regions abut against an inner surface of the monopile wall in use when the retaining arm is located in a deployed position (illustrated in FIG. 49). Arrow A indicates a force incident on a first wall abutment region 5844₁ due to an abutting relationship with the inner surface of the monopile wall and Arrow B indicates a force incident on the further wall abutment region 4844₂ due to an abutting relationship with the inner surface of the monopile wall in use, and when the retaining arm is oriented in the deployed position (as illustrated in FIG. 49). It will be appreciated that the whole weight of the CPS may be distributed among any number of retaining arms utilised in the CPS that are in a deployed position. Alternatively, a winch may provide a tension that partially supports the CPS weight via a winching line connected to a cable where a covered part of the cable extends through the rigid support body of the CPS. Alternatively, a winching line may be connected to the CPS itself. It will therefore be appreciated that substantial load can be applied to the monopile wall via each wall abutment region of each retaining arm. With reference to Newton's third law of motion, the monopile wall thus exerts an identical but opposed force on each wall abutment region of the wall abutment surface of the retaining arm. It will be appreciated that the combined force exerted on the first and further wall abutment region is transferred to engaged surface regions 5852, 5854 of the through hole and the connector (the spigot) which are most proximate to the wall abutment surface of the retaining arm. It will therefore be appreciated that the weight of the CPS may be supported by a number of connectors associated with each retaining arm situated in a deployed position. It will be appreciated that, in the CPS embodiment described herein, two retaining arms (the first a further retaining arms) are utilised and therefore the weight of the CPS is support by the first and further connectors that are associated with the respective first and further retaining arms. It will therefore be appreciated that a portion of the CPS weight (which may be around half of the CPS weight that is not further supported by other methods or devices or mechanisms) is supported by the connector shown in FIG. 58B when the retaining arm of FIG. 58B is oriented in a deployed position in use. The weight incident on the retaining arm in use is illustrated by arrow C.

It will be appreciated that, when compared with prior art retaining systems discussed with regard to technological background above, the load path from the location of abutting wall abutment regions of the retaining arm to the load supporting region of the connector is relatively short. Furthermore, due to the orientation of the retaining arms (that are able to swivel), the force exerted on the connector is directed substantially through the connector in a direction perpendicular to an axis associated with the connector, and is predominantly a shear force. That is to say, the degree to which rotational moments are applied to the connector are limited. Thus, the present arrangement and relatively short load path result in a more efficient retaining system which is less prone to failure than current prior art solutions. It will be appreciated that, utilising the two retaining arms described in the present CPS embodiment yields four wall abutment regions. The retaining arm arrangement is therefore a much more efficient use of material than prior art solutions, such as latch arm solutions discussed above. In fact, the retaining arm arrangement disclosed herein, which utilises two retaining arms, is 21 times more efficient than some currently adopted prior art solutions.

As discussed in the background section above, prior art CPS retaining solutions typically support the weight of the CPS at a particular point, or a particular number of points, for example a terminal end of a latch or a surface of a ball. These points are typically of limited surface area and therefore exhibit significant point loading on the inner surface of the monopile wall. It will be appreciated that higher contact stresses imparted on an inner surface of a monopile wall typically results in a higher rate of corrosion and therefore a reduced lifetime of an associated WTG. Such point loading of prior art approaches discussed above yields considerably higher contact stresses between retaining elements and the inner surface of the monopile wall. The beam loading of each (of the two) retaining arms utilised in the present CPS embodiment significantly reduces that contact stresses imparted on the monopile wall by distributing the weight of the CPS over four wall abutment regions (two on each retaining arm). It will be understood that at least some of these wall abutment regions may additionally have a larger surface area than abutment surfaces in prior art retaining elements thereby further decreasing stresses imparted on the monopile wall. Such an arrangement helps limit corrosion of the abutting regions of the monopile wall thereby helping to extend the lifetime of a WTG associated with the monopile. It will be appreciated that the high point loading of some prior art retaining solutions results in brinelling and other aberrant effects of abutment under load at the latch-monopile wall contact surfaces which increases the rate of corrosion.

Some prior art retaining solutions include a latch system which generates loading incident on a supporting point, which is often a pin proximate a terminal end of a latch, of around 1.5 times the force applied to the monopile wall by the abutment surface of the latch divided by the area of the latch abutment surface in contact with the monopile wall (Load=1.5×Force/Area). The present latch arm arrangement however, due to the geometry and relative dimensions of the latch arms illustrated in FIG. 58B, generates a load on the connector that is one fourteenth of the force applied to the monopile wall by the abutment surface regions of the arms divided by the area of the combined abutment regions of the arms in contact with the monopile wall ( 1/14×Force/Area). It will be appreciated that, when compared with prior art systems, the present retaining arrangement results in a considerable reduction of loading stresses.

For example, some retaining arms provide two areas of contact between the wall abutment surface of the retaining arm and an inner surface of the monopile wall, the areas of contact being arranged at the interface between the retaining arm and the monopile wall at either side of the swivel region. When the swivel region is offset axially with respect to the retaining arm (that is to say, not equidistant from each terminal end of the retaining arm) the effective areas of contact may be located at a distance of 2 L and L (L being an arbitrary distance) from the swivel region (taken along the wall abutment face of the retaining arm) respectively. The effective areas of contact may each be at a distance of 1.25 D and D (D being an arbitrary distance) from respective most proximate terminal ends of the wall abutment surface of the retaining arm. In a dual retaining arm system, in which a retaining arm is arranged on either side of a rigid support body is, there are 4 areas of contact between the retaining arms and the inner surface of the monopile wall (two areas of contact on each retaining arm). Thus, for an arbitrary force F (indicated by C in FIG. 58B) that is a load incident on each of the retaining arms due to the weight of the CPS system (and associated apparatus, for example the flexible elongate member) when the CPS is retained, by the arms, at a position at least partly through the aperture of the monopile wall, the resulting reaction forces at each of the effective areas of contact may be around R_{A}=F/3 (indicated by A in FIG. 58B) and R_{B}=⅔F (indicated by B in FIG. 58B) respectively. The shear area may be around 14A (A being an arbitrary area). A minimum shear stress incident on the connector located at the swivel region may be around F/14A. A maximum contact stress between the monopile wall and the retaining arm may be around 0.3 F/DW (where W is the width of the wall abutment surface of the retaining arm).

It can be shown that, for some prior art latch systems which utilise point loading in which all the force, F, associated with the retaining of a CPS in a monopile is incident at a single effective area of contact of the latch (in abutment with an inner surface of a monopile wall), the shear area may be around 2A. It can be shown that the minimum shear stress incident on a pin of the latch is around 3 F/2A. It can be shown that the minimum contact stress between the monopile wall and the latch is around 0.6 F/DW (where D is the length of the wall abutment surface of the latch and W is the width of the wall abutment surface of the latch). Thus, as indicated above, the load on a connector associated with a retaining arm is one fourteenth of the load associated on a pin of a prior art latch, and the use of a retaining arm system is 21 times more efficient than a prior art latch system.

It will be understood that, in the present CPS embodiment, the size of the connector Is not as constrained by space within the CPS and/or monopile and therefore the connector can readily by enlarged to provide additional strength (resilience to the loading of the CPS) if necessary.

It will further be appreciated that the use of two retaining arms, arranged at substantially opposite sides of the rigid support body helps limit, reduce or avoid misalignment of the system in use. It will be understood that misalignment of prior art systems can result in aberrant increases in loading on retaining latches (and components associated with such latches such as supporting elements) and/or the inner surface of the monopile wall and can ultimately result in damage. Such misalignment includes rotational and axial misalignment of the rigid support body with respect to a desired angle of penetration of the rigid support body through the aperture in the monopile wall when the rigid support body is arranged in a predetermined position or a retained position. This is due to the symmetrical arrangement of he two retaining arms. It will be appreciated that, should the rigid support body be rotationally misaligned in the aperture (such that each retaining arm is not arrange on substantially horizontally opposed sides of the support body), the force on each retaining arm will not be evenly distributed. The retaining arms will additionally not be swivelled away from the storage position to the same degree. That is to say that, at a particular instance in time, one of the retaining arms will be swivelled further away from the position of the retaining arms when arranged in the storage position than the other arm. At least partly due to the uneven distribution of such forces, the arms generate a restoring torque which acts to equilibrate the forces incident on each of the arms. This restoring torque thus acts to reduce misalignment of the rigid support body. The restoring torque thus acts to urge the rigid support body towards the predetermined position and acts to urge the retaining arms towards the deployed position.

FIG. 58C illustrates a still further perspective view of the retaining arm of FIG. 58A. It will be appreciated that FIG. 58C illustrates a side-on view of the retaining arm. FIG. 58C helps illustrate the wall abutment regions of the wall abutment surface of the retaining arm. FIG. 58C also helps illustrate the geometry of the through hole, a cross section of which is indicated by the dotted lines in FIG. 58C.

FIG. 58D illustrates another perspective view of the retaining arm of FIG. 58A. It will be appreciated that FIG. 58D illustrates an end-on view of the retaining arm.

FIG. 59 illustrates the latch arm 4692 of the CPS 4602 of FIGS. 46 to 45 in more detail. It will be appreciated that FIG. 59 illustrates a latch arm 4692 in isolation. The latch arm 4692 includes an elongate latch arm body 5904. The frangible connector 4696 is located at a first end 5908 of the latch arm 4682. The frangible connector 4696 is optionally an includes an eyelet or a socket body 5920 for receiving an elongate pin and a narrowed region 5912 between the eyelet and the latch arm body 5904. Alternatively, the frangible connector may include an elongate pin for connection to a respective socket in a retaining arm. It will be understood that the narrowed region 5912 is designed to fracture/break when subjected to a predetermined threshold force before any of the other elements associated with the latch arm 4692 break. It will be appreciated that the latch arm 4692 may instead include a different frangible portion which can be connected to a retaining arm. Optionally a frangible portion is located within the body 5904 of the latch arm 4692 such that the latch arm is breakable at a predetermined position, or cracking point, of the latch arm 4692. The abutment element is located proximate to a further end 15916 of the latch arm 4692. The abutment element 4698 of FIG. 59 is a peg member that extends away from the latch arm 4692. It will be appreciated that the abutment element 4698 moves with the latch arm 4692. It will be appreciated that the abutment element 4698 may instead be a protrusion or different geometry, for example triangular or rectangular and the like, or may be a recess in the latch arm 4692 that engages with a protrusion associated with a monopile wall, or the wall of any other suitable facility. With reference to FIGS. 48 and 53, it will be appreciated that peg 4698 can be located in a cooperating (or accommodating) recess 4814 in an inner surface (the surface of the outer sleeve in contact with the support body) of an outer sleeve 4652 coupled to the rigid support body 4604.

It will be appreciated that, when slidably disposed in a recess 4696 of a rigid support body 4604 (or coupled to the rigid support body) and in use during a pull-in process of the like in which the rigid support body 4604 is urged into a monopile 4608 via an aperture 4616 in a monopile wall 4612, the peg 4698, (which moves with the latch arm) abuts against the outer surface of the monopile wall 4612. It will be understood that, as the support body is urged into the monopile, due to the abutting relationship between the monopile wall 4612 and the peg 4698, an abutment force acts on the peg 4698 acting away from the wall 4612. It will be understood that the abutment force in generated in response to the peg 4698 abutting an outer surface of the wall 4612 of the monopile 4608 proximate to the aperture 4616 as a portion of the rigid support body 4604 is urged through the aperture 4616. When the abutment force overcomes a predetermined threshold force, which is a cracking force required to crack the frangible connector 4698 and can therefore be specified in manufacture of the latch arm 4692, the frangible connector 4698 is cracked. That is to say that the frangible connector breaks responsive to the abutment force. Following the cracking of the frangible connector 4698, it will be understood that the latch arm 4692 slides in the first direction of motion due to the abutment of the monopile wall 4616 against the abutment peg 4698. It will therefore be appreciated that, when the abutment force exceeds the predetermined threshold force, sliding of the latch arm 4692, and swivelling of the retaining arms 4682 from a storage position to a deployed or intermediate position is permitted. It will be appreciated that when the latch arm 4692 is connected to a respective retaining arm 4682 via the frangible connector 4698, which prevents slidable motion of the latch arm 4692 in the recess of the rigid support body 4604, the latch arm 4692 prevents swivelling of the respective retaining arm 4682 from a storage position to an intermediate or deployed position.

It will be appreciated that the abutment element of FIG. 59 is generally cylindrical. Optionally the abutment element may be any other shape. The abutment element may be a peg member. It will be appreciated that, in use, a cylindrical abutment element engages and abuts against an outer surface of a monopile wall at a consistent set-off distance and therefore offers some control over the position of the CPS relative to the monopile wall and associated aperture when the abutment element is expected to engage with the monopile wall. The generally cylindrical arrangement of the abutment element helps ensure consistent engagement between the monopile wall and abutment element as the abutment element will generally always engage the monopile wall at a curved outer surface of the generally cylindrical body of the abutment element.

It will be appreciated that an elongate pin member may instead constitute a frangible portion of the latch arm of FIG. 59. The elongate pin may be arranged to extend through a through-hole located at and end of the latch arm distal to the abutment element. The elongate pin may be polymeric or wooden or the like. The elongate pin may be substantially brittle and thus may completely shear when a sufficient force is applied to the pin. It will be appreciated that the pin may shear when a shearing force/cracking force of around 3000 N is incident on the pin. It will be appreciated that the pin may shear when a shearing/cracking force of between 2000 N and 10000 N is incident on the pin. It will be appreciated that the shearing force required to shear the pin may be relatively similar when the pin is dry and when the pin is wet. It will be appreciated that the pin may shear under a well-defined shearing/cracking force which corresponds or is related to a predetermined threshold force which may be generated by applying a tension to a winching line to pull the CPS into an aperture of a wall of a monopile such that an abutment element of the latch arm abuts against an outer surface of the monopile wall to transfer force to the pin. It will be appreciated that the pin may shear across a thinnest diameter of the pin, the axis of shearing aptly being around 90 degrees to the primary axis of the pin.

FIG. 60 illustrates another example of a latch arm 6000 for use in the CPS of FIGS. 46 to 57. The latch arm 6000 includes an elongate latch arm body 6004. A frangible connector 6008 is located at a first end 6012 of the latch arm 6000. The frangible connector 6008 includes an eyelet 6016 for receiving a pin and a narrowed region 6020 between the eyelet 6016 and the latch arm body 6004. It will be understood that the narrowed region 6020 is designed to fracture/break when subjected to a predetermined threshold force before any of the other elements associated with the latch arm 6000 break. The abutment element 6022 is located at a further end 6024 of the latch arm 792. The abutment element 6022 is a protruding wedge located at the terminus of the further end 6024 of the latch arm 6000. The abutment element 6022 includes an abutment face 6028 for abutting against monopile wall in use.

It will be understood that the abutment face 1926 of the wedge is oblique to a primary axis of the latch arm which at least partly cooperates with the outer surface of a monopile wall against which the abutment face abuts. For example, the abutment face at least partly cooperates with a curved outer surface of a monopile wall. It would be understood that the oblique abutment surface helps ensure that the abutment element abuts with the outer surface of the monopile wall at a desired orientation. It will be appreciated that the oblique abutment face, that is substantially flat defines a particular surface area of contact between the outer surface of the monopile wall and the abutment element. Thus, the oblique abutment face, which is at least partly complimentary to an outer surface of a monopile wall provides a greater control of the pulling force on the elongate flexible member (and thus on the CPS respectively) required to achieve a predetermined threshold force and crack (that is, to shear or completely break) the frangible portion of the latch arm. It will be appreciated that this is due to the fact that a reasonable estimation can be made as to the area of the abutment element and monopile wall that are in contact when the oblique surface of the abutment element abuts against the monopile wall. As indicated previously, the pulling force and predetermined threshold force could be measured in Newtons (N).

Aptly the latch arm is disposed to break at the frangible portion when exposed to a force of between 2000 and 10000 N, aptly around 3000 N.

It will be appreciated that an elongate pin member may instead constitute a frangible portion of the latch arm of FIG. 60. The elongate pin may be arranged to extend through a through-hole located at and end of the latch arm distal to the abutment element. The elongate pin may be polymeric or wooden or the like. The elongate pin may be substantially brittle and thus may completely shear when a sufficient force is applied to the pin. It will be appreciated that the pin may shear when a shearing force/cracking force of around 3000 N is incident on the pin. It will be appreciated that the pin may shear when a shearing/cracking force of between 2000 N and 10000 N is incident on the pin. It will be appreciated that the shearing force required to shear the pin may be relatively similar when the pin is dry and when the pin is wet. It will be appreciated that the pin may shear under a well-defined shearing/cracking force which corresponds or is related to a predetermined threshold force which may be generated by applying a tension to a winching line to pull the CPS into an aperture of a wall of a monopile such that an abutment element of the latch arm abuts against an outer surface of the monopile wall to transfer force to the pin. It will be appreciated that the pin may shear across a thinnest diameter of the pin, the axis of shearing aptly being around 90 degrees to the primary axis of the pin.

FIG. 61 illustrates another CPS 6102, for locating a flexible elongate member at a predetermined location with respect to a monopile wall through which an aperture is provided, in a first position 6100. It will be understood that the first position 6100 of the CPS 6102 may be prior to installation of the CPS system in a WTG. In the first position 6100, all of the rigid support body 6104 of the CPS 6102 is located outside of a monopile 6108, that is to say none of a rigid support body is located in a space enclosed by a wall 6112 of the monopile 6108, or within an aperture 6116 extending through the wall 6112. The first position 6100 is therefore a first position of the rigid support body 6104. It will be appreciated that, when a cable of other flexible elongate member is threaded through a through bore of the CPS, the installation of the CPS from the first position 6100 may be achieved via the winching process described in FIGS. 5 and 6. Although a monopile or WTG is specifically referred to here, it will be understood that the system could be utilised in any suitable structure or facility that includes a wall with an aperture extending therethrough and an internal cavity. The WTG is an example of a facility, the monopile being a part of the WTG.

As is illustrated in FIG. 61, the cable protection system includes a rigid support body 6104 arranged between a progressive stiffener 6120 (or bend stiffener) and a pull-in head adaptor 6124. The rigid support body 6104 is elongate and is substantially tubular and includes a cylindrical through bore. The cylindrical through bore (not shown in FIG. 61) extends through a whole length of the rigid support body. That is to say the rigid support body includes a through-bore that extends through the support body from a first end of the support body to a further end and through which a flexible elongate member is locatable. The rigid support 6104 body is formed from a metallic material. For example, a corrosion resistant alloy and the like may be used. The rigid support body 6104 may optionally be formed from a polymeric material or a reinforced polymeric material. The rigid support body 6104 may optionally be made from a composite material. The rigid support body 6104 may optionally be manufactured from a ceramic material. The bend stiffener 6120 is also an elongate body that surrounds a substantially cylindrical through bore. As is illustrated in FIG. 61, the bend stiffener 6120 includes a tapered portion 6128 including a tapered outer surface. It will be appreciated that the through bore of the tapered portion 6128 is substantially cylindrical and is therefore not itself tapered. The thickness of the tapered portion 6128 therefore varies along its length from a flared-out end 6134 arranged to be close to the rigid support body 6104 to a narrow end 6138 distal to the rigid support body 6104. The varying thickness of the tapered portion 6128 provides a non-uniform stiffness of the bend stiffener 6120 along its length. It will be appreciated that, when an elongate flexible member, such as a cable or the like, is arranged radially within the bend stiffener 6120, a flexibility of the elongate member is constrained at the flared-out end 6134 of the tapered portion and is relatively unconstrained at the narrow end 6138 of the tapered portion 6128. This tapered portion 6128 helps prevent a flexible elongate element, such as a cable, from exceeding a predetermined minimum bend radius that may be detrimental to the elongate element. The bend stiffener 6120 may also help reduce chafing, or other destructive frictional effects, at the interface between the elongate element and the rigid support body 6104. The bend stiffener 6120 additionally includes a substantially annular portion 6140 coupled to the flared-out end 6134 of the tapered portion 6128. A remaining end of the substantially annular portion is coupled to a first end 6142 of the rigid support body 6104. The coupling between the substantially annular portion 6140 of the bend stiffener 6120 and the first end 6142 of the rigid support body 6104 may be provided by conventional securing methods such as bolting of screwing of the like. The progressive stiffener is thus secured to the first end of the rigid support body.

A further end of the rigid support body 6104 is connected to the pull-in head adaptor 6124. The further end of the rigid support body is therefore secured to the pull-in head adaptor. It will be appreciated that the pull in head adaptor can house and can releasably engage with a pull-in head during a support body pull in operation. When engaged within the pull in head adaptor, the CPS system moves with the cable. Therefore, by pulling the cable into the monopile via the aperture by winching, the rigid support body is also pulled through the aperture.

As illustrated in FIG. 61, a region of the rigid support body 6104 proximate to the further end 6148 of the rigid support body is covered by an outer sleeve 6152. The outer sleeve 6152 is therefore located at a position distal to the first end 6134 of the rigid support body 6104. The outer sleeve 6152 shown is manufactured from a polymeric material. The outer sleeve 6152 may optionally comprise a polymeric material. The outer sleeve 6152 may optionally comprise a reinforced polymeric material. The outer sleeve 6152 may optionally comprise a composite material. As is illustrated in FIG. 61, the outer sleeve 6152 is arranged to radially surround a portion of the rigid support body 6104 and is substantially tubular. A first end of the outer sleeve 6156, most proximate to the first end 6134 of the rigid support body 6104 is angled such that an axis associated with a face 6155 of the first end 6156 of the outer sleeve 6152 is oblique to a primary axis of the outer sleeve 6152 (and the rigid support body 6104). It will therefore be appreciated that the outer sleeve 6152 extends further over the rigid support body 6104 on a top side 6160 of the rigid support body than the bottom side 6164 of the rigid support body 6104, the top 6160 and bottom 6164 sides of the rigid support body 6104 being on opposite substantially opposite sides of the rigid support body. It will be understood that the top and bottom sides of the rigid support body are simply relative terms, and that rigid support body may be arranged in any orientation, the top side 6160 of the rigid support body possibly being located on an upper surface of the rigid support body and the bottom side 6164 of the rigid support body optionally being located on a lower surface of the rigid support body 6104.

A further adaptor 6172 is connected to a remaining end of the pull-in head adaptor 6124 (the end of the pull-in head adaptor 6124 that connects the pull-in head adaptor to a bend restrictor element 6176. It will be understood that the bend restrictor element 6176 is part of a bend restrictor 6177 which includes multiple bend restrictor elements 6176. Three bend restrictor elements 6176 are shown in the bend restrictor 6177 of FIG. 61. It will be understood that any number of bend restrictor elements 6176 may be included in the bend restrictor 6177. The further adaptor 6172 may be connected to the pull-in head adaptor via suitable securing mechanisms such as screwing and/or bolting and the like. The further adaptor 6172 may be connected to a bend restrictor element 6176 by securing mechanisms such as screwing and/or bolting and the like. Alternatively, a bend restrictor element 6176 may be a part of the further adaptor 6172, that is to say a bend restrictor element 6176 may be arranged at a terminal end of the adaptor 6172, the bend restrictor element and the further adaptor being integrally formed. As shown in FIG. 61, the multiple bend restrictor elements 6176 are arranged in series and connected in an end-to-end configuration. It will be understood that the bend restrictor 6177 defines an end portion of the CPS 6102 which extends into the surrounding environment 6180 and away from the monopile wall 6112. The bend restrictor elements 6176 forming the bend restrictor 6177 limit the flexibility of a portion of an elongate member arranged within each of the bend restrictor elements 6176.

FIG. 61 also illustrates a retaining arm which is connected to the rigid support body 6104 via a respective connector 6184. It will be appreciated that, although only one retaining arm is shown in FIG. 61, the rigid support body 6104 also includes another retaining arm on a diametrically opposite surface of the rigid support body 6104 (the surface extending into the page). It will be understood that, although the CPS of FIG. 61 includes two retaining arms 6182, any suitable number of retaining arms 6182 may be utilised, the retaining arms 6182 optionally being arranged at any suitable position along the rigid support body 6104. It will be understood that the retaining arm 6182 is an example of a retaining element and any suitable shape or configuration of retaining element can instead be utilised. Each of the retaining arms 6182 are connected to the rigid support body 6104 via a respective connector 6184. That is to say a different connector 6184 connects each retaining arm 6182 to the rigid support body 6104. It will be appreciated that each retaining arm 6182 is on a respective side of the rigid support body 6104 that between, and is substantially equidistant from, the top 6160 and bottom 6164 sides of the rigid support body 6104. It will be appreciated that so-called side of the rigid support body refer to a regions of the cylindrical surface of the support body which extend a respective maximum and minimum distance in an x-axis and y-axis of an imaginary plane that is perpendicular to the primary axis of the rigid support body. Each retaining arm 6182 is connected to the rigid support body 6104, via the respective connectors 6184, at a position of the rigid support body 6104 more proximate to the first end 6142 of the rigid support body than the further end 6148 of the rigid support body 6104. The retaining arms 6182 include an elongate retaining body which comprises a through hole 6186 extending through the retaining body in a direction perpendicular to the primary axis of the retaining element to receive an end of a respective connector 6184. As illustrated in FIG. 61, the through hole 6186 is offset from a centre point of the retaining arm 6182 and is therefore located proximate to a first end 6188 of the retaining 6182. A remaining end of each connector 6184 is connected to the rigid support body. It will be understood that the connector may include a shaft. It will be appreciated that the connector may include a bearing to permit swivelling of the retaining arm 6182 with respect of the rigid support body 6104. The through hole 6186 may optionally include a bearing. The retaining arms 6182 are therefore disposed to swivel about the connector 6184, an end of which is located in the through hole 6186 of the body of the retaining arm 6182. It will be appreciated that the swivelling motion of each retaining arm 6182 is rotational motion centred around the through hole 6186 and connector 6184. The through hole 6186 of the body of each retaining arm 6182 therefore constitutes a swivel region that is optionally a swivel point. That is to say that swivelling of the retaining arm 6182, includes the partial spinning of the retaining arm about a particular point that is the swivel point.

A further end 6190 of each retaining arm 6182 is connected to a respective latch 6192 arm located in an elongate recess 6194 on the outer surface of the rigid support body 6104. The connection between the latch arm is facilitated by a frangible connector 6196. The frangible connector 6196 is an example of a frangible portion of the latch arm 6192. Optionally the frangible portion may be located at any suitable position of the latch arm 6192. Optionally the frangible portion may be a separate element and is not a part of the latch arm 6192. Optionally the frangible portion may be integrally formed with the latch arm 6192. It will be understood that the frangible connector is releasably connected to the further end of the retaining arm.

The latch arm 6192 further includes an abutment pin 6198 extending out from an outer surface of the latch arm 6192. The abutment pin 6198 may optionally be a part of, or integrally formed with, the latch arm 6192. The abutment pin 6198 may optionally be a separate element, and not a part of the latch arm 6192. The abutment pin 6198 is an example of an abutment element. It will be appreciated that FIG. 61 illustrates the retaining arm 6182, when connected to the latch arm 6192 arranged in a storage position 6199. It will be appreciated that the latch arm 6192, which is associated with the rigid support body 6104 being coupled to the rigid support body by being slidably located in the elongate recess/channel 6194, is disposed to prevent the retaining arm 6182 from swivelling away from the storage position 6199. The connection between the further end 6190 of the retaining arm 6182 and the latch arm 6192 via the frangible connection/connector 6196 therefore prevents the retaining arm 6182 from being disposed in a position that is not the storage position 6199. As is illustrated in FIG. 61, in the storage position 6199, the retaining arm 6182 is oriented such that a primary axis of the retaining body is parallel with, or substantially parallel with, a primary axis of the rigid support body 6104. It will be appreciated that any other retaining arms of the CPS of FIG. 61 will be disposed in a similar storage position.

FIG. 62 illustrates the CPS 6102 of FIG. 61 during installation 6200 where the rigid support body 6102 is partially passed through the aperture 6112 of the monopile wall 6112. It will be understood that installation may include the winching process described in FIGS. 4 and 5. This may be a part of a pull in process in which cable or another flexible elongate member is pulled into the monopile. It will be understood that the CPS 6102 has been pulled, from the first position 6100 illustrated in FIG. 61, towards the monopile such that the rigid support body 6104 intrudes into the aperture 6116 of the wall 6112 of the monopile 6108. As is illustrated in FIG. 62, the bend stiffener 6120 is located within the inner region/cavity 6204 of the monopile 6108. FIG. 62 illustrates that the first end 6142 of the rigid support body 6104 is located in an inner region/cavity 6204 of the monopile 6108. The further end 6148 of the rigid support body 6104 is located outside of the of monopile 6108 in an outer region associated with the monopile 6108 which is in the environment 6180. The outer sleeve 6152 is also located outside of the monopile 6108 in the environment 6180. As shown in FIG. 62, a portion of the rigid support body 6104 is located within the aperture 6116 in the monopile wall 6112. The retaining arms 6182 are disposed in the storage position 6199 as discussed in relation to FIG. 61. It will therefore be understood that the further end 6190 of the storage arms are therefore connected to respective latch arms 6192 via respective frangible connectors 6196. As shown in FIG. 62, the storage position 6199 of the arms 6182 allows for the rigid support body 6104 to at least partially pass through the aperture 6116. That is to say that the orientation of the storage position 6199 does not prevent the rigid support body 6104 and the retaining arms 6182 from entering into the inner region 6204 of the monopile 6108 via the aperture 6116. That is to say in the storage position the support body is locatable through an aperture in a wall of a monopile from a first position outside the monopile to a further position (such as the positions illustrated in FIG. 62 and FIG. 63, described below) in which at least a portion of the support body is within the monopile. In the position illustrated in FIG. 62, the abutment element 6198 abuts against the monopile wall 6112 proximate the aperture 6116.

FIG. 63 illustrates the CPS 6102 of FIG. 61 or FIG. 62 in a further position 6300 during installation through an aperture in a wall of an offshore structure. As shown in FIG. 63, in the further position the rigid support body 6104 has been pulled further into the inner region 804 of the monopile 6108, through the aperture 6116 of the monopile wall 6112 relative to the position illustrated ion FIG. 62. It will be appreciated that the rigid support body has been urged further into the monopile via the aperture. It will be therefore understood that in the further position 6300, a portion of the rigid support body 6104 is located within the monopile 6108. As is illustrated, in the further position 6300, the first end 6156 of the outer sleeve 6152 abuts against an outer surface 6302 of the monopile wall 6112 proximate the aperture 6116. The surface of the outer sleeve 6152 at the first end 6156 is therefore an end region that is a wall abutment surface 6304. It will be appreciated that a diameter of the outer sleeve 6152 is wider than a diameter of the rigid support body 6104. The diameter of the outer sleeve member 6152 is designed such that it is wider than a diameter of the aperture 6116 in the monopile wall 6112. It will therefore be appreciated that the abutting relationship between the wall abutment surface 6304 of the outer sleeve 6152 prevents the rigid support body 6104, and the CPS, from being pulled any further into the monopile 6108. In this sense, due to the position of the first end 6156 of the outer sleeve 6152 the further position 6300 of the rigid support body 6104 is a position at a maximum displacement towards, and into, the monopile 6108 through the aperture 6116. It will be appreciated that the aperture 6116 may be designed to receive the rigid support body 6104 at an angle that is oblique to the primary axis associated with the monopile wall 6112. Optionally this angle is around 45 degrees. As indicated with respect to FIG. 61, the first end 6156, and thus the wall abutment surface 6156, of the outer sleeve 6152 extends in an axis that is oblique to the primary axis associated with the rigid support body 6104. The oblique angle of the wall abutment surface 6304 is complimentary with the aperture 6116 such that abutment between the wall abutment surface 6304 and the outer surface of the wall 6302 occurs at a desired angle. Optionally this angle is around 45 degrees. Optionally the oblique angle of the wall abutment surface 6304 is around 45 degrees with respect to the primary axis associated with the rigid support body 6104.

As shown in FIG. 63, in the further position 6300 of the rigid support body 6104, the retaining arm 6182 is no longer oriented in the storage position 6199. The retaining arm 6182 is instead disposed in an intermediate position 6308. It will be understood that the retaining arm 6182 has rotatably swivelled from the storage position to the intermediate position 6108. As discussed with regard to FIG. 61, it will be appreciated that swivelling of the retaining arm includes at least partially rotating or spinning the retaining arm about a swivel region that is a swivel point. The swivel point includes a through bore into which a respective connector can intrude. It will be appreciated that, for the retaining arm 6182 to be able to rotate to the intermediate position 6308. the retaining arm 6182 and the latch arm 6192. As the retaining element 6198 associated with the latch arm 6182 was in an abutting relationship with the outer surface 6302 of the wall in FIG. 62, as the rigid support body 6102 is urged further into the aperture 6116 an abutment force is provided on the abutment element 6198 due to the contact between the abutment element 6198 and the outer surface 6302. It will be understood that the abutment force increases as a force pulling the rigid support body 6104 into the monopile 6108, such as a tension due to a winching operation and the like, increases.

When the abutment force exceeds a threshold force, the frangible connection 6196 between the further end 6190 of the retaining arm 6182 and the latch arm 6192 breaks due to the frangible connector 6196 and the abutment element 6198 being connected by the latch arm 6192. It will be understood that the frangible connector 6196 may include a pin and eyelet arrangement. Alternatively, the frangible connection may include a juxtaposition of materials with varying mechanical properties to promote fracture of the material at a particular point and under a particular force. Alternatively, the frangible connection 6196 may include a geometrically varied region, for example a region of reduced thickness/width. It will be understood that a particular cracking force required to be exerted on the frangible connection 6196 for the frangible connection 6196 to break can be specified in manufacture and therefore the threshold force may be a predetermined threshold force. Following disconnection of the latch arm 6192 and the retaining arm 6182, the latch arm is free to axially slide in the channel/recess 6194 of the rigid support body 6104 and is pushed towards the further end 6148 of the rigid support body and under the outer sleeve 6152 due to the abutment between the abutment element 6198 and the outer surface 6302 of the monopile wall 6112. It will be understood that the latch arm 6192 is slidable along an axis of sliding with respect to the support body 6104, the latch arm 6192 being slidably disposed in an elongate recess 6194 in an outer surface of the support body 6104. It will be understood that the axis of sliding extends in a direction that is substantially parallel with, but spaced apart from, a primary axis associated with the central through-bore that extends through the rigid support body 6104. It will also be understood that the latch arm 6192 slides in a first direction of motion away from a retaining arm 6182 supported on the rigid support body 6104 when the rigid support body 6104 passes through the aperture to thereby release the retaining arm from a storage position 6199 when the retaining element 6182 is within the monopile. The abutment element 6198 intrudes into a recess 6312 in the wall abutment surface 6304 of the outer sleeve 6152 to permit the wall abutment surface 6304 to abut against the outer surface 6302 of the monopile wall 6112. It will be appreciated that the threshold force could be measured in Newtons (N). It will be understood that the cracking force could be measured in Newtons (N). It will be understood that the cracking force could be measured by applying known force to the frangible connection, optionally via the abutment element, until the frangible connection breaks. It will be appreciated that the threshold force could be measured by applying known force to the frangible connection, optionally via the abutment element, until the frangible connection breaks. It will be appreciated that the cracking force may be a shear force. It will be appreciated that the frangible connection may shear at the shear force. It will be appreciated that the cracking force may be a break-free force which may correspond or be proportional to a break free tension applied to a winching line to pull the CPS into the monopile and release a retaining arm from a storage position. It will be appreciated that breaking the frangible connection may include a compete shear of a part of the frangible connection that is a complete break of a part of the frangible connection resulting in a complete separation of a respective retaining arm and latch arm. It will be appreciated that the frangible connection may be brittle and shears at around a shear force. It will be appreciated that the frangible connection may be substantially brittle and is substantially resistant to deformation, distorting, elongation, bending and the like.

As indicated in the above paragraph, following disconnection of the retaining arm 6182 and the latch arm 6192, the retaining arm is free to rotatably swivel from the storage position 6199 to the intermediate position. In the intermediate position, the primary axis associated with the retaining arm 6182 is oblique to the primary axis associated with the rigid support body 6104. The primary axis associated with the retaining arm is optionally substantially parallel to the primary axis associated with the monopile wall 6112. Due to the through hole 6186 of the retaining arm 6182 in which the connector 6184 is arranged being arranged offset to a centre point of the retaining arm, most proximate to the first end 6188 of the retaining arm 6182, the retaining arm swivels from the storage position 6199 to the intermediate position 6308 due to gravity. It will be understood that the retaining arm 6182 may be biased towards the intermediate position by one of more biasing elements such as a spring. As shown in FIG. 63, the retaining arm 6182 is arranged in a dished out region 6316 of the rigid support body 6104. An adjacent non-dished out portion 6320 provides an abutment surface 6324 that stops the retaining arm 6182 from swivelling beyond a predetermined position, the predetermined position being the intermediate position 6308.

FIG. 64A illustrates the CPS of FIGS. 61, 62 and 63 in another intermediate position 6400. In the intermediate position of FIG. 64, the rigid support body 6104 is arranged further towards the outer region associated with the monopile 6108, or the environment 6180, when compared with the further position of the rigid support 6104 illustrated in FIG. 63. This may be achieved, for example, by relaxing or reducing a tension associated with a winching line via a winch that is coupled to, and providing a tension on, a cable arranged through the CPS. As is illustrated in FIG. 64A a first abutment surface 6404 of the retaining arm 6182 is arranged in an abutting relationship with an inner surface 6408 of the monopile wall 6112 proximate the aperture 6116. The first abutment surface 6404 of the retaining arm 6182 therefore constitutes a wall abutment surface of the retaining arm 6182. The retaining arm 6182, disposed in an abutting relationship with the inner monopile surface 6408 therefore retains the rigid support body 6104 at a retained position, where a portion of the rigid support body 6104 is within the monopile 6108. That is to say the retaining arm 6182, disposed in an abutting relationship with the inner surface 6408 of the monopile 6108 prevents the rigid support body from returning to its first position 6100 where all of the rigid support body is located outside of the monopile and in the environment 6180. The wall abutment surface of the retaining arm is therefore disposed to abut against the inner surface of the wall of the monopile proximate to the aperture in the wall of the monopile. It will therefore be understood that in the position illustrated in FIG. 64A, the retaining arm is disposed in an intermediate position 6412 where the retaining arm prevents the support body passing fully through the aperture from towards the first position of FIG. 61, and to locate the rigid support body at a retained position with respect to the aperture.

It also be appreciated that the connector 6186 selectively allows the retaining arm 6182 to swivel from a storage position 6199 to the position illustrated in FIG. 64A 6412, for example on a shaft of the connector 6186. The position illustrated in FIG. 64A 6412 of the retaining arm 6182 is thus an equilibrium position in which a region of a respective retaining arm abuts a region of an inner surface of the wall and an angle of swivel of respective retaining arms 6182 is determined responsive to a reaction between the wall and at least a mass of a cable extending through the rigid support body 6102 and the support body 6102 itself. It will be appreciated that the CPS 6102 including the rigid support body 6104 with associated retaining arms 6182 (connected via respective connectors 6184) is an example of apparatus for locating a rigid support body at a retained or predetermined location with respect to an aperture in a wall of a facility, such as a WTG. It will be appreciated that the position of the support body illustrated in FIG. 64A is a retained position.

FIG. 64B illustrates the position of the CPS 6102 of FIG. 64A in cross section. As is shown in FIG. 64B, the outer sleeve 6152 is arranged towards the further end of the rigid support body and radially surrounds a section of the rigid support body proximate to the further end 6440 of the rigid support body 6402. As shown in FIG. 64B, an inner sleeve 6444 is also arranged radially around the rigid support body 6104 at the further end 6440 of the rigid support body. The inner sleeve 6444 includes a flared out inner sleeve base part 6448 most proximate to the further end of the rigid support body. The base part 6448 is substantially rectangular in cross section and is not covered the outer sleeve 6152. The inner sleeve 6444 also includes an inner sleeve stepped part 6452 extending from the base part towards the first end 6456 of the rigid support body and includes a progressively stepped outer surface 6460. That is to say that the stepped part of the inner sleeve has a telescopic profile. As shown in FIG. 64B, due to the stepped outer surface 6460, the inner sleeve gets thinner towards the first end of the rigid support body. That is to say that the stepped part 6460 of the inner sleeve 6444 flares out towards the base part 6448 and towards the further end of the rigid support body. The inner sleeve is made of a polymeric material. Optionally the inner sleeve is formed a metallic material, for example an alloy material. Optionally the inner sleeve is part of the rigid support body and optionally is integrally formed with the rigid support body. It will be understood that the inner sleeve 6444 moves with the rigid support body 6102. That is to say that the inner sleeve does not move relative to the rigid support body. The terminal end of the inner sleeve 6464 at the inner sleeve base part 6448 has a face 6468 that is flat and lies in a plane perpendicular to the primary axis of the rigid support body 6104.

As shown in FIG. 64B, the base is associated with a further drive surface and is arranged at a first terminal end of the further drive surface. The base includes a radially extending flange and is integrally formed with the rigid support body.

A terminal end 6472 of the outer sleeve proximate to the further end of the support body abuts against, or at least contacts, the base 6448 part of the inner sleeve 6444. The base part of the inner sleeve therefore provides a stop such that the outer sleeve 6152 cannot axially slide further towards the further end 6440 of the support body. An inner surface 6474 of the outer sleeve member includes a tapered part 6476 of the outer sleeve member. As shown in FIG. 64B the tapered part of the outer sleeve flares out to a similar degree as the stepped part 6460 of the inner sleeve. It will be understood that the tapered region of the outer sleeve flares out in an opposite direction to the tapered region of the inner sleeve. The tapered part of the outer sleeve therefore flares out towards the first end 6456 of the rigid support body 6102 and a thickness of the outer sleeve narrows towards the further end 6440 of the support body along the tapered part 6476. It will be understood that at least part of the tapered part of the outer sleeve radially faces, and is radially adjacent to the stepped part of the inner sleeve. The tapered part of the outer sleeve and the stepped part of the inner sleeve are separated by a gap that is an expansion region 6480. A swellable sleeve 6482 is located in the expansion region 6480 between the inner and outer sleeve. It will be appreciated that the swellable sleeve is an example of a swellable member. The swellable sleeve is formed from hydrophilic material. It will however be understood that any material that can swell or expand when exposed to water (which may be seawater, freshwater or brackish water for example). As illustrated in FIG. 64B, a radially inner surface 6484 of the swellable sleeve has a stepped profile that is complimentary with the stepped part 6452 of the inner sleeve and a radially outer surface of the swellable sleeve has a tapered surface 6486 that is complimentary with the tapered part 6476 of the outer sleeve. It will be appreciated that the tapered part of the outer sleeve and the stepped part of the inner sleeve flare out towards respective exterior facing end regions associated with the rigid support body. As shown in FIG. 64B, in this position a gap is present between the first end of the outer sleeve and the monopile wall 6112.

As illustrated in FIG. 64B, the outer sleeve has a first end and a remaining end. The first end of the outer sleeve is oblique to an imaginary plane orthogonal to a primary axis associated with a through-bore of the rigid support body. The remaining end of the outer sleeve includes a surface substantially in a further imaginary plane orthogonal to the primary axis and substantially parallel with the first imaginary plane. The outer sleeve of FIG. 64B is manufactured from a polymeric material. The polymeric material from which the outer sleeve is formed is substantially water resistant.

FIG. 65A illustrates the CPS of FIGS. 61 to 64 in another intermediate position 6500. It will be understood that in the intermediate position 6500 of FIG. 65A, the rigid support body 6104 is arranged at the same, or a similar, position with respect to the aperture 6116 of the wall 6112 of the monopile 6108 in the position of FIG. 64. It will however be appreciated that the outer sleeve 6152 has been urged over the surface of the rigid support body 6104 and towards the wall 6112 of the monopile. That is to say that the outer sleeve has axially slid up the support body towards the monopile. It will therefore be appreciated that in the position 6500 of FIG. 65, a gap 6508 between the wall abutment surface 6504 at the first end 6556 of the outer sleeve 6552 is smaller than the respective gap in the intermediate position of FIG. 64. It will be appreciated that the urging of the outer sleeve 6152 towards the wall 6112 occurs when the support body 6104 is immersed in a fluidic environment, such as water including seawater, fresh water and brackish water. This is due to the swelling of the swellable sleeve 6482 located radially between the inner sleeve 6444 and the outer sleeve 6152. It will be appreciated that the swellable sleeve 6482 may swell in one or more dimensions. The swellable sleeve of FIG. 65A swells substantially evenly in all three dimensions however it will be appreciated that a swellable sleeve that only expands in one dimension, or expands in a particular dimension to a greater degree than other dimensions, may be utilised. As shown in FIG. 65A, the inner sleeve 6444 does not move with the outer sleeve 6152 and remains in a fixed position with respect to the rigid support body 6104. It will be appreciated that, due to the axial motion of the outer sleeve towards the monopile, a section of the swellable sleeve is now not covered by the outer sleeve in the position of FIG. 65A. That is to say that a section of the swellable sleeve is located adjacent to, and between, the outer sleeve and the base of the inner sleeve in an axial direction parallel to the primary axis of the rigid support body.

FIG. 65B illustrates the position of the CPS 6102 of FIG. 65A in cross section. FIG. 65B illustrates how the swellable sleeve 6482 has swollen (expanded in all 3 dimensions) due to immersion in seawater. The base 4448 of the inner sleeve 6444 however provides an abutment surface which prevents the swellable sleeve 6482 from expanding into any space towards the further end of the rigid support body. It will be appreciated that expansion of the swellable member along the primary axis of the rigid support body 6104 thus must expand in a direction towards the first end of the rigid support body (towards the monopile wall 6112). It will therefore be appreciated that expansion of the swellable sleeve along the axis of the rigid support body acts to urge the outer sleeve towards the monopile wall 6112.

It will be appreciated that radial expansion of the swellable sleeve 6482 also acts to urge the outer sleeve 6152 towards the monopile wall. As the swellable sleeve expands in a radial direction, it abuts against both the stepped part 6452 of the inner sleeve 6444 and the tapered part 6476 of the outer sleeve. Due to the complimentary arrangement of the inner surface 6484 of the swellable sleeve with the stepped part of the inner sleeve, and the outer surface 6486 of the swellable sleeve with the tapered part of the outer sleeve, being oriented at an oblique angle with respect to the primary axis of the rigid support body, a radially outwardly facing force due to the abutment of the swellable sleeve between the inner and outer sleeves is at least partly transformed into an axial component of force incident on the outer sleeve which acts along the axis of the rigid support body and towards the first end of the rigid support body. The tapered part of the outer sleeve therefore constitutes a radially inwardly facing first drive surface 6540 and the stepped part of the inner sleeve constitutes a radially outwardly facing further drive surface 6550. As the swellable member swells in a radial direction, the force exerted on the first drive surface due to the abutting relationship of the complimentary surfaces of swellable sleeve with both the first and further drive surface respectively acts to urge the outer sleeve in a first direction of motion towards the monopile wall 6112. It will be appreciated that the radial force and any axial component thereof could be measured in Newtons (N) and could be determined based the expandable properties of the swellable sleeve.

It will be appreciated that a drive force is provided on the first drive surface of the outer sleeve to urge the outer sleeve towards the monopile responsive to the swelling of the swellable sleeve. It will be appreciated that the drive force could be measured in Newtons (N) and could be determined based the expandable properties of the swellable sleeve. Aptly the drive force is between 100 kN and 1 MN.

FIG. 66A illustrates the cable protection system of FIGS. 61 to 65 when the rigid support body 6104 is in a retained position 6600 following installation which the retaining arms 6182 are in abutment with the inner surface of the monopile wall 6112 and the outer sleeve 6152 is disposed towards the outer surface of the monopile wall. As is illustrated in FIG. 66A, the wall abutment surface 6604 at the first end 6608 of the outer sleeve 6152 is in an abutting relationship with the monopile wall. It will be appreciated that, due to further swelling of the swellable sleeve 6482, the outer sleeve has been urged further along the rigid support body in a first direction of motion towards the monopile wall relative to the position shown in FIG. 65A described above. It will be appreciated that the retaining arms of the CPS 6102 shown in FIG. 66A are in a deployed position 6616 that is an equilibrium position. With reference to FIG. 63, it will be understood that swivelling the retaining arm 6182 or arms from a storage position 6199 to a deployed position 6616 occurs via an intermediate position 6308 that is a position between the storage and deployed positions. The rigid support body is thus in a predetermined position 6600 in FIG. 66A. The abutment of the outer sleeve against the monopile wall, in conjunction with the deployed position of the retaining arms, secures the rigid support body of the CPS at the retained position. Unwanted motion of the rigid support body within, or proximate to, the aperture, due to environmental fluctuations such as wave cycles and the like, in the monopile wall is therefore limited.

FIG. 66B illustrates the position of the CPS 6102 of FIG. 66A in cross section. As illustrated in FIG. 66B, the swellable sleeve 6482 has further expanded when compared to the position of FIG. 65B. The further swelling of the swellable sleeve shown in FIG. 66B occurs via immersion in seawater for a longer period of time than the position of FIG. 65B. As illustrated in FIG. 66B, the swellable sleeve has radially expanded into an exposed region 6604 between the base 6448 of the inner sleeve 6444 and a further terminal end 6608 of the outer sleeve such that the further terminal end of the outer sleeve abuts against a catch point 6612 in the swellable sleeve 6482. The outer sleeve 6152 cannot slide back down the support body towards the further end of the support body to return to the position shown in FIG. 64.

It will be appreciated that the predetermined position of the rigid support body in the embodiment described in FIGS. 61 to 66 is the position illustrated in FIG. 66. That is to say the predetermined position of the rigid support body is an equilibrium position wherein the rigid support body extends through the aperture, the retaining arms are in abutment with the inner surface of the monopile wall and the outer sleeve is in abutment with the outer surface of the monopile wall. It will be appreciated that in the predetermined position, the retaining arms are arranged in the deployed position.

FIG. 67 illustrates another perspective view 6700 of the CPS 6102 of FIGS. 61 to 66 with the retaining arms 6182 being arranged in the storage position 6199.

FIG. 68 illustrates another perspective view 6800 if the CPS 6102 of FIGS. 61 to 66 with the retaining arms being arranged in an intermediate position 6308.

FIG. 69 illustrates a further perspective view 6900 of the CPS 6102 of FIG. 67. It will be appreciated that FIG. 69 shows the CPS from the so-called bottom side 6164 of the rigid support body 6104. As shown in FIG. 69, two retaining arms 6182₁, 6182₂ are connected to the rigid support body 6104 arranged on diametrically opposite sides of the rigid support body 6104. It will be appreciated that each retaining arm 6182₁, 6182₂ is associated with a respective latch arm 6192.

FIG. 70 illustrates a still further perspective view 7000 of the CPS 6102 of FIGS. 61 to 69. FIG. 14 illustrates the through bore 7004 extending through the bend stiffener 6120. It will be appreciated that the through bore 7004 extends through the whole CPS. FIG. 14 also clearly illustrates the two retaining arms 6182₁, 6182₂ connected to the rigid support body 6104. It will be understood that the perspective view in FIG. 70 illustrates the retaining arms 6182₁, 6182₂ in the intermediate position 6308. FIG. 70 additionally illustrates the recess 6312 in the wall abutment surface 6304 of the outer sleeve 6152 in more detail. FIG. 70 also illustrates that the pair of retaining arms 6182₁, 6182₂ are disposed in a spaced apart relationship on opposed sides of the rigid support body 6104. It will be appreciated that each retaining arm 6182₁, 6182₂ is connected to the support body 6104 via a respective connector 6184. It will be appreciated that each connector 6184 may include a bearing and shaft to allow the retaining arm 6182 to swivel with respect to the rigid support body 6104. In such an arrangement, either the bearing or shaft can be connected to a respective retaining arm and a remainder of the bearing or shaft can be connected to the rigid support body. It will be appreciated that a pair of latch arms are also included in the CPS of FIG. 70, each of the latch arms being associated with a respective one of the pair of the retaining arms 6182₁, 6182₂. It will be understood that the pair of latch arms are disposed in a spaced apart relationship on opposed sides of the rigid support body 6104.

FIG. 71 illustrates a cross-sectional view 7100 of the CPS 702 of FIGS. 61 to 70. FIG. 71 shows that the through bore 7104 extends through the entire length of CPS. FIG. 71 additionally helps illustrate the non-uniform thickness of the tapered region 6128 of the bend stiffener 6120. FIG. 71 helps illustrate that arrangement of the inner sleeve 6444, including a stepped further drive surface 6550 that is a radially outwardly facing surface, and the outer sleeve 6152, including a tapered first drive surface 6540 that is a radially inwardly facing drive surface and is oblique to the primary axis of the rigid support body 6104. As illustrated in FIG. 71. The respective axes of the first and further drive surface are substantially parallel and are spaced apart via an expansion region 6480. The swellable sleeve 6482 is arranged in the expansion region and includes a stepped radially inner surface that is complimentary with the further drive surface and a tapered radially outer surface that is complimentary with the first drive surface.

FIG. 72A illustrates the rigid support body 6104 of the CPS 6102 of FIGS. 61 to 71 in more detail. It will be appreciated that, aside from the connectors 6184 and retaining arms 6182, FIG. 72A illustrates an isolated rigid support body. FIG. 72A illustrates the rigid support body 6104 when not connected to the bend stiffener 6120 or the pull in head adaptor 6124, and when not partially covered by the outer sleeve 6152. The rigid support body is a generally cylindrical and integrally formed unit. A through bore 7204 extends through the rigid support body 6104. It will be understood that a cable, or other flexible elongate member, can be threaded through the rigid support body. The outer surface of the rigid support body 7008 may abut against the inner surface of the aperture 6116 of a monopile wall 6112 in use. It will be appreciated that the outer surface 7008 of the rigid support body 6104 is generally cylindrical. The outer surface 7008 may therefore include a substantially resistant and/or robust material to help avoid damage to the rigid support body in use. Optionally the outer surface of the rigid support body may be coated/covered with a protective and/or water resistant/proof and/or corrosion resistant cladding/coating. As is illustrated in FIG. 72A, the outer cylindrical surface includes a dished out surface region 6314. It will be understood that each retaining element is connected via a respective connector at a respective dished out surface region. It will be understood that each dished out surface region 6316 includes a first dished out end region 7212 and a further dished out end region 7216. As is shown in FIG. 72, the first dished out end region 7212 and the further dished out end region 7216 are disposed on opposed sides of a respective connector 6184 location. FIG. 72A also illustrates a respective non dished out region 7220 of the outer surface 7208 of the rigid support body proximate to the first and further dished out end regions. The non dished out region 7220 includes an abutment surface 6316. It will be understood that the abutment surface 6316 provides a stop to prevent swivelling motion of a respective retaining arm 782 beyond a preset place. As is illustrated in FIG. 72A, a pair of retaining arms 6182 are disposed in respective substantially diametrically opposed side positions on the outer cylindrical surface 7208. It will be appreciated, but not shown in FIG. 72A, that a further dished out portion 7216 is located on the reverse side of the rigid support body 6104 (substantially facing into the page in FIG. 72A). It will be appreciated that both retaining arms 6182 may swivel together or may swivel independently of each other.

FIG. 72B illustrates an end on view of the rigid support body 6104 when the retaining arms 6182₁, 6182₂ are not disposed in the storage position. As shown in FIG. 72B. the rigid support body 6104 includes a through bore 7204 extending through the support body. In order to maintain the integrity of the support body in use, due to abutment with the monopile wall and corrosion etc, the tubular rigid support body 6104 must be of a minimum thickness. The thickness of the support body in FIG. 72B is 15 mm. Optionally the thickness of the support body may be 12 mm. Optionally the thickness of the support body is between 1 mm and 100 mm thickness. The support body has a bore 5704 diameter 200 mm. Optionally the bore 7204 diameter is between 100 and 500 mm. The bore diameter is tailored to the cable that is to be threaded through the support body. It with reference to FIGS. 61 to 71, it will be appreciated that the support body includes two dished out surface regions 6316 proximate to respective retaining arms. In order to maintain the required thickness of the support body, the bore 7204 narrows throughout the portion of the support body that includes the dished out surface regions 6116. Two inwardly extending wall regions 7240, each arranged at a respective dished out surface region 6316, therefore maintain the thickness of the support body throughout each dished out surface region of the rigid support body. FIG. 72B also helps to illustrate that each retaining arm 6182₁, 6182₂ includes two wall abutment surfaces 7244₁, 7244₂, 7248₁, 7248₂ that abut with an inner surface of the monopile wall when the retaining arm is arranged in a deployed position in use. FIG. 72 additionally helps to illustrate the position of the abutment elements that are abutment pins of each latch arm 6192.

FIG. 72C illustrates an end on view of the rigid support body 6102 of FIG. 72A when the retaining arms are disposed in a storage position. FIG. 72C helps illustrate the inwardly extending wall regions 7240 of the through bore. It will be appreciated that the inwardly extending wall regions 7240 are only present through the portion of the rigid support body that includes the dished out surface regions 6116 and therefore the inwardly extending wall portions 7240 do not extend throughout the whole length of the rigid support body.

FIG. 73A illustrates the retaining arm 6182 of the CPS 6102 of FIGS. 61 to 71 in more detail. FIG. 73A shows an isolated retaining arm 7300. The retaining arm 6182 is an example of a retaining element. The retaining arm 6184 includes an elongate retaining body 7304. The elongate body 7304 is associated with a principal arm axis and arranged to swivel about the through hole 6186 that is a swivel point that is on the principal arm axis but offset from a centre point on the arm axis along a length of the retaining arm 6182. The retaining arm is formed from a metallic material. Optionally the retaining body may be manufactured from an alloy material. Optionally the retaining body may be made from any other suitable material. The retaining body 7304 includes a through hole 6186. It will be understood that the through hole is able to receive a connector to connect the through hole to a rigid support body. The through hole may include, or be associated with, a bearing to facilitate swivelling of the retaining arm about the through hole 6186 which is therefore a swivel point. The through hole 6186 may include a low-friction or frictionless inner surface to facilitate swivelling. As indicated above, the through hole 6184 is located proximate to the first end 6188 of the retaining arm 6182. It will be appreciated that the through hole 6184 is an example of an eyelet having a circular cross section through the retaining arm 6182 and is located on the principal axis of the retaining arm 6182. A coupling region 7308 is located at the further end 6190 of the retaining arm 6182. The coupling region 7308 is coupled to a respective latch arm 6192 via a frangible connector 6198 when the retaining arm 6182 is in the storage position 6199. The coupling region illustrated in FIG. 73A is a recess for receiving a pin. The retaining arm includes a wall abutment surface 6404 for abutting against an inner surface 6408 of a monopile wall 6112 when the retaining arm 6182 is disposed in the deployed position 6112. Optionally the wall abutment surface 6404 wall abutment surface may be covered in a protective cladding for protecting the inner surface 6408 of a monopile wall 6112 in use. It will be appreciated that the first end 6188 and the further end 6190 of the retaining arm 6182 are spaced apart across the elongate body 7304.

FIG. 73B illustrates a different perspective view 7340, that is a top-down view, of the retaining arm of FIG. 73A. As is illustrated in FIG. 73B, the retaining arm 6182 includes a through hole 6186 that is located a position along a primary axis associated with the retaining arm that is axially offset from a centre point of the retaining arm primary axis. That is to say that the through hole is located more proximate to a first end of the retaining arm than a further end of the retaining arm. The retaining arm receives a connector 6184 that may include a shaft and/or bearing and/or spigot. With reference to FIGS. 61 to 64, it will be appreciated that in use, when the retaining arm is released from a storage position (by cracking a frangible part that is part of or associated with a latch arm, the latch arm being associated with the retaining arm), the offset positioning of the through hole (and associated connecter) enables the retaining arm to swivel from the storage position to an intermediate or deployed position. That is to say that, as the through hole, which is an example of a swivel point or swivel region, is offset with respect to the centre of mass (and centre of gravity) of the retaining arm, a rotational force that is a restoring torque is exerted upon the retaining arm to swivel the retaining arm away from the storage position which, in the absence of a connection between the retaining arm and a respective latch arm, is a non-equilibrium position. The retaining arm illustrated in FIGS. 73A and 73B has a through hole diameter of approximately 50 mm to receive a cylindrical connector spigot with a diameter also of approximately 50 mm. It will be understood that any other suitable dimensions of through hole and cooperating connector could instead be utilised.

FIG. 73B also helps illustrate the position of two wall abutment regions 73441, 73442 of a wall abutment surface 7348 of the retaining arm. The wall abutment regions are axially located on either side of the portion of the retaining body that includes the through hole. It will be appreciated that the wall abutment regions abut against an inner surface of the monopile wall in use when the retaining arm is located in a deployed position (illustrated in FIG. 64). Arrow A indicates a force incident on a first wall abutment region 73441 due to an abutting relationship with the inner surface of the monopile wall and Arrow B indicates a force incident on the further wall abutment region 73442 due to an abutting relationship with the inner surface of the monopile wall in use, and when the retaining arm is oriented in the deployed position (as illustrated in FIG. 64). It will be appreciated that the whole weight of the CPS may be distributed among any number of retaining arms utilised in the CPS that are in a deployed position. Alternatively, a winch may provide a tension that partially supports the CPS weight via a winching line connected to a cable where a covered part of the cable extends through the rigid support body of the CPS. Alternatively, a winching line may be connected to the CPS itself. It will therefore be appreciated that substantial load can be applied to the monopile wall via each wall abutment region of each retaining arm. With reference to Newton's third law of motion, the monopile wall thus exerts an identical but opposed force on each wall abutment region of the wall abutment surface of the retaining arm. It will be appreciated that the combined force exerted on the first and further wall abutment region is transferred to engaged surface regions 7352, 7354 of the through hole and the connector (the spigot) which are most proximate to the wall abutment surface of the retaining arm. It will therefore be appreciated that the weight of the CPS may be supported by a number of connectors associated with each retaining arm situated in a deployed position. It will be appreciated that, in the CPS embodiment described herein, two retaining arms (the first a further retaining arms) are utilised and therefore the weight of the CPS is support by the first and further connectors that are associated with the respective first and further retaining arms. It will therefore be appreciated that a portion of the CPS weight (which may be around half of the CPS weight that is not further supported by other methods or devices or mechanisms) is supported by the connector shown in FIG. 73B when the retaining arm of is oriented in a deployed position in use. The weight incident on the retaining arm in use is illustrated by arrow C.

It will be appreciated that, when compared with prior art retaining systems discussed with regard to technological background above, the load path from the location of abutting wall abutment regions of the retaining arm to the load supporting region of the connector is relatively short. Furthermore, due to the orientation of the retaining arms (that are able to swivel), the force exerted on the connector is directed substantially through the connector in a direction perpendicular to an axis associated with the connector, and is predominantly a shear force. That is to say, the degree to which rotational moments are applied to the connector are limited. Thus, the present arrangement and relatively short load path result in a more efficient retaining system which is less prone to failure than current prior art solutions. It will be appreciated that, utilising the two retaining arms described in the present CPS embodiment yields four wall abutment regions. The retaining arm arrangement is therefore a much more efficient use of material than prior art solutions, such as latch arm solutions discussed above. In fact, the retaining arm arrangement disclosed herein, which utilises two retaining arms, is 21 times more efficient than some currently adopted prior art solutions.

As discussed in the background section above, prior art CPS retaining solutions typically support the weight of the CPS at a particular point, or a particular number of points, for example a terminal end of a latch or a surface of a ball. These points are typically of limited surface area and therefore exhibit significant point loading on the inner surface of the monopile wall. It will be appreciated that higher contact stresses imparted on an inner surface of a monopile wall typically results in a higher rate of corrosion and therefore a reduced lifetime of an associated WTG. Such point loading of prior art approaches discussed above yields considerably higher contact stresses between retaining elements and the inner surface of the monopile wall. The beam loading of each (of the two) retaining arms utilised in the present CPS embodiment significantly reduces that contact stresses imparted on the monopile wall by distributing the weight of the CPS over four wall abutment regions (two on each retaining arm). It will be understood that at least some of these wall abutment regions may additionally have a larger surface area than abutment surfaces in prior art retaining elements thereby further decreasing stresses imparted on the monopile wall. Such an arrangement helps limit corrosion of the abutting regions of the monopile wall thereby helping to extend the lifetime of a WTG associated with the monopile. It will be appreciated that the high point loading of some prior art retaining solutions results in brinelling and other aberrant effects of abutment under load at the latch-monopile wall contact surfaces which increases the rate of corrosion.

Some prior art retaining solutions include a latch system which generates loading incident on a supporting point, which is often a pin proximate a terminal end of a latch, of around 1.5 times the force applied to the monopile wall by the abutment surface of the latch divided by the area of the latch abutment surface in contact with the monopile wall (Load=1.5×Force/Area). The present latch arm arrangement however, due to the geometry and relative dimensions of the latch arms illustrated in FIG. 73B, generates a load on the connector that is one fourteenth of the force applied to the monopile wall by the abutment surface regions of the arms divided by the area of the combined abutment regions of the arms in contact with the monopile wall ( 1/14×Force/Area). It will be appreciated that, when compared with prior art systems, the present retaining arrangement results in a considerable reduction of loading stresses.

It will be understood that, in the present CPS embodiment, the size of the connector is not as constrained by space within the CPS and/or monopile and therefore the connector can readily by enlarged to provide additional strength (resilience to the loading of the CPS) if necessary.

For example, some retaining arms provide two areas of contact between the wall abutment surface of the retaining arm and an inner surface of the monopile wall, the areas of contact being arranged at the interface between the retaining arm and the monopile wall at either side of the swivel region. When the swivel region is offset axially with respect to the retaining arm (that is to say, not equidistant from each terminal end of the retaining arm) the effective areas of contact may be located at a distance of 2 L and L (L being an arbitrary distance) from the swivel region (taken along the wall abutment face of the retaining arm) respectively. The effective areas of contact may each be at a distance of 1.25 D and D (D being an arbitrary distance) from respective most proximate terminal ends of the wall abutment surface of the retaining arm. In a dual retaining arm system, in which a retaining arm is arranged on either side of a rigid support body is, there are 4 areas of contact between the retaining arms and the inner surface of the monopile wall (two areas of contact on each retaining arm). Thus, for an arbitrary force F (indicated by C in FIG. 73B) that is a load incident on each of the retaining arms due to the weight of the CPS system (and associated apparatus, for example the flexible elongate member) when the CPS is retained, by the arms, at a position at least partly through the aperture of the monopile wall, the resulting reaction forces at each of the effective areas of contact may be around R_{A}=F/3 (indicated by A in FIG. 73B) and R_{B}=⅔F (indicated by B in FIG. 73B) respectively. The shear area may be around 14A (A being an arbitrary area). A minimum shear stress incident on the connector located at the swivel region may be around F/14A. A maximum contact stress between the monopile wall and the retaining arm may be around 0.3 F/DW (where W is the width of the wall abutment surface of the retaining arm).

It can be shown that, for some prior art latch systems which utilise point loading in which all the force, F, associated with the retaining of a CPS in a monopile is incident at a single effective area of contact of the latch (in abutment with an inner surface of a monopile wall), the shear area may be around 2A. It can be shown that the minimum shear stress incident on a pin of the latch is around 3 F/2A. It can be shown that the minimum contact stress between the monopile wall and the latch is around 0.6 F/DW (where D is the length of the wall abutment surface of the latch and W is the width of the wall abutment surface of the latch). Thus, as indicated above, the load on a connector associated with a retaining arm is one fourteenth of the load associated on a pin of a prior art latch, and the use of a retaining arm system is 21 times more efficient than a prior art latch system.

It will further be appreciated that the use of two retaining arms, arranged at substantially opposite sides of the rigid support body helps limit, reduce or avoid misalignment of the system in use. It will be understood that misalignment of prior art systems can result in aberrant increases in loading on retaining latches (and components associated with such latches such as supporting elements) and/or the inner surface of the monopile wall and can ultimately result in damage. Such misalignment includes rotational and axial misalignment of the rigid support body with respect to a desired angle of penetration of the rigid support body through the aperture in the monopile wall when the rigid support body is arranged in a predetermined position or a retained position. This is due to the symmetrical arrangement of he two retaining arms. It will be appreciated that, should the rigid support body be rotationally misaligned in the aperture (such that each retaining arm is not arrange on substantially horizontally opposed sides of the support body), the force on each retaining arm will not be evenly distributed. The retaining arms will additionally not be swivelled away from the storage position to the same degree. That is to say that, at a particular instance in time, one of the retaining arms will be swivelled further away from the position of the retaining arms when arranged in the storage position than the other arm. At least partly due to the uneven distribution of such forces, the arms generate a restoring torque which acts to equilibrate the forces incident on each of the arms. This restoring torque thus acts to reduce misalignment of the rigid support body. The restoring torque thus acts to urge the rigid support body towards the predetermined position and acts to urge the retaining arms towards the deployed position.

FIG. 73C illustrates a still further perspective view of the retaining arm of FIG. 73A. It will be appreciated that FIG. 73C illustrates a side-on view of the retaining arm. FIG. 73C helps illustrate the wall abutment regions of the wall abutment surface of the retaining arm. FIG. 73C also helps illustrate the geometry of the through hole, a cross section of which is indicated by the dotted lines in FIG. 73C.

FIG. 73D illustrates another perspective view of the retaining arm of FIG. 73A. It will be appreciated that FIG. 73D illustrates an end-on view of the retaining arm.

FIG. 74 illustrates the latch arm 6192 of the CPS 6102 of FIGS. 61 to 71 in more detail. It will be appreciated that FIG. 74 illustrates a latch arm 6192 in isolation. The latch arm 6192 includes an elongate latch arm body 7404. The frangible connector 6196 is located at a first end 7408 of the latch arm 6182. The frangible connector 6196 is optionally an includes an eyelet or a socket body 7420 for receiving an elongate pin and a narrowed region 7412 between the eyelet and the latch arm body 7404. Alternatively, the frangible connector may include an elongate pin for connection to a respective socket in a retaining arm. It will be understood that the narrowed region 7412 is designed to fracture/break when subjected to a predetermined threshold force before any of the other elements associated with the latch arm 6192 break. It will be appreciated that the latch arm 6192 may instead include a different frangible portion which can be connected to a retaining arm. Optionally a frangible portion is located within the body 7404 of the latch arm 6192 such that the latch arm is breakable at a predetermined position, or cracking point, of the latch arm 6192. The abutment element is located proximate to a further end 7416 of the latch arm 6192. The abutment element 6198 of FIG. 74 is a peg member that extends away from the latch arm 6192. It will be appreciated that the abutment element 6198 moves with the latch arm 6192. It will be appreciated that the abutment element 6198 may instead be a protrusion or different geometry, for example triangular or rectangular and the like, or may be a recess in the latch arm 6192 that engages with a protrusion associated with a monopile wall, or the wall of any other suitable facility. With reference to FIGS. 63 and 70, it will be appreciated that peg 6198 can be located in a cooperating (or accommodating) recess 6314 in an inner surface (the surface of the outer sleeve in contact with the support body) of an outer sleeve 6152 coupled to the rigid support body 6104.

It will be appreciated that, when slidably disposed in a recess 6196 of a rigid support body 6104 (or coupled to the rigid support body) and in use during a pull-in process of the like in which the rigid support body 6104 is urged into a monopile 6108 via an aperture 6116 in a monopile wall 6112, the peg 6198, (which moves with the latch arm) abuts against the outer surface of the monopile wall 6112. It will be understood that, as the support body is urged into the monopile, due to the abutting relationship between the monopile wall 6112 and the peg 6198, an abutment force acts on the peg 6198 acting away from the wall 6112. It will be understood that the abutment force in generated in response to the peg 6198 abutting an outer surface of the wall 6112 of the monopile 6108 proximate to the aperture 6116 as a portion of the rigid support body 6104 is urged through the aperture 6116. When the abutment force overcomes a predetermined threshold force, which is a cracking force required to crack the frangible connector 6198 and can therefore be specified in manufacture of the latch arm 6192, the frangible connector 6198 is cracked. That is to say that the frangible connector breaks responsive to the abutment force. Following the cracking of the frangible connector 6198, it will be understood that the latch arm 6192 slides in the first direction of motion due to the abutment of the monopile wall 6116 against the abutment peg 6198. It will therefore be appreciated that, when the abutment force exceeds the predetermined threshold force, sliding of the latch arm 6192, and swivelling of the retaining arms 6182 from a storage position to a deployed or intermediate position is permitted. It will be appreciated that when the latch arm 6192 is connected to a respective retaining arm 6182 via the frangible connector 6198, which prevents slidable motion of the latch arm 6192 in the recess of the rigid support body 6104, the latch arm 6192 prevents swivelling of the respective retaining arm 6182 from a storage position to an intermediate or deployed position.

It will be appreciated that the abutment element of FIG. 74 is generally cylindrical. Optionally the abutment element may be any other shape. The abutment element may be a peg member. It will be appreciated that, in use, a cylindrical abutment element engages and abuts against an outer surface of a monopile wall at a consistent set-off distance and therefore offers some control over the position of the CPS relative to the monopile wall and associated aperture when the abutment element is expected to engage with the monopile wall. The generally cylindrical arrangement of the abutment element helps ensure consistent engagement between the monopile wall and abutment element as the abutment element will generally always engage the monopile wall at a curved outer surface of the generally cylindrical body of the abutment element.

It will be appreciated that an elongate pin member may instead constitute a frangible portion of the latch arm of FIG. 74. The elongate pin may be arranged to extend through a through-hole located at and end of the latch arm distal to the abutment element. The elongate pin may be polymeric or wooden or the like. The elongate pin may be substantially brittle and thus may completely shear when a sufficient force is applied to the pin. It will be appreciated that the pin may shear when a shearing force/cracking force of around 3000 N is incident on the pin. It will be appreciated that the pin may shear when a shearing/cracking force of between 2000 N and 10000 N is incident on the pin. It will be appreciated that the shearing force required to shear the pin may be relatively similar when the pin is dry and when the pin is wet. It will be appreciated that the pin may shear under a well-defined shearing/cracking force which corresponds or is related to a predetermined threshold force which may be generated by applying a tension to a winching line to pull the CPS into an aperture of a wall of a monopile such that an abutment element of the latch arm abuts against an outer surface of the monopile wall to transfer force to the pin. It will be appreciated that the pin may shear across a thinnest diameter of the pin, the axis of shearing aptly being around 90 degrees to the primary axis of the pin.

FIG. 75 illustrates another example of a latch arm 7500 for use in the CPS of FIGS. 61 to 72. The latch arm 7500 includes an elongate latch arm body 7504. A frangible connector 7508 is located at a first end 7512 of the latch arm 7500. The frangible connector 7508 includes an eyelet 7516 for receiving a pin and a narrowed region 7520 between the eyelet 7516 and the latch arm body 7504. It will be understood that the narrowed region 7520 is designed to fracture/break when subjected to a predetermined threshold force before any of the other elements associated with the latch arm 7500 break. The abutment element 7522 is located at a further end 7524 of the latch arm. The abutment element 7522 is a protruding wedge located at the terminus of the further end 7524 of the latch arm 7500. The abutment element 7522 includes an abutment face 7528 for abutting against monopile wall in use.

It will be understood that the abutment face 1926 of the wedge is oblique to a primary axis of the latch arm which at least partly cooperates with the outer surface of a monopile wall against which the abutment face abuts. For example, the abutment face at least partly cooperates with a curved outer surface of a monopile wall. It would be understood that the oblique abutment surface helps ensure that the abutment element abuts with the outer surface of the monopile wall at a desired orientation. It will be appreciated that the oblique abutment face, that is substantially flat defines a particular surface area of contact between the outer surface of the monopile wall and the abutment element. Thus, the oblique abutment face, which is at least partly complimentary to an outer surface of a monopile wall provides a greater control of the pulling force on the elongate flexible member (and thus on the CPS respectively) required to achieve a predetermined threshold force and crack (that is, to shear or completely break) the frangible portion of the latch arm. It will be appreciated that this is due to the fact that a reasonable estimation can be made as to the area of the abutment element and monopile wall that are in contact when the oblique surface of the abutment element abuts against the monopile wall. As indicated previously, the pulling force and predetermined threshold force could be measured in Newtons (N).

Aptly the latch arm is disposed to break at the frangible portion when exposed to a force of between 2000 and 10000 N, aptly around 3000 N.

It will be appreciated that an elongate pin member may instead constitute a frangible portion of the latch arm of FIG. 75. The elongate pin may be arranged to extend through a through-hole located at and end of the latch arm distal to the abutment element. The elongate pin may be polymeric or wooden or the like. The elongate pin may be substantially brittle and thus may completely shear when a sufficient force is applied to the pin. It will be appreciated that the pin may shear when a shearing force/cracking force of around 3000 N is incident on the pin. It will be appreciated that the pin may shear when a shearing/cracking force of between 2000 N and 10000 N is incident on the pin. It will be appreciated that the shearing force required to shear the pin may be relatively similar when the pin is dry and when the pin is wet. It will be appreciated that the pin may shear under a well-defined shearing/cracking force which corresponds or is related to a predetermined threshold force which may be generated by applying a tension to a winching line to pull the CPS into an aperture of a wall of a monopile such that an abutment element of the latch arm abuts against an outer surface of the monopile wall to transfer force to the pin. It will be appreciated that the pin may shear across a thinnest diameter of the pin, the axis of shearing aptly being around 90 degrees to the primary axis of the pin.

FIG. 76A illustrates a first step 7600 in a decommission process for a CPS 7604 in which a rigid support body 7608 is arranged at a predetermined location 7610 through an aperture 7614 in a wall 7618 of a monopile 7622. It will be understood that the monopile 7622 is an example of a facility. The CPS 7604 may be installed in any other suitable facility. Some examples of facilities are indicated with respect to FIG. 1. It will be understood that a decommission process involves removal of a CPS from an aperture of a facility. It will be understood that that the CPS 7604 illustrated in FIG. 76 in a first decommission step 7600 may be the CPS of FIG. 7, FIG. 20, FIG. 33, FIG. 46 or FIG. 61 when the rigid support body is disposed in a retained state (as shown for example in FIG. 10). The retained state is a retained position at the predetermined location 7610 of the support body. As shown in FIG. 76A, a retaining arm 7626 is disposed in a deployed position 7630 where two wall abutment surfaces 76341, 74342 of the retaining arm 7626 are in an abutting relationship with respective regions of an inner surface 7638 of the monopile wall 7618. The CPS shown in FIG. 76A utilises two retaining arms and therefore the retaining arm 7626₁ shown in FIG. 76A is a first retaining arm 7626₁.

FIG. 76A illustrates how a first end 7642 of the rigid support body 7608 is connected to a bend stiffener 7646. The bend stiffener shown in FIG. 76A is a dynamic bend stiffener. It will be appreciated that a bend stiffener is an example of a bend stiffening element and therefore the bend stiffener 7646 of FIG. 76A is an example of a dynamic bend stiffening element. The bend stiffener 7646 constitutes a terminal end of the CPS 7604 that is located in an inner region 7650 on the monopile 7622. It will be understood that the inner region 7650 is a region enclosed, or partially enclosed, by the wall 7618.

FIG. 76A also shows how a cable 7650 extends out of a terminal free end of the bend stiffener 7640 which is a terminal end of the CPS 7604 arrangement. The cable 7650 is an example of a flexible elongate member. A cable grip 7654 is arranged to secure around the end of the cable that is within the monopile 7622 (i.e the cable secures around the end of the cable that is located in the inner region 7650 of the monopile). The cable grip 7654 is connected to a first winching line 7658 via a coupling 7666. The cable grip of FIG. 76A and the coupling arrangement 7662 between the grip 7654 and first winching line 7658 is the arrangement shown in FIG. 4. The cable grip is therefore a Chinese-Finger-like element. It will be appreciated that any other clamping or securing method could instead be utilised. A coupling loop 7666 of the cable grip 7654 extends through a pull-in head 7670. That is to say that the pull-in head 7670 includes a through-bore and the coupling loop 7666 is pulled through the through-bore of the pull-in head 7670. It will be understood that the pull-in head 7670 of FIG. 76A is oriented such that a plurality of latch fingers 7672 arranged circumferentially on an outer surface of the pull-in head flare out in a direction towards the winching line 7658. A remaining end of the first winching line is connected to a winch 7674. It will be appreciated that the winch 7674 is an example of a first elongate member winch element. It will be appreciated that the first winching line 7658 is an example of a first elongate member winching line. Alternatively, the pull-in head is a release cone, and the latch fingers are outwardly biased.

FIG. 76B illustrates the CPS decommission step 7600 of FIG. 76A in cross section. FIG. 76B illustrates how the cable 7650 is arranged through a through bore 7678 which extends through the CPS 7604. FIG. 76B also illustrates the further retaining arm 76262 which is arranged in the deployed position 7630.

FIG. 77 illustrates a further step 7700 of the CPS decommission process for the CPS 7604 of FIG. 76A, in which a rigid support body 7608 is arranged at a predetermined location 7610 through an aperture 7614 in a wall 7618 of a monopile 7622, in cross section. As shown in FIG. 77, the cable has been pulled further outside of the monopile with respect to the position shown in FIGS. 76A and 76B. This may be achieved by cooperatively reducing a first tension on the cable, 7650 provided by the first winch 7674 from within the monopile via the first winching line 7658, and increasing a further tension on the cable, provided by a further winch from outside of the monopile 7618 via a further winching line. It will be appreciated that such cooperative tensioning of the cable (via adjustment of the first and further tensions) can be achieved by the arrangement described with reference to FIG. 5 above. It will be appreciated that the first tension and further tension could be measured using a tension meter and could be measured in Newtons (N). It will be appreciated that the first tension and further tension are examples pulling forces. As shown in FIG. 77 the cable 7650 has been pulled through the CPS 7604 such that a first end 7704 of the cable 7650 and a portion of the pull-in head 7670 are located within the bend stiffener 7646 of the CPS 7604.

Optionally, prior to connecting the cable to the first winching line (and also to the pull-in head adaptor) the end region of the cable, which is an example of a flexible elongate member, is unsecured from a securing element inside the facility. It will be appreciated that the cable extends through a through bore of the rigid support body.

FIG. 78 illustrates a still further step 7800 of the CPS decommission process for the CPS 7604 of FIGS. 76 and 77, in which a rigid support body 7608 is arranged at a predetermined location 7610 through an aperture 7614 in a wall 7618 of a monopile 7622, in cross section. As shown in FIG. 78, the cable has been pulled further outside of the monopile with respect to the position shown in FIG. 77 such that the first end 7704 of the cable 7650 is located within the rigid support body 7608. The pull-in head is located at a first end 7808 of the rigid support body 7608 such that the latch fingers 7672 of the pull-in head are engaged in a complimentary and abutting relationship with a latch finger engagement surface 7816 of the inner surface of the first end 7808 of the rigid support body 7608. That is to say that the latch finger engagement surface 7816 extends radially inwardly and is thus a narrowed region of the rigid support body 7608 inner diameter. Therefore, due to the direction in which the latch fingers 7672 flare out, which is oblique to the primary axis associated with the cable 7650 and widens in a direction towards the winching line, the latch fingers 7672 can be compressed to be pulled passed the latch finger engagement surface in a direction towards the aperture 7614. Once the latch fingers 7672 move past the latch finger engagement surface 7816, the latch fingers return to the flared out state and are arranged to abut against the latch finger engagement surface as illustrated in FIG. 78, such that the pull-in head 7670 cannot move further inside the monopile (towards the winch) independently of the rigid support body of the CPS. It will be appreciated that one or more than one latch finger engagement surface 7816 may be arranged in the rigid support body 7608.

It will be understood that the pull-in head is lowered through the bend stiffener which optionally is a dynamic bend stiffening element, to a first raised end of the rigid support body. The pull-in head may be a release cone. As the head/cone is located through the rigid support body, the pull-in head/release cone is secured to the rigid support body via a cooperating relationship between at least one recessed region in an inner bore of the rigid support body and a respective finger of the head/cone which may be biased outwardly or may return from a compressed state to an equilibrium position to engage with the recessed region.

FIG. 79 illustrates another step 7900 of the CPS decommission process for the CPS 7604 of FIGS. 76 to 78, in which a rigid support body 7608 is arranged through an aperture 7614 in a wall 7618 of a monopile 7622, in cross section. When compared with the position 7800 shown in FIG. 78, the cable 7650 of FIG. 79 has been pulled further into the monopile 7622. This is achieved by increasing the first tension (which acts towards the first winch 7674 located within a WTG which includes the monopile 7622) on the cable 7650 provided by the first winch 7674 via the first winching line 7658. Due to the abutting relationship between the latch fingers 7672 of the pull-in head 7670 with the latch finger engagement surface 7816 of the inner surface of the rigid support body 7608, the cable cannot move back towards the first winch 7674 (further towards and into the monopile 7622) independently of the rigid support body 7608 of the CPS 7604. The rigid support body 7608 (alongside the entire CPS 7604) is thus lifted towards the monopile wall 7618, the support body 7608 extending further through the aperture 7614.

As shown in FIG. 79, the rigid support body 7608 is pulled further through the aperture 7614 of the monopile wall 7618 until a maximum displacement of the rigid support body 7604 through the aperture 7614 is reached. The maximum displacement is determined by the abutment of an outer wall abutment surface 7908 of an outer sleeve 7912 that surrounds a further end 7916 of the rigid support body 7608 distal to the first end 7704 of the support body with an outer surface 7920 of the monopile wall 7618 proximate the aperture 7614. The position 7900 illustrated in FIG. 79 is thus at this maximum displacement of the support body/CPS towards and into the monopile. As is illustrated, at this position, there is clearance/a gap 7924 between an inner surface 7928 of the monopile wall 7618 and the further retaining arm 76262. It will be appreciated that similar there is a similar gap/clearance between the inner surface 7928 of the monopile wall 7618 and the first retaining arm 7626₁. The retaining arms are thus no longer disposed in a deployed position and are instead arranged in an intermediate position 7928. The rigid support body is thus no longer disposed in a retained position and instead is arranged in an intermediate position 7932.

It will be appreciated that, in FIG. 79, the covered region of the cable has been urged away from an inner surface of the wall of the monopile to release a load force on each retaining arm. Such urging is achieved by pulling on a pulling line secured to the cable via a winch within the WTG. Optionally the winch is located in tower region of the WTG such as the turbine tower, which is an example of a tower structure mounted on a facility.

It will be appreciated that, with respect to FIG. 78, the direction of motion of the cable (and the pull-in head or release cone) has been reversed by pulling on a respective winching line. The rigid support body and flexible elongate member and release cone are thus pulled together away from the wall of the monopile.

FIG. 80 illustrates another step 8000 of the CPS decommission process for the CPS 7604 of FIGS. 76 to 79, in which a rigid support body 7608 is arranged through an aperture 7614 in a wall 7618 of a monopile 7622. It will be appreciated that in the step shown in FIG. 80 8000, the CPS is in substantially the same position as in FIG. 79 7900. It will be appreciated that rolling or yawing or pitching motion due to the surrounding environment may result in slight positional changes of the CPS as shown in FIG. 80, with respect to the aperture 7614, compared with the step shown in FIG. 79 7900. FIG. 80 helps to illustrate the clearance (or gap) between the first retaining arm and the inner surface of the monopile wall 7618.

As illustrated in FIG. 80, a portion of the first winching line 7658 is threaded through a collar 8008. The collar is located within the monopile 7622. The collar 8008 is therefore able to axially slide along the first winching line 7658. The collar includes a collar body 8016 which is formed from a first arcuate collar body portion 8020₁ and a further arcuate collar body portion 8020₂. The two collar body portions 8020₁, 8020₂ are therefore split collar body portions and can be secured together to form the collar 8008. That is to say that the split collar portions are arranged in a juxtaposed relationship into to form a generally cylindrical arrangement/configuration, each split collar portion including a cylindrical portion part and a protruding portion. It will be appreciated that, while two split collar body portions form the collar of FIG. 80, any other suitable number of split collar body portions could instead be utilised. Optionally, as an alternative, the collar 8008 may be integrally formed. The collar is secured via two straps 8024 however it will be appreciated that other suitable securing methods could instead be utilised including welding, bolting, screwing, gluing and the like. The collar 8008 includes a cylindrical portion 8028 which is generally cylindrical or annular and includes a cylindrical though bore 8032. The collar also includes a first protruding portion 8036 which extends from the cylindrical portion, on a particular side of the collar. That is to say that the first protruding portion only connects to part of the cylindrical portion. The first protruding portion extends along an axis that is parallel with the primary axis of the cylindrical portion. The first protruding portion 8036 includes 8040 a terminal end region that is a free end region not connected to the cylindrical portion which includes a surface 8044 that is angled and is oblique to the primary axis of the first protruding portion. The terminal end region is distal to the cylindrical portion and includes the angled surface 8044 which is a first protruding portion abutment surface. A magnet 8048 is arranged proximate to the first protruding portion end region 8040. The magnet is an example of a magnetic element. A magnetic element is an example of a collar biasing element. It will be appreciated that two, three, four or more magnets may instead be included. It will be understood that the magnet is supported by the collar body distal to the cylindrical portion and disposed at an end region of the first protruding portion.

The cylindrical portion 8028 of the collar 8008 includes an eyelet 8052 on an opposite side of the cylindrical portion 8028 from which the first protruding portion 8036 extends. Optionally the eyelet may instead be a securing clasp or the like. The eyelet is located on an outer surface or terminal end of the cylindrical portion. A collar winching line is coupled to the eyelet. A remaining end of the collar winching line is connected to a collar winch 8060 which is an example of a collar winch element.

FIG. 81 illustrates another step 8100 of the CPS decommission process for the CPS 7604 of FIGS. 76 to 80, in which a rigid support body 7608 is arranged through an aperture 7614 in a wall 7618 of a monopile 7622. It will be appreciated that in the step shown in FIG. 81 8100, the CPS is in substantially the same position as in FIGS. 79 7900 and 80 8000. In FIG. 81, the collar winch 8060 has released more of the collar winching line 8056 such that a free portion of the collar winching line is longer than a free portion of the collar winching line shown in FIG. 79. The collar 8008 has therefore been allowed to axially slide along the first winching line 7658 towards the CPS 7604 and towards the monopile wall 7618. The first protruding portion 8036 of the collar 8008 is thus now located partially over a terminal, free end of the bend stiffener 7646 of the CPS 7604.

FIG. 82 illustrates another step 8200 of the CPS decommission process for the CPS 7604 of FIGS. 76 to 81, in which a rigid support body 7608 is arranged through an aperture 7614 in a wall 7618 of a monopile 7622. It will be appreciated that in the step shown in FIG. 82 8200, the CPS is in substantially the same position as in FIG. 79 to FIG. 81. In FIG. 82, the collar winch has further unwound the collar winching line 8056 to further extend a free portion of the collar winching line 8056 when compared to the arrangement illustrated in FIG. 81. The collar 8008 has thus axially slid over the CPS such that the cylindrical portion 8028 of the collar 8008 is located over the first end 7642 of the rigid support body 7608 alongside a section of the bend stiffener connected to the first end of the support body. As is shown in FIG. 81, in this position, the terminal end 8044 of the first protruding portion end region 8040 abuts against a collar abutment surface 8204 of the first retaining arm 7626₁. It will be appreciated that the first protruding portion end region 8040 similarly abuts against a respective collar abutment surface of the further retaining arm 76262. The first protruding portion end region therefore constitutes a retaining element abutment surface. At the position shown in FIG. 82, the spacing between the first protruding portion end region of the collar and the monopile wall 7618 may be such that the magnet 8048 may begin to urge the collar towards the monopile wall. It would be understood that the monopile wall is optionally formed from a magnetic material. It will be understood that urging the collar towards the monopile wall via the magnet would result from an attractive magnetic force between the magnet 8048 and the monopile wall 7618.

It will be appreciated that the collar abutment surface of the retaining arm is a further abutment surface and is located on an opposite side of the retaining arm to at least one (or a portion of) the wall abutment surface of the retaining arm.

FIG. 83 illustrates another step 8300 of the CPS decommission process for the CPS 7604 of FIGS. 76 to 82, in which a rigid support body 7608 is arranged through an aperture 7614 in a wall 7618 of a monopile 7622. It will be appreciated that in the step shown in FIG. 83 8300, the CPS is in substantially the same position as in FIG. 79 to FIG. 82. In FIG. 83, the collar winch 8060 has further unwound the collar winching line 8056 to further extend a free portion of the collar winching line 8056 when compared to the arrangement illustrated in FIG. 82. The collar 8008 has slide further along the rigid support body towards the monopile wall 7618. It will be appreciated that an attractive force between the magnet 8048 and the monopile wall 7618 urges the collar along the rigid support body towards the monopile wall. As the collar moves further towards the monopile wall, due to the abutting relationship between the abutment surface 8044 of the first protruding portion end region 8040 and the collar abutment surface 8204 of the first retaining arm 7626₁, the first retaining arm is urged away from the intermediate position of FIG. 82.

The first retaining arm 7626₁ is connected to the rigid support body at a swivel region 8308 that receives a connector. That is to say, the connector 8312 connects the first retaining arm 7626₁ to the support body and the retaining arm 7626₁ is able to swivel about the connector in the swivel region. The swivel region 8308 and the connector 8312 are arranged proximate to a first end 8316 of the first retaining arm 7626₁ and distal to a further 8320 end of the first retaining arm 7626₁. It will be appreciated that the collar abutment surface 8204 of the first retaining arm is positioned proximate to the further end 8320 of the first retaining arm 7626₁. It will also be appreciated that the further retaining arm 76262 is connected to the support body 7608 in a similar manner as described above for the first retaining arm 7626₁. It will be appreciated that swivelling of the retaining is a rotating motion that includes partially spinning the retaining arm about a point that is the swivel region. The retaining arms swivel away from a deployed position or an intermediate position, where the retaining arms are in an equilibrium position in which they facilitate retaining the support body within the monopile, and towards a non-deployed position in which the retaining arms do not retain the rigid support body through the aperture in the monopile wall.

FIG. 84 illustrates another step 8400 of the CPS decommission process for the CPS 7604 of FIGS. 76 to 83, in which a rigid support body 7608 is arranged through an aperture 7614 in a wall 7618 of a monopile 7622. It will be appreciated that in the step shown in FIG. 84 8400, the CPS is in substantially the same position as in FIG. 79 to FIG. 83. In FIG. 84, the collar winch 8060 has further unwound the collar winching line 8056 to further extend a free portion of the collar winching line 8056 when compared to the arrangement illustrated in FIG. 83. The collar 8008 has slid further along the rigid support body towards the monopile wall 7618. It will be appreciated that an attractive force between the magnet 8048 and the monopile wall 7618 urges the collar along the rigid support body towards the monopile wall. It will be appreciated that the attractive force is an attractive magnetic force. Due to the further displacement of the collar 8008 when compared with the arrangement of FIG. 83, the first retaining arm 7626 has further swivelled away from the deployed or intermediate position where the retaining arms are at a position which facilitates retaining the support body within the monopile and towards a non-deployed position in which the retaining arms do not retain the rigid support body through the aperture in the monopile wall. As is illustrated in FIG. 84, the cylindrical portion 8028 includes two cut out side regions 8408 with an arcuate edge on the end of the cylindrical portion from which the protruding section extends. The cut out side regions are arranged on opposite sides of the cylindrical portion such that the two cut out side regions are located on each side of the first protruding portion. As shown in FIG. 84, the cut out sides are arranged to receive the first end of the 8308 of the retaining arms such that the retaining arms can swivel towards a non-deployed position. The side of the cylindrical portion opposite the first protruding portion is not cut away and therefore constitutes a further protruding portion 8412. The first protruding portion is longer and extends further from the cylindrical portion than the further protruding portion. The first and further protruding portions extend in respective primary axes that are substantially parallel.

As illustrated in FIG. 84, the further protruding portion 8412 of the collar is substantially nose-like and includes a nose end region distal 8436 to the cylindrical portion 8028. The nose end region includes a further abutment surface that is a further protruding portion abutment surface 8440 at a terminal free end of the further protruding portion. It will be appreciated that the nose is an arcuate nose that includes an inner surface that lies on an imaginary circular cylinder aligned with an inner bore of the cylindrical portion. It will be appreciated that a magnet may be supported by the collar body distal to the cylindrical portion at an end region of a further protruding portion.

The inner surface collar body shown is generally cylindrical throughout. Optionally a radially inner surface of the first protruding portion and/or a further protruding portion may be flared out towards an end of the collar body distal to the cylindrical portion.

FIG. 85 illustrates another step 8500 of the CPS decommission process for the CPS 7604 of FIGS. 76 to 84, in which a rigid support body 7608 is arranged through an aperture 7614 in a wall 7618 of a monopile 7622. It will be appreciated that in the step shown in FIG. 85 8500, the CPS is in substantially the same position as in FIG. 79 to FIG. 84. In FIG. 85, the collar winch 8060 has further unwound the collar winching line 8056 to further extend a free portion of the collar winching line 8056 when compared to the arrangement illustrated in FIG. 84. The collar 8008 has slid further along the rigid support body and is now in an abutting relationship with an inner surface 8504 of the monopile wall 7618 proximate the aperture 7614. It will be understood that, via the magnet (and the attractive magnetic force between the magnet and monopile wall provided therefrom), the abutment surface 8044 of the first protruding portion end region 8040 of the collar 8008 and the inner surface of the monopile wall are urged into contact. As shown in FIG. 85, the first retaining arm 7626₁ has now swivelled to a non-deployed position 8508 where the first retaining arm 7626₁ does not prevent the rigid support body 7608 from being removed from the aperture 7614 in the monopile wall 7618. It will be appreciated that the first retaining element 7626₁ is no longer in abutment with the first abutment surface 8044 of the first protruding portion 8036 and instead rests against a non-deployed abutment surface 8512 that is an upper edge surface of the first protruding portion 8036. That is to say, as the first protruding portion is substantially arcuate, following the curve of the lower part of the cylindrical portion 8028 and the non-deployed abutment surface 8512 is located on an exposed arc edge. It will be appreciated that the further retaining arm 7626₁ rests against a respective non-deployed abutment surface on the remaining exposed arc end/edge. It will be appreciated that the collar winch, via the collar winching line, acts to selectively lower the collar from within the WTG.

FIG. 86 illustrates another step 8600 of the CPS decommission process for the CPS 7604 of FIGS. 76 to 85, in which a rigid support body 7608 is arranged through an aperture 7614 in a wall 7618 of a monopile 7622. As shown in FIG. 86, the collar 8008 remains in the same position as is shown in FIG. 85. It will be understood that the first abutment surface 8044 of the first protruding portion 8036 and the further abutment surface 8440 of the further protruding portion 8412 therefore remain in abutment with the inner surface 8504 of the monopile wall 718 as the magnet 8048 continues to urge the collar into abutment with the monopile wall. 7618. The rigid support body (and CPS generally) however is illustrated at a position that is further towards the environment 8608 outside of the monopile 7622 when compared to the arrangement of FIG. 86. That is to say that the rigid support body 7608 is arranged such that more of the rigid support body is located outside of the monopile such that a gap 8616 between the outer wall abutment surface 7908 of the outer sleeve 7912 and the outer surface 7920 of the monopile wall 7618 is present. This is achieved by relaxing the first tension applied to the cable provided by the first winch 7674 via the first winching line 7658 to allow the rigid support body to partially slide through the aperture towards the environment 8608, thereby allowing the CPS to move further towards or into the environment. Aptly, a further tension applied to a further end of the cable via a further winching line, acting in a direction to pull the cable further out of the monopile through the aperture, is cooperatively increased as the first tension is relaxed. It will be appreciated that the further tension may be provided by a further winch, connected to a remaining end of the further winching line, situated on a vessel of a platform and the like. In the position shown in FIG. 86, the first retaining arm 7626₁ (and also the further retaining arm 76262) is in the non-deployed position and extends through the aperture 7614.

It will be appreciated that the first abutment surface 8044 (of the first protruding portion) and the further abutment surface 8440 (of the further protruding portion) lie in a common plane oblique to an imaginary plane orthogonal to a primary axis associated with a through-bore of the collar body.

FIG. 87 illustrates another step 8700 of the CPS decommission process for the CPS 7604 of FIGS. 76 to 86, in which a rigid support body 7608 is arranged through an aperture 7614 in a wall 7618 of a monopile 7622. With reference to FIG. 86, the rigid support body 7608 (and the CPS 7604 as a whole) is located further towards, or within, the environment 8608 outside of the monopile 7622. It will be appreciated that this is due to further relaxing of the first tension on the cable provided by the first winch 7674 via the first winching line 7658. Aptly a further tension acting to pull the cable out of the monopile via the aperture is cooperatively further increased as the first tension is reduced. The first retaining arm 7626₁ (and the further retaining arm 76262 not shown in FIG. 87) are now wholly located outside of the monopile. It will be appreciated that the locating (by swivelling) of the retaining arms into a non-deployed position via the collar allows the retaining arms to pass through the aperture to be arranged outside of the monopile as shown in the position of FIG. 87.

FIG. 88 illustrates another step 8800 of the CPS decommission process for the CPS 7604 of FIGS. 76 to 87, in which a rigid support body 7608 is arranged through an aperture 7614 in a wall 7618 of a monopile 7622. It will be appreciated that the rigid support body and CPS are arranged in substantially the same position with respect to the aperture of the monopile wall as the arrangement shown in FIG. 87. The first retaining arm 7626₁ (and the further retaining arm 76262) is however no longer constrained into a non-deployed position and has therefore swivelled away from the non-deployed position under gravity (or optionally via a biasing element such as a spring). As the retaining element however is not located within the monopile in the arrangement of FIG. 88, the retaining element cannot aid in retaining the support body at least partially within the monopile.

FIG. 89 illustrates another step 8900 of the CPS decommission process for the CPS 7604 of FIGS. 76 to 88. With respect to FIGS. 88 and 89, the CPS is located further towards the environment 8608 by further relaxing the first tension provided on the cable by the first winch 7674 via the first winching line 7658. Aptly, via a further winching line connected to a further winch situated on a vessel or platform and the like, a further tension acting to pull the cable out of the monopile through the aperture is cooperatively further increased as the first tension is reduced. In the position of FIG. 89, the rigid support body 7608 is located entirely outside of the monopile 7622 and in the environment 8608. In the position illustrated in FIG. 89, only the free end of the bend stiffener 7646 of the CPS 7604 remains through the aperture 7614 and in the monopile 7622.

FIG. 90 illustrates another step 9000 of the CPS decommission process for the CPS 7604 of FIGS. 76 to 89. With respect to the position shown in FIG. 89, the CPS is located further towards the environment 8608 by further relaxing the first tension provided on the cable by the first winch 7674 via the first winching line 7658. Aptly, a further tension acting to pull the cable through the aperture and out of the monopile is cooperatively further increased. The CPS 7604 is now wholly located within the environment 8608 and has thus been removed from the monopile. That is to say that no part of the CPS 7604 is now located through the aperture 7618 in the monopile wall 7622. As illustrated in FIG. 90, the collar 8008 has been retracted axially along the first winching line 7658 within the monopile 7622 and in a direction towards the first winch 7674, from its position shown in FIGS. 85 to 89. It will be understood that this is achieved by winding in the collar winching line 8058 via the collar winch 8060 to reduce a length of the free portion of the collar winching line.

FIG. 91A illustrates the collar 8008 of FIGS. 80 to 90 in more detail. As illustrated in FIG. 91A, the collar includes a collar body 8016 which includes a first split collar body portion 8020₁ and a further split collar body portion 8020₂. It will be understood that the split collar body portions are substantially arcuate and are connected to form a substantially cylindrical collar 8008. The split collar body portions are secured together via straps. Other securing methods can alternatively be utilised. Alternatively, the collar is integrally formed. The collar 8008 includes a cylindrical portion 8028 which defines a tubular through bore through which a winching line can be threaded. An outer surface of the cylindrical portion includes an eyelet 8052 for receiving a winching line. It will be appreciated that the eyelet is arranged at a centre point of the curve of the arcuate further split collar body portion 8020₂. The collar 8008 includes a first protruding portion 8036. It will be understood that the first protruding portion is part of the first split collar body portion 8020₁. The protruding portion includes a first protruding portion end region 8040 distal to the cylindrical portion that includes a first abutment surface 8044. The first abutment surface 8044 is oblique to a primary axis associated with the protruding portion 8036. The collar 8008 also includes a further protruding portion 8412 that is a nose and is arranged radially opposite to the first protruding portion. The further protruding 8412 portion includes a nose-end region 8436 distal to the cylindrical portion that includes a further abutment surface 8440. The further protruding portion is part of the further split collar portion. The collar additionally includes two cut out side regions 8408 arranged at radially opposite sides of the collar 8008 for receiving an end of a respective retaining arm. It will be appreciated that the cut out side regions are part of the further split collar body portion. The collar of FIG. 91A 8008 additionally includes a magnet proximate to the first protruding portion end region 8040. The collar may optionally comprise a magnet proximate to the nose end region of the further protruding portion. Alternatively, the collar does not include any magnets.

The collar body illustrated in FIG. 91A has a mass of 50 kg or greater and is manufactured from a cast iron or a magnetisable material. Optionally the collar body may include a mass between 10 and 100 kg. Optionally any other suitable mass of collar body may be utilised. Optionally the collar body may be manufactured from any other magnetisable material.

Optionally the collar body may be manufactured from a non-magnetisable material. Optionally the collar body in formed from a metallic or alloy or polymeric or composite material.

It will be understood that a different collar may be utilised for systems which utilise different retaining elements such as prior art latches and/or ball-grab technologies. For example, a generally cylindrical collar may be utilised which includes a tapered inner surface that flares out towards an abutment surface for abutting against an inner surface of a monopile wall. It would be understood that such a collar may include magnets to help urge the collar over retaining elements.

FIG. 91B illustrates a further perspective view of the collar of FIG. 91A. It will be appreciated that FIG. 91B is a substantially top-down view of the collar. FIG. 91B helps illustrate how the cylindrical portion 8028 defines a through bore 8032 of the collar. FIG. 91B also helps illustrate how the further protruding portion 8412 is a nose that includes a nose end region 8436 that includes a further abutment surface 8440.

FIG. 91C illustrates a still further perspective view of the collar 8008 of FIG. 91A. It will be appreciated that FIG. 91C is a substantially bottom-up view of the collar 8008. FIG. 91C helps illustrate how the cylindrical portion 8028 defines a substantially tubular through bore 8032. FIG. 91C also helps illustrate the substantially arcuate first protruding portion 8036.

FIG. 91D illustrates another perspective view of the collar 8008 of FIG. 91A. FIG. 91D illustrates how the first and further split collar body portions 8020₁, 8020₂ are secured together to form the collar body 8016.

It will be appreciated that a radius associated with an imaginary circle substantially containing each arcuate edge of the cut out side regions of the collar, in a plan view of a side cross section of the collar body, is greater than a distance between an associated swivel point of a retaining element and at least one end of that retaining element. That is to say a radius associated with an imaginary circle substantially containing each arcuate edge of the cut out side regions of the collar is greater than a distance between an associated swivel point of a retaining element and at least one end of that retaining element.

It will additionally be appreciated that the first and further protruding portions have arcuate abutment ends that provide a stop to abut with a curved inner surface of a wall of the facility to locate the collar at a position in which a projection of the collar body axially towards the wall entirely surrounds the aperture in the wall.

Optionally the collar body may include a securing element to receive a manipulator connector from a remotely operated vehicle (ROV).

FIG. 92A illustrates a first step 9200 in another decommission process for a CPS 9204 in which a rigid support body 9208 is arranged at a predetermined location 9210 through an aperture 9214 in a wall 9218 of a monopile 9222. It will be understood that the monopile 9222 is an example of a facility. The CPS 9204 may be installed in any other suitable facility. Some examples of facilities are indicated with respect to FIG. 1. It will be understood that a decommission process involves removal of a CPS from an aperture of a facility. It will be understood that that the CPS 9204 illustrated in FIG. 92A in a first decommission step 9200 may be the CPS of FIG. 7, FIG. 20, FIG. 33, FIG. 46 or FIG. 61 when the rigid support body is disposed in a retained state (as shown for example in FIG. 10). The retained state is a retained position at the predetermined location 9210 of the support body. As shown in FIG. 92A, a retaining arm 9226 is disposed in a deployed position 9230 where two wall abutment surfaces 92341, 92342 of the retaining arm 9226 are in an abutting relationship with respective regions of an inner surface 9238 of the monopile wall 9218. The CPS shown in FIG. 92A utilises two retaining arms and therefore the retaining arm 9226₁ shown in FIG. 92A is a first retaining arm 9226₁.

FIG. 92A illustrates how a first end 9242 of the rigid support body 9208 is connected to a bend stiffener 9246. The bend stiffener shown in FIG. 92A is a dynamic bend stiffener. It will be appreciated that a bend stiffener is an example of a bend stiffening element and therefore the bend stiffener 9246 of FIG. 92A is an example of a dynamic bend stiffening element. The bend stiffener 9246 constitutes a terminal end of the CPS 9204 that is located in an inner region 9250 on the monopile 9222. It will be understood that the inner region 9250 is a region enclosed, or partially enclosed, by the wall 9218.

FIG. 92A also shows how a cable 9250 extends out of a terminal free end of the bend stiffener 9240 which is a terminal end of the CPS 9204 arrangement. The cable 9250 is an example of a flexible elongate member. A cable grip 9254 is arranged to secure around the end of the cable that is within the monopile 9222 (i.e. the cable grip secures around the end of the cable that is located in the inner region 9250 of the monopile). The cable grip 9254 is connected to a first winching line 9258 via a coupling 9262. The cable grip of FIG. 92A and the coupling arrangement 9262 between the grip 9254 and first winching line 9258 is the arrangement shown in FIG. 4. The cable grip is therefore a Chinese-Finger-like element. It will be appreciated that any other clamping or securing method could instead be utilised. A coupling loop 9266 of the cable grip 9254 extends through a pull-in head 9270. That is to say that the pull-in head 9270 includes a through-bore and the coupling loop 9266 is pulled through the through-bore of the pull-in head 9270. It will be understood that the pull-in head 9270 of FIG. 92A is oriented such that a plurality of latch fingers 9272 arranged circumferentially on an outer surface of the pull-in head flare out in a direction towards the winching line 9258. A remaining end of the first winching line is connected to a winch 9274. It will be appreciated that the winch 9274 is an example of a first elongate member winch element. It will be appreciated that the first winching line 9258 is an example of a first elongate member winching line.

FIG. 92B illustrates the CPS decommission step 9200 of FIG. 92A in cross section. FIG. 92B illustrates how the cable 9250 is arranged through a through bore 9278 which extends through the CPS 9204. FIG. 92B also illustrates the further retaining arm 9226₁ which is arranged in the deployed position 9230.

FIG. 93 illustrates a further step 9300 of the CPS decommission process for the CPS 9204 of FIG. 92A, in which a rigid support body 9208 is arranged at a predetermined location 9210 through an aperture 9214 in a wall 9218 of a monopile 9222, in cross section. As shown in FIG. 93, the cable has been pulled further outside of the monopile with respect to the position shown in FIGS. 92A and 92B. This may be achieved by cooperatively reducing a first tension on the cable, 9250 provided by the first winch 9274 from within the monopile via the first winching line 9258, and increasing a further tension on the cable, provided by a further winch from outside of the monopile 9218 via a further winching line. It will be appreciated that such cooperative tensioning of the cable (via adjustment of the first and further tensions) can be achieved by the arrangement described with reference to FIG. 5 above. It will be appreciated that the first tension and further tension could be measured using a tension meter and could be measured in Newtons (N). It will be appreciated that the first and further tensions are examples of pulling forces. As shown in FIG. 93 the cable 9250 has been pulled through the CPS 9204 such that a first end 9304 of the cable 9250 and a portion of the pull-in head 9270 is located within the bend stiffener 9246 of the CPS 9204.

It will be appreciated that, prior to connecting the cable to the first winching line (and also to the pull-in head adaptor) the end region of the cable, which is an example of a flexible elongate member, is unsecured from a securing element inside the facility. It will be appreciated that the cable extends through a through bore of the rigid support body.

FIG. 94 illustrates a still further step 9400 of the CPS decommission process for the CPS 9204 of FIGS. 92 and 93, in which a rigid support body 9208 is arranged at a predetermined location 9210 through an aperture 9214 in a wall 9218 of a monopile 9222, in cross section. As shown in FIG. 94, the cable has been pulled further outside of the monopile with respect to the position shown in FIG. 93 such that the first end 9304 of the cable 9250 is located within the rigid support body 9208. The pull-in head is located at a first end 9208 of the rigid support body 9208 such that the latch fingers 9272 of the pull-in head are engaged in an complimentary and abutting relationship with a latch finger engagement surface 9416 of the inner surface of the first end 9408 of the rigid support body 9208. That is to say that the latch finger engagement surface 9416 extends radially inwardly and is thus a narrowed region of the rigid support body 9208 inner diameter. Therefore, due to the direction in which the latch fingers 9272 flare out, which is oblique to the primary axis associated with the cable 9250 and widens in a direction towards the winching line, the latch fingers 9272 can be compressed to be pulled passed the latch finger engagement surface in a direction towards the aperture 9214. Once the latch fingers 9272 move past the latch finger engagement surface 9416, the latch fingers return to the flared out state such and are arranged to abut against the latch finger engagement surface as illustrated in FIG. 94 such that the pull-in head 9270 cannot move further inside the monopile (towards the winch) independently of the rigid support body of the CPS. It will be appreciated that one, or more than one, latch finger engagement surface may be arranged in the rigid support body.

FIG. 95 illustrates another step 9500 of the CPS decommission process for the CPS 9204 of FIGS. 92 to 94, in which a rigid support body 9208 is arranged through an aperture 9214 in a wall 9218 of a monopile 9222, in cross section. When compared with the position 9400 shown in FIG. 94, the cable 9250 of FIG. 95 has been pulled further into the monopile 9222. This is achieved by increasing the first tension (which acts towards the first winch 9274 located within a WTG which includes with the monopile 9222) on the cable 9250 provided by the first winch 9274 via the first winching line 9258. Due to the abutting relationship between the latch fingers 9272 of the pull-in head 9270 with the latch finger engagement surface 9416 of the inner surface of the rigid support body 9208, the cable cannot move back towards the first winch 9274 (further towards and into the monopile 9222) independently of the rigid support body 9208 of the CPS 9204. The rigid support body 9208 (alongside the entire CPS 9204) is thus lifted towards the monopile wall 9218, the support body 9208 extending further through the aperture 9214.

As shown in FIG. 95, the rigid support body 9208 is pulled further through the aperture 9214 of the monopile wall 9218 until a maximum displacement of the rigid support body 9204 through the aperture 9214 is reached. The maximum displacement is determined by the abutment of an outer wall abutment surface 9508 of an outer sleeve 9512 that surrounds a further end 9516 of the rigid support body 9208 distal to the first end 9304 of the support body with an outer surface 9520 of the monopile wall 9218 proximate the aperture 9214. The position 9500 illustrated in FIG. 95 is thus at this maximum displacement of the support body/CPS towards and into the monopile. As is illustrated, at this position, there is clearance/a gap 9524 between an inner surface 9528 of the monopile wall 9218 and the further retaining arm 9226₂. It will be appreciated that similar there is a similar gap/clearance between the inner surface 9528 of the monopile wall 9218 and the first retaining arm 9226₁. The retaining arms are thus no longer disposed in a deployed position and are instead arranged in an intermediate position 9528. The rigid support body is thus no longer disposed in a retained position and instead is arranged in an intermediate position 9532. That is to say that the rigid support body is urged away from the wall thereby locating all or substantially all of a wall abutment surface of each respective retaining member, element or arm in a spaced apart relationship with respect to the inner surface of the wall. It will be understood that a tension is applied to the end region of the cable via the first winch element thereby pulling the rigid support body and each retaining element supported on the rigid support body away from the inner surface of the wall. All, or substantially all of, the wall abutment surface associated with each retaining arm, which is a retaining member or element, is therefore arranged in a spaced apart relationship with respect to the inner surface of the wall.

FIG. 96 illustrates another step 9600 of the CPS 9204 decommission process of FIGS. 92 to 95, in which a rigid support body 9208 is arranged through an aperture 9214 in a wall 9218 of a monopile 9222. It will be appreciated that the rigid support body 9208 (and the CPS 9204) is held in substantially the same position as shown in FIG. 95 due to the first tension provided by the first winch 9274 via the first winching line 9258. It will be appreciated that the CPS may be subject to motion due to environmental stimuli such as currents and wave cycles and the like. A remotely operated underwater vehicle (ROV) 9604 has been lowered into the monopile to allow the rigid support body (and thus the CPS) to be removed from the aperture 9214 in the monopile wall 9218 from within the monopile 9222.

FIG. 97 illustrates another step 9700 of the CPS 9204 decommission process of FIGS. 92 to 96, in which a rigid support body 9208 is arranged through an aperture 9214 in a wall 9218 of a monopile 9222. It will be appreciated that the rigid support body 9208 (and the CPS 9204) is held in substantially the same position as shown in FIGS. 95 and 96 due to the first tension provided by the first winch 9274 via the first winching line 9258. In the arrangement shown in FIG. 97 the ROV, via a ROV manipulator arm 9704, has begun to swivel the first retaining arm 9226₁ away from the deployed or intermediate positions illustrated in FIGS. 92 to 96, which are positions in which the first retaining arm can retain the rigid support body through the aperture 9214 of the monopile wall 9218, towards a non-deployed position where the first retaining arm does not retain the support body through the aperture in the monopile wall. It will be appreciated that the ROV similarly swivels the further retaining arm towards a non-deployed position. Optionally a separate ROV swivels each retaining arm towards a non-deployed position. It will be appreciated that the clearance (or gap) 9526 provided between the respective retaining arms and the monopile wall 9218 allow for the swivelling motion of the retaining arms.

The first retaining arm 9226₁ is connected to the rigid support body at a swivel region 9708 that receives a connector 9712. That is to say, the connector 9712 connects the first retaining arm 9226₁ to the support body and the retaining arm 9226₁ is able to swivel about the connector in the swivel region. The swivel region 9708 and the connector 9712 are arranged proximate to a first end 9716 of the first retaining arm 9226₁ and distal to a further 9720 end of the first retaining arm 9226₁. It will be appreciated that the further retaining arm 9226₂ is connected to the support body 9208 in a similar manner as described above for the first retaining arm 9226₁. It will be appreciated that swivelling of the retaining is a rotating motion that includes partially spinning the retaining arm about a point that is the swivel region. The retaining arms swivel away from a deployed position or an intermediate position illustrated In FIGS. 92 to 96, where the retaining arms are in an equilibrium position in which they facilitate retaining the support body within the monopile, and towards a non-deployed position in which the retaining arms do not retain the rigid support body through the aperture in the monopile wall.

It will be appreciated that the retaining arm may be repositioned into a storage or intermediate position to facilitate removal of the support body from the monopile. Such an intermediate position may be a predetermined intermediate position in which the angle of swivel of the arm does not prohibit the arm from passing through the aperture. Such repositioning may be achieved via a (or more than one) human diver or Remote Operated Vehicle (ROV) or submersible apparatus or submersible transport located inside the monopile. It will be appreciated that such repositioning of the retaining arms is achieved via swivelling of the arm about the swivel point.

FIG. 98 illustrates another step 9800 of the CPS 9204 decommission process of FIGS. 92 to 97, in which a rigid support body 9208 is arranged through an aperture 9214 in a wall 9218 of a monopile 9222. It will be appreciated that the rigid support body 9208 (and the CPS 9204) is held in substantially the same position as shown in FIGS. 95 and 97 due to the first tension provided by the first winch 9274 via the first winching line 9258. As illustrated in FIG. 98,

The ROV 9504, via the manipulator arm 9704, has swivelled the first retaining arm 9226₁ (along with the further retaining arm 9226₂) to a non-deployed position 9804 which is a position where the retaining arms do not retain the rigid support body through the aperture 9214 of the monopile wall (9218). It will be understood that in the non-deployed position 9804, each retaining arm is able to pass through the aperture. Such a position may be a predetermined intermediate position.

FIG. 99 illustrates another step 9900 of the CPS decommission process for the CPS 9204 of FIGS. 92 to 98, in which a rigid support body 9208 is arranged through an aperture 9214 in a wall 9218 of a monopile 9222. The rigid support body (and CPS generally) however is illustrated at a position that is further towards the environment 9908 outside of the monopile 9222 when compared to the arrangement of FIG. 98. That is to say that the rigid support body 9208 is arranged such that more of the rigid support body is located outside of the monopile such that a gap 9916 between the outer wall abutment surface 9508 of the outer sleeve 9512 and the outer surface 9520 of the monopile wall 9218 is present. This is achieved by relaxing the first tension applied to the cable provided by the first winch 9274 via the first winching line 9258 to allow the rigid support body to partially slide through the aperture towards the environment 9908, thereby allowing the CPS to move further towards or into the environment. In the position shown in FIG. 99, the first retaining arm 9226₁ (and also the further retaining arm 9226₂) is in the non-deployed position and extends through the aperture.

It will be appreciated that, via the first winching line, the cable has effective been lowered from within the WTG.

FIG. 100 illustrates another step 10000 of the CPS decommission process for the CPS 9204 of FIGS. 92 to 99, in which a rigid support body 9208 is arranged through an aperture 9214 in a wall 9218 of a monopile 9222. With reference to FIG. 99, the rigid support body 9208 (and the CPS 9204 as a whole) is located further towards, or within, the environment 9908 outside of the monopile 9222. It will be appreciated that this is due to further relaxing of the first tension on the cable provided by the first winch 9274 via the first winching line 9258. Aptly, via a further winching line connected to a further winch situated on a vessel or platform and the like, a further tension acting to pull the cable out of the monopile through the aperture is cooperatively further increased as the first tension is reduced. The first retaining arm 9226₁ (and the further retaining arm 9226₂ not shown in FIG. 100) are now wholly located outside of the monopile. It will be appreciated that by virtue of locating (by swivelling) the retaining arms into a non-deployed position via the ROV 9604, the retaining arms are able to pass through the aperture to be arranged outside of the monopile as shown in the position of FIG. 100. That is to say that, in the non-deployed position, the retaining arms are not disposed in an arrangement in which the arms are prevented from passing through the aperture in the monopile wall.

FIG. 101 illustrates another step 10100 of the CPS decommission process for the CPS 9204 of FIGS. 92 to 100, in which a rigid support body 9208 is arranged through an aperture 9214 in a wall 9218 of a monopile 9222. It will be appreciated that the rigid support body and CPS are arranged in substantially the same position with respect to the aperture of the monopile wall as the arrangement shown in FIG. 100. The first retaining arm 9226₁ (and the further retaining arm 9226₂) is however no longer constrained into a non-deployed position and has therefore swivelled away from the non-deployed position under gravity (or optionally via a biasing element such as a spring). As the retaining element however is not located within the monopile in the arrangement of FIG. 101, the retaining element cannot aid in retaining the support body at least partially within the monopile.

FIG. 102 illustrates another step 10200 of the CPS decommission process for the CPS 9204 of FIGS. 92 to 101. With respect to FIGS. 100 and 102, the CPS is located further towards the environment 8608 by further relaxing the first tension provided on the cable by the first winch 9274 via the first winching line 9258. In the position of FIG. 102, the rigid support body 9208 is located entirely outside of the monopile 9222 and in the environment 9908. In the position illustrated in FIG. 102, only the free end of the bend stiffener 9246 of the CPS 9204 remains through the aperture 9214 and in the monopile 9222.

FIG. 103 illustrates another step 10300 of the CPS decommission process for the CPS 9204 of FIGS. 92 to 102. With respect to the position shown in FIG. 103, the CPS is located further towards the environment 9908 by further relaxing the first tension provided on the cable by the first winch 9274 via the first winching line 9258. Aptly a further tension acting to pull the cable through the aperture out of the monopile, provided by a further winch that is located on a vessel or platform outside of the monopile via a further winching line, is increased cooperatively as the first tension is relaxed. The CPS 9204 is now wholly located within the environment 9908 and has thus been removed from the monopile. That is to say that no part of the CPS 9204 is now located through the aperture 9218 in the monopile wall 9222.

It will be appreciated that in the decommission process described with reference to FIGS. 92 to 103, the first and further retaining arms could instead be removed. This may be achieved by removing a respective connector associated with a respective retaining arm from the rigid support body or by removing a retaining arm from a respective connector. This may be achieved by unbolting or unscrewing and the like. A connector could additionally be cut or sheared to remove a respective retaining arm. Optionally, the retaining arms may be removed using any other suitable removal technique.

It will be appreciated that in the decommission process described with reference to FIGS. 92 to 103 occurs subsequent to urging at least a first portion of a rigid support body, which is proximate to the bend stiffener in the CPS arrangement through an aperture in a wall of a facility, the facility shown herein being a WTG that includes a monopile, from outside to inside the facility. It will be appreciated that a covered portion of a flexible elongate member extends through the rigid support body. In the arrangement described with reference to FIGS. 92 to 103 the covered portion of a flexible elongate member is a section of the cable that at a particular instance in time is located radially within the rigid support body. It will be appreciated that the decommission process described with reference to FIGS. 92 to 103 also occurs subsequent to positioning at least one retaining element, which is a retaining arm in the arrangement described with reference to FIGS. 92 to 103, supported via the rigid support body in a respective deployed position in which a respective wall abutment surface of the retaining element is disposed in an abutting relationship against an inner surface of a wall of the facility, for retaining the rigid support body at a predetermined location with respect to the wall of the facility in which at least a first portion of the rigid support body is inside the facility. It will be appreciated that the deployed position is an equilibrium position and is shown in FIGS. 92A and B.

It will be appreciated that the decommission process described with reference to FIGS. 92 to 103 occurs entirely within the monopile itself. That is to say that the one or more active repositioning steps performed by the ROV which includes swivelling (or optionally removing) the retaining arms are wholly performed inside the monopile. That is to say that repositioning each retaining element from the deployed position and an intermediate position by swivelling towards a non-deployed position occurs within the monopile. The first portion of the support body (which is a part of the support body located within the monopile when the support body is in a retained state) can subsequently be urged through the aperture from inside to outside the facility thereby removing the first portion from the facility. This urging is optionally undertaken by the ROV from within the monopile. It will be appreciated that in emergency situations, or otherwise, one or more human divers may also be present within the monopile to perform such decommissioning activities.

The swivelling of a respective retaining arm from a deployed or intermediate position (or state) to a non-deployed position (or state) is an example of an active repositioning step. Another example of an active repositioning step is removal of a retaining arm. It will be appreciated that such steps include a predetermined action associated only with the step of repositioning a retaining element and are initiated and completed only as part of the active repositioning step. These steps are undertaken entirely from within the monopile and therefore divers or ROVs and the like are not required to be situated in potentially hostile environments, for example the environment outside of the monopile. It will be understood that such repositioning steps are carried out without carrying out any action associated with the repositioning via any repositioning component, used to reposition a retaining element, that extends through the aperture when the retaining element is repositioned. That is to say that there is no requirement for an ROV, for example, to be arranged outside the monopile and utilise any equipment that extends through the aperture into the monopile. It will be appreciated that swivelling the retaining arm away from a deployed or intermediate position and to a non-deployed position may include swivelling the retaining arm to another intermediate position or to a storage position.

It will be appreciated that repositioning each retaining arm can be facilitated by urging the rigid support body in a direction away from the wall. All, or substantially all, of the wall abutment surface of each respective retaining arm is thus disposed in a spaced apart relationship with respect to the inner surface of the wall.

It will further be appreciated that the decommissioning processes described herein may include unsecuring an end region of the cable, that extends through the through bore in the rigid support body, from a securing element inside the facility. Subsequently raising the end region of the cable via the first winch pulls the rigid support body and each retaining arm supported on the rigid support body away from the inner surface of the wall thereby locating all or substantially all of a wall abutment surface associated with each retaining arm in a spaced apart relationship with respect to the inner surface of the wall.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method for locating a rigid support body at a predetermined location with respect to an aperture in a wall of a facility, comprising the steps of:
providing a rigid support body at a first position outside a facility, the rigid support body comprising at least one retaining element disposed in a storage position, and comprising a through-bore that extends through the support body from a first end of the support body to a further end;
via a first pulling force applied to a first terminal end region of a flexible elongate member that includes a covered region located in the through-bore, urging the rigid support body at least partially through an aperture in a wall of a facility, the rigid support body thereby being located at a further position whereby a portion of the rigid support body and at least one retaining element supported on the rigid support body is within the facility and the retaining element is spaced apart from an inner surface of the wall of the facility;
subsequent to location of said retaining element within the facility and in a spaced apart relationship with said inner wall surface, positioning the retaining element out of a storage position by selectively swivelling the retaining element from the storage position; and
subsequently urging the rigid support body into a retained position whereby at least a portion of an abutment surface of the retaining element is disposed in an abutting relationship with the inner surface of the wall proximate to the aperture to thereby locate the rigid support body at a predetermined location with respect to the aperture in which the retaining element is disposed in a deployed position.

2. The method as claimed in claim 1, further comprising:
securing a terminal end of a first winching line to the first terminal end region of the flexible elongate member, the winching line optionally being secured to the flexible elongate member via a Chinese finger cable grip element.

3. The method as claimed in claim 2, further comprising:
providing the first pulling force via a tension in the first winching line provided by a winching element coupled to a remaining terminal end of the first winching line.

4. The method as claimed in claim 1, further comprising the steps of:
applying the first pulling force applied to the first terminal end in a first pulling direction and, via the first pulling force, providing an urging force to the rigid support body in a first penetration direction aligned with an axis of the rigid support body.

5. The method as claimed in claim 4, further comprising:
applying the first pulling force applied to the first terminal end in the first pulling direction that is a substantially vertically upward direction.

6. The method as claimed in claim 1, further comprising:
securing a remaining terminal end region of the flexible elongate member to a tensioning element, the tensioning element optionally being secured to the flexible elongate member via a further Chinese finger cable grip element, the tensioning element optionally comprising a further winching line, a cable engine or a clamping quadrant.

7. The method as claimed in claim 6, further comprising:
via a further pulling force on the tensioning element, urging the rigid support body in a further penetration direction directed away from within the facility, the penetration direction optionally extending in an axis that is around 45 degrees to the primary axis associated with the wall of the facility.

8. The method as claimed in claim 1, further comprising:
urging the rigid support body into the retained position via relaxing the first pulling force and allowing movement of a previously inside portion of the rigid support body out of the facility via gravity.

9. The method as claimed in claim 1, further comprising:
positioning the retaining element by selectively swivelling the retaining element from the storage position to the deployed position, optionally via an intermediate position.

10. The method as claimed in claim 9 wherein the step of selectively swivelling comprises:
selectively swivelling at least one of a pair of retaining arms, each disposed on respective opposed sides of the rigid support body, about a respective swivel point, from a storage position towards a deployed position, optionally via an intermediate position.

11. The method as claimed in claim 10, further comprising:
simultaneously swivelling both retaining arms of the pair.

12. The method as claimed in claim 10, whereby the step of selectively swivelling comprises:
removing a securing constraint on each retaining arm and subsequently urging each retaining arm to the deployed position via gravity or via a biasing force exerted via a biasing member.

13. The method as claimed in claim 1, further comprising:
reversibly urging the retaining element into a deployed position.

14. The method as claimed in claim 1, further comprising:
via a sealing element, sealing the aperture around the rigid support body to thereby prevent fluid communication between the facility and the environment in at least one direction.

15. The method as claimed in claim 1, further comprising:
with the rigid body in the retained position in which an axial position of the rigid support body with respect to a location of the aperture remains substantially unchanged, constantly adjusting a swivel angle and/or an angle of attack, of an abutment surface of a retaining element, adopted by each retaining element responsive to environmental forces whereby the retaining element maintains an equilibrium position responsive to all forces exerted on the rigid support body despite at least one of a yaw and pitch and roll angle associated with an orientation of the rigid support body varying.

16. The method as claimed in claim 1, further comprising:
releasing each retaining element from a storage position by breaking a frangible connection of an associated retaining latch arm via an ROV or by urging an abutment element of the latch arm into abutment with an outside surface of the wall as the rigid support body is urged at least partly through the aperture.

17. The method as claimed in claim 1, further comprising:
at least a portion of the inner surface of the wall of the facility comprises a protective layer to reduce damage and/or wear, the protective layer optionally being corrosion resistant.

18. The method as claimed in claim 1, further comprising:
the facility comprises a monopile that optionally comprises a portion of a turbine tower of a Wind Turbine Generator (WTG).

19. The method as claimed in claim 1, further comprising:
the flexible elongate member comprises a flexible pipe or umbilical or a submarine cable and optionally the elongate member comprises a dynamic portion of a submarine electricity cable.

20. The method as claimed in claim 1, further comprising:
the rigid support body is arranged, in the retained position in which the retaining element is located in a deployed position, at an oblique angle in respect of a vertical axis associated with the facility, the angle optionally being about around 45 degrees.
